(19) United States
(12) Patent Application Publication
(10) Pub. No.: US 2026/0235856 A1
(43) Pub. Date: Aug. 13, 2026

(54) VARIABLE MAGNIFICATION OPTICAL SYSTEM AND IMAGING APPARATUS

(71) Applicant: FUJIFILM Corporation, Tokyo (JP)

(72) Inventor: Masato KONDO, Saitama-shi (JP)

(73) Assignee: FUJIFILM Corporation, Tokyo (JP)

(21) Appl. No.: 19/640,011

(22) Filed: Apr. 6, 2026

Related U.S. Application Data
(63) Continuation of application No. PCT/JP2024/032442, filed on Sep. 10, 2024.

(30) Foreign Application Priority Data
Oct. 12, 2023 (JP) 2023-177108

(51) Int. Cl. G02B 15/14

(52) U.S. Cl. CPC G02B 15/1455

(57) ABSTRACT

A variable magnification optical system consists of a first lens group having a positive refractive power, an intermediate group consisting of two or fewer lens groups that have a negative refractive power, and a subsequent group consisting of a plurality of lens groups in order from an object side to an image side. A lens group of the subsequent group that is closest to the object side has a positive refractive power. The first lens group moves and all spacings of adjacent lens groups change during changing a magnification. The variable magnification optical system satisfies a predetermined conditional expression.

### CROSS-REFERENCE TO RELATED APPLICATIONS

This application is a continuation application of International Application No. PCT/JP2024/032442, filed on Sep. 10, 2024, which claims priority from Japanese Patent Application No. 2023-177108, filed on Oct. 12, 2023. The entire disclosure of each of the above applications is incorporated herein by reference.

### BACKGROUND

### Technical Field

A technology of the present disclosure relates to a variable magnification optical system and an imaging apparatus.

### Related Art

In the related art, as a variable magnification optical system that is usable in an imaging apparatus such as a digital camera, a variable magnification optical system disclosed in JP2023-040257A is known.

### SUMMARY

A variable magnification optical system that is configured to be reduced in size and that maintains favorable optical performance in an entire magnification range is desired. Levels of these requirements have been increasing year by year.

The present disclosure provides a variable magnification optical system that is configured to be reduced in size and that maintains favorable optical performance in an entire magnification range, and an imaging apparatus comprising the variable magnification optical system.

According to a first aspect of the present disclosure, there is provided a variable magnification optical system consisting of a first lens group having a positive refractive power, an intermediate group consisting of two or fewer lens groups that have a negative refractive power, and a subsequent group consisting of a plurality of lens groups in order from an object side to an image side, in which a lens group of the subsequent group that is closest to the object side has a positive refractive power, the first lens group moves and all spacings of adjacent lens groups change during changing a magnification, and Conditional Expressions (1), (2), and (3) are satisfied, which are represented by

$$2.9 < TLw / ( f t \times tan ω t ) < 7 , \qquad ( 1 )$$

$$0.4 < Bfw / ( f t \times tan ω t ) < 1.5 , and \qquad ( 2 )$$

$$0.05 < ( fw \times TLw ) / ( f {t}^{2} \times FNow ) < 0.23 . \qquad ( 3 )$$

Symbols in Conditional Expressions (1), (2), and (3) are defined as follows. A sum of a distance on an optical axis from a lens surface of the first lens group that is closest to the object side to a lens surface of the subsequent group that is closest to the image side and a back focus of an entire system in an air-equivalent distance, in a state in which an infinite distance object is in focus at a wide angle end, is denoted by TLw. A focal length of the entire system in a state in which the infinite distance object is in focus at a telephoto end is denoted by ft. A maximum half angle of view in a state in which the infinite distance object is in focus at the telephoto end is denoted by @t. The back focus of the entire system in the air-equivalent distance in a state in which the infinite distance object is in focus at the wide angle end is denoted by Bfw. A focal length of the entire system in a state in which the infinite distance object is in focus at the wide angle end is denoted by fw. An open F-number in a state in which the infinite distance object is in focus at the wide angle end is denoted by FNow.

In a second aspect of the present disclosure, in the variable magnification optical system of the first aspect, Conditional Expression (3-1) is satisfied, which is represented by

$$0.08 < ( f w \times T L w ) / ( f {t}^{2} \times FNow ) < 0.165 . \qquad ( 3 - 1 )$$

In a third aspect of the present disclosure, in the variable magnification optical system of the second aspect, Conditional Expression (3-2) is satisfied, which is represented by

$$0.1 < ( f w \times TLw ) / ( f {t}^{2} \times FNow ) < 0.16 . \qquad ( 3 - 2 )$$

In a fourth aspect of the present disclosure, in the variable magnification optical system of the first aspect, in a case in which a maximum half angle of view in a state in which the infinite distance object is in focus at the wide angle end is denoted by ωw, Conditional Expression (4) is satisfied, which is represented by

$$0.1 5 < tan ω w / FNow < 0.5 . \qquad ( 4 )$$

In a fifth aspect of the present disclosure, in the variable magnification optical system of the first aspect, Conditional Expression (5) is satisfied, which is represented by

$$0.65 < FNow / ( f t / f w ) < 1.6 . \qquad ( 5 )$$

In a sixth aspect of the present disclosure, in the variable magnification optical system of the first aspect, in a case in which a focal length of the first lens group is denoted by f1, Conditional Expression (6) is satisfied, which is represented by

$$0.02 < f w / f l < 0.3 . \qquad ( 6 )$$

In a seventh aspect of the present disclosure, in the variable magnification optical system of the first aspect, in a case in which a focal length of the first lens group is denoted by f1, and a focal length of the intermediate group in a state in which the infinite distance object is in focus at the wide angle end is denoted by fMw, Conditional Expression (7) is satisfied, which is represented by

$$4.5 < f l / ( - f M w ) < 14 . \qquad ( 7 )$$

In an eighth aspect of the present disclosure, in the variable magnification optical system of the first aspect, in a case in which a focal length of the intermediate group in a state in which the infinite distance object is in focus at the wide angle end is denoted by fMw, Conditional Expression (8) is satisfied, which is represented by

$$0.3 < ( - fMw ) / {( f w \times f t )}^{1 / 2} < 1.4 . \qquad ( 8 )$$

In a ninth aspect of the present disclosure, in the variable magnification optical system of the first aspect, in a case in which a focal length of the first lens group is denoted by f1, and an open F-number in a state in which the infinite distance object is in focus at the telephoto end is denoted by FNot, Conditional Expression (9) is satisfied, which is represented by

$$5 < f 1 / ( ft / FNot ) < 20. \qquad ( 9 )$$

In a tenth aspect of the present disclosure, in the variable magnification optical system of the first aspect, Conditional Expression (10) is satisfied, which is represented by

$$2.5 < T Lw / fw < 8. \qquad ( 10 )$$

In an eleventh aspect of the present disclosure, in the variable magnification optical system of the second aspect, Conditional Expression (1-1) is satisfied, which is represented by

$$3. 5 < TLw / ( ft \times tan ω t ) < 6. \qquad ( 1 - 1 )$$

In a twelfth aspect of the present disclosure, in the variable magnification optical system of the eleventh aspect, in a case in which a maximum half angle of view in a state in which the infinite distance object is in focus at the wide angle end is denoted by ow, Conditional Expression (4-1) is satisfied, which is represented by

$$0. 21 < tan ω w / FNow < 0.35 . \qquad ( 4 - 1 )$$

In a thirteenth aspect of the present disclosure, in the variable magnification optical system of the twelfth aspect, Conditional Expression (5-1) is satisfied, which is represented by

$$0.85 < FNow / ( ft / fw ) < 1.28 . \qquad ( 5 - 1 )$$

In a fourteenth aspect of the present disclosure, in the variable magnification optical system of the thirteenth aspect, in a case in which a focal length of the first lens group is denoted by f1, Conditional Expression (6-2) is satisfied, which is represented by

$$0.05 < fw / f 1 < 0.13 . \qquad ( 6 - 2 )$$

In a fifteenth aspect of the present disclosure, in the variable magnification optical system of the fourteenth aspect, in a case in which a focal length of the intermediate group in a state in which the infinite distance object is in focus at the wide angle end is denoted by fMw, Conditional Expression (7-1) is satisfied, which is represented by

$$5.7 < f 1 / ( - fMw ) < 8.7 . \qquad ( 7 - 1 )$$

In a sixteenth aspect of the present disclosure, in the variable magnification optical system of the fifteenth aspect, the first lens group includes a negative lens and a positive lens.

In a seventeenth aspect of the present disclosure, in the variable magnification optical system of the fifteenth aspect, the intermediate group includes three negative lenses.

In an eighteenth aspect of the present disclosure, in the variable magnification optical system of the fourteenth aspect, the intermediate group includes an Lmn lens having a negative refractive power, and a surface of the Lmn lens on the object side is an aspherical surface in which a refractive power at a position of a maximum effective diameter is shifted in a positive direction compared to a refractive power in a paraxial region.

In a nineteenth aspect of the present disclosure, in the variable magnification optical system of the eighteenth aspect, the surface of the Lmn lens on the object side has a concave shape in the paraxial region and has a convex shape in a peripheral portion including the position of the maximum effective diameter.

In a twentieth aspect of the present disclosure, in the variable magnification optical system of the fifteenth aspect, Conditional Expression (10-1) is satisfied, which is represented by

$$3. 5 < TLw / fw < 6. \qquad ( 10 - 1 )$$

In a twenty-first aspect of the present disclosure, in the variable magnification optical system of the fifteenth aspect, in a case in which the focal length of the intermediate group in a state in which the infinite distance object is in focus at the wide angle end is denoted by fMw, Conditional Expression (8-1) is satisfied, which is represented by

$$0.6 < ( - fMw ) / {( fw \times ft )}^{1 / 2} < 0.9 . \qquad ( 8 - 1 )$$

In a twenty-second aspect of the present disclosure, in the variable magnification optical system of the fifteenth aspect, in a case in which an open F-number in a state in which the infinite distance object is in focus at the telephoto end is denoted by FNot, Conditional Expression (9-1) is satisfied, which is represented by

$$7 < f 1 / ( ft / FNot < 11. \qquad ( 9 - 1 )$$

In a twenty-third aspect of the present disclosure, in the variable magnification optical system of the third aspect, Conditional Expression (1-1) is satisfied, which is represented by

$$3. 5 < TLw / ( ft \times tan ω t ) < 6. \qquad ( 1 - 1 )$$

In a twenty-fourth aspect of the present disclosure, in the variable magnification optical system of the twenty-third aspect, in a case in which a maximum half angle of view in a state in which the infinite distance object is in focus at the wide angle end is denoted by ow, Conditional Expression (4-1) is satisfied, which is represented by

$$0.21 < tan ω w / FNow < 0.35 . \qquad ( 4 - 1 )$$

In a twenty-fifth aspect of the present disclosure, in the variable magnification optical system of the twenty-fourth aspect, Conditional Expression (5-1) is satisfied, which is represented by

$$0.85 < FNow / ( ft / fw ) < 1.28 . \qquad ( 5 - 1 )$$

In a twenty-sixth aspect of the present disclosure, in the variable magnification optical system of the twenty-fifth aspect, in a case in which a focal length of the first lens group is denoted by f1, Conditional Expression (6-1) is satisfied, which is represented by

$$0.048 < fw / f 1 < 0.14 . \qquad ( 6 - 1 )$$

In a twenty-seventh aspect of the present disclosure, in the variable magnification optical system of the twenty-sixth aspect, in a case in which a focal length of the intermediate group in a state in which the infinite distance object is in focus at the wide angle end is denoted by fMw, Conditional Expression (7-1) is satisfied, which is represented by

$$5.7 < f 1 / ( - fMw ) < 8.7 . \qquad ( 7 - 1 )$$

In a twenty-eighth aspect of the present disclosure, in the variable magnification optical system of the twenty-seventh aspect, the first lens group includes a negative lens and a positive lens.

In a twenty-ninth aspect of the present disclosure, in the variable magnification optical system of the twenty-seventh aspect, the intermediate group includes three negative lenses.

In a thirtieth aspect of the present disclosure, in the variable magnification optical system of the twenty-sixth aspect, the intermediate group includes an Lmn lens having a negative refractive power, and a surface of the Lmn lens on the object side is an aspherical surface in which a refractive power at a position of a maximum effective diameter is shifted in a positive direction compared to a refractive power in a paraxial region.

In a thirty-first aspect of the present disclosure, in the variable magnification optical system of the thirtieth aspect, the surface of the Lmn lens on the object side has a concave shape in the paraxial region and has a convex shape in a peripheral portion including the position of the maximum effective diameter.

In a thirty-second aspect of the present disclosure, in the variable magnification optical system of the twenty-seventh aspect, Conditional Expression (10-1) is satisfied, which is represented by

$$3. 5 < TLw / fw < 6 . \qquad ( 10 - 1 )$$

In a thirty-third aspect of the present disclosure, in the variable magnification optical system of the twenty-seventh aspect, in a case in which the focal length of the intermediate group in a state in which the infinite distance object is in focus at the wide angle end is denoted by fMw, Conditional Expression (8-1) is satisfied, which is represented by

$$0.6 < ( - fMw ) / {( f w \times f t )}^{1 / 2} < 0.9 . \qquad ( 8 - 1 )$$

In a thirty-fourth aspect of the present disclosure, in the variable magnification optical system of the twenty-seventh aspect, in a case in which an open F-number in a state in which the infinite distance object is in focus at the telephoto end is denoted by FNot, Conditional Expression (9-1) is satisfied, which is represented by

$$7 < f l / ( f t / FNot ) < 11. \qquad ( 9 - 1 )$$

In a thirty-fifth aspect of the present disclosure, in the variable magnification optical system of the first aspect, in a case in which an open F-number in a state in which the infinite distance object is in focus at the telephoto end is denoted by FNot, and a sum of a distance on the optical axis from the lens surface of the first lens group that is closest to the object side to the lens surface of the subsequent group that is closest to the image side and a back focus of the entire system in the air-equivalent distance, in a state in which the infinite distance object is in focus at the telephoto end, is denoted by TLt, Conditional Expression (11) is satisfied, which is represented by

$$8 < FNot \times ( TLt / f t ) < 17. \qquad ( 11 )$$

In a thirty-sixth aspect of the present disclosure, in the variable magnification optical system of the first aspect, in a case in which a focal length of the first lens group is denoted by f1, and a focal length of the lens group of the subsequent group that is closest to the object side is denoted by fR1, Conditional Expression (12) is satisfied, which is represented by

$$1. 5 < f l / fR 1 < 17. \qquad ( 12 )$$

In a thirty-seventh aspect of the present disclosure, in the variable magnification optical system of the first aspect, Conditional Expression (13) is satisfied, which is represented by

$$1. 2 < TLw / f t < 2.2 . \qquad ( 13 )$$

In a thirty-eighth aspect of the present disclosure, in the variable magnification optical system of the first aspect, Conditional Expression (14) is satisfied, which is represented by

$$2.8 < f t / f w < 4 . \qquad ( 14 )$$

In a thirty-ninth aspect of the present disclosure, in the variable magnification optical system of the first aspect, in a case in which a focal length of the first lens group is denoted by f1, Conditional Expression (15) is satisfied, which is represented by

$$3 < fl / {( f w \times f t )}^{1 / 2} < 9. \qquad ( 15 )$$

In a fortieth aspect of the present disclosure, in the variable magnification optical system of the first aspect, in a case in which a sum of a distance on the optical axis from the lens surface of the first lens group that is closest to the object side to the lens surface of the subsequent group that is closest to the image side and a back focus of the entire system in terms of the air-equivalent distance, in a state in which the infinite distance object is in focus at the telephoto end, is denoted by TLt, Conditional Expression (16) is satisfied, which is represented by

$$1. 25 < TLt / TLw < 1.6 . \qquad ( 16 )$$

In a forty-first aspect of the present disclosure, in the variable magnification optical system of the first aspect, in a case in which a focal length of the subsequent group in a state in which the infinite distance object is in focus at the wide angle end is denoted by fRw, Conditional Expression (17) is satisfied, which is represented by

$$0.3 < fw / f R w < 1.2 . \qquad ( 17 )$$

In a forty-second aspect of the present disclosure, in the variable magnification optical system of the first aspect, in a case in which a focal length of the subsequent group in a state in which the infinite distance object is in focus at the telephoto end is denoted by fRt, Conditional Expression (18) is satisfied, which is represented by

$$0.6 < f t / f R t < 5 . \qquad ( 18 )$$

In a forty-third aspect of the present disclosure, in the variable magnification optical system of the first aspect, in a case in which a focal length of the lens group of the subsequent group that is closest to the object side is denoted by fR1, Conditional Expression (19) is satisfied, which is represented by

$$0.05 < f R 1 / {( f w \times f t )}^{1 / 2} < 3 . \qquad ( 19 )$$

In a forty-fourth aspect of the present disclosure, in the variable magnification optical system of the first aspect, in a case in which a focal length of the lens group of the subsequent group that is closest to the object side is denoted by fR1, Conditional Expression (20) is satisfied, which is represented by

$$0.15 < f w / fR 1 < 2. \qquad ( 20 )$$

In a forty-fifth aspect of the present disclosure, in the variable magnification optical system of the first aspect, an anti-vibration group that moves in a direction intersecting the optical axis during image shake correction is disposed in the subsequent group, and in a case in which a focal length of the anti-vibration group is denoted by fIS, Conditional Expression (21) is satisfied, which is represented by

$$0.2 < \vert fIS / f t \vert < 2. \qquad ( 21 )$$

In a forty-sixth aspect of the present disclosure, in the variable magnification optical system of the first aspect, at least one focusing group that moves along the optical axis during focusing is disposed in the subsequent group, and in a case in which a focal length of the at least one focusing group is denoted by ff, Conditional Expression (22) is satisfied, which is represented by

$$0.2 < \vert ff / f t \vert < 1.4 . \qquad ( 22 )$$

In a forty-seventh aspect of the present disclosure, in the variable magnification optical system of the first aspect, the subsequent group includes an Lrn lens having a negative refractive power, and a surface of the Lrn lens on the image side is an aspherical surface in which a refractive power at a position of a maximum effective diameter is shifted in a positive direction compared to a refractive power in a paraxial region.

In a forty-eighth aspect of the present disclosure, in the variable magnification optical system of the forty-seventh aspect, the surface of the Lrn lens on the image side has a concave shape in the paraxial region and has a convex shape in a peripheral portion including the position of the maximum effective diameter.

In a forty-ninth aspect of the present disclosure, in the variable magnification optical system of the first aspect, a focusing group that moves along the optical axis during focusing is disposed only in the subsequent group.

In a fiftieth aspect of the present disclosure, in the variable magnification optical system of the forty-ninth aspect, two focusing groups that move by changing a mutual spacing during focusing are disposed in the subsequent group.

In a fifty-first aspect of the present disclosure, in the variable magnification optical system of the first aspect, the first lens group includes a cemented lens formed by a negative meniscus lens having a convex surface facing the object side and a positive lens having a convex surface facing the object side cemented together in order from the object side, and in a case in which a refractive index of the negative meniscus lens for a d line is denoted by Ndn, and an Abbe number of the negative meniscus lens based on the d line is denoted by vdn, Conditional Expression (23) is satisfied, which is represented by

$$1.94 < Ndn + 0.01 \times vdn < 2.5 . \qquad ( 23 )$$

In a fifty-second aspect of the present disclosure, in the variable magnification optical system of the fifty-first aspect, in a case in which a refractive index of the positive lens for the d line is denoted by Ndp, the positive lens having the convex surface facing the object side, and an Abbe number of the positive lens based on the d line is denoted by vdp, the positive lens having the convex surface facing the object side, Conditional Expression (24) is satisfied, which is represented by

$$2 < Ndp + 0.01 \times vdp < 2.6 . \qquad ( 24 )$$

In a fifty-third aspect of the present disclosure, in the variable magnification optical system of the first aspect, in a case in which an average value of Abbe numbers of all positive lenses of the first lens group based on a d line is denoted by vdlp_ave, Conditional Expression (25) is satisfied, which is represented by

$$40 < vd1p\_ave < 85. \qquad ( 25 )$$

In a fifty-fourth aspect of the present disclosure, in the variable magnification optical system of the first aspect, in a case in which a sum of thicknesses of all lenses of the first lens group on the optical axis is denoted by dlsum, and a focal length of the first lens group is denoted by f1, Conditional Expression (26) is satisfied, which is represented by

$$0.01 < d 1 sum / f 1 < 0.2 . \qquad ( 26 )$$

In a fifty-fifth aspect of the present disclosure, in the variable magnification optical system of the first aspect, the intermediate group consists of two lens groups having a negative refractive power, and in a case in which a focal length of a lens group of the intermediate group that is closest to the object side is denoted by fM1, and a focal length of a lens group of the intermediate group that is closest to the image side is denoted by fM2, Conditional Expression (27) is satisfied, which is represented by

$$0.01 < fM 1 / fM 2 < 1.6 . \qquad ( 27 )$$

In a fifty-sixth aspect of the present disclosure, in the variable magnification optical system of the first aspect, the subsequent group consists of a first subsequent lens group having a positive refractive power, a second subsequent lens group having a negative refractive power, and a third subsequent lens group in order from the object side to the image side.

In a fifty-seventh aspect of the present disclosure, in the variable magnification optical system of the fifty-sixth aspect, in a case in which a focal length of the first subsequent lens group is denoted by fR1, and a focal length of the second subsequent lens group is denoted by fR2, Conditional Expression (28) is satisfied, which is represented by

$$0. 2 < fR 1 / ( - fR 2 ) < 2. \qquad ( 28 )$$

In a fifty-eighth aspect of the present disclosure, in the variable magnification optical system of the first aspect, the subsequent group consists of a first subsequent lens group having a positive refractive power, a second subsequent lens group having a positive refractive power, and a third subsequent lens group having a negative refractive power in order from the object side to the image side.

In a fifty-ninth aspect of the present disclosure, in the variable magnification optical system of the fifty-eighth aspect, in a case in which a focal length of the second subsequent lens group is denoted by fR2, and a focal length of the third subsequent lens group is denoted by fR3, Conditional Expression (29) is satisfied, which is represented by

$$0. 4 < fR 2 / ( - fR 3 ) < 3.7 . \qquad ( 29 )$$

In a sixtieth aspect of the present disclosure, in the variable magnification optical system of the fifty-eighth aspect, in a case in which a focal length of the first subsequent lens group is denoted by fR1, and a focal length of the second subsequent lens group is denoted by fR2, Conditional Expression (30) is satisfied, which is represented by

$$0.3 < fR 1 / fR 2 < 4. \qquad ( 30 )$$

In a sixty-first aspect of the present disclosure, in the variable magnification optical system of the first aspect, the subsequent group includes at least a first subsequent lens group having a positive refractive power, a second subsequent lens group having a negative refractive power, a third subsequent lens group having a positive refractive power, and a fourth subsequent lens group having a negative refractive power consecutively in order from the object side to the image side.

In a sixty-second aspect of the present disclosure, in the variable magnification optical system of the sixty-first aspect, in a case in which a focal length of the first subsequent lens group is denoted by fR1, and a focal length of the second subsequent lens group is denoted by fR2, Conditional Expression (28A) is satisfied, which is represented by

$$0.2 < fR 1 / ( - fR2 ) < 1.5 . \qquad ( 28 A )$$

In a sixty-third aspect of the present disclosure, in the variable magnification optical system of the sixty-first aspect, in a case in which a focal length of the second subsequent lens group is denoted by fR2, and a focal length of the third subsequent lens group is denoted by fR3, Conditional Expression (31) is satisfied, which is represented by

$$0.3 < ( - fR 2 ) / fR 3 < 2.4 . \qquad ( 31 )$$

In a sixty-fourth aspect of the present disclosure, in the variable magnification optical system of the sixty-first aspect, in a case in which a focal length of the first subsequent lens group is denoted by fR1, and a focal length of the third subsequent lens group is denoted by fR3, Conditional Expression (32) is satisfied, which is represented by

$$0.1 < fR 1 / fR 3 < 1.4 . \qquad ( 32 )$$

In a sixty-fifth aspect of the present disclosure, in the variable magnification optical system of the sixty-first aspect, in a case in which a focal length of the second subsequent lens group is denoted by fR2, and a focal length of the fourth subsequent lens group is denoted by fR4, Conditional Expression (33) is satisfied, which is represented by

$$0.15 < ( - fR 2 ) / ( - fR 4 ) < 1.8 . \qquad ( 33 )$$

In a sixty-sixth aspect of the present disclosure, in the variable magnification optical system of the first aspect, the subsequent group includes at least a first subsequent lens group having a positive refractive power, a second subsequent lens group having a positive refractive power, a third subsequent lens group having a negative refractive power, and a fourth subsequent lens group having a positive refractive power consecutively in order from the object side to the image side.

In a sixty-seventh aspect of the present disclosure, in the variable magnification optical system of the sixty-sixth aspect, in a case in which a focal length of the first subsequent lens group is denoted by fR1, and a focal length of the third subsequent lens group is denoted by fR3, Conditional Expression (34) is satisfied, which is represented by

$$0. 4 < fR 1 / ( - fR 3 ) < 2.5 . \qquad ( 34 )$$

In a sixty-eighth aspect of the present disclosure, in the variable magnification optical system of the sixty-sixth aspect, in a case in which a focal length of the second subsequent lens group is denoted by fR2, and a focal length of the third subsequent lens group is denoted by fR3, Conditional Expression (29A) is satisfied, which is represented by

$$0.3 < fR 2 / ( - fR 3 ) < 3.5 . \qquad ( 29 A )$$

In a sixty-ninth aspect of the present disclosure, in the variable magnification optical system of the sixty-sixth aspect, in a case in which a focal length of the first subsequent lens group is denoted by fR1, and a focal length of the second subsequent lens group is denoted by fR2, Conditional Expression (30A) is satisfied, which is represented by

$$0.3 < fR 1 / fR 2 < 5. \qquad ( 30 A )$$

In a seventieth aspect of the present disclosure, in the variable magnification optical system of the sixty-sixth aspect, in a case in which a focal length of the second subsequent lens group is denoted by fR2, and a focal length of the fourth subsequent lens group is denoted by fR4, Conditional Expression (35) is satisfied, which is represented by

$$0 \text{.1} < fR 2 / fR 4 < 2. \qquad ( 35 )$$

In a seventy-first aspect of the present disclosure, in the variable magnification optical system of the first aspect, the subsequent group consists of a first subsequent lens group having a positive refractive power, a second subsequent lens group having a positive refractive power, a third subsequent lens group having a positive refractive power, a fourth subsequent lens group, and a fifth subsequent lens group in order from the object side to the image side.

In a seventy-second aspect of the present disclosure, in the variable magnification optical system of the seventy-first aspect, in a case in which a focal length of the first subsequent lens group is denoted by fR1, and a focal length of the second subsequent lens group is denoted by fR2, Conditional Expression (30B) is satisfied, which is represented by

$$0.1 < fR 1 / fR 2 < 4.5 . \qquad ( 30 B )$$

In a seventy-third aspect of the present disclosure, in the variable magnification optical system of the seventy-first aspect, in a case in which a focal length of the second subsequent lens group is denoted by fR2, and a focal length of the third subsequent lens group is denoted by fR3, Conditional Expression (36) is satisfied, which is represented by

$$0.2 < fR 2 / fR 3 < 3. \qquad ( 36 )$$

In a seventy-fourth aspect of the present disclosure, in the variable magnification optical system of the first aspect, the subsequent group consists of a first subsequent lens group having a positive refractive power, a second subsequent lens group having a positive refractive power, a third subsequent lens group having a negative refractive power, a fourth subsequent lens group having a negative refractive power, and a fifth subsequent lens group having a positive refractive power in order from the object side to the image side.

In a seventy-fifth aspect of the present disclosure, in the variable magnification optical system of the seventy-fourth aspect, in a case in which a focal length of the first subsequent lens group is denoted by fR1, and a focal length of the second subsequent lens group is denoted by fR2, Conditional Expression (30C) is satisfied, which is represented by

$$0. 2 < fR 1 / fR 2 < 4. \qquad ( 30 C )$$

In a seventy-sixth aspect of the present disclosure, in the variable magnification optical system of the seventy-fourth aspect, in a case in which a focal length of the third subsequent lens group is denoted by fR3, and a focal length of the fourth subsequent lens group is denoted by fR4, Conditional Expression (37) is satisfied, which is represented by

$$0.01 < fR 3 / fR 4 < 4. \qquad ( 37 )$$

In a seventy-seventh aspect of the present disclosure, in the variable magnification optical system of the first aspect, the subsequent group includes at least a first subsequent lens group having a positive refractive power, a second subsequent lens group having a negative refractive power, and a third subsequent lens group having a negative refractive power consecutively in order from the object side to the image side.

In a seventy-eighth aspect of the present disclosure, in the variable magnification optical system of the seventy-seventh aspect, in a case in which a focal length of the first subsequent lens group is denoted by fR1, and a focal length of the second subsequent lens group is denoted by fR2, Conditional Expression (28B) is satisfied, which is represented by

$$0. 2 < fR 1 / ( - fR 2 ) < 1.8 . \qquad ( 28 B )$$

In a seventy-ninth aspect of the present disclosure, in the variable magnification optical system of the seventy-seventh aspect, in a case in which a focal length of the second subsequent lens group is denoted by fR2, and a focal length of the third subsequent lens group is denoted by fR3, Conditional Expression (38) is satisfied, which is represented by

$$0.05 < ( - fR 2 ) / ( - fR 3 ) < 1.2 . \qquad ( 38 )$$

According to an eightieth aspect of the present disclosure, there is provided an imaging apparatus comprising the variable magnification optical system of any one of the first to seventy-ninth aspects.

Expressions “consists of” and “consisting of” in the present specification indicate that a lens substantially not having a refractive power, an optical element other than a lens, such as a stop, a filter, and a cover glass, a mechanism part such as a lens flange, a lens barrel, an imaging element, and a camera shake correction mechanism, and the like may be included in addition to illustrated constituents.

Expressions “group having a positive refractive power” and “a group has a positive refractive power” in the present specification mean that a positive refractive power is provided as a whole group. Similarly, an expression “group having a negative refractive power” means that an entire group has a negative refractive power. Expressions “lens having a positive refractive power” and “positive lens” are synonymous. An expression “lens having a negative refractive power” is synonymous with a “negative lens”. An expression “group” in the present specification is not limited to having a configuration consisting of a plurality of lenses, and may have a configuration consisting of only one lens.

A compound aspherical lens (a lens in which a lens (for example, a spherical lens) and a film of an aspherical shape formed on the lens are integrally formed and which functions as one aspherical lens as a whole) is not regarded as a cemented lens and is regarded as one lens. A sign of a refractive power and a surface shape of a lens including an aspherical surface will be used in terms of a paraxial region unless otherwise specified.

An expression “entire system” in the present specification means a variable magnification optical system. An expression “focal length” used in conditional expressions means a paraxial focal length. Unless otherwise noted, an expression “distance on the optical axis” used in the conditional expressions means a geometrical distance. Unless otherwise specified, values used in the conditional expressions are values based on the d line in a state where the infinite distance object is in focus.

According to the present disclosure, the variable magnification optical system that is configured to be reduced in size and that maintains the favorable optical performance in the entire magnification range, and the imaging apparatus comprising the variable magnification optical system can be provided.

### BRIEF DESCRIPTION OF THE DRAWINGS

FIG. 1 is a diagram showing a cross-sectional view of a configuration and a movement trajectory of a variable magnification optical system according to one embodiment, which corresponds to a variable magnification optical system of Example 1.

FIG. 2 is a cross-sectional view of the configuration of the variable magnification optical system in FIG. 1 and is a diagram for describing symbols of conditional expressions.

FIG. 3 is a diagram for describing a position of a maximum effective diameter.

FIG. 4 is each aberration diagram of the variable magnification optical system of Example 1.

FIG. 5 is a diagram showing a cross-sectional view of a configuration and a movement trajectory of a variable magnification optical system of Example 2.

FIG. 6 is each aberration diagram of the variable magnification optical system of Example 2.

FIG. 7 is a diagram showing a cross-sectional view of a configuration and a movement trajectory of a variable magnification optical system of Example 3.

FIG. 8 is each aberration diagram of the variable magnification optical system of Example 3.

FIG. 9 is a diagram showing a cross-sectional view of a configuration and a movement trajectory of a variable magnification optical system of Example 4.

FIG. 10 is each aberration diagram of the variable magnification optical system of Example 4.

FIG. 11 is a diagram showing a cross-sectional view of a configuration and a movement trajectory of a variable magnification optical system of Example 5.

FIG. 12 is each aberration diagram of the variable magnification optical system of Example 5.

FIG. 13 is a diagram showing a cross-sectional view of a configuration and a movement trajectory of a variable magnification optical system of Example 6.

FIG. 14 is each aberration diagram of the variable magnification optical system of Example 6.

FIG. 15 is a diagram showing a cross-sectional view of a configuration and a movement trajectory of a variable magnification optical system of Example 7.

FIG. 16 is each aberration diagram of the variable magnification optical system of Example 7.

FIG. 17 is a diagram showing a cross-sectional view of a configuration and a movement trajectory of a variable magnification optical system of Example 8.

FIG. 18 is each aberration diagram of the variable magnification optical system of Example 8.

FIG. 19 is a diagram showing a cross-sectional view of a configuration and a movement trajectory of a variable magnification optical system of Example 9.

FIG. 20 is each aberration diagram of the variable magnification optical system of Example 9.

FIG. 21 is a diagram showing a cross-sectional view of a configuration and a movement trajectory of a variable magnification optical system of Example 10.

FIG. 22 is each aberration diagram of the variable magnification optical system of Example 10.

FIG. 23 is a diagram showing a cross-sectional view of a configuration and a movement trajectory of a variable magnification optical system of Example 11.

FIG. 24 is each aberration diagram of the variable magnification optical system of Example 11.

FIG. 25 is a diagram showing a cross-sectional view of a configuration and a movement trajectory of a variable magnification optical system of Example 12.

FIG. 26 is each aberration diagram of the variable magnification optical system of Example 12.

FIG. 27 is a diagram showing a cross-sectional view of a configuration and a movement trajectory of a variable magnification optical system of Example 13.

FIG. 28 is each aberration diagram of the variable magnification optical system of Example 13.

FIG. 29 is a diagram showing a cross-sectional view of a configuration and a movement trajectory of a variable magnification optical system of Example 14.

FIG. 30 is each aberration diagram of the variable magnification optical system of Example 14.

FIG. 31 is a diagram showing a cross-sectional view of a configuration and a movement trajectory of a variable magnification optical system of Example 15.

FIG. 32 is each aberration diagram of the variable magnification optical system of Example 15.

FIG. 33 is a diagram showing a cross-sectional view of a configuration and a movement trajectory of a variable magnification optical system of Example 16.

FIG. 34 is each aberration diagram of the variable magnification optical system of Example 16.

FIG. 35 is a diagram showing a cross-sectional view of a configuration and a movement trajectory of a variable magnification optical system of Example 17.

FIG. 36 is each aberration diagram of the variable magnification optical system of Example 17.

FIG. 37 is a diagram showing a cross-sectional view of a configuration and a movement trajectory of a variable magnification optical system of Example 18.

FIG. 38 is each aberration diagram of the variable magnification optical system of Example 18.

FIG. 39 is a diagram showing a cross-sectional view of a configuration and a movement trajectory of a variable magnification optical system of Example 19.

FIG. 40 is each aberration diagram of the variable magnification optical system of Example 19.

FIG. 41 is a diagram showing a cross-sectional view of a configuration and a movement trajectory of a variable magnification optical system of Example 20.

FIG. 42 is each aberration diagram of the variable magnification optical system of Example 20.

FIG. 43 is a diagram showing a cross-sectional view of a configuration and a movement trajectory of a variable magnification optical system of Example 21.

FIG. 44 is each aberration diagram of the variable magnification optical system of Example 21.

FIG. 45 is a diagram showing a cross-sectional view of a configuration and a movement trajectory of a variable magnification optical system of Example 22.

FIG. 46 is each aberration diagram of the variable magnification optical system of Example 22.

FIG. 47 is a diagram showing a cross-sectional view of a configuration and a movement trajectory of a variable magnification optical system of Example 23.

FIG. 48 is each aberration diagram of the variable magnification optical system of Example 23.

FIG. 49 is a diagram showing a cross-sectional view of a configuration and a movement trajectory of a variable magnification optical system of Example 24.

FIG. 50 is each aberration diagram of the variable magnification optical system of Example 24.

FIG. 51 is a diagram showing a cross-sectional view of a configuration and a movement trajectory of a variable magnification optical system of Example 25.

FIG. 52 is each aberration diagram of the variable magnification optical system of Example 25.

FIG. 53 is a diagram showing a cross-sectional view of a configuration and a movement trajectory of a variable magnification optical system of Example 26.

FIG. 54 is each aberration diagram of the variable magnification optical system of Example 26.

FIG. 55 is a diagram showing a cross-sectional view of a configuration and a movement trajectory of a variable magnification optical system of Example 27.

FIG. 56 is each aberration diagram of the variable magnification optical system of Example 27.

FIG. 57 is a diagram showing a cross-sectional view of a configuration and a movement trajectory of a variable magnification optical system of Example 28.

FIG. 58 is each aberration diagram of the variable magnification optical system of Example 28.

FIG. 59 is a diagram showing a cross-sectional view of a configuration and a movement trajectory of a variable magnification optical system of Example 29.

FIG. 60 is each aberration diagram of the variable magnification optical system of Example 29.

FIG. 61 is a diagram showing a cross-sectional view of a configuration and a movement trajectory of a variable magnification optical system of Example 30.

FIG. 62 is each aberration diagram of the variable magnification optical system of Example 30.

FIG. 63 is a perspective view of a front side of an imaging apparatus according to one embodiment.

FIG. 64 is a perspective view of a rear side of the imaging apparatus according to one embodiment.

### DETAILED DESCRIPTION

Hereinafter, an embodiment of the present disclosure will be described with reference to drawings.

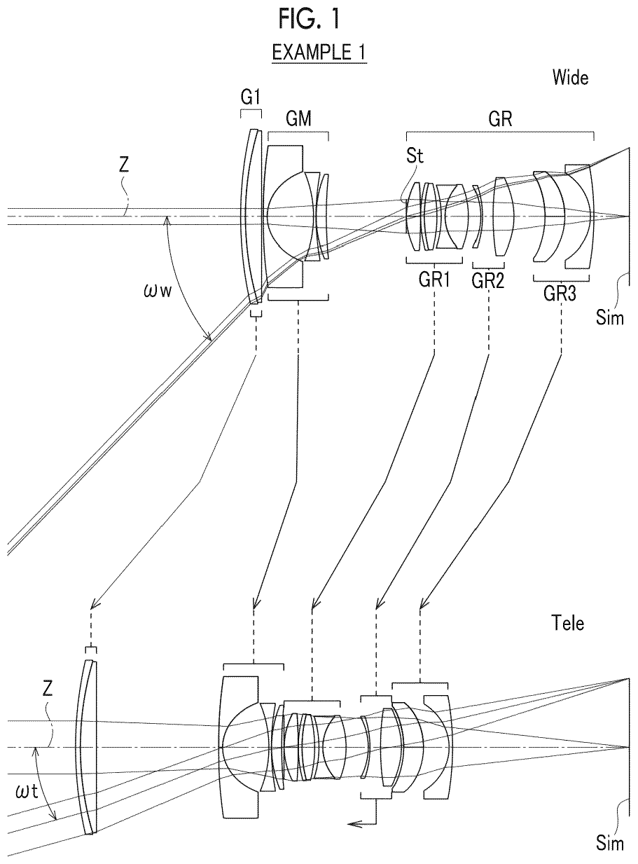

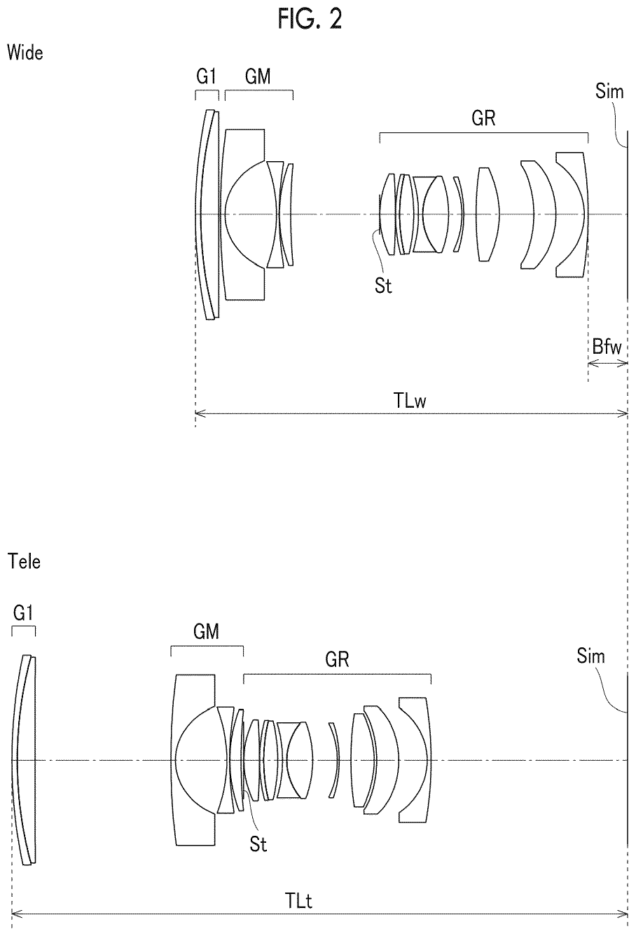

FIG. 1 shows a cross-sectional view of a configuration and a movement trajectory and a luminous flux of a variable magnification optical system according to one embodiment of the present disclosure. FIG. 2 shows a cross-sectional view of the configuration of the variable magnification optical system in FIG. 1. FIGS. 1 and 2 show a state where an infinite distance object is in focus, in which a left side is an object side, and a right side is an image side. In FIGS. 1 and 2, an upper part labeled “Wide” shows a wide-angle end state, and a lower part labeled “Tele” shows a telephoto end state. As the luminous flux, FIG. 1 shows an on-axis luminous flux and a luminous flux of a maximum half angle of view ww at a wide angle end and an on-axis luminous flux and a luminous flux of a maximum half angle of view ot at a telephoto end. Examples shown in FIG. 1 and FIG. 2 correspond to a variable magnification optical system of Example 1 described later. The following description will be mainly provided with reference to FIG. 1, and FIG. 2 will be referred to, as necessary.

A variable magnification optical system of the present disclosure consists of, in order from the object side to the image side along an optical axis Z, a first lens group G1 that has a positive refractive power, an intermediate group GM consisting of two or fewer lens groups that have a negative refractive power, and a subsequent group GR consisting of a plurality of lens groups. A lens group of the subsequent group GR that is closest to the object side has a positive refractive power. During changing a magnification, the first lens group G1 moves, and all spacings between adjacent lens groups change in the variable magnification optical system. With the above-described configuration, an advantage in suppressing various aberrations in an entire magnification range is achieved.

In particular, setting the first lens group G1 as a group having a positive refractive power achieves an advantage in reduction in size. In addition, by setting the first lens group G1 as a group having a positive refractive power, a height of a ray incident on the intermediate group GM from the optical axis Z can be decreased. Thus, an advantage of suppressing fluctuations of aberrations during changing the magnification is achieved. With the configuration in which the first lens group G1 is a group having a positive refractive power and the intermediate group GM consists of one or two lens groups having a negative refractive power, it is advantageous for changing the magnification while suppressing the various aberrations. By moving a plurality of lens groups including the first lens group G1 during changing the magnification, it is advantageous for suppressing the various aberrations in the entire magnification range.

In the present specification, a group in which a spacing between the group and an adjacent group thereof changes in an optical axis direction during changing the magnification is set as one lens group. During changing the magnification, a spacing between adjacent lenses does not change in one lens group. That is, an expression “lens group” means a portion that constitutes the variable magnification optical system and that includes at least one lens divided by an air spacing that is changed during changing the magnification. During changing the magnification, each lens group is moved or fixed in lens group units. The expression “lens group” may include a constituent not having a refractive power, such as an aperture stop St, other than a lens.

For example, each group of the variable magnification optical system shown in FIG. 1 is configured as follows. The first lens group G1 consists of two lenses. The intermediate group GM consists of one lens group composed of three lenses. The subsequent group GR consists of three lens groups of a first subsequent lens group GR1 composed of the aperture stop St and five lenses, a second subsequent lens group GR2 composed of two lenses, and a third subsequent lens group GR3 composed of two lenses in this order from the object side to the image side. The aperture stop St shown in FIG. 1 does not indicate a size or a shape, but indicates a position on an optical axis.

In an example in FIG. 1, during changing the magnification, the first lens group G1, the intermediate group GM, the first subsequent lens group GR1, the second subsequent lens group GR2, and the third subsequent lens group GR3 move along the optical axis Z by changing spacings with their adjacent lens groups. In FIG. 1, a schematic movement trajectory of each lens group during changing the magnification from the wide angle end to the telephoto end is shown by a solid line arrow between Wide and Tele of FIG. 1.

It should be noted that the example shown in FIG. 1 is an example, and the variable magnification optical system according to an embodiment of the present disclosure can be variously modified without departing from a scope of a technology of the present disclosure. Hereinafter, a preferred configuration and a possible configuration of the variable magnification optical system according to the embodiment of the present disclosure will be described.

It is preferable that the first lens group G1 includes a negative lens and a positive lens. In a case in which such a configuration is adopted, there is an advantage in chromatic aberration correction.

The first lens group G1 preferably includes a cemented lens formed by a negative meniscus lens having a convex surface facing the object side and a positive lens having a convex surface facing the object side cemented together in this order from the object side. In such a case, corrections of a lateral chromatic aberration at the wide angle end and an axial chromatic aberration at the telephoto end are advantageous.

It is preferable that the intermediate group GM includes three negative lenses. In such a case, there is an advantage in securing a zoom ratio.

It is preferable that the intermediate group GM includes an Lmn lens having a negative refractive power. A surface of the Lmn lens on the object side is an aspherical surface in which a refractive power at a position of a maximum effective diameter is shifted in a positive direction compared to a refractive power in a paraxial region. By forming the Lmn lens in such a shape, an advantage of suppressing fluctuations of an astigmatism during changing the magnification is achieved. In the example of FIG. 1, a lens of the intermediate group GM that is closest to the object side corresponds to the Lmn lens having an aspherical surface. The surface of the Lmn lens on the object side may be configured to have a concave shape in the paraxial region and to have a convex shape in a peripheral portion including the position of the maximum effective diameter. In such a case, there is an advantage in suppressing the fluctuations of the astigmatism during changing the magnification.

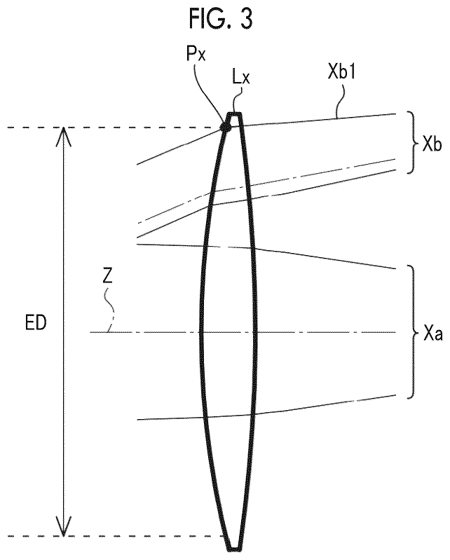

An expression “position of the maximum effective diameter” in the present specification will be described with reference to FIG. 3. FIG. 3 is a diagram for description. In FIG. 3, a left side is the object side, and a right side is the image side. FIG. 3 shows an on-axis luminous flux Xa and an off-axis luminous flux Xb which pass through a lens Lx. In an example of FIG. 3, a ray Xb1 that is an upper ray in the off-axis luminous flux Xb is a ray passing through an outermost side. Here, an expression “outer side” refers to a radially outward side with the optical axis Z as a center, that is, a side away from the optical axis Z. In the present specification, a position of an intersection between the ray that passes through the outermost side and a lens surface is a position Px of the maximum effective diameter. In addition, twice a distance from the position Px of the maximum effective diameter to the optical axis Z is an effective diameter ED of a surface of the lens Lx on the object side. In the example of FIG. 3, the upper ray of the off-axis luminous flux Xb is the ray passing through the outermost side, but which ray passes through the outermost side varies depending on an optical system.

In addition, an expression “refractive power at the position of the maximum effective diameter is shifted in the positive direction compared to the refractive power in the paraxial region” in the present specification has the following meanings based on a sign of the refractive power. In a case in which a surface has a positive refractive power in both of the paraxial region and the position of the maximum effective diameter, this means that the positive refractive power is stronger at the position of the maximum effective diameter compared to that in the paraxial region. In a case in which the surface has a negative refractive power in both of the paraxial region and the position of the maximum effective diameter, this means that the negative refractive power is weaker at the position of the maximum effective diameter compared to that in the paraxial region. In a case in which the surface has refractive powers of different signs between the paraxial region and the position of the maximum effective diameter, this means that the refractive power is negative in the paraxial region, and the refractive power is positive at the position of the maximum effective diameter.

The subsequent group GR may include an Lrn lens having a negative refractive power. A surface of the Lrn lens on the image side is an aspherical surface in which a refractive power at a position of a maximum effective diameter is shifted in a positive direction compared to a refractive power in a paraxial region. By forming the Lrn lens in such a shape, there is an advantage in reducing an incidence angle of a principal ray of an off-axis luminous flux onto an image plane Sim. The surface of the Lrn lens on the image side may be configured to have a concave shape in the paraxial region and to have a convex shape in a peripheral portion including the position of the maximum effective diameter. In such a case, there is an advantage in reducing the incidence angle of the principal ray of the off-axis luminous flux onto the image plane Sim while achieving reduction in a total optical length.

At least one focusing group that moves along the optical axis Z during focusing may be disposed in the subsequent group GR. Focusing is performed by moving the focusing group. In the example in FIG. 1, the focusing group consists of the second subsequent lens group GR2. Parentheses and an arrow in a left-right direction provided to the second subsequent lens group GR2 in the lower part of FIG. 1 indicate that the second subsequent lens group GR2 is a focusing group and indicate a direction in which the second subsequent lens group GR2 moves during focusing from the infinite distance object to a close distance object. The focusing group functions throughout the entire magnification range including the wide-angle end state, but in FIG. 1, the arrows are noted only in the lower part of the drawing in order to avoid complication of the drawing.

While there is only one focusing group included in the variable magnification optical system in the example in FIG. 1, the variable magnification optical system according to the present disclosure may include a plurality of focusing groups. For example, two focusing groups that move by changing a mutual spacing during focusing may be configured to be disposed in the subsequent group GR. In such a case, a moving amount of each focusing group during focusing can be suppressed. In a case in which one or a plurality of focusing groups included in the variable magnification optical system are disposed only in the subsequent group GR, breathing caused by focusing can be suppressed. One focusing group may be configured to consist of an entire lens group. In such a case, there is an advantage in simplifying a drive mechanism.

As shown in examples described below, an anti-vibration group that moves in a direction intersecting the optical axis Z during image shake correction may be configured to be disposed in the subsequent group GR. The image shake correction is performed by moving the anti-vibration group. The anti-vibration group may be configured to be disposed closer to the object side than the focusing group in the subsequent group GR. This is advantageous for reducing a diameter of the anti-vibration group. The anti-vibration group may be configured to consist of one lens or one cemented lens. In such a case, there is an advantage in achieving reduction in weight of the anti-vibration group.

A lens corresponding to the focusing group and a lens corresponding to the anti-vibration group may be lenses different from those in the example in FIG. 1.

All the lens groups move during changing the magnification in the example of FIG. 1, but the variable magnification optical system of the present disclosure may be configured to include at least one lens group that remains stationary with respect to the image plane Sim during changing the magnification. In such a case, since the number of cams that move the lens groups can be reduced, the drive mechanism can be simplified. While an example in which the variable magnification optical system is a zoom lens is shown in FIG. 1, the variable magnification optical system according to the present disclosure may be the zoom lens or a varifocal lens.

Next, preferred configurations and possible configurations related to conditional expressions of the variable magnification optical system according to the present disclosure will be described. It should be noted that, in the following description related to the conditional expressions, duplicate descriptions of symbols will be omitted by using the same symbol for the same definition in order to avoid redundant description. Hereinafter, the “variable magnification optical system of the present disclosure” will be simply referred to as the “variable magnification optical system” in order to avoid redundant description.

It is preferable that the variable magnification optical system satisfies Conditional Expression (1). Here, a sum of a distance on the optical axis from a lens surface of the first lens group G1 that is closest to the object side to a lens surface of the subsequent group GR that is closest to the image side and a back focus of an entire system in an air-equivalent distance in a state in which the infinite distance object is in focus at the wide angle end is denoted by TLw. A focal length of the entire system in a state in which the infinite distance object is in focus at the telephoto end is denoted by ft. A maximum half angle of view in a state in which the infinite distance object is in focus at the telephoto end is denoted by ωt. tan is a tangent. TLw denotes a total optical length in a state where the infinite distance object is in focus at the wide angle end. For example, FIG. 2 shows a total optical length TLw. By not causing a corresponding value of Conditional Expression (1) to be less than or equal to its lower limit value, an advantage of suppressing the various aberrations in the entire magnification range is achieved. By not causing the corresponding value of Conditional Expression (1) to be greater than or equal to its upper limit value, an advantage of size reduction of the entire optical system is achieved.

$$2.9 < TLw / ( ft \times tan ω t ) < 7 \qquad ( 1 )$$

In order to obtain more favorable characteristics, the lower limit value of Conditional Expression (1) is more preferably 3.2, still more preferably 3.5, and still more preferably 3.8. In order to obtain more favorable characteristics, the upper limit value of Conditional Expression (1) is more preferably 6.5, still more preferably 6, and still more preferably 5.5. For example, it is more preferable that the variable magnification optical system satisfies Conditional Expression (1-1).

$$3. 5 < TLw / ( ft \times tan ω t ) < 6 \qquad ( 1 - 1 )$$

It is preferable that the variable magnification optical system satisfies Conditional Expression (2). Here, the back focus of the entire system in the air-equivalent distance in a state in which the infinite distance object is in focus at the wide angle end is denoted by Bfw. The back focus in the air-equivalent distance is an air-equivalent distance on the optical axis from a lens surface of the variable magnification optical system that is closest to the image side to the image plane Sim. For example, FIG. 2 shows a back focus Bfw. By not causing a corresponding value of Conditional Expression (2) to be less than or equal to its lower limit value, the back focus Bfw is not excessively decreased. Thus, it is easier to attach a mount replacement mechanism. By not causing the corresponding value of Conditional Expression (2) to be greater than or equal to its upper limit value, the back focus Bfw is not excessively increased. Thus, size reduction is facilitated.

$$0. 4 < Bfw / ( ft \times tan ω t ) < 1.5 \qquad ( 2 )$$

In order to obtain more favorable characteristics, the lower limit value of Conditional Expression (2) is more preferably 0.42, still more preferably 0.44, still more preferably 0.46, and still more preferably 0.48. In order to obtain more favorable characteristics, the upper limit value of Conditional Expression (2) is more preferably 1.4, further preferably 1.3, further preferably 1.25, and further preferably 1.2.

The variable magnification optical system preferably satisfies Conditional Expression (3). By not causing a corresponding value of Conditional Expression (3) to be less than or equal to its lower limit value, an advantage of suppressing the various aberrations in the entire magnification range is achieved. By not causing the corresponding value of Conditional Expression (3) to be greater than or equal to its upper limit value, an advantage of the size reduction of the entire optical system is achieved, or an advantage of obtaining a sufficient zoom ratio as the variable magnification optical system is achieved.

$$0.05 < ( fw \times TLw ) / ( {ft}^{2} \times FNow ) < 0.23 . \qquad ( 3 )$$

In order to obtain more favorable characteristics, the lower limit value of Conditional Expression (3) is more preferably 0.06, still more preferably 0.07, still more preferably 0.08, and still more preferably 0.1. In order to obtain more favorable characteristics, the upper limit value of Conditional Expression (3) is more preferably 0.2, further preferably 0.18, further preferably 0.165, and further preferably 0.16. For example, the variable magnification optical system more preferably satisfies Conditional Expression (3-1) below and further preferably satisfies Conditional Expression (3-2) below.

$$0.08 < ( fw \times TLw ) / ( {ft}^{2} \times FNow ) < 0.165 \qquad ( 3 - 1 )$$

$$0.1 < ( fw \times TLw ) / ( {ft}^{2} \times FNow ) < 0.16 \qquad ( 3 - 2 )$$

In a case in which a maximum half angle of view in a state in which the infinite distance object is in focus at the wide angle end is denoted by ωw, it is preferable that the variable magnification optical system satisfies Conditional Expression (4). By not causing a corresponding value of Conditional Expression (4) to be less than or equal to its lower limit value, it is easier to decrease an open F-number at the wide angle end while increasing an angle of view at the wide angle end. By not causing the corresponding value of Conditional Expression (4) to be greater than or equal to its upper limit value, an advantage of suppressing an increase in the number of lenses and suppressing a size increase of the optical system while obtaining favorable optical performance is achieved.

$$0.1 5 < tan ω w / FNow < 0.5 \qquad ( 4 )$$

In order to obtain more favorable characteristics, the lower limit value of Conditional Expression (4) is more preferably 0.17, further preferably 0.19, further preferably 0.21, further preferably 0.23, and further preferably 0.25. In order to obtain more favorable characteristics, the upper limit value of Conditional Expression (4) is more preferably 0.42, further preferably 0.38, further preferably 0.35, further preferably 0.34, and further preferably 0.33. For example, the variable magnification optical system more preferably satisfies Conditional Expression (4-1) below.

$$0.21 < tan ω w / FNow < 0.35 \qquad ( 4 - 1 )$$

The variable magnification optical system preferably satisfies Conditional Expression (5) below. By not causing a corresponding value of Conditional Expression (5) to be equal to or less than its lower limit value, an advantage in the size reduction in the entire optical system or an advantage in suppressing various aberrations particularly at the wide angle end is achieved. By not causing the corresponding value of Conditional Expression (5) to be greater than or equal to its upper limit value, it is easier to obtain sufficient brightness at the wide angle end.

$$0.65 < FNow / ( ft / fw ) < 1.6 \qquad ( 5 )$$

In order to obtain more favorable characteristics, the lower limit value of Conditional Expression (5) is preferably 0.7, more preferably 0.75, yet more preferably 0.8, especially preferably 0.85, and most preferably 0.9. In order to obtain more favorable characteristics, an upper limit value of Conditional Expression (5) is more preferably 1.52, still more preferably 1.44, still more preferably 1.36, still more preferably 1.28, still more preferably 1.23, and still more preferably 1.2. For example, it is more preferable that the variable magnification optical system satisfies Conditional Expression (5-1).

$$0.85 < FNow / ( ft / fw ) < 1.28 \qquad ( 5 - 1 )$$

In a case in which a focal length of the first lens group G1 is denoted by f1, the variable magnification optical system preferably satisfies Conditional Expression (6). By not causing a corresponding value of Conditional Expression (6) to be less than or equal to its lower limit value, an advantage of reducing the total optical length is achieved. By not causing the corresponding value of Conditional Expression (6) to be equal to or more than its upper limit value, an advantage in securing the angle of view at the wide angle end is achieved.

$$0.02 < fw / f 1 < 0.3 \qquad ( 6 )$$

In order to obtain more favorable characteristics, the lower limit value of Conditional Expression (6) is preferably 0.03, more preferably 0.04, yet more preferably 0.045, even more preferably 0.048, especially preferably 0.049, and most preferably 0.05. In order to obtain more favorable characteristics, the upper limit value of Conditional Expression (6) is more preferably 0.25, further preferably 0.2, further preferably 0.165, further preferably 0.14, further preferably 0.135, and further preferably 0.13. For example, the variable magnification optical system more preferably satisfies Conditional Expression (6-1) below and further preferably satisfies Conditional Expression (6-2) below.

$$0.048 < fw / f 1 < 0.14 \qquad ( 6 - 1 )$$

$$0.05 < fw / f 1 < 0.13 \qquad ( 6 - 2 )$$

The variable magnification optical system preferably satisfies Conditional Expression (7). Here, a focal length of the intermediate group GM in a state where the infinite distance object is in focus at the wide angle end is denoted by fMw. By not causing a corresponding value of Conditional Expression (7) to be less than or equal to its lower limit value, a refractive power of the intermediate group GM is not excessively decreased. Thus, it is easier to suppress a moving amount of the intermediate group GM during changing the magnification. By not causing the corresponding value of Conditional Expression (7) to be greater than or equal to its upper limit value, a refractive power of the first lens group G1 is not excessively decreased. Thus, it is easier to suppress an increase in size of the first lens group G1.

$$4.5 < f 1 / ( - fMw ) < 14 \qquad ( 7 )$$

In order to obtain more favorable characteristics, the lower limit value of Conditional Expression (7) is more preferably 5, still more preferably 5.3, still more preferably 5.5, and still more preferably 5.7. In order to obtain more favorable characteristics, the upper limit value of Conditional Expression (7) is more preferably 12, further preferably 10, further preferably 9, and further preferably 8.7. For example, the variable magnification optical system more preferably satisfies Conditional Expression (7-1) below.

$$5.7 < f 1 / ( - fMw ) < 8.7 \qquad ( 7 - 1 )$$

The variable magnification optical system preferably satisfies Conditional Expression (8) below. By not causing a corresponding value of Conditional Expression (8) to be less than or equal to its lower limit value, the refractive power of the intermediate group GM is not excessively increased. Thus, an aberration amount of a field curvature occurring in the intermediate group GM can be suppressed. Accordingly, an advantage of correcting aberrations during changing the magnification is achieved. By not causing the corresponding value of Conditional Expression (8) to be greater than or equal to its upper limit value, the refractive power of the intermediate group GM is not excessively decreased. Thus, the moving amount of the intermediate group GM during changing the magnification can be suppressed. Accordingly, since the total optical length is not excessively increased, an advantage of size reduction is achieved.

$$0.3 < ( - fMw ) / {( fw \times ft )}^{1 / 2} < 1.4 \qquad ( 8 )$$

In order to obtain more favorable characteristics, the lower limit value of Conditional Expression (8) is more preferably 0.4, still more preferably 0.5, and still more preferably 0.6. In order to obtain more favorable characteristics, the upper limit value of Conditional Expression (8) is more preferably 1.2, still more preferably 1, and even more preferably 0.9. For example, the variable magnification optical system more preferably satisfies Conditional Expression (8-1) below.

$$0.6 < ( - fMw ) / {( fw \times ft )}^{1 / 2} < 0.9 \qquad ( 8 - 1 )$$

The variable magnification optical system preferably satisfies Conditional Expression (9). Here, an open F-number in a state where the infinite distance object is in focus at the telephoto end is denoted by FNot. By not causing a corresponding value of Conditional Expression (9) to be less than or equal to its lower limit value, an advantage of high performance is achieved. By not causing the corresponding value of Conditional Expression (9) to be greater than or equal to its upper limit value, the refractive power of the first lens group G1 is not excessively decreased. Thus, there is an advantage in reduction in size of the first lens group G1.

$$5 < f 1 / ( ft / FNot ) < 20 \qquad ( 9 )$$

In order to obtain more favorable characteristics, the lower limit value of Conditional Expression (9) is more preferably 6, still more preferably 6.5, and still more preferably 7. In order to obtain more favorable characteristics, the upper limit value of Conditional Expression (9) is more preferably 16, further preferably 13, and further preferably 11. For example, the variable magnification optical system more preferably satisfies Conditional Expression (9-1) below.

$$7 < f 1 / ( ft / FNot ) < 11 \qquad ( 9 - 1 )$$

The variable magnification optical system preferably satisfies Conditional Expression (10) below. By not causing a corresponding value of Conditional Expression (10) to be less than or equal to its lower limit value, there is an advantage in suppressing the various aberrations. By not causing the corresponding value of Conditional Expression (10) to be equal to or greater than its upper limit value, there is an advantage in achieving reduction in the total optical length.

$$2.5 < TLw / fw < 8 \qquad ( 10 )$$

In order to obtain more favorable characteristics, the lower limit value of Conditional Expression (10) is more preferably 3, further preferably 3.5, and further preferably 4. In order to obtain more favorable characteristics, the upper limit value of Conditional Expression (10) is more preferably 7, further preferably 6, and further preferably 5.6. For example, the variable magnification optical system more preferably satisfies Conditional Expression (10-1) below.

$$3.5 < TLw / fw < 6 \qquad ( 10 - 1 )$$

It is preferable that the variable magnification optical system satisfies Conditional Expression (11). Here, a sum of a distance on the optical axis from the lens surface of the first lens group G1 that is closest to the object side to the lens surface of the subsequent group GR that is closest to the image side and a back focus of the entire system in the air-equivalent distance in a state where the infinite distance object is in focus at the telephoto end is denoted by TLt. TLt denotes a total optical length in a state where the infinite distance object is in focus at the telephoto end. For example, FIG. 2 shows the total optical length TLt. By not causing a corresponding value of Conditional Expression (11) to be equal to or less than its lower limit value, an advantage in the size reduction in the entire optical system or an advantage in suppressing various aberrations particularly at the telephoto end is achieved. By not causing the corresponding value of Conditional Expression (11) to be equal to or greater than its upper limit value, it is advantageous for shortening the total optical length TLt while decreasing an F-number at the telephoto end.

$$8 < FNot \times ( TLt / ft ) < 17 \qquad ( 11 )$$

In order to obtain more favorable characteristics, the lower limit value of Conditional Expression (11) is more preferably 9 and further preferably 10. In order to obtain more favorable characteristics, the upper limit value of Conditional Expression (11) is more preferably 15 and further preferably 14.

In a case in which a focal length of the lens group of the subsequent group GR that is closest to the object side is denoted by fR1, the variable magnification optical system preferably satisfies Conditional Expression (12) below. By not causing a corresponding value of Conditional Expression (12) to be equal to or less than its lower limit value, a positive refractive power of the lens group of the subsequent group GR that is closest to the object side is prevented from being excessively weak, so that an advantage in suppressing fluctuations of a spherical aberration during changing the magnification is achieved. By not causing the corresponding value of Conditional Expression (12) to be equal to or more than its upper limit value, the positive refractive power of the lens group of the subsequent group GR that is closest to the object side is prevented from being excessively strong, so that it is possible to prevent the spherical aberration from being excessively corrected, particularly at the wide angle end.

$$1.5 < f 1 / fR 1 < 17 \qquad ( 12 )$$

In order to obtain more favorable characteristics, the lower limit value of Conditional Expression (12) is more preferably 3 and further preferably 5. In order to obtain more favorable characteristics, the upper limit value of Conditional Expression (12) is more preferably 13 and further preferably 10.

The variable magnification optical system preferably satisfies Conditional Expression (13) below. By not causing a corresponding value of Conditional Expression (13) to be less than or equal to its lower limit value, it is easier to suppress the various aberrations at the wide angle end. By not causing the corresponding value of Conditional Expression (13) to be greater than or equal to its upper limit value, it is easier to reduce the total optical length TLw at the wide angle end.

$$1.2 < TLw / ft < 2.2 \qquad ( 13 )$$

In order to obtain more favorable characteristics, the lower limit value of Conditional Expression (13) is more preferably 1.3 and still more preferably 1.4. In order to obtain more favorable characteristics, the upper limit value of Conditional Expression (13) is more preferably 2 and still more preferably 1.8.

It is preferable that the variable magnification optical system satisfies Conditional Expression (14). By not causing a corresponding value of Conditional Expression (14) to be less than or equal to its lower limit value, the zoom ratio is not excessively low. Thus, it is possible to sufficiently exhibit the value of the variable magnification optical system. By not causing the corresponding value of Conditional Expression (14) to be equal to or greater than its upper limit value, the zoom ratio is not excessively increased, so that it is possible to prevent a moving amount of the lens group during changing the magnification from being excessively increased, and thus it is advantageous for achieving reduction in size of the entire optical system.

$$2.8 < ft / fw < 4 \qquad ( 14 )$$

In order to obtain more favorable characteristics, the lower limit value of Conditional Expression (14) is more preferably 2.9, still more preferably 3, and still more preferably 3.1. In order to obtain more favorable characteristics, the upper limit value of Conditional Expression (14) is more preferably 3.7, still more preferably 3.5, and still more preferably 3.3.

It is preferable that the variable magnification optical system satisfies Conditional Expression (15). By not causing a corresponding value of Conditional Expression (15) to be less than or equal to its lower limit value, the refractive power of the first lens group G1 is not excessively strong. Thus, there is an advantage in suppressing the fluctuations of the aberrations during changing the magnification. By not causing the corresponding value of Conditional Expression (15) to be greater than or equal to its upper limit value, the refractive power of the first lens group G1 is not excessively weak. Thus, there is an advantage in the reduction in size of the first lens group G1.

$$3 < f 1 / {( fw \times ft )}^{1 / 2} < 9 \qquad ( 15 )$$

In order to obtain more favorable characteristics, the lower limit value of Conditional Expression (15) is more preferably 3.4, still more preferably 3.7, and still more preferably 4. In order to obtain more favorable characteristics, the upper limit value of Conditional Expression (15) is more preferably 7, further preferably 6, and further preferably 5.

It is preferable that the variable magnification optical system satisfies Conditional Expression (16). By not causing a corresponding value of Conditional Expression (16) to be less than or equal to its lower limit value, an advantage of suppressing the various aberrations in the entire magnification range is achieved. By not causing the corresponding value of Conditional Expression (16) to be greater than or equal to its upper limit value, the total optical length TLt at the telephoto end is not excessively increased. Thus, an advantage of size reduction is achieved.

$$1.25 < TLt / TLw < 1.6 \qquad ( 16 )$$

In order to obtain more favorable characteristics, the lower limit value of Conditional Expression (16) is more preferably 1.35 and still more preferably 1.4. In order to obtain more favorable characteristics, the upper limit value of Conditional Expression (16) is more preferably 1.55 and still more preferably 1.5.

The variable magnification optical system preferably satisfies Conditional Expression (17) below. Here, a focal length of the subsequent group GR in a state in which the infinite distance object is in focus at the wide angle end is denoted by fRw. By not causing a corresponding value of Conditional Expression (17) to be less than or equal to its lower limit value, it is easier to reduce the total optical length TLw at the wide angle end. Thus, an advantage of size reduction is achieved. By not causing the corresponding value of Conditional Expression (17) to be greater than or equal to its upper limit value, an advantage of suppressing the spherical aberration at the wide angle end is achieved.

$$0.3 < fw / fRw < 1.2 \qquad ( 17 )$$

In order to obtain more favorable characteristics, the lower limit value of Conditional Expression (17) is more preferably 0.5 and still more preferably 0.65. In order to obtain more favorable characteristics, the upper limit value of Conditional Expression (17) is more preferably 1 and still more preferably 0.85.

It is preferable that the variable magnification optical system satisfies Conditional Expression (18). Here, a focal length of the subsequent group GR in a state in which the infinite distance object is in focus at the telephoto end is denoted by fRt. By not causing a corresponding value of Conditional Expression (18) to be less than or equal to its lower limit value, it is easier to reduce the total optical length TLt at the telephoto end. Thus, an advantage of size reduction is achieved. By not causing the corresponding value of Conditional Expression (18) to be equal to or more than its upper limit value, an advantage in suppressing a spherical aberration at the telephoto end is achieved.

$$0.6 < ft / fRt < 5 \qquad ( 18 )$$

In order to obtain more favorable characteristics, the lower limit value of Conditional Expression (18) is more preferably 0.8 and further preferably 0.9. In order to obtain more favorable characteristics, the upper limit value of Conditional Expression (18) is more preferably 4 and further preferably 3.

The variable magnification optical system preferably satisfies Conditional Expression (19) below. By not causing a corresponding value of Conditional Expression (19) to be less than or equal to its lower limit value, a refractive power of the lens group of the subsequent group GR that is closest to the object side is not excessively increased. Thus, an advantage of suppressing the fluctuations of the aberrations during changing the magnification is achieved. By not causing the corresponding value of Conditional Expression (19) to be greater than or equal to its upper limit value, the refractive power of the lens group of the subsequent group GR that is closest to the object side is not excessively decreased. Thus, an advantage of size reduction is achieved.

$$0.05 < fR 1 / {( fw \times ft )}^{1 / 2} < 3 \qquad ( 19 )$$

In order to obtain more favorable characteristics, the lower limit value of Conditional Expression (19) is more preferably 0.15, still more preferably 0.25, and even more preferably 0.3. In order to obtain more favorable characteristics, the upper limit value of Conditional Expression (19) is more preferably 2, further preferably 1.5, and further preferably 1.

It is preferable that the variable magnification optical system satisfies Conditional Expression (20). By not causing a corresponding value of Conditional Expression (20) to be less than or equal to its lower limit value, the positive refractive power of the lens group of the subsequent group GR that is closest to the object side is not excessively decreased. Thus, an advantage of correcting the spherical aberration particularly at the wide angle end is achieved. By not causing the corresponding value of Conditional Expression (20) to be greater than or equal to its upper limit value, the positive refractive power of the lens group of the subsequent group GR that is closest to the object side is not excessively increased. Thus, an advantage of suppressing the fluctuations of the spherical aberrations during changing the magnification is achieved.

$$0.15 < fw / fR 1 < 2 \qquad ( 20 )$$

In order to obtain more favorable characteristics, the lower limit value of Conditional Expression (20) is more preferably 0.2, still more preferably 0.25, and even more preferably 0.3. In order to obtain more favorable characteristics, the upper limit value of Conditional Expression (20) is more preferably 1.5, further preferably 1.2, and further preferably 1.

In a configuration in which the above-described anti-vibration group is disposed in the subsequent group GR, the variable magnification optical system preferably satisfies Conditional Expression (21) below. Here, a focal length of the anti-vibration group is denoted by fIS. By not causing a corresponding value of Conditional Expression (21) to be its lower limit value or less, it is advantageous in correcting the various aberrations. By not causing the corresponding value of Conditional Expression (21) to be greater than or equal to its upper limit value, it is possible to secure a refractive power of the anti-vibration group. Thus, it is easier to suppress a moving amount of the anti-vibration group during image shake correction. This achieves an advantage in reduction in size.

$$0.2 < \vert fIS / ft \vert < 2 \qquad ( 21 )$$

In order to obtain more favorable characteristics, the lower limit value of Conditional Expression (21) is more preferably 0.3, still more preferably 0.4, and still more preferably 0.5. In order to obtain more favorable characteristics, the upper limit value of Conditional Expression (21) is more preferably 1.6, further preferably 1.2, and further preferably 1.

In a configuration in which the above-described focusing group is disposed in the subsequent group GR, the variable magnification optical system preferably satisfies Conditional Expression (22) below. Here, a focal length of at least one focusing group is denoted by ff. By not causing a corresponding value of Conditional Expression (22) to be its lower limit value or less, it is advantageous in correcting the various aberrations. By not causing the corresponding value of Conditional Expression (22) to be greater than or equal to its upper limit value, it is possible to secure a refractive power of the focusing group. Thus, it is easier to suppress a moving amount of the focusing group during focusing. This achieves an advantage in reduction in size.

$$0.2 < \vert ff / ft \vert < 1.4 \qquad ( 22 )$$

In order to obtain more favorable characteristics, the lower limit value of Conditional Expression (22) is more preferably 0.3, still more preferably 0.4, and still more preferably 0.45. In order to obtain more favorable characteristics, the upper limit value of Conditional Expression (22) is more preferably 1.2, still more preferably 1, and even more preferably 0.85.

In a configuration in which the first lens group G1 includes a cemented lens formed by a negative meniscus lens having a convex surface facing the object side and a positive lens having a convex surface facing the object side cemented together in this order from the object side, the variable magnification optical system preferably satisfies Conditional Expression (23) below. Here, a refractive index of the negative meniscus lens of the first lens group G1 for a d line and an Abbe number of the negative meniscus lens based on the d line are denoted by Ndn and vdn, respectively. By not causing a corresponding value of Conditional Expression (23) to be less than or equal to its lower limit value, a material other than a material having a low refractive index and a small Abbe number can be selected. Thus, it is easier to correct the lateral chromatic aberration at the wide angle end. By not causing the corresponding value of Conditional Expression (23) to be greater than or equal to its upper limit value, it is possible to select a material other than a material having a high refractive index and a high Abbe number. Thus, it is possible to select a material not having a high relative density and to facilitate reduction in weight. Alternatively, this prevents an excessively small difference in Abbe number between the positive lens and the negative lens which constitute the first lens group G1, and thus prevents a strong refractive power of each lens constituting the first lens group G1. As a result, correction of high-order aberrations of a spherical aberration at the telephoto end is facilitated. In the present specification, “high-order” related to aberrations refers to the fifth order or higher.

$$1.94 < Ndn + 0.01 \times vdn < 2.5 \qquad ( 23 )$$

In order to obtain more favorable characteristics, the lower limit value of Conditional Expression (23) is more preferably 2 and still more preferably 2.04. In order to obtain more favorable characteristics, the upper limit value of Conditional Expression (23) is more preferably 2.35 and still more preferably 2.3.

In the configuration in which the first lens group G1 includes the cemented lens formed by the negative meniscus lens having a convex surface facing the object side and the positive lens having a convex surface facing the object side cemented together in this order from the object side, the variable magnification optical system preferably satisfies Conditional Expression (24) below. Here, a refractive index of the positive lens of the first lens group G1 for the d line and an Abbe number of the positive lens based on the d line are denoted by Ndp and vdp, respectively. By not causing a corresponding value of Conditional Expression (24) to be equal to or less than its lower limit value, the material other than the material having a low refractive index and a low Abbe number can be selected, so that an increase in the high-order aberrations of the spherical aberration at the telephoto end can be suppressed, and thus it is easy to achieve high performance. Alternatively, insufficient correction of the axial chromatic aberration at the telephoto end can be suppressed. By not causing the corresponding value of Conditional Expression (24) to be greater than or equal to its upper limit value, it is possible to select the material other than the material with a high refractive index and a high Abbe number, and thus a material of which a relative density is not large can be selected, and weight reduction is facilitated. Alternatively, this can suppress overcorrection of the axial chromatic aberration at the telephoto end.

$$2 < Ndp + 0.01 \times vdp < 2.6 \qquad ( 24 )$$

In order to obtain more favorable characteristics, the lower limit value of Conditional Expression (24) is more preferably 2.1 and still more preferably 2.16. In order to obtain more favorable characteristics, the upper limit value of Conditional Expression (24) is more preferably 2.45 and still more preferably 2.4.

In a case in which an average value of Abbe numbers of all positive lenses of the first lens group G1 based on the d line is denoted by vdlp_ave, the variable magnification optical system preferably satisfies Conditional Expression (25). By not causing a corresponding value of Conditional Expression (25) to be equal to or less than its lower limit value, there is an advantage particularly in correcting the axial chromatic aberration at the telephoto end. By not causing the corresponding value of Conditional Expression (25) to be greater than or equal to its upper limit value, an advantage of correcting various aberrations other than the chromatic aberration is achieved.

$$40 < vd 1 p\_ave < 85 \qquad ( 25 )$$

In order to obtain more favorable characteristics, the lower limit value of Conditional Expression (25) is more preferably 50 and further preferably 55. In order to obtain more favorable characteristics, the upper limit value of Conditional Expression (25) is more preferably 75 and further preferably 70.

In a case in which a sum of thicknesses of all lenses of the first lens group G1 on the optical axis is denoted by dlsum, the variable magnification optical system preferably satisfies Conditional Expression (26) below. By not causing a corresponding value of Conditional Expression (26) to be less than or equal to its lower limit value, an advantage of securing strength of the first lens group G1 is achieved. By not causing the corresponding value of Conditional Expression (26) to be equal to or greater than an upper limit value thereof, there is an advantage in reducing a weight of the first lens group G1.

$$0.01 < d 1 sum / f 1 < 0.2 \qquad ( 26 )$$

In order to obtain more favorable characteristics, the lower limit value of Conditional Expression (26) is more preferably 0.015 and still more preferably 0.02. In order to obtain more favorable characteristics, the upper limit value of Conditional Expression (26) is more preferably 0.15 and still more preferably 0.12.

The number of lens groups included in the intermediate group GM and in the subsequent group GR may be different from the number thereof in the example of FIG. 1. In addition, the number of lenses included in each group may be different from the number of the example of FIG. 1.

For example, the intermediate group GM may be configured to consist of two lens groups. In such a case, it is advantageous for suppressing the fluctuations of the aberrations during changing the magnification.

In a configuration in which the intermediate group GM consists of two lens groups that have a negative refractive power, it is preferable that the variable magnification optical system satisfies Conditional Expression (27). Here, it is assumed that a focal length of a lens group of the intermediate group GM that is closest to the object side is fM1. It is assumed that a focal length of a lens group of the intermediate group GM that is closest to the image side is fM2. By not causing a corresponding value of Conditional Expression (27) to be equal to or less than its lower limit value, there is an advantage in suppressing fluctuations in the various aberrations during changing the magnification. By not causing the corresponding value of Conditional Expression (27) to be greater than or equal to its upper limit value, there is an advantage in securing the zoom ratio.

$$0.01 < fM 1 / fM 2 < 1.6 \qquad ( 27 )$$

In order to obtain more favorable characteristics, the lower limit value of Conditional Expression (27) is more preferably 0.03, further preferably 0.05, further preferably 0.1, and further preferably 0.15. In order to obtain more favorable characteristics, the upper limit value of Conditional Expression (27) is more preferably 1.4, further preferably 1.2, further preferably 1, and further preferably 0.8.

The subsequent group GR may be configured to consist of three lens groups, may be configured to consist of four lens groups, may be configured to consist of five lens groups, or may be configured to consist of six lens groups. By limiting the number of lens groups constituting the subsequent group GR to three, it is easier to reduce the total optical length. By setting the number of the lens groups constituting the subsequent group GR to be greater than or equal to four, it is easier to suppress the fluctuations of the aberrations during changing the magnification. More specifically, for example, the subsequent group GR can be configured as follows.

The subsequent group GR may be configured to consist of, in order from the object side to the image side, a first subsequent lens group having a positive refractive power, a second subsequent lens group having a negative refractive power, and a third subsequent lens group. By limiting the number of the lens groups included in the subsequent group GR to three, it is easier to reduce the total optical length.

In a configuration in which the subsequent group GR consists of the first subsequent lens group having a positive refractive power, the second subsequent lens group having a negative refractive power, and the third subsequent lens group, in this order from the object side to the image side, it is preferable that the variable magnification optical system satisfies Conditional Expression (28). Here, a focal length of the first subsequent lens group is denoted by fR1. A focal length of the second subsequent lens group is denoted by fR2.

$$0.2 < fR 1 / ( - fR 2 ) < 2 \qquad ( 28 )$$

By not causing a corresponding value of Conditional Expression (28) to be less than or equal to its lower limit value, the refractive power of the second subsequent lens group is not excessively decreased. Thus, an advantage of suppressing the fluctuations of the aberrations during changing the magnification is achieved. By not causing the corresponding value of Conditional Expression (28) to be equal to or more than its upper limit value, the refractive power of the first subsequent lens group is prevented from being excessively weak, so that an advantage in suppressing the spherical aberration at the telephoto end is achieved.

In order to obtain more favorable characteristics, the lower limit value of Conditional Expression (28) is more preferably 0.25, further preferably 0.3, further preferably 0.35, and further preferably 0.4. In order to obtain more favorable characteristics, the upper limit value of Conditional Expression (28) is more preferably 1.5, further preferably 1.2, further preferably 1.1, and further preferably 1.

The subsequent group GR may consist of a first subsequent lens group having a positive refractive power, a second subsequent lens group having a positive refractive power, and a third subsequent lens group having a negative refractive power, in this order from the object side to the image side. By limiting the number of the lens groups included in the subsequent group GR to three, it is easier to reduce the total optical length.

In a configuration in which the subsequent group GR consists of, in order from the object side to the image side, the first subsequent lens group having a positive refractive power, the second subsequent lens group having a positive refractive power, and the third subsequent lens group having a negative refractive power, the variable magnification optical system preferably satisfies at least one of Conditional Expression (29) or (30). Here, a focal length of the first subsequent lens group is denoted by fR1. A focal length of the second subsequent lens group is denoted by fR2. A focal length of the third subsequent lens group is denoted by fR3.

$$0.4 < fR 2 / ( - fR 3 ) < 3.7 \qquad ( 29 )$$

$$0.3 < fR 1 / fR 2 < 4 \qquad ( 30 )$$

By not causing a corresponding value of Conditional Expression (29) to be less than or equal to its lower limit value, the refractive power of the third subsequent lens group is not excessively decreased. Thus, an advantage of suppressing the fluctuations of the aberrations during changing the magnification is achieved. By not causing the corresponding value of Conditional Expression (29) to be equal to or more than its upper limit value, the refractive power of the second subsequent lens group is prevented from being excessively weak, so that an advantage in suppressing the spherical aberration at the telephoto end is achieved.

In order to obtain more favorable characteristics, the lower limit value of Conditional Expression (29) is more preferably 0.5, further preferably 0.55, further preferably 0.58, and further preferably 0.6. In order to obtain more favorable characteristics, the upper limit value of Conditional Expression (29) is more preferably 3.4, further preferably 3.2, further preferably 3, and further preferably 2.8.

By not causing a corresponding value of Conditional Expression (30) to be equal to or less than its lower limit value, the refractive power of the second subsequent lens group is prevented from being excessively weak, so that an advantage in correcting the spherical aberration at the telephoto end is achieved. By not causing the corresponding value of Conditional Expression (30) to be greater than or equal to its upper limit value, the refractive power of the first subsequent lens group is not excessively decreased. Thus, an advantage of suppressing the fluctuations of the aberrations during changing the magnification is achieved.

In order to obtain more favorable characteristics, the lower limit value of Conditional Expression (30) is more preferably 0.4, further preferably 0.5, further preferably 0.6, and further preferably 0.7. In order to obtain more favorable characteristics, the upper limit value of Conditional Expression (30) is more preferably 3.5, further preferably 3.2, further preferably 3, and further preferably 2.8.

The subsequent group GR may be configured to include at least a first subsequent lens group having a positive refractive power, a second subsequent lens group having a negative refractive power, a third subsequent lens group having a positive refractive power, and a fourth subsequent lens group having a negative refractive power consecutively in this order from the object side to the image side. By including at least four lens groups in the subsequent group GR, it is easier to suppress the fluctuations of the aberrations during changing the magnification.

In a configuration in which the subsequent group GR includes at least the first subsequent lens group having a positive refractive power, the second subsequent lens group having a negative refractive power, the third subsequent lens group having a positive refractive power, and the fourth subsequent lens group having a negative refractive power consecutively in this order from the object side to the image side, the variable magnification optical system preferably satisfies at least one of Conditional Expression (28A), (31), (32), or (33) below. Here, a focal length of the first subsequent lens group is denoted by fR1. A focal length of the second subsequent lens group is denoted by fR2. A focal length of the third subsequent lens group is denoted by fR3. A focal length of the fourth subsequent lens group is denoted by fR4.

$$0.2 < fR 1 / ( - fR 2 ) < 1.5 \qquad ( 28 A )$$

$$0.3 < ( - fR 2 ) / fR 3 < 2.4 \qquad ( 31 )$$

$$0.1 < fR 1 / fR 3 < 1.4 \qquad ( 32 )$$

$$0.15 < ( - fR 2 ) / ( - fR 4 ) < 1.8 \qquad ( 33 )$$

By not causing a corresponding value of Conditional Expression (28A) to be less than or equal to its lower limit value, the refractive power of the second subsequent lens group is not excessively decreased. Thus, an advantage of suppressing the fluctuations of the aberrations during changing the magnification is achieved. By not causing the corresponding value of Conditional Expression (28A) to be equal to or more than its upper limit value, the refractive power of the first subsequent lens group is prevented from being excessively weak, so that an advantage in suppressing the spherical aberration at the telephoto end is achieved.

In order to obtain more favorable characteristics, the lower limit value of Conditional Expression (28A) is more preferably 0.25, further preferably 0.3, further preferably 0.35, and further preferably 0.4. In order to obtain more favorable characteristics, the upper limit value of Conditional Expression (28A) is more preferably 1.2, further preferably 1, further preferably 0.9, and further preferably 0.8.

By not causing a corresponding value of Conditional Expression (31) to be less than or equal to its lower limit value, the refractive power of the third subsequent lens group is not excessively decreased. Thus, an advantage of suppressing the fluctuations of the aberrations during changing the magnification is achieved. By not causing the corresponding value of Conditional Expression (31) to be equal to or more than its upper limit value, the refractive power of the second subsequent lens group is prevented from being excessively weak, so that an advantage in suppressing the spherical aberration at the telephoto end is achieved.

In order to obtain more favorable characteristics, the lower limit value of Conditional Expression (31) is preferably 0.35, more preferably 0.4, yet more preferably 0.45, and especially preferably 0.5. In order to obtain more favorable characteristics, the upper limit value of Conditional Expression (31) is more preferably 2.1, still more preferably 1.8, still more preferably 1.5, and still more preferably 1.3.

By not causing a corresponding value of Conditional Expression (32) to be equal to or less than its lower limit value, the positive refractive power of the first subsequent lens group is prevented from being excessively strong, so that an advantage in correcting the spherical aberration at the telephoto end is achieved. By not causing the corresponding value of Conditional Expression (32) to be greater than or equal to its upper limit value, the positive refractive power of the third subsequent lens group is not excessively increased. Thus, an advantage of securing an appropriate length of the back focus is achieved.

In order to obtain more favorable characteristics, the lower limit value of Conditional Expression (32) is more preferably 0.15, further preferably 0.2, further preferably 0.25, and further preferably 0.3. In order to obtain more favorable characteristics, the upper limit value of Conditional Expression (32) is more preferably 1.1, further preferably 0.8, further preferably 0.6, and further preferably 0.5.

By not causing a corresponding value of Conditional Expression (33) to be equal to or less than its lower limit value, the negative refractive power of the fourth subsequent lens group is not excessively decreased, and thus it is advantageous for preventing insufficient correction of the aberrations during changing the magnification. By not causing the corresponding value of Conditional Expression (33) to be equal to or greater than its upper limit value, the negative refractive power of the fourth subsequent lens group is not excessively increased, and thus it is possible to prevent the aberrations during changing the magnification from being excessively corrected.

In order to obtain more favorable characteristics, the lower limit value of Conditional Expression (33) is more preferably 0.2, further preferably 0.25, further preferably 0.3, and further preferably 0.35. In order to obtain more favorable characteristics, the upper limit value of Conditional Expression (33) is more preferably 1.5, further preferably 1.3, further preferably 1.1, and further preferably 0.95.

The subsequent group GR may be configured to include at least a first subsequent lens group having a positive refractive power, a second subsequent lens group having a positive refractive power, a third subsequent lens group having a negative refractive power, and a fourth subsequent lens group having a positive refractive power consecutively in this order from the object side to the image side. By including at least four lens groups in the subsequent group GR, it is easier to suppress the fluctuations of the aberrations during changing the magnification.

In a configuration in which the subsequent group GR includes at least the first subsequent lens group having a positive refractive power, the second subsequent lens group having a positive refractive power, the third subsequent lens group having a negative refractive power, and the fourth subsequent lens group having a positive refractive power consecutively in this order from the object side to the image side, the variable magnification optical system preferably satisfies at least one of Conditional Expression (34), (29A), (30A), or (35) below. Here, a focal length of the first subsequent lens group is denoted by fR1. A focal length of the second subsequent lens group is denoted by fR2. A focal length of the third subsequent lens group is denoted by fR3. A focal length of the fourth subsequent lens group is denoted by fR4.

$$0.4 < fR 1 / ( - fR 3 ) < 2.5 \qquad ( 34 )$$

$$0.3 < fR 2 / ( - fR 3 ) < 3.5 \qquad ( 29 A )$$

$$0.3 < fR 1 / fR 2 < 5 \qquad ( 30 A )$$

$$0.1 < fR 2 / fR 4 < 2 \qquad ( 35 )$$

By not causing a corresponding value of Conditional Expression (34) to be less than or equal to its lower limit value, the refractive power of the third subsequent lens group is not excessively decreased. Thus, an advantage of suppressing the fluctuations of the aberrations during changing the magnification is achieved. By not causing the corresponding value of Conditional Expression (34) to be equal to or more than its upper limit value, the refractive power of the first subsequent lens group is prevented from being excessively weak, so that an advantage in suppressing the spherical aberration at the telephoto end is achieved.

In order to obtain more favorable characteristics, the lower limit value of Conditional Expression (34) is more preferably 0.5, further preferably 0.6, further preferably 0.7, and further preferably 0.8. In order to obtain more favorable characteristics, the upper limit value of Conditional Expression (34) is more preferably 2.2, further preferably 1.9, further preferably 1.7, and further preferably 1.5.

By not causing a corresponding value of Conditional Expression (29A) to be less than or equal to its lower limit value, the refractive power of the third subsequent lens group is not excessively decreased. Thus, an advantage of suppressing the fluctuations of the aberrations during changing the magnification is achieved. By not causing the corresponding value of Conditional Expression (29A) to be equal to or more than its upper limit value, the refractive power of the second subsequent lens group is prevented from being excessively weak, so that an advantage in suppressing the spherical aberration at the telephoto end is achieved.

In order to obtain more favorable characteristics, the lower limit value of Conditional Expression (29A) is preferably 0.35, more preferably 0.4, yet more preferably 0.45, and especially preferably 0.5. In order to obtain more favorable characteristics, the upper limit value of Conditional Expression (29A) is more preferably 3, further preferably 2.6, further preferably 2.3, and further preferably 2.

By not causing a corresponding value of Conditional Expression (30A) to be equal to or less than its lower limit value, the refractive power of the second subsequent lens group is prevented from being excessively weak, so that an advantage in correcting the spherical aberration at the telephoto end is achieved. By not causing the corresponding value of Conditional Expression (30A) to be greater than or equal to its upper limit value, the refractive power of the first subsequent lens group is not excessively decreased. Thus, an advantage of suppressing the fluctuations of the aberrations during changing the magnification is achieved.

In order to obtain more favorable characteristics, the lower limit value of Conditional Expression (30A) is more preferably 0.6, further preferably 0.9, further preferably 1.1, and further preferably 1.2. In order to obtain more favorable characteristics, the upper limit value of Conditional Expression (30A) is more preferably 4, further preferably 3.5, further preferably 3, and further preferably 2.5.

By not causing a corresponding value of Conditional Expression (35) to be equal to or less than its lower limit value, the refractive power of the fourth subsequent lens group is not excessively decreased, and thus it is advantageous for preventing the insufficient correction of the aberrations during changing the magnification. By not causing the corresponding value of Conditional Expression (35) to be equal to or greater than its upper limit value, the refractive power of the fourth subsequent lens group is not excessively increased, and thus it is possible to prevent the aberrations during changing the magnification from being excessively corrected.

In order to obtain more favorable characteristics, the lower limit value of Conditional Expression (35) is more preferably 0.2, further preferably 0.3, further preferably 0.35, and further preferably 0.4. In order to obtain more favorable characteristics, the upper limit value of Conditional Expression (35) is more preferably 1.5, further preferably 1.1, further preferably 0.9, and further preferably 0.8.

The subsequent group GR may be configured to consist of, in order from the object side to the image side, a first subsequent lens group having a positive refractive power, a second subsequent lens group having a positive refractive power, a third subsequent lens group having a positive refractive power, a fourth subsequent lens group, and a fifth subsequent lens group. By setting the number of lens groups constituting the subsequent group GR to five as described above, it is easier to suppress the fluctuations of the aberrations during changing the magnification.

In a configuration in which the subsequent group GR consists of, in order from the object side to the image side, the first subsequent lens group having a positive refractive power, the second subsequent lens group having a positive refractive power, the third subsequent lens group having a positive refractive power, the fourth subsequent lens group, and the fifth subsequent lens group, it is preferable that the variable magnification optical system satisfies at least one of Conditional Expression (30B) or (36). Here, a focal length of the first subsequent lens group is denoted by fR1. A focal length of the second subsequent lens group is denoted by fR2. A focal length of the third subsequent lens group is denoted by fR3.

$$0.1 < fR 1 / fR 2 < 4.5 \qquad ( 30 B )$$

$$0.2 < fR 2 / fR 3 < 3 \qquad ( 36 )$$

By not causing a corresponding value of Conditional Expression (30B) to be equal to or less than its lower limit value, the refractive power of the second subsequent lens group is prevented from being excessively weak, so that an advantage in correcting the spherical aberration at the telephoto end is achieved. By not causing the corresponding value of Conditional Expression (30B) to be greater than or equal to its upper limit value, the refractive power of the first subsequent lens group is not excessively decreased. Thus, an advantage of suppressing the fluctuations of the aberrations during changing the magnification is achieved.

In order to obtain more favorable characteristics, the lower limit value of Conditional Expression (30B) is more preferably 0.2, further preferably 0.3, further preferably 0.4, and further preferably 0.5. In order to obtain more favorable characteristics, the upper limit value of Conditional Expression (30B) is more preferably 3, further preferably 2, further preferably 1.3, and further preferably 0.9.

By not causing a corresponding value of Conditional Expression (36) to be equal to or less than its lower limit value, the positive refractive power of the third subsequent lens group is prevented from being excessively weak, so that an advantage in correcting the spherical aberration at the telephoto end is achieved. By not causing the corresponding value of Conditional Expression (36) to be greater than or equal to its upper limit value, the positive refractive power of the second subsequent lens group is not excessively decreased. Thus, an advantage of suppressing the fluctuations of the aberrations during changing the magnification is achieved.

In order to obtain more favorable characteristics, the lower limit value of Conditional Expression (36) is more preferably 0.3, further preferably 0.35, further preferably 0.4, and further preferably 0.45. In order to obtain more favorable characteristics, the upper limit value of Conditional Expression (36) is more preferably 2, further preferably 1.5, further preferably 1, and further preferably 0.8.

The subsequent group GR may consist of a first subsequent lens group having a positive refractive power, a second subsequent lens group having a positive refractive power, a third subsequent lens group having a negative refractive power, a fourth subsequent lens group having a negative refractive power, and a fifth subsequent lens group having a positive refractive power, in this order from the object side to the image side. By setting the number of lens groups constituting the subsequent group GR to five as described above, it is easier to suppress the fluctuations of the aberrations during changing the magnification.

In a configuration in which the subsequent group GR consists of the first subsequent lens group having a positive refractive power, the second subsequent lens group having a positive refractive power, the third subsequent lens group having a negative refractive power, the fourth subsequent lens group having a negative refractive power, and the fifth subsequent lens group having a positive refractive power, in this order from the object side to the image side, it is preferable that the variable magnification optical system satisfies at least one of Conditional Expression (30C) or (37). Here, a focal length of the first subsequent lens group is denoted by fR1. A focal length of the second subsequent lens group is denoted by fR2. A focal length of the third subsequent lens group is denoted by fR3. A focal length of the fourth subsequent lens group is denoted by fR4.

$$0.2 < fR 1 / fR 2 < 4 \qquad ( 30 C )$$

$$0.01 < fR 3 / fR 4 < 4 \qquad ( 37 )$$

By not causing a corresponding value of Conditional Expression (30C) to be equal to or less than its lower limit value, the refractive power of the second subsequent lens group is prevented from being excessively weak, so that an advantage in correcting the spherical aberration at the telephoto end is achieved. By not causing the corresponding value of Conditional Expression (30C) to be greater than or equal to its upper limit value, the refractive power of the first subsequent lens group is not excessively decreased. Thus, an advantage of suppressing the fluctuations of the aberrations during changing the magnification is achieved.

In order to obtain more favorable characteristics, the lower limit value of Conditional Expression (30C) is more preferably 0.25, further preferably 0.3, further preferably 0.35, and further preferably 0.4. In order to obtain more favorable characteristics, the upper limit value of Conditional Expression (30C) is more preferably 3.2, further preferably 2.5, further preferably 2, and further preferably 1.5.

By not causing a corresponding value of Conditional Expression (37) to be less than or equal to its lower limit value, the refractive power of the fourth subsequent lens group is not excessively decreased. Thus, an advantage of correcting a distortion is achieved. By not causing the corresponding value of Conditional Expression (37) to be equal to or greater than its upper limit value, the refractive power of the third subsequent lens group is not excessively decreased, and thus it is advantageous for correcting the aberrations during changing the magnification.

In order to obtain more favorable characteristics, the lower limit value of Conditional Expression (37) is more preferably 0.02, still more preferably 0.03, still more preferably 0.035, and still more preferably 0.04. In order to obtain more favorable characteristics, the upper limit value of Conditional Expression (37) is more preferably 3, further preferably 2, further preferably 1, and further preferably 0.5.

The subsequent group GR may be configured to include at least a first subsequent lens group having a positive refractive power, a second subsequent lens group having a negative refractive power, and a third subsequent lens group having a negative refractive power consecutively in this order from the object side to the image side. By including at least three lens groups in the subsequent group GR, it is easier to suppress the fluctuations of the aberrations during changing the magnification.

In a configuration in which the subsequent group GR includes at least the first subsequent lens group having a positive refractive power, the second subsequent lens group having a negative refractive power, and the third subsequent lens group having a negative refractive power consecutively in this order from the object side to the image side, the variable magnification optical system preferably satisfies at least one of Conditional Expression (28B) or (38) below. Here, a focal length of the first subsequent lens group is denoted by fR1. A focal length of the second subsequent lens group is denoted by fR2. A focal length of the third subsequent lens group is denoted by fR3.

$$0.2 < fR 1 / ( - fR 2 ) < 1.8 \qquad ( 28 B )$$

$$0.05 < ( - fR 2 ) / ( - fR 3 ) < 1.2 \qquad ( 38 )$$

By not causing a corresponding value of Conditional Expression (28B) to be less than or equal to its lower limit value, the refractive power of the second subsequent lens group is not excessively decreased. Thus, an advantage of suppressing the fluctuations of the aberrations during changing the magnification is achieved. By not causing the corresponding value of Conditional Expression (28B) to be equal to or more than its upper limit value, the refractive power of the first subsequent lens group is prevented from being excessively weak, so that an advantage in suppressing the spherical aberration at the telephoto end is achieved.

In order to obtain more favorable characteristics, the lower limit value of Conditional Expression (28B) is more preferably 0.25, further preferably 0.3, further preferably 0.35, and further preferably 0.4. In order to obtain more favorable characteristics, the upper limit value of Conditional Expression (28B) is more preferably 1.5, further preferably 1.2, further preferably 1, and further preferably 0.9.

By not causing a corresponding value of Conditional Expression (38) to be less than or equal to its lower limit value, the refractive power of the third subsequent lens group is not excessively decreased. Thus, an advantage of suppressing the fluctuations of the aberrations during changing the magnification is achieved. By not causing the corresponding value of Conditional Expression (38) to be equal to or more than its upper limit value, the refractive power of the second subsequent lens group is prevented from being excessively weak, so that an advantage in suppressing the spherical aberration at the telephoto end is achieved.

In order to obtain more favorable characteristics, the lower limit value of Conditional Expression (38) is more preferably 0.1, further preferably 0.15, further preferably 0.2, and further preferably 0.22. In order to obtain more favorable characteristics, the upper limit value of Conditional Expression (38) is more preferably 0.9, further preferably 0.75, further preferably 0.6, and further preferably 0.5.

The preferred configurations and the possible configurations described above can be combined in any manner without inconsistency, and it is preferable that the preferred configurations and possible configurations described above are selectively adopted as appropriate in accordance with required specifications.

For example, a preferred aspect of the variable magnification optical system according to the present disclosure consists of the first lens group G1 having a positive refractive power, the intermediate group GM consisting of two or fewer lens groups that have a negative refractive power, and the subsequent group GR consisting of a plurality of lens groups in order from the object side to the image side, in which the lens group of the subsequent group GR that is closest to the object side has a positive refractive power, the first lens group G1 moves and all the spacings of the adjacent lens groups change during changing the magnification, and Conditional Expressions (1), (2), and (3) are satisfied.

Next, examples of the variable magnification optical system according to the embodiment of the present disclosure will be described, with reference to the drawings. Reference numerals added to the groups in the cross-sectional views of each example are used independently for each example in order to avoid complication of description and drawings due to an increase in the number of digits of the reference numerals. Accordingly, a common reference numeral provided in the drawings of different examples does not necessarily indicate a common configuration.

### Example 1

A configuration and a movement trajectory of a variable magnification optical system of Example 1 are shown in FIG. 1, and its illustration method and configuration are described above. Thus, duplicate descriptions will be partially omitted here. The variable magnification optical system of Example 1 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, and a third subsequent lens group GR3 having a negative refractive power. A lens of the intermediate group GM that is closest to the object side corresponds to an Lmn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the object side, and other lens groups remain stationary with respect to an image plane Sim.

With respect to the variable magnification optical system of Example 1, basic lens data is shown in Table 1, specifications and variable surface spacings are shown in Table 2, and aspherical coefficients are shown in Table 3.

A table of the basic lens data is described as below. An Sn column shows surface numbers in a case in which a surface closest to the object side is a first surface and the number is increased one by one toward the image side. A curvature radius of each surface is shown in an R column. A D column shows a surface spacing between each surface and a surface adjacent to the surface on the image side on the optical axis. An Nd column shows a refractive index of each constituent for a d line. A vd column shows a d line-based Abbe number of each constituent. A θg,F column shows a partial dispersion ratio of each constituent between a g line and an F line. An ED column shows an effective diameter of each surface.

Assuming that refractive indexes of a certain lens for the g line, the F line, and a C line are Ng, NF, and NC, respectively, and that a partial dispersion ratio of the lens between the g line and F line is θg,F, θg,F is defined by the following expression.

$$θ g , F = ( Ng - NF ) / ( NF - NC )$$

Expressions “d line”, “C line”, “F line”, and “g line” described in the present specification mean emission lines, in which a wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

In the table of the basic lens data, a sign of a curvature radius of a surface having a convex shape facing the object side is defined as positive, and a sign of a curvature radius of a surface having a convex shape facing the image side is defined as negative. In Table 1, a field of a surface number of a surface corresponding to an aperture stop St has a surface number and text (St). A value in a lowermost field of the D column in the table indicates a spacing between a surface closest to the image side in the table and the image plane Sim. A symbol DD [ ] is used for each variable surface spacing during changing the magnification, and an object-side surface number of the spacing is given in [ ] and is noted in a surface spacing column.

Table 2 shows a zoom ratio Zr, a focal length f, a back focus Bf, an open F-number FNo., a maximum full angle of view 2ω, and variable surface spacings based on the d line. In a case in which the variable magnification optical system is a zoom lens, a zoom ratio is synonymous with a zoom magnification. In a field of 2ω, [°] indicates a degree unit. In Table 2, values in a wide-angle end state, a middle focal length state, and a telephoto end state are respectively shown in columns labeled with “Wide”, “Middle”, and “Tele”.

In the basic lens data, a reference sign * is attached to a surface number of an aspherical surface, and a value of a paraxial curvature radius is written in a field of a curvature radius of the aspherical surface. In Table 3, an Sn row shows surface numbers of aspherical surfaces, and KA and Am rows show numerical values of aspherical coefficients for each aspherical surface. It should be noted that m of Am is an integer equal to or more than 3, and varies depending on a surface. For example, for a fourth surface of Example 1, m=4, 6, 8, and 10 is established. “E±n” (n: integer) in the numerical values of the aspherical coefficients in Table 3 indicates “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

where,
Zd: a depth of the aspherical surface (a length of a perpendicular line drawn from a point on the aspherical surface at a height h to a plane that is in contact with an aspherical surface apex and that is perpendicular to an optical axis Z),
h: a height (a distance from the optical axis Z to a lens surface),
C: a reciprocal of the paraxial curvature radius,
KA and Am: aspherical coefficients, and
Σ in the aspheric equation means a sum related to m.

Although, in data of each table, a degree unit is used for angles, and a millimeter unit is used for lengths, since the optical system can also be proportionally enlarged or proportionally reduced to be used, other appropriate units can also be used. In addition, numerical values rounded to predetermined digits are described in each table shown below.

TABLE 1
Example 1

| Sn | R | D | Nd | νd | θg, F | ED |
|---|---|---|---|---|---|---|
| 1 | 133.0077 | 1.3709 | 1.95906 | 17.47 | 0.65993 | 54.80 |
| 2 | 104.1808 | 4.6443 | 1.72916 | 54.68 | 0.54451 | 53.79 |
| 3 | 38203.3994 | DD[3] | | | | 53.26 |
| *4 | 271.8578 | 1.1364 | 1.49710 | 81.56 | 0.53848 | 44.51 |
| *5 | 13.8476 | 13.3096 | | | | 28.13 |
| 6 | −39.0384 | 0.7143 | 1.49700 | 81.54 | 0.53748 | 27.65 |
| 7 | 79.8400 | 0.0683 | | | | 26.66 |
| 8 | 37.8778 | 2.8883 | 1.91650 | 31.60 | 0.59117 | 26.43 |
| 9 | 138.4526 | DD[9] | | | | 25.94 |
| 10(St) | ∞ | 0.0500 | | | | 20.09 |
| *11 | 23.4291 | 4.0252 | 1.49710 | 81.56 | 0.53848 | 21.20 |
| *12 | −198.5688 | 0.0498 | | | | 21.16 |
| 13 | 42.5815 | 1.0572 | 1.83400 | 37.21 | 0.58082 | 20.96 |
| 14 | 44.1682 | 3.6273 | 1.53775 | 74.70 | 0.53936 | 20.67 |
| 15 | −45.1215 | 1.2374 | | | | 20.35 |
| 16 | −34.6408 | 1.1100 | 1.80400 | 46.53 | 0.55775 | 19.66 |
| 17 | 15.2875 | 6.6929 | 1.53775 | 74.70 | 0.53936 | 19.14 |
| 18 | −28.6510 | DD[18] | | | | 19.44 |
| 19 | −22.0201 | 0.4929 | 1.88300 | 39.22 | 0.57288 | 19.05 |
| 20 | −32.8864 | 3.0394 | | | | 19.50 |
| *21 | 98.3569 | 6.0000 | 1.61881 | 63.85 | 0.54182 | 23.57 |
| *22 | −24.6648 | DD[22] | | | | 24.40 |
| *23 | −28.7242 | 5.6877 | 1.49710 | 81.56 | 0.53848 | 26.00 |
| *24 | −22.7075 | 7.3643 | | | | 28.14 |
| 25 | −16.5401 | 1.0000 | 1.48749 | 70.24 | 0.53007 | 27.38 |
| 26 | −98.1769 | DD[26] | | | | 32.50 |

TABLE 2
Example 1

| | Wide | Middle | Tele |
|---|---|---|---|
| Zr | 1.0 | 1.8 | 3.3 |
| f | 20.77 | 37.74 | 68.55 |
| Bf | 10.19 | 25.35 | 50.67 |
| FNo. | 4.13 | 4.13 | 4.12 |
| 2ω[°] | 97.2 | 57.6 | 33.8 |
| DD[3] | 0.50 | 16.22 | 34.98 |
| DD[9] | 23.01 | 9.37 | 0.68 |
| DD[18] | 3.43 | 6.73 | 6.37 |
| DD[22] | 8.93 | 4.60 | 0.67 |
| DD[26] | 10.19 | 25.35 | 50.67 |

TABLE 3
Example 1

| Sn | 4 | 12 | 21 | 23 |
|---|---|---|---|---|
| KA | 1.0000000E+00 | 1.0000000E+00 | 1.0000000E+00 | 1.0000000E+00 |
| A4 | 5.5137943E−06 | −1.1520092E−06 | 4.6971198E−06 | 1.0643576E−05 |
| A6 | −1.1726876E−08 | −7.1094274E−08 | 7.5637256E−09 | −4.4777094E−08 |
| A8 | 1.1899438E−11 | 4.4036515E−10 | 1.6724882E−10 | 1.6225119E−10 |
| A10 | −5.5431249E−15 | −9.0228698E−13 | −1.3080908E−12 | −3.0290073E−12 |

| Sn | 5 | 11 | 22 | 24 |
|---|---|---|---|---|
| KA | 0.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 3.4047355E−05 | −7.7108479E−06 | 2.4199457E−05 | −3.9569931E−06 |
| A5 | −1.8413112E−07 | −1.6321811E−08 | −7.7662764E−07 | −4.2062595E−07 |
| A6 | 3.4377259E−07 | −5.3426439E−08 | −1.7868962E−09 | 1.3111800E−07 |
| A7 | −3.6704615E−08 | −1.3661754E−09 | 4.3286224E−09 | −6.2871157E−09 |
| A8 | 1.5215933E−09 | 1.7909238E−10 | 1.9814154E−10 | −8.9458900E−10 |
| A9 | 8.0143206E−11 | 2.5757874E−11 | 6.0589217E−11 | −5.2197340E−12 |
| A10 | −4.8825218E−12 | 1.7996960E−12 | −9.9179750E−12 | 4.5326307E−12 |
| A11 | 5.0856207E−13 | 3.2374049E−13 | 1.1381376E−13 | 3.3059835E−13 |
| A12 | −3.0663154E−14 | 1.1004940E−14 | −7.2429298E−16 | −1.6580462E−14 |
| A13 | −4.1888355E−15 | −3.7704110E−15 | −3.2662397E−15 | −1.1615577E−15 |
| A14 | 2.3163782E−16 | −5.4256805E−16 | 6.0418943E−16 | −8.3286158E−17 |
| A15 | 9.8968635E−18 | −2.4167001E−17 | −2.5446546E−17 | −1.2238247E−18 |
| A16 | 4.9237083E−19 | −1.1776650E−18 | −1.7992948E−19 | 2.7552907E−19 |
| A17 | −2.7444006E−20 | 7.9495451E−19 | 2.5624616E−19 | 2.9664967E−20 |
| A18 | −4.1187738E−22 | 7.8139426E−21 | −2.6776014E−20 | 5.9394412E−22 |
| A19 | −4.7191008E−22 | 1.2791422E−21 | 5.6436641E−22 | −3.5509854E−23 |
| A20 | 2.6158693E−23 | −3.1620765E−22 | 1.2534910E−23 | −4.5613828E−24 |

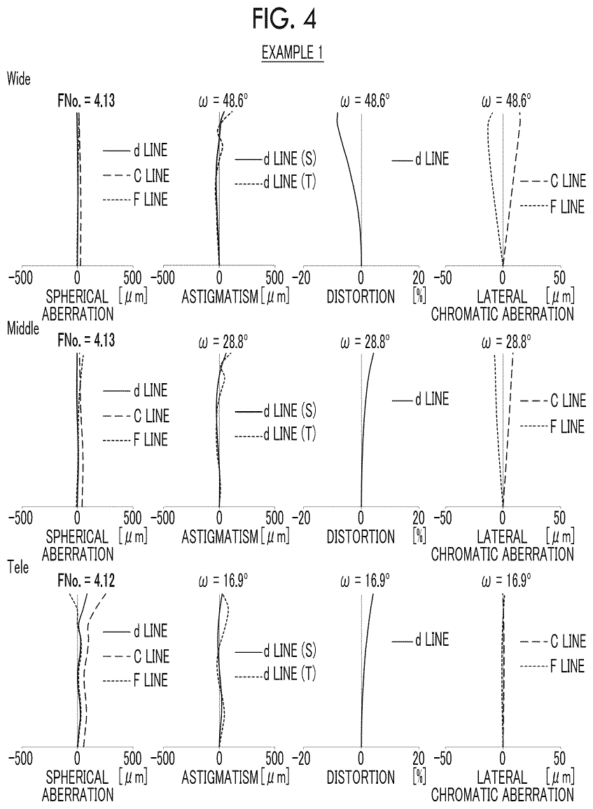

FIG. 4 shows each aberration diagram of the variable magnification optical system of Example 1 in a state where the infinite distance object is in focus. In FIG. 4, a spherical aberration, an astigmatism, a distortion, and a lateral chromatic aberration are shown in this order from the left. FIG. 4 shows aberrations in the wide-angle end state in an upper part labeled “Wide”, aberrations in the middle focal length state in a middle part labeled “Middle”, and aberrations in the telephoto end state in a lower part labeled “Tele”. In a spherical aberration diagram, aberrations at the d line, the C line, and the F line are shown by a solid line, a long broken line, and a short broken line, respectively. In an astigmatism diagram, the aberration at the d line in a sagittal direction is indicated by a solid line, and the aberration on the d line in a tangential direction is indicated by a short broken line. In a distortion diagram, the aberration at the d line is indicated by a solid line. In a lateral chromatic aberration diagram, the aberrations at the C line and at the F line are shown by a long broken line and a short broken line, respectively. In the spherical aberration diagram, a value of the open F-number is shown after FNo.=. In other aberration diagrams, a value of a maximum half angle of view is shown after ω=.

Symbols, meanings, description methods, and illustration methods of each piece of data related to Example 1 are essentially the same for the following examples unless otherwise noted, and thus duplicate descriptions thereof will be omitted below.

### Example 2

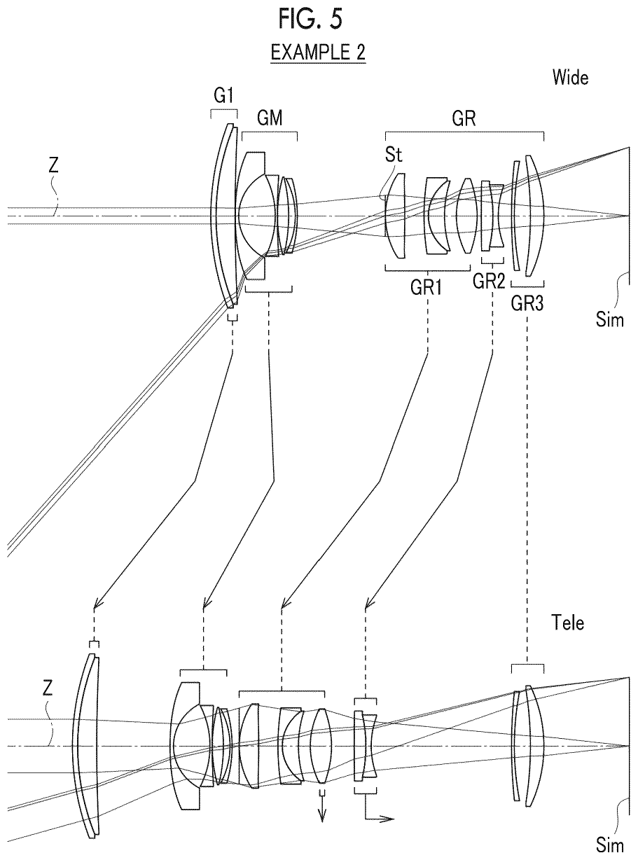

A configuration and a movement trajectory of a variable magnification optical system of Example 2 are shown in FIG. 5. In FIG. 5, a lens group that remains stationary with respect to an image plane Sim during changing the magnification is shown by a straight dotted line in an up-down direction instead of a solid line arrow of the movement trajectory. This illustration method related to the lens group that remains stationary with respect to the image plane Sim during changing a magnification also applies to the following examples. The variable magnification optical system of Example 2 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, and a third subsequent lens group GR3 having a positive refractive power. A lens of the intermediate group GM that is closest to the object side corresponds to an Lmn lens.

During changing the magnification from a wide angle end to a telephoto end, the third subsequent lens group GR3 remains stationary with respect to the image plane Sim, and other lens groups move along an optical axis Z by changing their spacings with respect to their adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of one lens of the first subsequent lens group GR1 that is closest to the image side. Parentheses and an arrow pointing down attached to the lens of the first subsequent lens group GR1 that is closest to the image side in FIG. 5 indicate that the lens constitutes the anti-vibration group. The anti-vibration group functions throughout an entire magnification range including a wide-angle end state, but in FIG. 5, the arrows are noted only in a lower part to avoid complication of the figure. This illustration method related to the anti-vibration group is the same in the following examples.

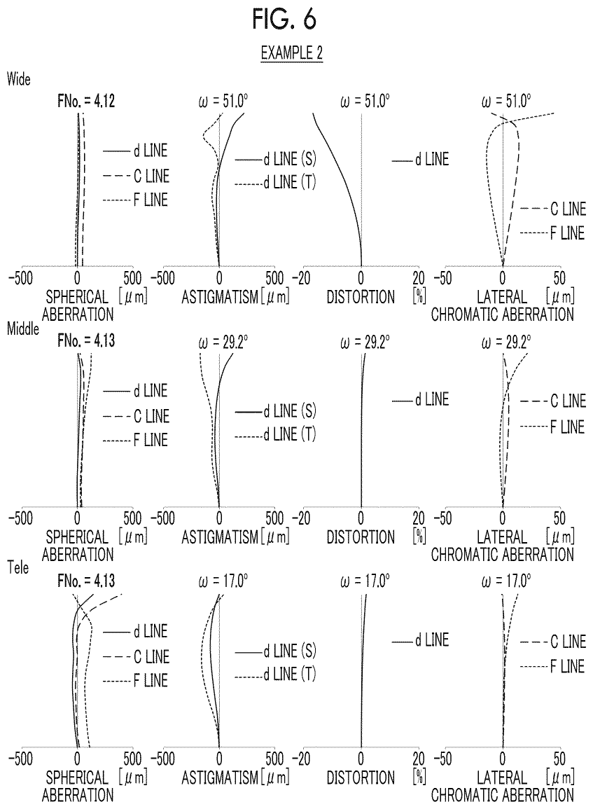

With respect to the variable magnification optical system of Example 2, basic lens data is shown in Table 4, specifications and variable surface spacings are shown in Table 5, aspherical coefficients are shown in Table 6, and each aberration diagram is shown in FIG. 6.

TABLE 4
Example 2

| Sn | R | D | Nd | νd | θg, F | ED |
|---|---|---|---|---|---|---|
| 1 | 88.4524 | 1.5000 | 1.72047 | 34.71 | 0.58350 | 58.00 |
| 2 | 81.1794 | 5.4735 | 1.64000 | 60.08 | 0.53704 | 55.66 |
| 3 | 591.0224 | DD[3] | | | | 53.88 |
| *4 | 85.3842 | 0.9939 | 1.76450 | 49.10 | 0.55289 | 37.84 |
| *5 | 15.7131 | 10.4899 | | | | 26.21 |
| 6 | −30.3349 | 0.6002 | 1.75500 | 52.32 | 0.54757 | 25.51 |
| 7 | 195.1970 | 0.0498 | | | | 24.73 |
| 8 | 49.9045 | 3.1934 | 1.92286 | 18.90 | 0.64960 | 24.42 |
| 9 | −56.1609 | 1.9082 | | | | 24.29 |
| 10 | −26.9659 | 0.6002 | 1.95906 | 17.47 | 0.65993 | 23.47 |
| 11 | −45.4189 | DD[11] | | | | 23.40 |
| 12(St) | ∞ | 0.0501 | | | | 23.94 |
| *13 | 26.2498 | 5.5547 | 1.80610 | 40.73 | 0.56940 | 26.28 |
| *14 | −254.4355 | 5.5394 | | | | 25.72 |
| 15 | 84.5447 | 1.2498 | 1.84666 | 23.78 | 0.62054 | 23.66 |
| 16 | 13.8396 | 4.6310 | 1.61800 | 63.32 | 0.54271 | 21.90 |
| 17 | 38.1328 | 3.4055 | | | | 21.89 |
| *18 | 25.4419 | 5.9650 | 1.61881 | 63.85 | 0.54182 | 23.40 |
| *19 | −31.9868 | DD[19] | | | | 23.45 |
| 20 | 807.2951 | 3.3491 | 1.95906 | 17.47 | 0.65993 | 20.08 |
| 21 | −47.8384 | 1.5349 | 1.88300 | 39.22 | 0.57288 | 19.56 |
| 22 | 29.0765 | DD[22] | | | | 18.60 |
| 23 | 174.4539 | 0.8249 | 1.53996 | 59.46 | 0.54418 | 34.00 |
| 24 | 99.8128 | 4.6042 | | | | 34.40 |
| 25 | −122.9258 | 3.8810 | 1.75500 | 52.32 | 0.54757 | 35.55 |
| 26 | −48.1303 | 24.5600 | | | | 36.33 |

TABLE 5
Example 2

| | Wide | Middle | Tele |
|---|---|---|---|
| Zr | 1.0 | 1.8 | 3.3 |
| f | 21.08 | 38.29 | 69.56 |
| Bf | 24.56 | 24.56 | 24.56 |
| FNo. | 4.12 | 4.13 | 4.13 |
| 2ω[°] | 102.0 | 58.4 | 34.0 |
| DD[3] | 0.05 | 12.40 | 21.06 |
| DD[11] | 25.11 | 9.76 | 2.02 |
| DD[19] | 1.20 | 4.81 | 6.52 |
| DD[22] | 3.79 | 13.99 | 40.31 |

TABLE 6
Example 2

| Sn | 4 | 5 | 13 | 14 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 3.2745489E−06 | −8.0390922E−06 | −9.6445365E−06 | −1.7691717E−06 |
| A5 | 2.2736601E−07 | 1.4837075E−06 | 1.9968312E−06 | 2.6081380E−06 |
| A6 | 3.6933457E−09 | −1.0886028E−07 | −2.2446776E−07 | −3.1898303E−07 |
| A7 | 1.1395283E−10 | −2.4225365E−10 | 1.1348267E−08 | 2.1738027E−08 |
| A8 | −1.2734938E−11 | 6.0098482E−10 | 2.0481189E−10 | −6.5249859E−10 |
| A9 | −3.3727689E−12 | 3.0804440E−12 | −9.0243265E−11 | −6.0007356E−11 |
| A10 | 1.3648998E−13 | −9.0958996E−13 | 5.2514937E−12 | 5.4090574E−12 |

| Sn | 18 | 19 |
|---|---|---|
| KA | 1.0000000E+00 | 1.0000000E+00 |
| A3 | 0.0000000E+00 | 0.0000000E+00 |
| A4 | −1.2184957E−05 | 1.5544373E−05 |
| A5 | −2.9448563E−06 | −2.5622070E−06 |
| A6 | 1.1708711E−06 | 8.7920870E−07 |
| A7 | −2.1371741E−07 | −1.5317127E−07 |
| A8 | 2.0871818E−08 | 1.4666590E−08 |
| A9 | −1.0228842E−09 | −7.0860939E−10 |
| A10 | 1.9229707E−11 | 1.3028744E−11 |

### Example 3

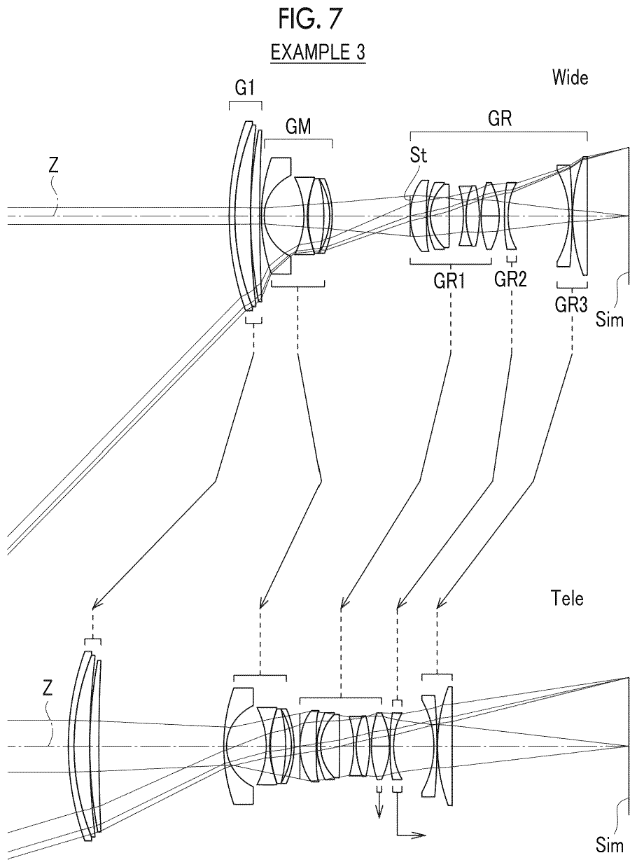

A configuration and a movement trajectory of a variable magnification optical system of Example 3 are shown in FIG. 7. The variable magnification optical system of Example 3 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, and a third subsequent lens group GR3 having a negative refractive power. A second lens from the object side of the intermediate group GM corresponds to an Lmn lens. A lens constituting the second subsequent lens group GR2 corresponds to an Lrn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of one lens of the first subsequent lens group GR1 that is closest to the image side.

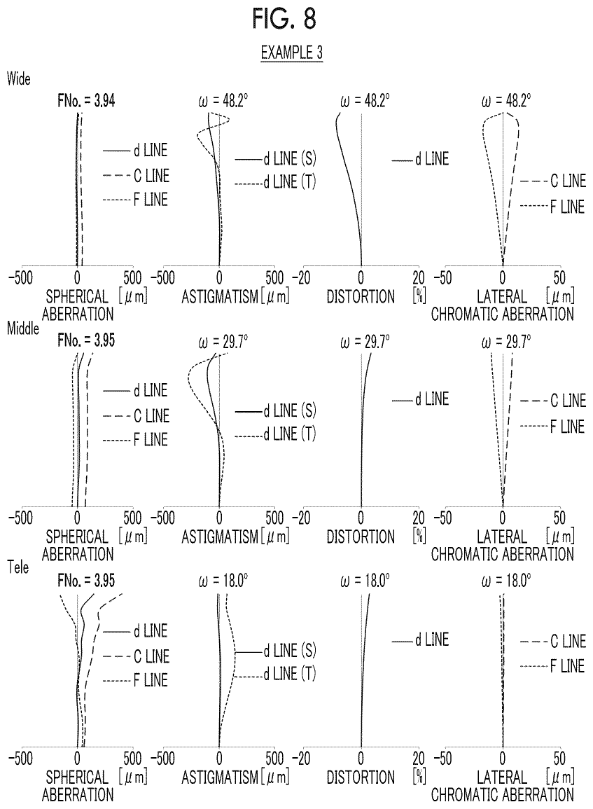

With respect to the variable magnification optical system of Example 3, basic lens data is shown in Table 7, specifications and variable surface spacings are shown in Table 8, aspherical coefficients are shown in Table 9, and each aberration diagram is shown in FIG. 8.

TABLE 7
Example 3

| Sn | R | D | Nd | νd | θg, F | ED |
|---|---|---|---|---|---|---|
| 1 | 96.1749 | 1.6248 | 2.10420 | 17.02 | 0.66311 | 59.60 |
| 2 | 83.5963 | 4.5089 | 1.64000 | 60.08 | 0.53704 | 57.20 |
| 3 | 257.2268 | 0.0498 | | | | 55.83 |
| 4 | 160.5513 | 2.5847 | 1.59522 | 67.73 | 0.54426 | 54.00 |
| 5 | 599.6951 | DD[5] | | | | 53.47 |
| 6 | 59.2665 | 0.7998 | 1.75500 | 52.32 | 0.54757 | 36.59 |
| 7 | 14.4948 | 11.4228 | | | | 25.59 |
| *8 | −27.4515 | 0.9655 | 1.61881 | 63.85 | 0.54182 | 24.33 |
| *9 | 31.0099 | 0.2500 | | | | 23.45 |
| 10 | 37.4830 | 4.3626 | 2.00100 | 29.13 | 0.59952 | 23.46 |
| 11 | −52.6094 | 1.6701 | | | | 23.17 |
| 12 | −23.9648 | 0.7498 | 2.00272 | 19.32 | 0.64514 | 23.20 |
| 13 | −32.0863 | DD[13] | | | | 23.48 |
| 14(St) | ∞ | 0.0498 | | | | 20.56 |
| *15 | 22.8158 | 4.6343 | 1.61881 | 63.85 | 0.54182 | 22.00 |
| *16 | 677.3183 | 0.2501 | | | | 21.36 |
| 17 | 27.2520 | 0.8810 | 1.69930 | 51.11 | 0.55523 | 21.07 |
| 18 | 14.5504 | 5.4087 | 1.49700 | 81.54 | 0.53748 | 19.92 |
| 19 | −843.8332 | 4.0716 | | | | 19.56 |
| 20 | −35.1125 | 0.7499 | 1.78590 | 44.20 | 0.56317 | 18.40 |
| 21 | 26.3478 | 3.8413 | 1.43875 | 94.66 | 0.53402 | 18.69 |
| 22 | −42.4418 | 0.4998 | | | | 19.00 |
| *23 | 31.0243 | 5.2269 | 1.49710 | 81.56 | 0.53848 | 20.70 |
| *24 | −22.3392 | DD[24] | | | | 20.99 |
| *25 | 465.4850 | 1.0510 | 1.59201 | 67.02 | 0.53589 | 21.04 |
| *26 | 32.3712 | DD[26] | | | | 20.60 |
| 27 | −32.0568 | 0.8748 | 1.59522 | 67.73 | 0.54426 | 28.92 |
| 28 | −201.4057 | 0.1748 | | | | 31.94 |
| 29 | 58.0250 | 4.2060 | 1.80610 | 40.93 | 0.57141 | 37.05 |
| 30 | ∞ | DD[30] | | | | 37.35 |

TABLE 8
Example 3

| | Wide | Middle | Tele |
|---|---|---|---|
| Zr | 1.0 | 1.8 | 3.1 |
| f | 20.82 | 36.65 | 64.54 |
| Bf | 11.96 | 23.12 | 50.80 |
| FNo. | 3.94 | 3.95 | 3.95 |
| 2ω[°] | 96.4 | 59.4 | 36.0 |
| DD[5] | 0.50 | 18.11 | 35.91 |
| DD[13] | 22.38 | 6.81 | 1.66 |
| DD[24] | 1.50 | 4.91 | 0.15 |
| DD[26] | 17.50 | 11.83 | 11.55 |
| DD[30] | 11.96 | 23.12 | 50.80 |

TABLE 9
Example 3

| Sn | 8 | 9 | 15 | 16 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 3.1655285E−05 | 1.1353308E−05 | 8.8024403E−06 | 2.0902363E−05 |
| A5 | 8.9543537E−07 | 9.5145072E−08 | −1.7702033E−07 | −5.3676882E−07 |
| A6 | −5.7109924E−07 | −5.0896666E−07 | 3.0238656E−08 | 1.2620219E−07 |
| A7 | 1.6727342E−09 | 4.9317982E−09 | 8.0008626E−09 | 4.2725949E−09 |
| A8 | 4.2686965E−09 | 3.8813333E−09 | −1.3983426E−09 | −1.2359636E−09 |
| A9 | −6.1450934E−13 | −1.6655399E−11 | 8.2685497E−11 | −1.1521854E−11 |
| A10 | −1.7656967E−11 | −1.7478723E−11 | 1.4747643E−11 | 1.2768325E−11 |
| A11 | −8.6538605E−14 | −1.1153984E−13 | −7.5233114E−13 | 5.2280931E−13 |
| A12 | 1.8914858E−14 | 2.2773338E−14 | −6.3390458E−14 | −3.6048847E−14 |
| A13 | −3.1328087E−16 | 1.4244172E−15 | −1.9143315E−15 | 2.3832169E−15 |
| A14 | 3.8383650E−17 | −2.2747156E−17 | 2.3744180E−16 | −4.0183645E−16 |
| A15 | 3.8810851E−18 | 3.5204109E−19 | 3.8804588E−17 | −5.8237999E−17 |
| A16 | 5.4256357E−19 | 1.1150136E−19 | −2.5268477E−18 | −2.5859699E−18 |
| A17 | −2.1292091E−20 | 5.8994727E−20 | 8.3424454E−21 | 5.8397922E−20 |
| A18 | −6.9664049E−22 | −5.0890879E−21 | −8.3379558E−21 | 8.7386577E−20 |
| A19 | −4.6825455E−23 | −3.9296822E−22 | 4.3859423E−21 | 2.8255883E−21 |
| A20 | 7.6261919E−26 | 3.1766471E−23 | −2.4428519E−22 | −4.5638268E−22 |

| Sn | 23 | 24 | 25 | 26 |
|---|---|---|---|---|
| KA | 1.0000000E+00 | 1.0000000E+00 | 1.4584000E+01 | 2.2732300E+00 |
| A3 | 0.0000000E+00 | 0.0000000E+00 | 0.0000000E+00 | 0.0000000E+00 |
| A4 | −2.0713117E−05 | 2.8916750E−05 | 1.3534770E−04 | 1.3352030E−04 |
| A5 | 4.3967208E−07 | −6.6922083E−07 | −9.2003482E−07 | −2.0457860E−07 |
| A6 | −4.8712348E−08 | −4.3067438E−08 | −1.6785647E−06 | −1.6540204E−06 |
| A7 | −2.9412808E−10 | 1.2374355E−09 | −8.7156518E−10 | −8.7589925E−10 |
| A8 | 1.3485434E−09 | 1.6454072E−09 | 1.7799908E−08 | 1.6384968E−08 |
| A9 | −4.6526159E−11 | −2.1023037E−11 | 8.5534384E−12 | −6.7431624E−11 |
| A10 | −1.8453764E−11 | −1.4042663E−11 | −1.2580366E−10 | −9.5234886E−11 |
| A11 | 5.0166277E−13 | −2.7030883E−13 | 9.5050590E−14 | 8.4299702E−14 |
| A12 | 1.3916174E−13 | 1.2697809E−13 | 4.8403653E−13 | 3.9173872E−13 |
| A13 | 1.8663403E−15 | −7.7788356E−15 | 4.7071845E−15 | −1.1505247E−14 |
| A14 | −4.5394344E−16 | 6.8137437E−16 | −6.9133672E−16 | 9.3894470E−18 |
| A15 | −8.7711051E−18 | −3.1027692E−17 | −8.4344757E−17 | −6.1684459E−17 |
| A16 | −1.0018667E−18 | 4.3568872E−18 | 2.1055866E−18 | 2.1364583E−19 |
| A17 | −3.8490140E−20 | −8.5261358E−19 | 1.0216714E−19 | 8.9638202E−19 |
| A18 | −3.7692124E−20 | 3.8728011E−20 | 2.0967558E−20 | 1.3055421E−20 |
| A19 | 8.3585576E−21 | 6.3767366E−21 | 2.2042412E−21 | 1.8464631E−21 |
| A20 | −3.4984372E−22 | −4.7894522E−22 | −3.6312840E−22 | −6.1519129E−22 |

### Example 4

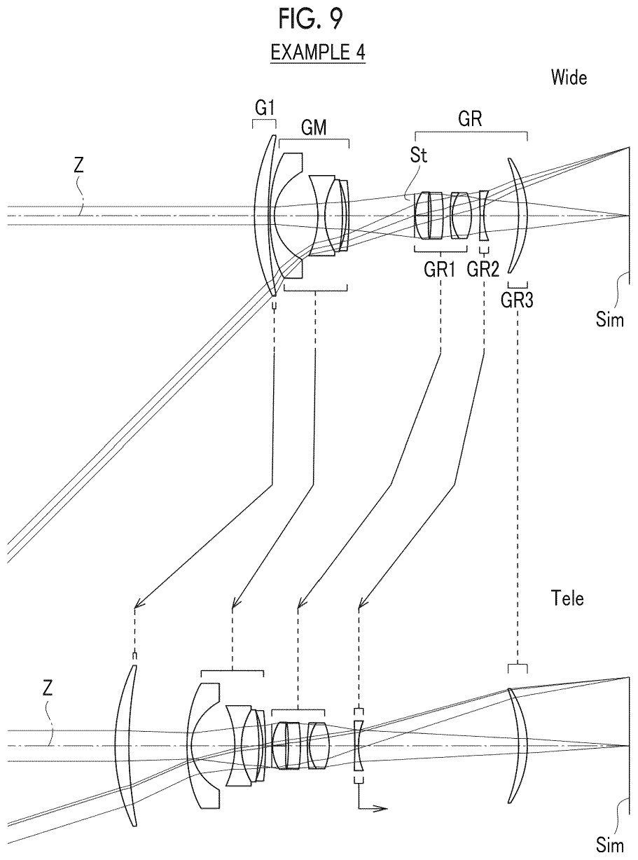

A configuration and a movement trajectory of a variable magnification optical system of Example 4 are shown in FIG. 9. The variable magnification optical system of Example 4 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, and a third subsequent lens group GR3 having a positive refractive power. A lens of the intermediate group GM that is closest to the object side corresponds to an Lmn lens. A lens constituting the second subsequent lens group GR2 corresponds to an Lrn lens.

During changing a magnification from a wide angle end to a telephoto end, the third subsequent lens group GR3 remains stationary with respect to the image plane Sim, and other lens groups move along an optical axis Z by changing their spacings with respect to their adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim.

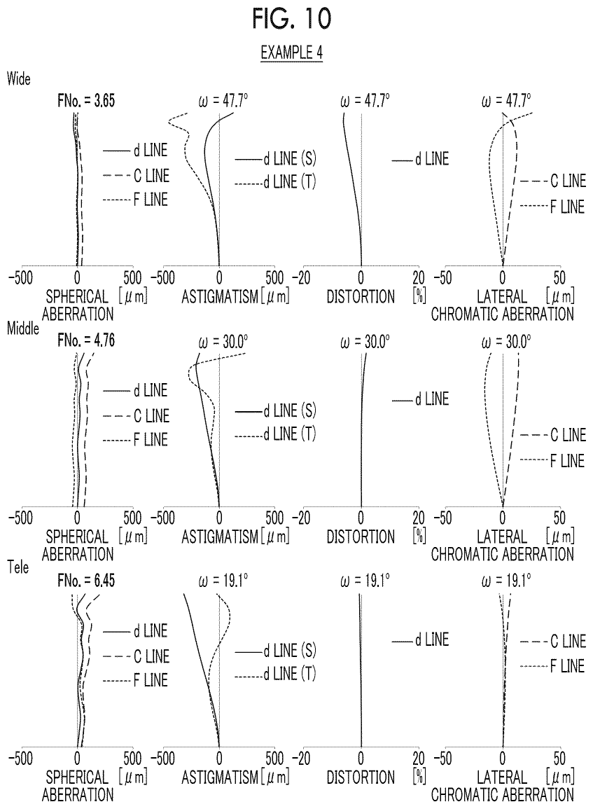

For the variable magnification optical system of Example 4, basic lens data is shown in Table 10, specifications and variable surface spacings are shown in Table 11, aspherical coefficients are shown in Table 12, and each aberration diagram is shown in FIG. 10.

TABLE 10
Example 4

| Sn | R | D | Nd | νd | θg, F | ED |
|---|---|---|---|---|---|---|
| 1 | 64.1944 | 3.9748 | 1.83481 | 42.74 | 0.56490 | 50.60 |
| 2 | 140.0736 | DD[2] | | | | 49.20 |
| *3 | 66.9852 | 1.2498 | 1.80610 | 40.73 | 0.56940 | 39.34 |
| *4 | 15.8149 | 12.5002 | | | | 27.77 |
| 5 | −32.2634 | 1.8690 | 1.52653 | 68.17 | 0.53295 | 25.24 |
| 6 | 24.1937 | 5.0342 | 1.89286 | 20.36 | 0.63944 | 22.66 |
| 7 | −70.2124 | 1.1390 | | | | 22.00 |
| 8 | −30.2697 | 0.7499 | 1.95906 | 17.47 | 0.65993 | 22.14 |
| 9 | −110.8581 | DD[9] | | | | 21.78 |
| 10(St) | ∞ | 0.2389 | | | | 13.64 |
| *11 | 16.3185 | 3.7984 | 1.55332 | 71.68 | 0.54029 | 14.78 |
| *12 | −113.3486 | 0.7498 | | | | 14.36 |
| 13 | −68.2805 | 3.4510 | 2.00272 | 19.32 | 0.64514 | 14.35 |
| 14 | −60.6593 | 2.0011 | | | | 14.66 |
| 15 | 58.2014 | 0.5999 | 1.95375 | 32.32 | 0.59056 | 14.48 |
| 16 | 14.1764 | 5.5100 | 1.55200 | 70.70 | 0.54219 | 14.16 |
| 17 | −20.7154 | DD[17] | | | | 14.40 |
| *18 | −72.5060 | 1.0540 | 1.49710 | 81.56 | 0.53848 | 15.35 |
| *19 | 28.8451 | DD[19] | | | | 15.60 |
| 20 | −53.9350 | 2.5001 | 1.95375 | 32.32 | 0.59056 | 35.54 |
| 21 | −36.1275 | 29.3400 | | | | 36.00 |

TABLE 11
Example 4

| | Wide | Middle | Tele |
|---|---|---|---|
| Zr | 1.0 | 1.8 | 3.0 |
| f | 20.89 | 36.77 | 62.66 |
| Bf | 29.34 | 29.34 | 29.34 |
| FNo. | 3.65 | 4.76 | 6.45 |
| 2ω[°] | 95.4 | 60.0 | 38.2 |
| DD[2] | 0.50 | 0.49 | 16.71 |
| DD[9] | 18.82 | 5.08 | 1.80 |
| DD[17] | 2.50 | 8.31 | 7.38 |
| DD[19] | 10.00 | 18.49 | 45.98 |

TABLE 12
Example 4

| Sn | 3 | 4 |
|---|---|---|
| KA | 1.0000000E+00 | 1.0000000E+00 |
| A4 | 9.5445640E−06 | 1.3046510E−06 |
| A6 | −1.2019807E−08 | −7.1225256E−09 |
| A8 | 1.8947746E−12 | −6.9420949E−11 |
| A10 | 3.8857501E−14 | −4.6981976E−13 |

| Sn | 11 | 12 | 18 | 19 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.3071152E−05 | 9.6062161E−05 | 2.1887049E−04 | 2.2086879E−04 |
| A5 | 7.9544021E−06 | 4.7507599E−06 | −7.0462310E−06 | −3.2846377E−06 |
| A6 | −1.7138492E−06 | −1.2693499E−06 | −5.2317510E−06 | −5.8826643E−06 |
| A7 | 2.3411134E−07 | 2.6343472E−07 | 5.8134154E−07 | 4.0413874E−07 |
| A8 | 1.7334875E−09 | 3.1503839E−08 | −9.2485730E−09 | 8.3993680E−08 |
| A9 | −4.5229575E−10 | −1.0018057E−08 | 4.4679178E−09 | −4.8179861E−09 |
| A10 | 7.7615731E−11 | 3.3846798E−10 | −4.2181916E−10 | −2.0433576E−09 |
| A11 | −1.1734290E−11 | 4.2979731E−11 | −1.9896257E−10 | 9.4130680E−11 |
| A12 | −1.4489620E−13 | 3.6058148E−12 | 2.2747374E−11 | 1.6948090E−11 |
| A13 | −2.6672611E−13 | 4.8138326E−13 | 2.1865098E−12 | 1.6126447E−12 |
| A14 | −6.5194113E−14 | 7.7071703E−14 | −9.8793915E−13 | −2.0039354E−13 |
| A15 | 6.8374971E−15 | −3.2912445E−14 | 1.6152532E−13 | 1.9426392E−14 |
| A16 | 1.4145869E−15 | 2.3387146E−16 | −4.0457275E−15 | −7.5015903E−15 |
| A17 | 1.0281943E−15 | −2.7750266E−17 | −6.4987345E−16 | −4.0855990E−18 |
| A18 | −1.2993033E−16 | 3.8620375E−17 | −1.2407639E−16 | 5.0071518E−17 |
| A19 | −1.4307874E−17 | −4.6679998E−18 | 1.8675756E−17 | 6.1664517E−18 |
| A20 | 1.7276099E−18 | 4.0017565E−19 | −4.0843305E−19 | −6.0871746E−19 |

### Example 5

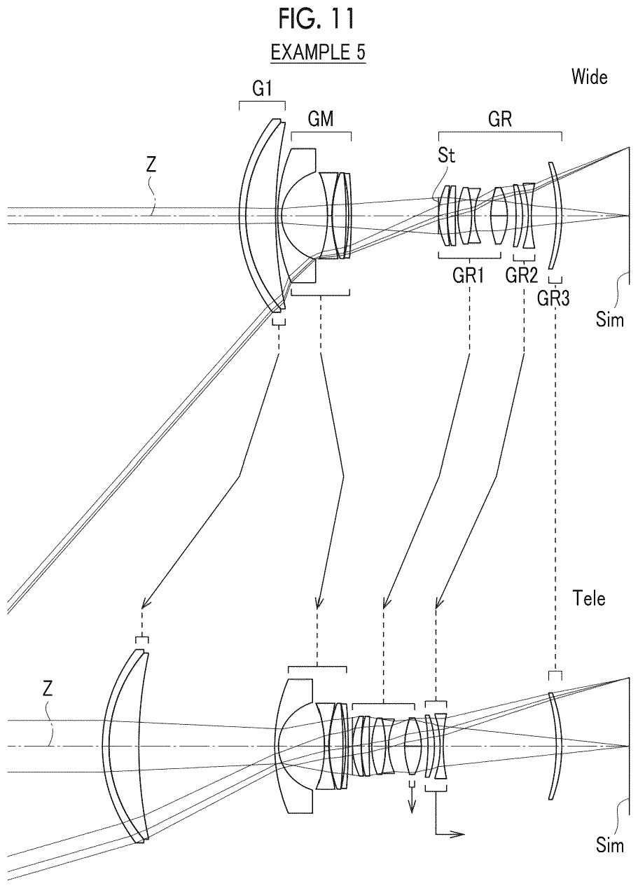

A configuration and a movement trajectory of a variable magnification optical system of Example 5 are shown in FIG. 11. The variable magnification optical system of Example 5 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, and a third subsequent lens group GR3 having a positive refractive power. A second lens from the object side of the intermediate group GM corresponds to an Lmn lens. A lens of the second subsequent lens group GR2 that is closest to the image side corresponds to an Lrn lens.

During changing a magnification from a wide angle end to a telephoto end, the third subsequent lens group GR3 remains stationary with respect to the image plane Sim, and other lens groups move along an optical axis Z by changing their spacings with respect to their adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of one lens of the first subsequent lens group GR1 that is closest to the image side.

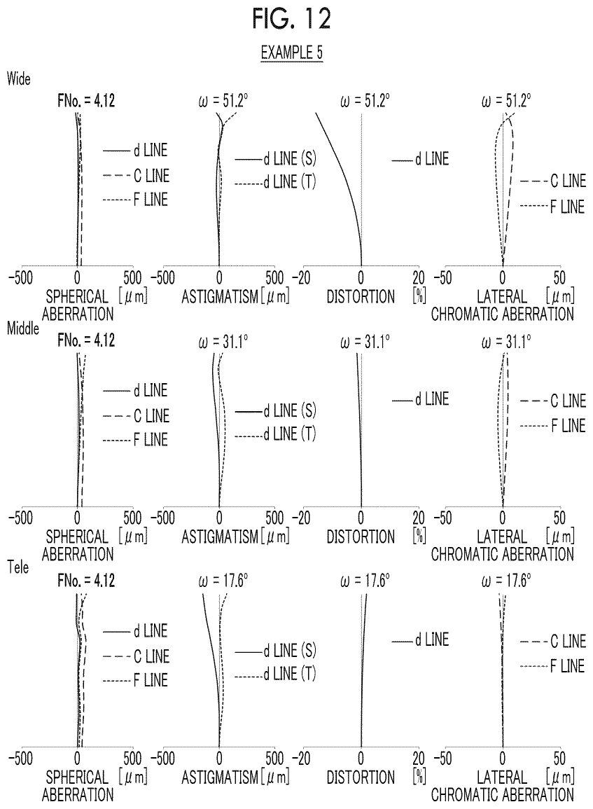

With respect to the variable magnification optical system of Example 5, basic lens data is shown in Table 13, specifications and variable surface spacings are shown in Table 14, aspherical coefficients are shown in Table 15A and Table 15B, and each aberration diagram is shown in FIG. 12.

TABLE 13
Example 5

| Sn | R | D | Nd | νd | θg, F | ED |
|---|---|---|---|---|---|---|
| 1 | 53.0382 | 1.8748 | 2.00272 | 19.32 | 0.64514 | 60.80 |
| 2 | 47.8660 | 8.5891 | 1.55032 | 75.50 | 0.54001 | 58.63 |
| 3 | 152.4117 | DD[3] | | | | 57.64 |
| 4 | 58.8455 | 1.0796 | 1.80420 | 46.50 | 0.55727 | 42.13 |
| 5 | 14.6232 | 13.0705 | | | | 27.60 |
| *6 | −40.3454 | 1.2498 | 1.49710 | 81.56 | 0.53848 | 27.08 |
| *7 | 41.9271 | 0.1203 | | | | 26.96 |
| 8 | 41.6765 | 3.9445 | 2.00069 | 25.46 | 0.61364 | 27.00 |
| 9 | −141.8005 | 0.7502 | | | | 26.68 |
| 10 | −70.0022 | 0.7501 | 1.92286 | 18.90 | 0.64960 | 26.59 |
| 11 | −176.1906 | DD[11] | | | | 26.25 |
| 12(St) | ∞ | 0.0498 | | | | 17.99 |
| *13 | 22.0398 | 2.4789 | 1.59201 | 67.02 | 0.53589 | 18.80 |
| *14 | 61.1945 | 0.0498 | | | | 18.74 |
| 15 | 39.1932 | 2.2499 | 1.84666 | 23.78 | 0.61923 | 18.76 |
| 16 | 410.8368 | 0.7551 | | | | 18.51 |
| 17 | 25.9151 | 3.9411 | 1.43875 | 94.66 | 0.53402 | 17.74 |
| 18 | −36.7050 | 0.8748 | 1.80518 | 25.46 | 0.61572 | 17.12 |
| 19 | 21.1479 | 4.6267 | | | | 16.22 |
| *20 | 24.8480 | 4.7804 | 1.49710 | 81.56 | 0.53848 | 17.00 |
| *21 | −19.8187 | DD[21] | | | | 17.76 |
| 22 | −60.1284 | 1.8604 | 2.00272 | 19.32 | 0.64514 | 19.20 |
| 23 | −31.5781 | 1.6409 | | | | 19.55 |
| *24 | −32.3179 | 0.8748 | 1.85135 | 40.10 | 0.56954 | 19.55 |
| *25 | 59.9767 | DD[25] | | | | 20.38 |
| 26 | −63.3807 | 1.5571 | 1.75500 | 52.32 | 0.54757 | 33.00 |
| 27 | −53.2214 | 19.4200 | | | | 33.54 |

TABLE 14
Example 5

| | Wide | Middle | Tele |
|---|---|---|---|
| Zr | 1.0 | 1.8 | 3.2 |
| f | 20.62 | 36.31 | 66.81 |
| Bf | 19.42 | 19.42 | 19.42 |
| FNo. | 4.12 | 4.12 | 4.12 |
| 2ω[°] | 102.4 | 62.2 | 35.2 |
| DD[3] | 0.62 | 18.58 | 39.05 |
| DD[11] | 25.05 | 9.71 | 1.20 |
| DD[21] | 2.50 | 3.26 | 1.90 |
| DD[25] | 7.18 | 15.15 | 32.51 |

TABLE 15A
Example 5

| Sn | 6 | 7 | 14 |
|---|---|---|---|
| KA | 1.0000000E+00 | 1.0000000E+00 | 1.0000000E+00 |
| A4 | 9.8143106E−06 | −3.7605649E−06 | −1.0129755E−05 |
| A6 | −1.8569240E−08 | 4.1497880E−10 | 1.2962107E−08 |
| A8 | −1.9220069E−10 | −5.7011158E−10 | 5.7995745E−11 |
| A10 | 1.5480214E−13 | 1.1562835E−12 | −5.6837345E−12 |
| Sn | 13 | 20 | 21 |
| KA | 1.0000000E+00 | 1.0000000E+00 | 1.0000000E+00 |
| A3 | 0.0000000E+00 | 0.0000000E+00 | 0.0000000E+00 |
| A4 | −1.4735743E−05 | −3.3123473E−05 | 3.8775056E−05 |
| A5 | −5.2640723E−08 | 4.4299942E−07 | −2.5808067E−07 |
| A6 | −1.7898671E−08 | −3.9168847E−08 | −1.9765479E−07 |
| A7 | 3.5377023E−10 | −5.2448884E−09 | 1.0708378E−08 |
| A8 | −3.3780463E−11 | 2.1925148E−09 | 2.2565834E−09 |
| A9 | 3.5374473E−12 | 3.9175577E−11 | −6.1036313E−12 |
| A10 | 1.0782092E−12 | −3.0549610E−11 | −1.3586347E−11 |
| A11 | −1.3321604E−13 | −8.6597133E−13 | −1.8855376E−12 |
| A12 | −6.2218283E−15 | 1.4790365E−13 | −1.6253396E−14 |
| A13 | −1.3841049E−15 | −1.7111546E−14 | 9.4931445E−16 |
| A14 | −5.9902061E−17 | 4.3798746E−18 | 2.9925192E−17 |
| A15 | −1.1068006E−17 | 1.7834921E−16 | −2.1144224E−17 |
| A16 | −8.5733694E−19 | −1.9824007E−17 | 1.8071674E−17 |
| A17 | −7.4239547E−20 | 3.3190973E−18 | 3.3467524E−18 |
| A18 | −4.7753550E−21 | −1.6538311E−20 | −1.9432482E−19 |
| A19 | 2.1278292E−21 | −9.8773218E−21 | −7.5221433E−20 |
| A20 | 3.5754727E−23 | −2.0822600E−21 | 3.8990035E−21 |

TABLE 15B
Example 5

| Sn | 24 | 25 |
|---|---|---|
| KA | 1.0000000E+00 | 1.0000000E+00 |
| A3 | 0.0000000E+00 | 0.0000000E+00 |
| A4 | 3.2932187E−05 | 3.2733894E−05 |
| A5 | −8.8890427E−07 | −1.1652103E−06 |
| A6 | −6.2897515E−07 | −4.6633529E−07 |
| A7 | 3.5953161E−09 | −6.2132593E−09 |
| A8 | 4.6859525E−09 | 6.1285932E−09 |
| A9 | 2.9340011E−10 | 1.9925942E−11 |
| A10 | −3.7164002E−11 | −1.2082197E−11 |
| A11 | 6.2422124E−12 | −3.4937243E−13 |
| A12 | −8.2764445E−13 | 2.2504684E−14 |
| A13 | 1.6876888E−14 | −2.7913352E−15 |
| A14 | 6.0066197E−16 | −3.2287109E−15 |
| A15 | −8.6227352E−17 | −1.7936952E−16 |
| A16 | −1.1403603E−16 | 3.1129576E−17 |
| A17 | 5.6003539E−18 | 1.1080436E−18 |
| A18 | 1.0045043E−18 | 1.3944973E−19 |
| A19 | 7.3551721E−20 | 7.0507379E−21 |
| A20 | −1.0721719E−20 | −1.9457949E−21 |

### Example 6

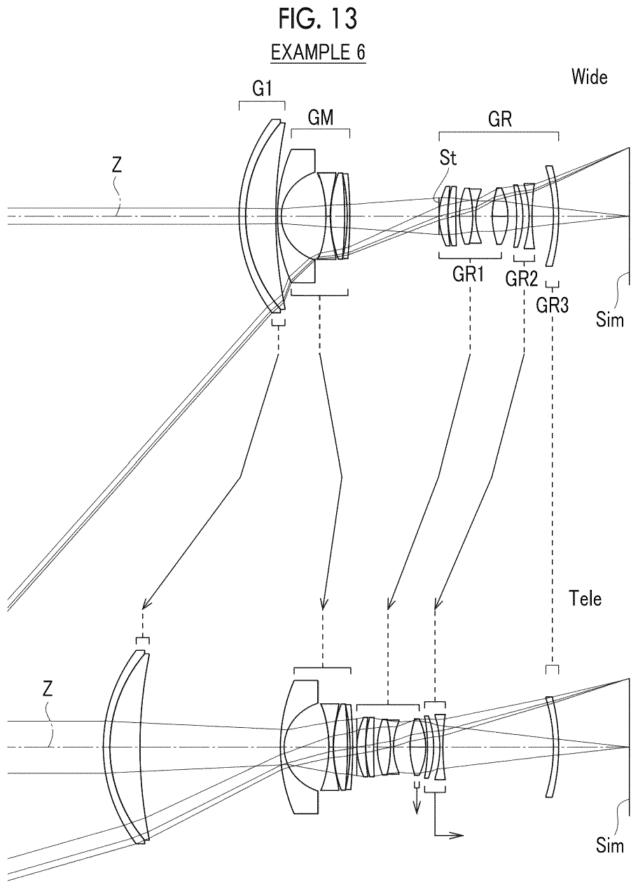

A configuration and a movement trajectory of a variable magnification optical system of Example 6 are shown in FIG. 13. The variable magnification optical system of Example 6 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, and a third subsequent lens group GR3 having a negative refractive power. A second lens from the object side of the intermediate group GM corresponds to an Lmn lens. A lens of the second subsequent lens group GR2 that is closest to the image side corresponds to an Lrn lens.

During changing a magnification from a wide angle end to a telephoto end, the third subsequent lens group GR3 remains stationary with respect to the image plane Sim, and other lens groups move along an optical axis Z by changing their spacings with respect to their adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of one lens of the first subsequent lens group GR1 that is closest to the image side.

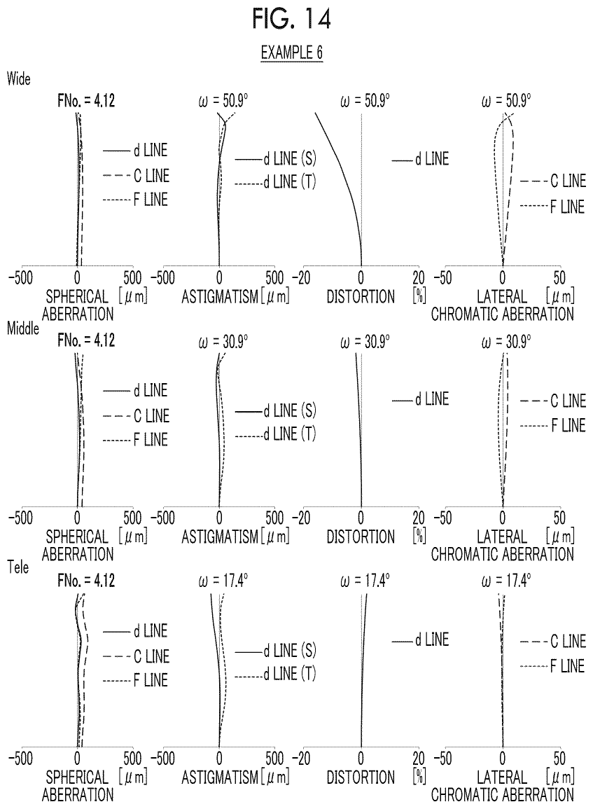

With respect to the variable magnification optical system of Example 6, basic lens data is shown in Table 16, specifications and variable surface spacings are shown in Table 17, aspherical coefficients are shown in Table 18A and Table 18B, and each aberration diagram is shown in FIG. 14.

TABLE 16
Example 6

| Sn | R | D | Nd | νd | θg, F | ED |
|---|---|---|---|---|---|---|
| 1 | 53.6544 | 1.8748 | 2.00272 | 19.32 | 0.64514 | 60.80 |
| 2 | 47.9221 | 8.6638 | 1.55032 | 75.50 | 0.54001 | 58.60 |
| 3 | 158.6185 | DD[3] | | | | 57.63 |
| 4 | 57.5946 | 1.0733 | 1.80420 | 46.50 | 0.55727 | 41.88 |
| 5 | 14.6774 | 12.6990 | | | | 27.60 |
| *6 | −41.1896 | 1.2500 | 1.49710 | 81.56 | 0.53848 | 27.24 |
| *7 | 43.8392 | 0.0999 | | | | 27.06 |
| 8 | 42.8285 | 3.9906 | 2.00069 | 25.46 | 0.61364 | 27.08 |
| 9 | −150.3534 | 0.7502 | | | | 26.71 |
| 10 | −68.6938 | 0.7501 | 1.92286 | 18.90 | 0.64960 | 26.68 |
| 11 | −160.6104 | DD[11] | | | | 26.35 |
| 12(St) | ∞ | 0.0498 | | | | 17.86 |
| *13 | 21.9113 | 2.4779 | 1.59201 | 67.02 | 0.53589 | 18.67 |
| *14 | 62.0509 | 0.0500 | | | | 18.61 |
| 15 | 39.2590 | 2.2498 | 1.84666 | 23.78 | 0.61923 | 18.63 |
| 16 | 302.4342 | 1.0866 | | | | 18.38 |
| 17 | 26.5698 | 3.7623 | 1.43875 | 94.66 | 0.53402 | 17.58 |
| 18 | −38.0637 | 0.8748 | 1.80518 | 25.46 | 0.61572 | 17.01 |
| 19 | 21.6980 | 4.7627 | | | | 16.18 |
| *20 | 25.9965 | 4.4904 | 1.49710 | 81.56 | 0.53848 | 17.00 |
| *21 | −20.0841 | DD[21] | | | | 17.68 |
| 22 | −56.5666 | 1.7844 | 2.00272 | 19.32 | 0.64514 | 19.20 |
| 23 | −31.9564 | 1.7754 | | | | 19.57 |
| *24 | −34.0772 | 0.8752 | 1.85135 | 40.10 | 0.56954 | 19.70 |
| *25 | 89.3791 | DD[25] | | | | 20.47 |
| 26 | −55.4813 | 1.5000 | 1.75500 | 52.32 | 0.54757 | 30.63 |
| 27 | −68.1015 | 20.3100 | | | | 31.54 |

TABLE 17
Example 6

| | Wide | Middle | Tele |
|---|---|---|---|
| Zr | 1.0 | 1.8 | 3.2 |
| f | 20.89 | 36.78 | 67.67 |
| Bf | 20.31 | 20.31 | 20.31 |
| FNo. | 4.12 | 4.12 | 4.12 |
| 2ω[°] | 101.8 | 61.8 | 34.8 |
| DD[3] | 0.50 | 17.78 | 40.34 |
| DD[11] | 25.63 | 10.17 | 1.18 |
| DD[21] | 2.50 | 2.32 | 0.50 |
| DD[25] | 6.14 | 15.43 | 31.75 |

TABLE 18A
Example 6

| Sn | 6 | 7 | 14 |
|---|---|---|---|
| KA | 1.0000000E+00 | 1.0000000E+00 | 1.0000000E+00 |
| A4 | 8.4940881E−06 | −4.5444722E−06 | −9.7368110E−06 |
| A6 | −1.8775936E−08 | 2.2712802E−09 | 1.5153190E−08 |
| A8 | −1.9076938E−10 | −5.6330830E−10 | 6.1577061E−11 |
| A10 | 1.5617752E−13 | 1.1758463E−12 | −5.6819817E−12 |
| Sn | 13 | 20 | 21 |
| KA | 1.0000000E+00 | 1.0000000E+00 | 1.0000000E+00 |
| A3 | 0.0000000E+00 | 0.0000000E+00 | 0.0000000E+00 |
| A4 | −1.4895505E−05 | −3.1416647E−05 | 3.8436581E−05 |
| A5 | −1.6987858E−08 | 4.9037341E−07 | −3.7817716E−07 |
| A6 | −1.9642162E−08 | −4.1064881E−08 | −1.9731173E−07 |
| A7 | 2.7276671E−10 | −5.3662622E−09 | 1.0725857E−08 |
| A8 | −3.6869948E−11 | 2.1891441E−09 | 2.2571784E−09 |
| A9 | 3.4551695E−12 | 3.9122246E−11 | −6.0443342E−12 |
| A10 | 1.0774868E−12 | −3.0556505E−11 | −1.3570358E−11 |
| A11 | −1.3299309E−13 | −8.6480078E−13 | −1.8844278E−12 |
| A12 | −6.1919127E−15 | 1.4859901E−13 | −1.6083545E−14 |
| A13 | −1.3825555E−15 | −1.7080192E−14 | 9.3272606E−16 |
| A14 | −6.0226080E−17 | 2.2681456E−17 | 3.4976540E−17 |
| A15 | −1.1187157E−17 | 1.7945315E−16 | −2.1927800E−17 |
| A16 | −8.8406819E−19 | −1.9694884E−17 | 1.7895722E−17 |
| A17 | −7.8245525E−20 | 3.3271736E−18 | 3.3237951E−18 |
| A18 | −4.8810274E−21 | −3.6486440E−20 | −2.0048090E−19 |
| A19 | 2.1262920E−21 | −1.1496567E−20 | −7.3043733E−20 |
| A20 | 3.6210146E−23 | −1.3451973E−21 | 4.1125973E−21 |

TABLE 18B
Example 6

| Sn | 24 | 25 |
|---|---|---|
| KA | 1.0000000E+00 | 1.0000000E+00 |
| A3 | 0.0000000E+00 | 0.0000000E+00 |
| A4 | 3.3553306E−05 | 3.2370965E−05 |
| A5 | −8.3336851E−07 | −1.0390791E−06 |
| A6 | −6.2766611E−07 | −4.6754822E−07 |
| A7 | 3.6715871E−09 | −6.3741910E−09 |
| A8 | 4.6881359E−09 | 6.1365684E−09 |
| A9 | 2.9339626E−10 | 2.0353290E−11 |
| A10 | −3.7153763E−11 | −1.2071210E−11 |
| A11 | 6.2414051E−12 | −3.4942634E−13 |
| A12 | −8.2748022E−13 | 2.2517985E−14 |
| A13 | 1.6907860E−14 | −2.7908789E−15 |
| A14 | 5.9776749E−16 | −3.2284245E−15 |
| A15 | −8.5710290E−17 | −1.7931572E−16 |
| A16 | −1.1395364E−16 | 3.1129792E−17 |
| A17 | 5.6052493E−18 | 1.1099627E−18 |
| A18 | 1.0046546E−18 | 1.3958032E−19 |
| A19 | 7.3522795E−20 | 7.0320301E−21 |
| A20 | −1.0742910E−20 | −1.9497221E−21 |

### Example 7

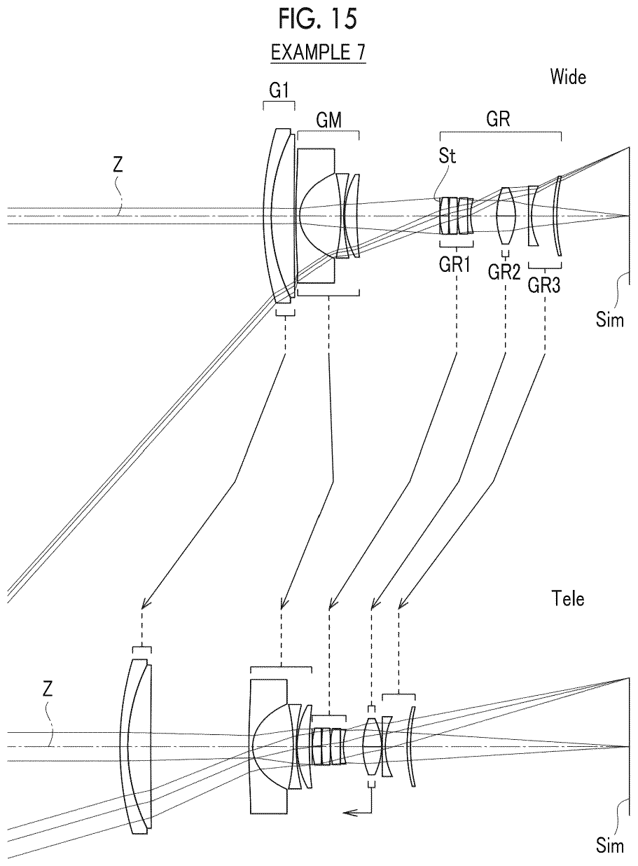

A configuration and a movement trajectory of a variable magnification optical system of Example 7 are shown in FIG. 15. The variable magnification optical system of Example 7 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, and a third subsequent lens group GR3 having a negative refractive power. A lens of the intermediate group GM that is closest to the object side corresponds to an Lmn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the object side, and other lens groups remain stationary with respect to an image plane Sim.

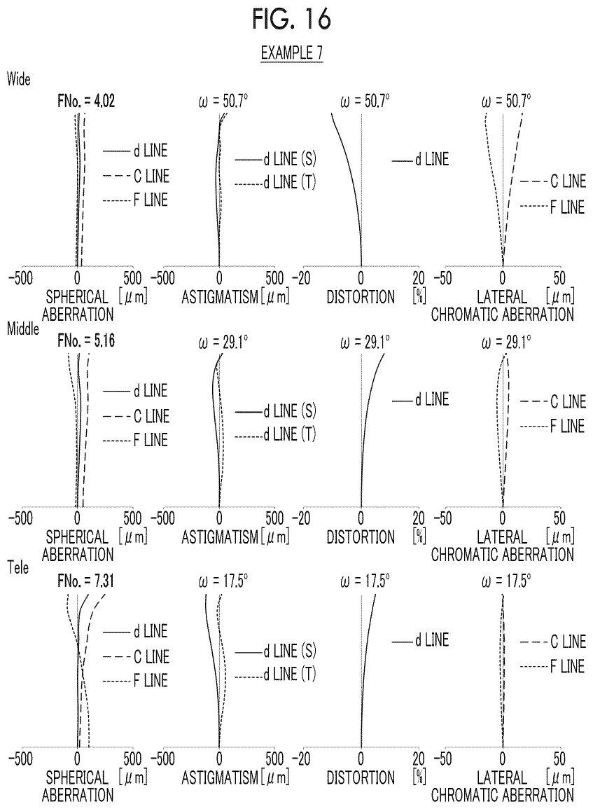

With respect to the variable magnification optical system of Example 7, basic lens data is shown in Table 19, specifications and variable surface spacings are shown in Table 20, aspherical coefficients are shown in Table 21A and Table 21B, and each aberration diagram is shown in FIG. 16.

TABLE 19
Example 7

| Sn | R | D | Nd | νd | θg, F | ED |
|---|---|---|---|---|---|---|
| 1 | 104.8947 | 2.2500 | 1.85025 | 30.05 | 0.59797 | 54.80 |
| 2 | 62.3639 | 6.5992 | 1.75500 | 52.32 | 0.54757 | 51.33 |
| 3 | 1947.0513 | DD[3] | | | | 50.32 |
| *4 | 290.5320 | 1.0813 | 1.61881 | 63.85 | 0.54182 | 42.19 |
| *5 | 12.1706 | 11.6772 | | | | 26.79 |
| 6 | −65.5070 | 0.8498 | 1.49700 | 81.54 | 0.53748 | 26.54 |
| 7 | 59.6226 | 0.2502 | | | | 25.96 |
| 8 | 29.4479 | 3.4900 | 1.85026 | 32.27 | 0.59299 | 25.99 |
| 9 | 114.8159 | DD[9] | | | | 25.49 |
| 10(St) | ∞ | 0.0498 | | | | 11.32 |
| *11 | 22.4924 | 2.5000 | 1.49710 | 81.56 | 0.53848 | 11.55 |
| *12 | −211.9434 | 0.0499 | | | | 11.59 |
| 13 | 61.8823 | 2.4999 | 1.49700 | 81.54 | 0.53748 | 11.59 |
| 14 | −92.4745 | 0.0546 | | | | 11.49 |
| 15 | 28.3472 | 2.8181 | 1.49700 | 81.54 | 0.53748 | 11.38 |
| 16 | 451.9091 | 0.8748 | 1.88300 | 39.22 | 0.57288 | 10.87 |
| 17 | 19.3596 | DD[17] | | | | 10.60 |
| *18 | 24.0555 | 5.3692 | 1.49710 | 81.56 | 0.53848 | 17.00 |
| *19 | −18.5187 | DD[19] | | | | 17.67 |
| *20 | 1557.5114 | 0.8748 | 1.74320 | 49.29 | 0.55303 | 18.52 |
| *21 | 23.0770 | 6.2501 | | | | 18.81 |
| 22 | 52.8704 | 1.0001 | 2.10420 | 17.02 | 0.66311 | 24.79 |
| 23 | 59.5402 | DD[23] | | | | 24.93 |

TABLE 20
Example 7

| | Wide | Middle | Tele |
|---|---|---|---|
| Zr | 1.0 | 1.8 | 3.3 |
| f | 19.78 | 35.93 | 65.27 |
| Bf | 20.86 | 35.69 | 62.88 |
| FNo. | 4.02 | 5.16 | 7.31 |
| 2ω[°] | 101.4 | 58.2 | 35.0 |
| DD[3] | 0.50 | 16.25 | 28.20 |
| DD[9] | 23.86 | 9.12 | 0.81 |
| DD[17] | 7.50 | 7.54 | 5.60 |
| DD[19] | 3.75 | 2.31 | 0.19 |
| DD[23] | 20.86 | 35.69 | 62.88 |

TABLE 21A
Example 7

| Sn | 4 | 5 | 11 |
|---|---|---|---|
| KA | 1.0000000E+00 | 0.0000000E+00 | 1.0000000E+00 |
| A3 | 0.0000000E+00 | 0.0000000E+00 | 0.0000000E+00 |
| A4 | −5.4858416E−07 | 4.6773158E−05 | −2.2877600E−05 |
| A5 | 8.7880006E−07 | −4.4642034E−07 | 7.9257510E−07 |
| A6 | −7.2780937E−08 | 2.8842203E−07 | −1.1672567E−07 |
| A7 | 1.4425805E−10 | 2.5741999E−09 | −4.6227480E−09 |
| A8 | 8.9028772E−11 | −3.1450686E−09 | 4.7406826E−09 |
| A9 | −1.6707435E−12 | 2.8344505E−10 | 1.1080950E−09 |
| A10 | −6.8390888E−14 | −1.2020354E−11 | −2.5025213E−10 |
| A11 | 4.5233927E−15 | 1.2569386E−12 | 9.3912928E−12 |
| A12 | 1.4599384E−16 | −7.1456940E−14 | 3.0213392E−12 |
| A13 | 2.3188917E−18 | −3.4656103E−15 | −2.9126512E−13 |
| A14 | −5.7272726E−19 | 1.5011957E−16 | −2.3471523E−14 |
| A15 | 9.3938017E−23 | 2.9495211E−17 | 2.9891034E−15 |
| A16 | −1.0765090E−21 | −2.6535955E−18 | −2.2523730E−16 |
| A17 | 3.6146768E−23 | 6.5244998E−21 | −2.3753458E−17 |
| A18 | 3.0045422E−24 | 6.7373392E−21 | 2.9138500E−18 |
| A19 | −9.7081726E−26 | 1.0437166E−22 | −2.1717598E−18 |
| A20 | 1.0613442E−28 | −1.2243535E−23 | 4.6023326E−19 |

| Sn | 12 | 21 |
|---|---|---|
| KA | 1.0000000E+00 | 1.0000000E+00 |
| A4 | 1.4485085E−06 | −1.7981495E−07 |
| A6 | 1.5992523E−07 | 3.9281114E−09 |
| A8 | 1.7972472E−09 | −7.5453485E−11 |
| A10 | 1.3756443E−11 | −4.0580944E−13 |

TABLE 21B
Example 7

| Sn | 18 | 19 | 20 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | −2.3185651E−05 | 5.3482446E−05 | 9.9671644E−06 |
| A5 | 5.5028479E−07 | −1.2601661E−06 | −1.3234044E−06 |
| A6 | 9.1007661E−08 | 3.6287729E−08 | 1.1131672E−07 |
| A7 | 1.0254123E−09 | 9.7049976E−09 | −1.2219797E−08 |
| A8 | −9.0667566E−10 | −2.9604273E−09 | −9.1442788E−10 |
| A9 | 1.8886363E−10 | 5.3996589E−10 | 1.3091028E−10 |
| A10 | 8.9865987E−12 | −4.6204063E−11 | −1.2319489E−11 |
| A11 | 1.6255652E−12 | 2.9534670E−12 | 4.7834038E−12 |
| A12 | −6.4588985E−13 | 7.3872274E−13 | −7.6466002E−13 |
| A13 | −1.9131414E−13 | −8.6977732E−14 | 6.0294682E−14 |
| A14 | 2.5503878E−14 | −6.4439256E−15 | 1.7387525E−15 |
| A15 | 5.8829007E−15 | −4.8637333E−16 | −1.7954047E−16 |
| A16 | −7.5296855E−16 | 3.1843836E−16 | −6.4070596E−17 |
| A17 | −3.6753735E−17 | −2.1476862E−17 | −1.7538419E−18 |
| A18 | 6.0970185E−18 | 1.0899013E−18 | 2.3917018E−19 |
| A19 | −6.8259848E−20 | −2.6722604E−19 | 1.0433191E−19 |
| A20 | −3.7073563E−21 | 1.7289902E−20 | −7.0770952E−21 |

### Example 8

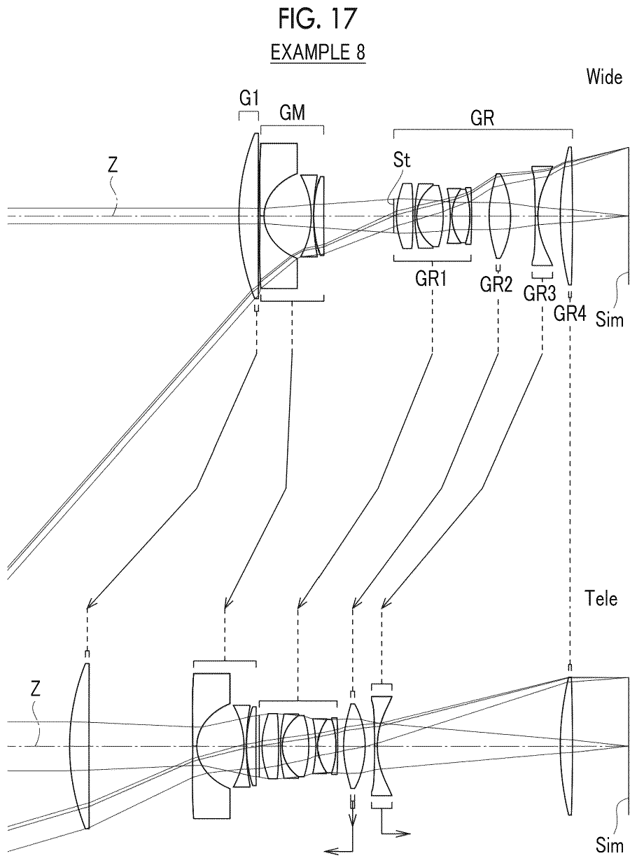

A configuration and a movement trajectory of a variable magnification optical system of Example 8 are shown in FIG. 17. The variable magnification optical system of Example 8 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, and a fourth subsequent lens group GR4 having a positive refractive power.

During changing a magnification from a wide angle end to a telephoto end, the fourth subsequent lens group GR4 remains stationary with respect to an image plane Sim, and other lens groups move along an optical axis Z by changing their spacings with respect to their adjacent lens groups. The variable magnification optical system includes two focusing groups. A focusing group on the object side consists of the second subsequent lens group GR2, and a focusing group on the image side consists of the third subsequent lens group GR3. During focusing from an infinite distance object to a close distance object, the second subsequent lens group GR2 moves to the object side, the third subsequent lens group GR3 moves to the image side, and other lens groups remain stationary with respect to the image plane Sim. An anti-vibration group consists of the second subsequent lens group GR2.

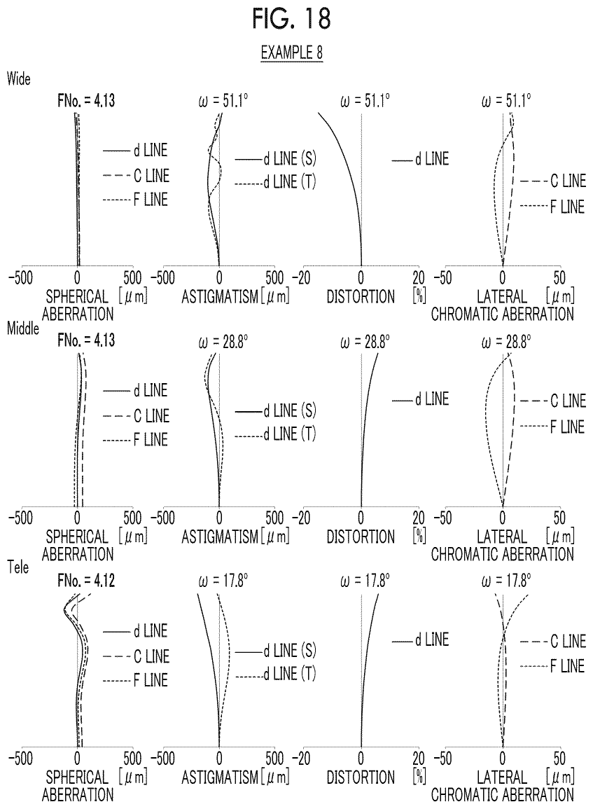

For the variable magnification optical system of Example 8, basic lens data is shown in Table 22, specifications and variable surface spacings are shown in Table 23, aspherical coefficients are shown in Table 24, and each aberration diagram is shown in FIG. 18.

TABLE 22
Example 8

| Sn | R | D | Nd | νd | θg, F | ED |
|---|---|---|---|---|---|---|
| 1 | 76.6828 | 5.5691 | 1.48749 | 70.24 | 0.53007 | 52.00 |
| 2 | 5935.0014 | DD[2] | | | | 51.33 |
| *3 | −247.6286 | 1.1598 | 1.49710 | 81.56 | 0.53848 | 45.64 |
| *4 | 12.7864 | 13.5831 | | | | 26.75 |
| 5 | −28.5121 | 0.6653 | 1.43875 | 94.66 | 0.53402 | 25.74 |
| 6 | 74.3779 | 0.0501 | | | | 24.87 |
| 7 | 44.4102 | 2.7210 | 2.00100 | 29.14 | 0.59974 | 24.79 |
| 8 | 1780.5399 | DD[8] | | | | 24.46 |
| 9(St) | ∞ | 0.7839 | | | | 19.43 |
| *10 | 25.6306 | 4.7359 | 1.59201 | 67.02 | 0.53589 | 20.45 |
| *11 | −321.2598 | 0.5722 | | | | 20.49 |
| 12 | 49.2997 | 0.5267 | 1.53996 | 59.46 | 0.54418 | 20.23 |
| 13 | 12.2574 | 7.6122 | 1.52841 | 76.45 | 0.53954 | 19.28 |
| 14 | −35.0970 | 2.0240 | | | | 18.93 |
| 15 | −42.9190 | 0.4848 | 1.80440 | 39.58 | 0.57623 | 17.27 |
| 16 | 15.1460 | 5.1843 | 1.49700 | 81.54 | 0.53748 | 16.68 |
| 17 | −28.9485 | 0.4813 | 1.66672 | 48.32 | 0.56101 | 16.81 |
| 18 | −210.1923 | DD[18] | | | | 17.82 |
| *19 | 35.1653 | 6.1998 | 1.61881 | 63.85 | 0.54182 | 26.00 |
| *20 | −30.3501 | DD[20] | | | | 26.59 |
| *21 | −346.2106 | 0.7914 | 1.49710 | 81.56 | 0.53848 | 28.94 |
| *22 | 26.2330 | DD[22] | | | | 31.18 |
| 23 | 98.5115 | 3.5158 | 2.00272 | 19.32 | 0.64514 | 43.38 |
| 24 | −716.8188 | 16.1700 | | | | 43.40 |

TABLE 23
Example 8

| | Wide | Middle | Tele |
|---|---|---|---|
| Zr | 1.0 | 1.8 | 3.1 |
| f | 20.47 | 37.18 | 63.45 |
| Bf | 16.17 | 16.17 | 16.17 |
| FNo. | 4.13 | 4.13 | 4.12 |
| 2ω[°] | 102.2 | 57.6 | 35.6 |
| DD[2] | 0.50 | 15.95 | 29.87 |
| DD[8] | 20.13 | 6.28 | 0.95 |
| DD[18] | 5.03 | 4.36 | 1.69 |
| DD[20] | 7.06 | 6.08 | 2.72 |
| DD[22] | 6.43 | 23.70 | 52.64 |

TABLE 24
Example 8

| Sn | 3 | 4 |
|---|---|---|
| KA | 1.0000000E+00 | 0.0000000E+00 |
| A4 | 1.3338045E−05 | 3.9191497E−05 |
| A6 | −3.8161033E−08 | 1.5318429E−07 |
| A8 | 6.7887809E−11 | −9.3682291E−10 |
| A10 | −5.4232571E−14 | 2.0554983E−11 |
| A12 | −3.6748158E−19 | −1.5593882E−13 |
| A14 | 1.4560517E−20 | 4.6718469E−16 |

| Sn | 10 | 11 | 19 |
|---|---|---|---|
| KA | 1.0000000E+00 | 1.0000000E+00 | 1.0000000E+00 |
| A4 | −1.8917984E−05 | −1.0629413E−05 | −1.4289859E−05 |
| A6 | −7.5693071E−08 | −5.8850217E−08 | −1.3686522E−08 |
| A8 | 5.0720797E−10 | 3.4307748E−10 | 9.7188457E−11 |
| A10 | −4.6484341E−12 | −3.5663363E−12 | −4.3125577E−13 |
| Sn | 20 | 21 | 22 |
| KA | 1.0000000E+00 | 1.0000000E+00 | 1.0000000E+00 |
| A4 | 9.4944038E−06 | −6.4487398E−06 | −9.2607027E−06 |
| A6 | −3.5440909E−08 | 8.4813417E−08 | 6.8900422E−08 |
| A8 | 5.8743872E−11 | −6.1264783E−10 | −5.7942784E−10 |
| A10 | −6.9338058E−13 | 2.4611171E−13 | 7.5664525E−13 |

### Example 9

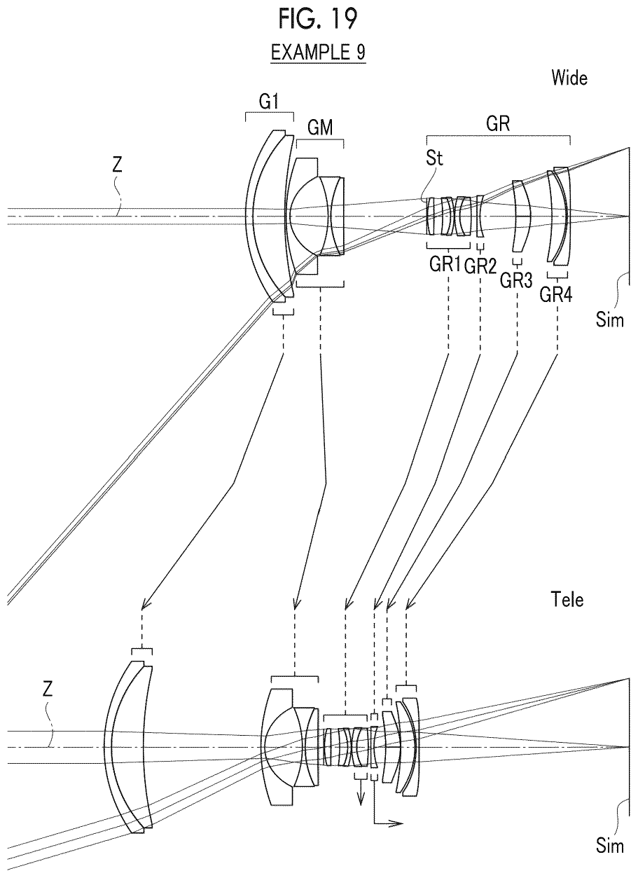

A configuration and a movement trajectory of a variable magnification optical system of Example 9 are shown in FIG. 19. The variable magnification optical system of Example 9 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a positive refractive power, and a fourth subsequent lens group GR4 having a negative refractive power. A lens of the intermediate group GM that is closest to the object side corresponds to an Lmn lens. A lens constituting the second subsequent lens group GR2 corresponds to an Lrn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of a cemented lens of the first subsequent lens group GR1 that is closest to the image side.

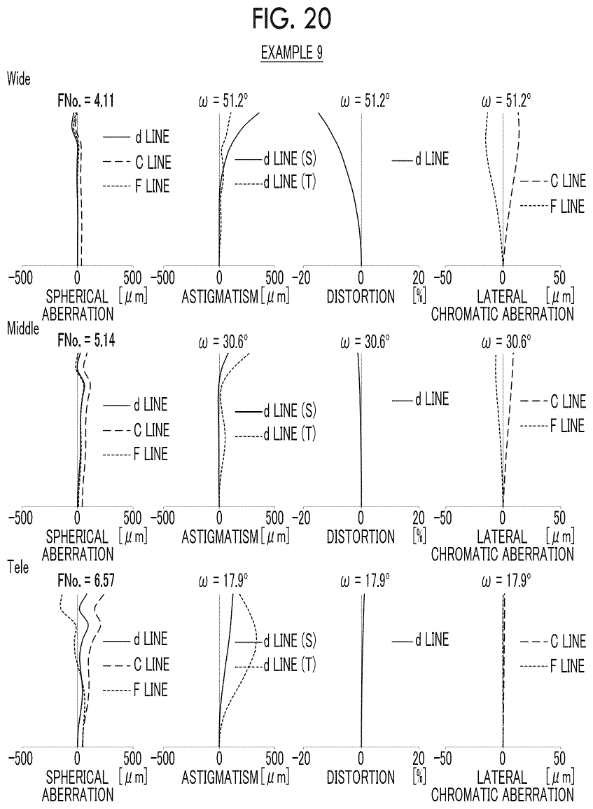

With respect to the variable magnification optical system of Example 9, basic lens data is shown in Table 25, specifications and variable surface spacings are shown in Table 26, aspherical coefficients are shown in Table 27A and Table 27B, and each aberration diagram is shown in FIG. 20.

TABLE 25
Example 9

| Sn | R | D | Nd | νd | θg, F | ED |
|---|---|---|---|---|---|---|
| 1 | 49.9954 | 2.1000 | 1.95375 | 32.32 | 0.59056 | 54.00 |
| 2 | 39.2957 | 9.1537 | 1.64000 | 60.08 | 0.53704 | 50.80 |
| 3 | 118.5383 | DD[3] | | | | 48.93 |
| *4 | 58.5167 | 1.0972 | 1.85400 | 40.38 | 0.56890 | 36.53 |
| *5 | 13.2715 | 10.8130 | | | | 25.00 |
| 6 | −32.8747 | 0.8098 | 1.49700 | 81.54 | 0.53748 | 24.71 |
| 7 | 29.0453 | 3.6659 | 2.00100 | 29.14 | 0.59974 | 24.09 |
| 8 | 1469.3632 | DD[8] | | | | 23.76 |
| 9(St) | ∞ | 0.2500 | | | | 11.32 |
| *10 | 26.4276 | 1.8316 | 1.61881 | 63.85 | 0.54182 | 11.59 |
| *11 | −123.3072 | 2.4999 | | | | 11.51 |
| 12 | −45.5232 | 2.2998 | 1.43875 | 94.66 | 0.53402 | 11.40 |
| 13 | −14.9463 | 0.9998 | 1.75500 | 52.32 | 0.54757 | 11.63 |
| 14 | −22.0224 | 0.1737 | | | | 12.00 |
| 15 | 23.5029 | 1.4338 | 1.95375 | 32.32 | 0.59056 | 12.20 |
| 16 | 12.8640 | 3.2911 | 1.59522 | 67.73 | 0.54426 | 11.90 |
| 17 | −60.9436 | DD[17] | | | | 12.00 |
| *18 | 1614.8771 | 0.8748 | 1.59201 | 67.02 | 0.53589 | 12.69 |
| *19 | 20.7506 | DD[19] | | | | 13.00 |
| *20 | −54.8242 | 4.2498 | 1.49710 | 81.56 | 0.53848 | 20.68 |
| *21 | −20.1003 | DD[21] | | | | 22.37 |
| 22 | −74.0428 | 4.0693 | 1.95906 | 17.47 | 0.65993 | 27.83 |
| 23 | −26.4108 | 0.3758 | | | | 28.51 |
| *24 | −31.2469 | 0.8498 | 2.00178 | 19.32 | 0.64480 | 28.45 |
| *25 | −6707.8046 | DD[25] | | | | 30.80 |

TABLE 26
Example 9

| | Wide | Middle | Tele |
|---|---|---|---|
| Zr | 1.0 | 1.8 | 3.2 |
| f | 20.40 | 37.06 | 66.30 |
| Bf | 16.96 | 35.69 | 60.40 |
| FNo. | 4.11 | 5.14 | 6.57 |
| 2ω[°] | 102.4 | 61.2 | 35.8 |
| DD[3] | 0.40 | 16.32 | 33.79 |
| DD[8] | 23.85 | 9.81 | 1.50 |
| DD[17] | 1.66 | 1.08 | 0.80 |
| DD[19] | 10.31 | 6.98 | 3.35 |
| DD[21] | 6.09 | 3.70 | 0.07 |
| DD[25] | 16.96 | 35.69 | 60.40 |

TABLE 27A
Example 9

| Sn | 4 | 5 | 10 |
|---|---|---|---|
| KA | 1.0000000E+00 | 0.0000000E+00 | 1.0000000E+00 |
| A3 | 0.0000000E+00 | 0.0000000E+00 | 0.0000000E+00 |
| A4 | 7.9904037E−06 | 5.4160843E−05 | 3.8815662E−05 |
| A5 | −4.4664774E−07 | −2.3204762E−07 | −4.1865161E−07 |
| A6 | −1.6725379E−08 | 7.4195449E−08 | −7.2697649E−07 |
| A7 | 5.8108272E−10 | 2.0121218E−09 | −9.2867970E−09 |
| A8 | 2.3987211E−11 | −1.4935946E−10 | 4.8693388E−08 |
| A9 | 9.5655817E−13 | 5.5277302E−11 | −3.8583986E−09 |
| A10 | −1.7464136E−14 | 1.7255321E−12 | 2.7304368E−09 |
| A11 | 3.2978061E−16 | −1.7911879E−13 | −4.0956813E−10 |
| A12 | −4.7928043E−17 | −1.3152751E−14 | −5.8535076E−12 |
| A13 | −2.7730666E−18 | 5.7232568E−16 | −2.3519744E−13 |
| A14 | −1.6065622E−19 | 7.3746595E−17 | 6.1470543E−13 |
| A15 | −1.3505470E−20 | −3.1382899E−18 | −4.1349104E−15 |
| A16 | 2.7371002E−22 | −4.3815297E−19 | 2.1734122E−15 |
| A17 | 2.2853644E−23 | 4.9673754E−20 | 1.2238379E−18 |
| A18 | 2.0389701E−24 | 4.7052410E−21 | −5.4620107E−18 |
| A19 | −1.2110974E−26 | 2.0283733E−23 | −5.6346938E−17 |
| A20 | −2.8943322E−27 | −2.0704818E−23 | 5.4341152E−18 |

| Sn | 11 | 18 | 20 |
|---|---|---|---|
| KA | 1.0000000E+00 | 1.0000000E+00 | 1.0000000E+00 |
| A4 | 5.8300794E−05 | −1.2187333E−05 | 3.7179121E−06 |
| A6 | −1.0770178E−06 | 3.0899179E−07 | −5.1293603E−08 |
| A8 | 7.3690427E−08 | 1.2696840E−08 | 2.4037486E−10 |
| A10 | −4.5632627E−10 | −3.0072936E−10 | 6.1476656E−12 |

TABLE 27B
Example 9

| Sn | 19 | 21 |
|---|---|---|
| KA | 1.0000000E+00 | 1.0000000E+00 |
| A3 | 0.0000000E+00 | 0.0000000E+00 |
| A4 | −1.5283459E−05 | 3.9644019E−05 |
| A5 | 2.2389324E−06 | 3.3729146E−08 |
| A6 | −7.7638813E−07 | −3.5008213E−09 |
| A7 | 3.5859410E−08 | 1.1079563E−09 |
| A8 | 2.7913256E−08 | 2.4258576E−10 |
| A9 | 1.3195674E−09 | −1.2372224E−11 |
| A10 | −6.9817065E−10 | −1.1505785E−13 |
| A11 | −1.9370257E−11 | 1.6289337E−13 |
| A12 | 1.0990458E−11 | 3.2060127E−14 |
| A13 | −2.4916164E−12 | −1.0694372E−15 |
| A14 | 1.6130147E−13 | −4.2657138E−17 |
| A15 | 3.1948843E−14 | −7.3119566E−18 |
| A16 | −1.6218453E−15 | 3.9794249E−19 |
| A17 | −1.2566311E−15 | 1.5039247E−19 |
| A18 | 1.7503801E−16 | −3.9554955E−21 |
| A19 | −1.4005890E−18 | 2.1958487E−22 |
| A20 | −4.7487943E−19 | −3.4226840E−23 |

| Sn | 24 | 25 |
|---|---|---|
| KA | 1.0000000E+00 | 1.0000000E+00 |
| A4 | −2.3007094E−06 | −9.3796914E−06 |
| A6 | −3.6395501E−08 | −1.1520708E−08 |
| A8 | −4.0710003E−12 | −1.8934982E−11 |
| A10 | −2.4407187E−14 | −4.8627191E−14 |

### Example 10

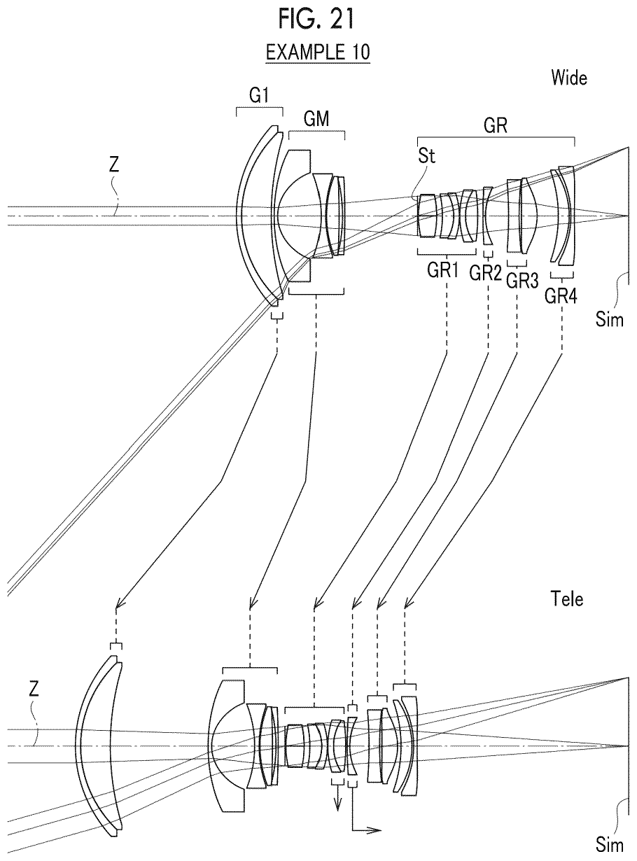

A configuration and a movement trajectory of a variable magnification optical system of Example 10 are shown in FIG. 21. The variable magnification optical system of Example 10 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a positive refractive power, and a fourth subsequent lens group GR4 having a negative refractive power. A lens of the intermediate group GM that is closest to the object side corresponds to an Lmn lens. A lens constituting the second subsequent lens group GR2 corresponds to an Lrn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of a cemented lens of the first subsequent lens group GR1 that is closest to the image side.

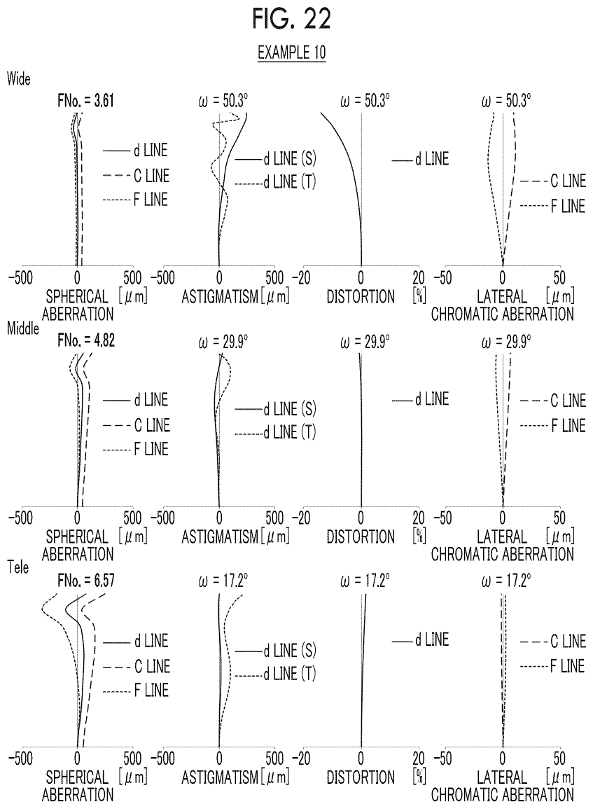

With respect to the variable magnification optical system of Example 10, basic lens data is shown in Table 28, specifications and variable surface spacings are shown in Table 29, aspherical coefficients are shown in Table 30A and Table 30B, and each aberration diagram is shown in FIG. 22.

TABLE 28
Example 10

| Sn | R | D | Nd | νd | θg, F | ED |
|---|---|---|---|---|---|---|
| 1 | 44.3976 | 1.5000 | 2.00069 | 25.46 | 0.61364 | 56.27 |
| 2 | 38.3756 | 8.5285 | 1.58313 | 59.37 | 0.54345 | 52.56 |
| 3 | 94.4560 | DD[3] | | | | 49.68 |
| *4 | 61.3098 | 1.0053 | 1.69350 | 53.20 | 0.54661 | 41.37 |
| *5 | 13.7994 | 12.3643 | | | | 27.20 |
| 6 | −39.4281 | 1.2899 | 1.49700 | 81.61 | 0.53887 | 26.52 |
| 7 | 40.8438 | 0.2498 | | | | 24.85 |
| 8 | 36.9896 | 3.5856 | 2.00100 | 29.13 | 0.59952 | 24.79 |
| 9 | −249.3052 | 1.0002 | | | | 24.30 |
| 10 | −53.6662 | 0.6502 | 1.76200 | 40.10 | 0.57655 | 24.42 |
| 11 | −265.9435 | DD[11] | | | | 23.87 |
| 12(St) | ∞ | 0.2501 | | | | 12.44 |
| *13 | 28.5105 | 5.2498 | 1.49710 | 81.56 | 0.53848 | 12.81 |
| *14 | −35.9177 | 1.6475 | | | | 13.41 |
| 15 | −35.4554 | 3.2598 | 1.64000 | 60.08 | 0.53704 | 13.47 |
| 16 | −15.3471 | 1.6250 | 1.78590 | 44.20 | 0.56317 | 13.87 |
| 17 | −23.7559 | 0.1252 | | | | 14.40 |
| 18 | 29.1295 | 1.6250 | 1.95375 | 32.32 | 0.59056 | 15.66 |
| 19 | 15.7778 | 3.5100 | 1.55332 | 71.68 | 0.54029 | 15.62 |
| 20 | −66.2264 | DD[20] | | | | 15.90 |
| *21 | 157.4533 | 0.7500 | 1.49710 | 81.56 | 0.53848 | 16.94 |
| *22 | 20.8167 | DD[22] | | | | 17.40 |
| 23 | −139.3460 | 3.0310 | 1.65412 | 39.68 | 0.57378 | 20.65 |
| 24 | 112.0501 | 0.6707 | | | | 22.78 |
| *25 | 2495.9729 | 4.5029 | 1.51633 | 64.06 | 0.53345 | 23.21 |
| *26 | −18.2463 | DD[26] | | | | 23.73 |
| 27 | −46.0195 | 3.1250 | 1.95906 | 17.47 | 0.65993 | 28.14 |
| 28 | −27.6390 | 0.4999 | | | | 28.93 |
| *29 | −31.6028 | 1.0002 | 1.95150 | 29.83 | 0.59560 | 29.08 |
| *30 | 301.9561 | DD[30] | | | | 31.12 |

TABLE 29
Example 10

| | Wide | Middle | Tele |
|---|---|---|---|
| Zr | 1.0 | 1.8 | 3.3 |
| f | 20.90 | 37.96 | 68.96 |
| Bf | 15.61 | 35.74 | 60.81 |
| FNo. | 3.61 | 4.82 | 6.57 |
| 2ω[°] | 100.6 | 59.8 | 34.4 |
| DD[3] | 0.85 | 13.90 | 28.13 |
| DD[11] | 20.90 | 9.43 | 1.94 |
| DD[20] | 1.50 | 0.85 | 0.44 |
| DD[22] | 6.64 | 4.50 | 5.52 |
| DD[26] | 6.08 | 3.24 | 1.00 |
| DD[30] | 15.61 | 35.74 | 60.81 |

TABLE 30A
Example 10

| Sn | 4 | 5 | 13 |
|---|---|---|---|
| KA | 1.0000000E+00 | 0.0000000E+00 | 1.0000000E+00 |
| A3 | 0.0000000E+00 | 0.0000000E+00 | 0.0000000E+00 |
| A4 | 1.0443388E−05 | 3.7908775E−05 | −4.2058571E−05 |
| A5 | −6.4434488E−07 | 1.5510403E−06 | 7.5586788E−07 |
| A6 | 5.1039134E−09 | −2.5651397E−07 | −3.1418797E−07 |
| A7 | 4.8598817E−10 | 2.3100946E−08 | −1.2992350E−08 |
| A8 | −5.3170619E−12 | 1.2314839E−09 | 1.6848244E−09 |
| A9 | −2.6200688E−13 | −1.3202823E−10 | 7.3434732E−10 |
| A10 | 2.8363695E−15 | −6.2958450E−12 | 5.4671486E−11 |
| A11 | 1.2614664E−15 | 1.5475016E−13 | −2.0572082E−11 |
| A12 | 7.9644303E−17 | 5.7741170E−14 | −1.1864190E−12 |
| A13 | −9.9151336E−19 | 3.8095233E−15 | −1.6663764E−13 |
| A14 | −8.8239870E−20 | −6.4635946E−16 | −1.1999390E−14 |
| A15 | −6.7546029E−21 | −6.3353828E−18 | 6.9495238E−15 |
| A16 | 7.5810962E−23 | 2.8037329E−18 | −5.1011060E−17 |
| A17 | 3.2854443E−23 | 9.5628375E−20 | 1.2779506E−16 |
| A18 | −2.3787297E−24 | −1.2303784E−20 | 1.1218082E−17 |
| A19 | −1.7476597E−26 | −6.2070652E−22 | 7.8113303E−19 |
| A20 | 2.8895106E−27 | 5.3634028E−23 | −6.6790926E−19 |

| Sn | 14 | 21 | 25 |
|---|---|---|---|
| KA | 1.0000000E+00 | 1.0000000E+00 | 1.0000000E+00 |
| A4 | −3.4369950E−06 | 1.8575979E−06 | −1.9251989E−05 |
| A6 | −2.1789409E−07 | 1.6610426E−07 | 7.8837002E−08 |
| A8 | 2.6712695E−09 | 2.2560505E−09 | 7.7054788E−10 |
| A10 | −5.0445395E−11 | −5.9228380E−11 | 3.4385661E−12 |

TABLE 30B
Example 10

| Sn | 22 | 26 |
|---|---|---|
| KA | 1.0000000E+00 | 1.0000000E+00 |
| A3 | 0.0000000E+00 | 0.0000000E+00 |
| A4 | 4.5254948E−06 | 3.4426466E−05 |
| A5 | −5.6927725E−07 | −4.4394333E−07 |
| A6 | −4.7898669E−08 | 7.3730921E−08 |
| A7 | 1.0407378E−07 | −1.5303115E−09 |
| A8 | 1.4937721E−09 | 1.9624487E−10 |
| A9 | −3.2732465E−09 | 5.5049034E−11 |
| A10 | −3.3457077E−11 | 2.4778745E−12 |
| A11 | 5.0641649E−11 | 3.2860732E−14 |
| A12 | 2.2370379E−12 | −3.7283031E−14 |
| A13 | −3.4160881E−15 | −1.8050615E−16 |
| A14 | −8.7045527E−14 | 1.2170928E−16 |
| A15 | −4.2251184E−15 | 2.4875817E−17 |
| A16 | 4.4395242E−16 | −4.6052176E−20 |
| A17 | 1.8938280E−17 | 1.6652747E−19 |
| A18 | −8.5130873E−18 | −4.9115522E−21 |
| A19 | 3.1207734E−18 | −9.2040536E−22 |
| A20 | −2.1170348E−19 | 6.7718247E−24 |

| Sn | 29 | 30 |
|---|---|---|
| KA | 1.0000000E+00 | 1.0000000E+00 |
| A4 | 5.6392756E−06 | −8.3380350E−06 |
| A6 | −1.2454736E−09 | −1.2026368E−08 |
| A8 | −4.3362051E−10 | −1.5605698E−10 |
| A10 | 1.6533925E−12 | 5.6861486E−13 |

### Example 11

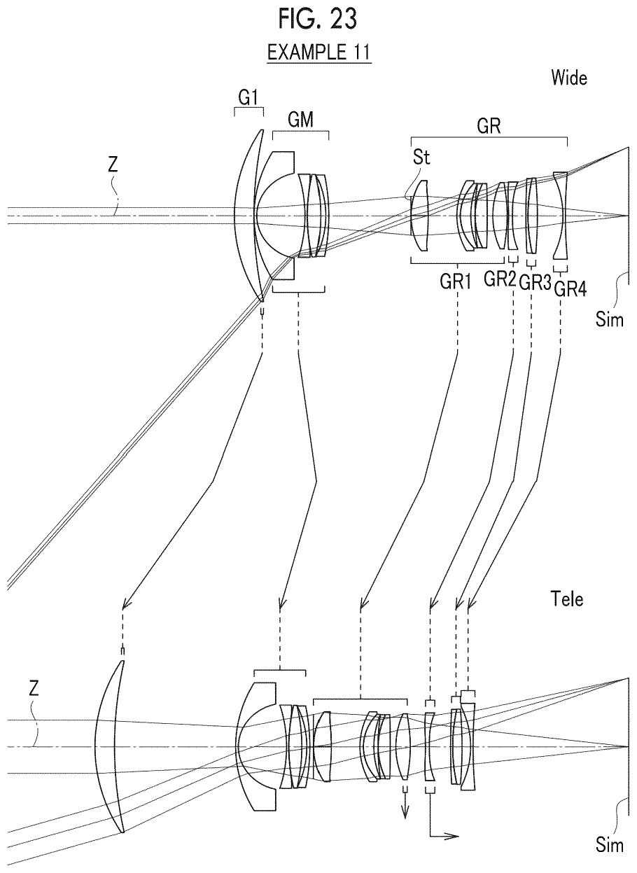

A configuration and a movement trajectory of a variable magnification optical system of Example 11 are shown in FIG. 23. The variable magnification optical system of Example 11 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a positive refractive power, and a fourth subsequent lens group GR4 having a negative refractive power. A second lens from the object side of the intermediate group GM corresponds to an

Lmn lens. A lens constituting the second subsequent lens group GR2 corresponds to an Lrn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of one lens of the first subsequent lens group GR1 that is closest to the image side.

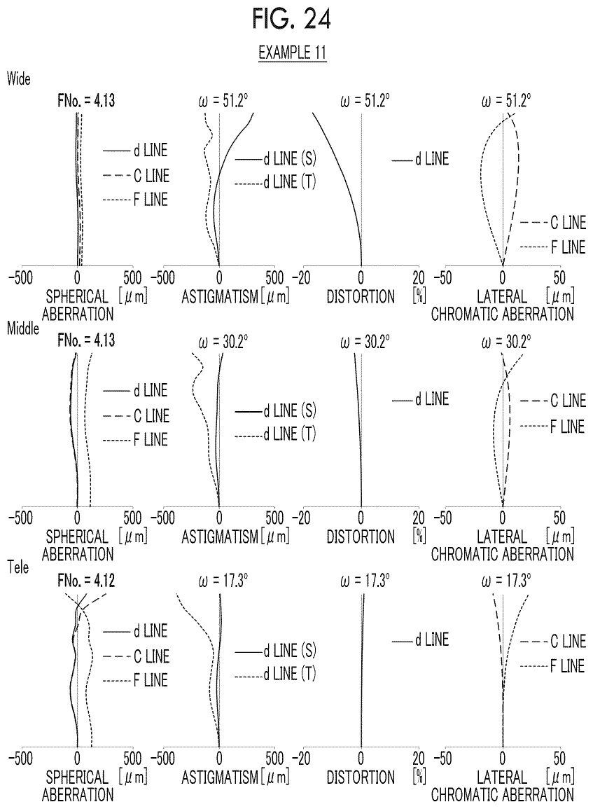

For the variable magnification optical system of Example 11, basic lens data is shown in Table 31, specifications and variable surface spacings are shown in Table 32, aspherical coefficients are shown in Table 33, and each aberration diagram is shown in FIG. 24.

TABLE 31
Example 11

| Sn | R | D | Nd | νd | θg, F | ED |
|---|---|---|---|---|---|---|
| 1 | 51.7396 | 5.6089 | 1.51680 | 64.20 | 0.53430 | 54.00 |
| 2 | 131.3729 | DD[2] | | | | 53.43 |
| 3 | 40.5784 | 0.7731 | 1.75500 | 52.32 | 0.54757 | 40.15 |
| 4 | 13.7142 | 13.8359 | | | | 26.76 |
| *5 | −44.1673 | 0.6258 | 1.61881 | 63.85 | 0.54182 | 26.13 |
| *6 | 55.9048 | 0.0500 | | | | 26.06 |
| 7 | 62.5731 | 3.6994 | 1.96300 | 24.11 | 0.62126 | 25.96 |
| 8 | −61.5732 | 1.4362 | | | | 25.67 |
| 9 | −31.3091 | 0.8748 | 1.78880 | 28.43 | 0.60092 | 25.61 |
| 10 | −67.3010 | DD[10] | | | | 25.34 |
| 11(St) | ∞ | 0.0498 | | | | 20.27 |
| *12 | 23.4442 | 4.9198 | 1.49710 | 81.56 | 0.53848 | 21.98 |
| *13 | −71.9328 | 8.2200 | | | | 21.61 |
| 14 | 23.6105 | 1.0000 | 1.85026 | 32.27 | 0.59299 | 21.38 |
| 15 | 15.1871 | 3.0048 | 1.49700 | 81.54 | 0.53748 | 20.30 |
| 16 | 28.1935 | 1.1888 | | | | 20.12 |
| 17 | 70.6531 | 0.0498 | 1.84666 | 23.78 | 0.62054 | 20.13 |
| 18 | 24.8855 | 3.4598 | 1.43875 | 94.66 | 0.53402 | 20.01 |
| 19 | −393.0052 | 1.6099 | | | | 20.20 |
| *20 | 27.0860 | 4.1340 | 1.61881 | 63.85 | 0.54182 | 20.60 |
| *21 | −49.3510 | DD[21] | | | | 20.77 |
| *22 | −56.4435 | 1.1087 | 1.80610 | 40.73 | 0.56940 | 21.27 |
| *23 | 111.9384 | DD[23] | | | | 21.27 |
| 24 | 244.0458 | 0.6158 | 1.60300 | 65.44 | 0.54022 | 23.01 |
| 25 | 58.8505 | 2.6711 | 1.92286 | 18.90 | 0.64960 | 23.46 |
| 26 | −149.7262 | DD[26] | | | | 23.63 |
| 27 | −30.4275 | 0.6981 | 1.48749 | 70.24 | 0.53007 | 25.25 |
| 28 | 168.8508 | DD[28] | | | | 27.30 |

TABLE 32
Example 11

| | Wide | Middle | Tele |
|---|---|---|---|
| Zr | 1.0 | 1.8 | 3.3 |
| f | 20.92 | 38.00 | 69.02 |
| Bf | 18.18 | 25.03 | 44.69 |
| FNo. | 4.13 | 4.13 | 4.12 |
| 2ω[°] | 102.4 | 60.4 | 34.6 |
| DD[2] | 0.05 | 19.41 | 34.77 |
| DD[10] | 23.55 | 8.66 | 1.02 |
| DD[21] | 0.39 | 3.24 | 4.36 |
| DD[23] | 3.86 | 5.55 | 6.10 |
| DD[26] | 7.35 | 5.65 | 2.46 |
| DD[28] | 18.18 | 25.03 | 44.69 |

TABLE 33
Example 11

| Sn | 5 | 6 | 12 | 13 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.8354834E−05 | −6.4472959E−06 | −5.0452126E−06 | 1.6559985E−05 |
| A5 | −8.9501549E−07 | 5.5245896E−07 | −2.8362817E−07 | −1.6278342E−06 |
| A6 | −1.7566468E−07 | −3.2196337E−07 | 1.7929356E−09 | 1.5515738E−07 |
| A7 | 2.0367152E−09 | 2.7318830E−09 | 3.2213538E−09 | 1.4151811E−08 |
| A8 | 2.1481018E−09 | 2.2225082E−09 | −1.6005803E−10 | −2.3845608E−09 |
| A9 | −6.8004750E−11 | −3.3861955E−12 | 5.4802442E−11 | 6.2643141E−11 |
| A10 | −4.2419115E−12 | −8.5074284E−12 | 9.7013822E−12 | 1.1337280E−11 |
| A11 | −1.1757410E−14 | 5.7352173E−14 | 6.5815564E−15 | 3.7639930E−13 |
| A12 | 2.8851096E−14 | −8.4510282E−15 | −4.6275753E−14 | 9.6300480E−16 |
| A13 | −2.4996779E−15 | −1.7786550E−15 | −1.3287551E−15 | 2.3592988E−15 |
| A14 | −3.1555163E−18 | 1.8393910E−16 | −1.9053634E−18 | 5.6238841E−17 |
| A15 | −1.7920392E−18 | 2.1892367E−18 | −1.4958608E−17 | −5.4612407E−17 |
| A16 | 5.7930791E−20 | −5.9438297E−19 | 1.2824460E−18 | −1.0014267E−18 |
| A17 | 6.2664821E−20 | 1.0720347E−19 | 9.4375612E−20 | −1.6783854E−19 |
| A18 | −1.3140980E−21 | −1.3783983E−20 | 4.2387246E−21 | −4.3731490E−21 |
| A19 | 7.4148565E−23 | 9.1464781E−22 | 1.3776212E−21 | 1.1014122E−21 |
| A20 | −1.1463787E−23 | −2.5286720E−23 | −2.7001534E−23 | 3.7116472E−22 |

| Sn | 20 | 21 | 22 | 23 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 4.6888753E−08 | 1.8159892E−05 | 1.8612596E−04 | 1.8166630E−04 |
| A5 | 4.3622283E−07 | −1.3207685E−07 | −6.2734063E−07 | −3.1805212E−07 |
| A6 | −1.0365497E−07 | −7.8012770E−08 | −1.9403376E−06 | −1.7043443E−06 |
| A7 | −3.6349832E−09 | −2.4237064E−09 | 5.2685741E−09 | −4.3028943E−09 |
| A8 | 1.3844844E−09 | 1.4118866E−09 | 1.6414641E−08 | 1.2510661E−08 |
| A9 | 9.9526288E−12 | 2.8354722E−11 | −1.7546781E−11 | 5.3323362E−11 |
| A10 | −3.1249664E−12 | −1.2639364E−11 | −9.7678787E−11 | −6.3355466E−11 |
| A11 | 2.3387648E−13 | 1.5822122E−13 | −2.5615760E−13 | 7.3026630E−13 |
| A12 | −3.5366639E−14 | 8.2994791E−14 | 2.8496707E−13 | 1.8072059E−13 |
| A13 | −2.5192429E−16 | −1.7184594E−15 | −1.0393189E−14 | −8.6128487E−16 |
| A14 | −1.7687920E−16 | −1.2990170E−16 | 4.7813417E−15 | 6.7780384E−16 |
| A15 | −2.8119904E−17 | 1.5138592E−17 | 3.4605459E−17 | −1.8145709E−16 |
| A16 | 1.6590041E−20 | −9.8537366E−18 | −4.4311757E−17 | −4.7128667E−18 |
| A17 | 5.9060931E−19 | 7.9437893E−19 | −2.2584988E−18 | −1.3344438E−18 |
| A18 | 5.9490772E−20 | 1.1262499E−20 | 2.0427925E−19 | 3.4830305E−19 |
| A19 | −1.6326777E−21 | 2.5616247E−21 | 1.9800084E−20 | −1.0143165E−20 |
| A20 | −3.5189705E−22 | −2.7353311E−22 | −1.0296607E−21 | −2.3537037E−22 |

### Example 12

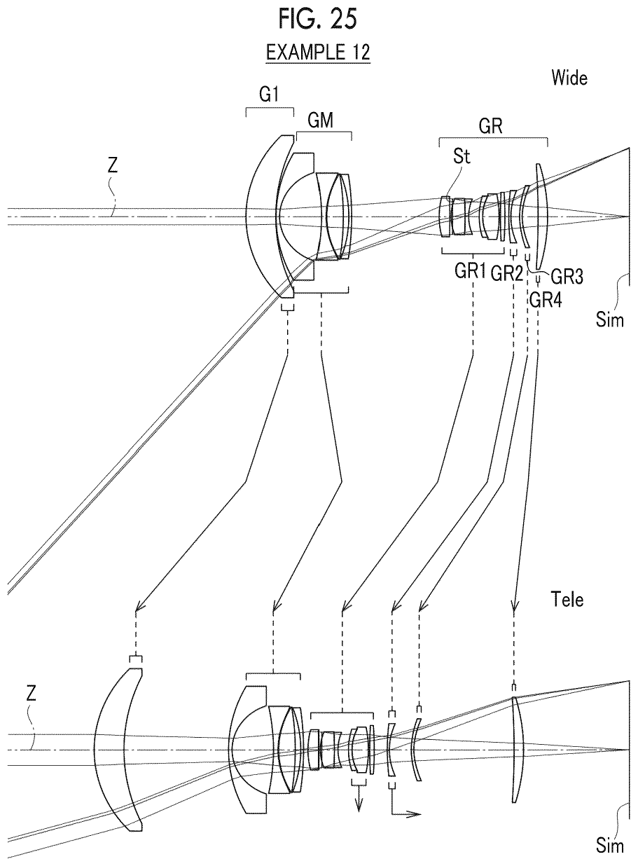

A configuration and a movement trajectory of a variable magnification optical system of Example 12 are shown in FIG. 25. The variable magnification optical system of Example 12 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a negative refractive power, and a fourth subsequent lens group GR4 having a positive refractive power. A second lens from the object side of the intermediate group GM corresponds to an Lmn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of a cemented lens formed by a second lens and a third lens from the image side of the first subsequent lens group GR1 cemented together.

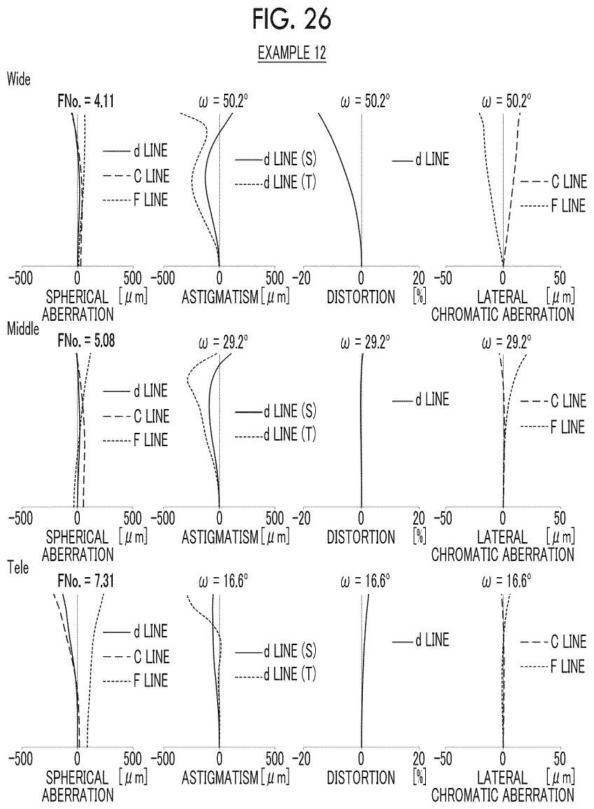

For the variable magnification optical system of Example 12, basic lens data is shown in Table 34, specifications and variable surface spacings are shown in Table 35, aspherical coefficients are shown in Table 36, and each aberration diagram is shown in FIG. 26.

TABLE 34
Example 12

| Sn | R | D | Nd | νd | θg, F | ED |
|---|---|---|---|---|---|---|
| 1 | 36.8959 | 8.5039 | 1.51680 | 64.20 | 0.53430 | 50.80 |
| 2 | 54.8220 | DD[2] | | | | 46.32 |
| 3 | 41.8577 | 0.9996 | 1.77535 | 50.31 | 0.55042 | 39.77 |
| 4 | 14.6258 | 11.8386 | | | | 27.60 |
| *5 | −56.6469 | 1.3009 | 1.69350 | 53.20 | 0.54661 | 27.24 |
| *6 | 25.8521 | 0.1868 | | | | 26.58 |
| 7 | 26.9075 | 4.7044 | 1.96300 | 24.11 | 0.62126 | 26.76 |
| 8 | −89.0363 | 1.5735 | | | | 26.71 |
| 9 | −38.7397 | 0.8000 | 1.95906 | 17.47 | 0.65993 | 26.40 |
| 10 | −94.3210 | DD[10] | | | | 26.16 |
| *11 | 26.5534 | 3.0002 | 1.85135 | 40.10 | 0.56954 | 12.60 |
| *12 | −289.1300 | 0.8000 | | | | 11.72 |
| 13(St) | ∞ | −0.4000 | | | | 11.13 |
| 14 | 15.8188 | 4.0100 | 1.53775 | 74.70 | 0.53936 | 11.31 |
| 15 | −92.5807 | 1.0000 | 1.85025 | 30.05 | 0.59797 | 11.06 |
| 16 | 14.9038 | 3.0002 | | | | 10.95 |
| 17 | 22.8748 | 1.0000 | 1.96300 | 24.11 | 0.62126 | 12.80 |
| 18 | 14.9757 | 4.6808 | 1.49700 | 81.54 | 0.53748 | 12.96 |
| 19 | −38.3174 | 0.3748 | | | | 14.27 |
| 20 | 148.8903 | 1.2865 | 2.10420 | 17.02 | 0.66311 | 15.00 |
| 21 | −120.9433 | DD[21] | | | | 15.22 |
| 22 | 75.8977 | 0.6000 | 1.71299 | 53.87 | 0.54587 | 16.27 |
| 23 | 21.1068 | DD[23] | | | | 16.40 |
| *24 | 21.8920 | 0.7498 | 1.51633 | 64.06 | 0.53345 | 19.03 |
| *25 | 17.9725 | DD[25] | | | | 19.39 |
| 26 | −259.2083 | 2.6917 | 1.85026 | 32.27 | 0.59299 | 32.61 |
| 27 | −60.4981 | DD[27] | | | | 33.00 |

TABLE 35
Example 12

| | Wide | Middle | Tele |
|---|---|---|---|
| Zr | 1.0 | 1.8 | 3.4 |
| f | 21.17 | 38.46 | 70.92 |
| Bf | 23.38 | 26.17 | 30.23 |
| FNo. | 4.11 | 5.08 | 7.31 |
| 2ω[°] | 100.4 | 58.4 | 33.2 |
| DD[2] | 0.10 | 17.91 | 29.85 |
| DD[10] | 25.00 | 9.06 | 1.26 |
| DD[21] | 1.11 | 3.71 | 3.74 |
| DD[23] | 2.48 | 3.06 | 6.23 |
| DD[25] | 4.53 | 8.66 | 28.61 |
| DD[27] | 23.38 | 26.17 | 30.23 |

TABLE 36
Example 12

| Sn | 5 | 6 | 11 | 12 |
|---|---|---|---|---|
| KA | 1.0000000E+00 | 1.0000000E+00 | 1.0000000E+00 | 1.0000000E+00 |
| A4 | 1.5173710E−05 | 1.0832629E−06 | 1.0825484E−05 | 2.2661565E−05 |
| A6 | −2.3728209E−08 | −1.6172589E−08 | 2.3700189E−07 | 2.0147464E−07 |
| A8 | −1.6401243E−10 | −4.1647252E−10 | −2.0750895E−09 | −1.3849431E−09 |
| A10 | 3.7379119E−13 | 7.1222215E−13 | 2.6123980E−11 | 2.0129784E−11 |

| Sn | 24 | 25 |
|---|---|---|
| KA | 0.0000000E+00 | 0.0000000E+00 |
| A3 | 0.0000000E+00 | 0.0000000E+00 |
| A4 | −1.4057903E−04 | −1.4674742E−04 |
| A5 | 1.2881729E−07 | −1.9174786E−07 |
| A6 | 1.1931359E−06 | 1.2267084E−06 |
| A7 | 5.6974091E−08 | 6.3021755E−08 |
| A8 | 6.3677367E−09 | 4.9489196E−09 |
| A9 | −1.7251312E−09 | −1.0738219E−09 |
| A10 | 5.4406740E−11 | −1.8465603E−10 |
| A11 | −2.7498509E−11 | −1.6900369E−12 |
| A12 | 1.8889371E−12 | −9.3695927E−14 |
| A13 | 4.8632391E−13 | 3.1000320E−13 |
| A14 | −1.2542490E−13 | 9.0128264E−15 |
| A15 | −1.3409112E−15 | −2.3528196E−15 |
| A16 | 2.2630230E−15 | −3.3595947E−17 |
| A17 | 8.6825299E−17 | 2.1678470E−18 |
| A18 | −3.9847418E−17 | 1.4559734E−19 |
| A19 | 1.7607970E−18 | 1.4979275E−19 |
| A20 | 4.6894385E−21 | −1.4468194E−20 |

### Example 13

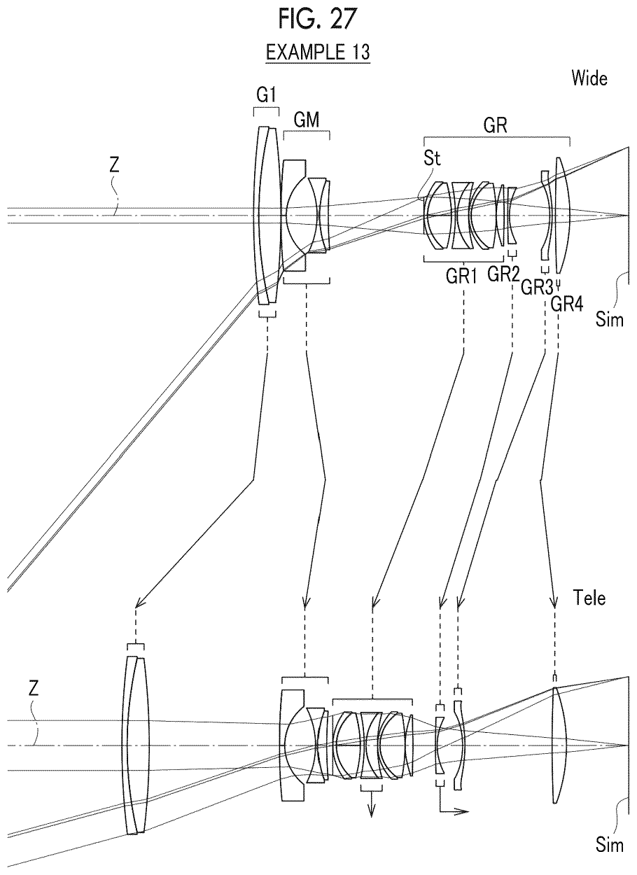

A configuration and a movement trajectory of a variable magnification optical system of Example 13 are shown in FIG. 27. The variable magnification optical system of Example 13 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a negative refractive power, and a fourth subsequent lens group GR4 having a positive refractive power. A lens of the intermediate group GM that is closest to the object side corresponds to an Lmn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of a second cemented lens from the object side of the first subsequent lens group GR1.

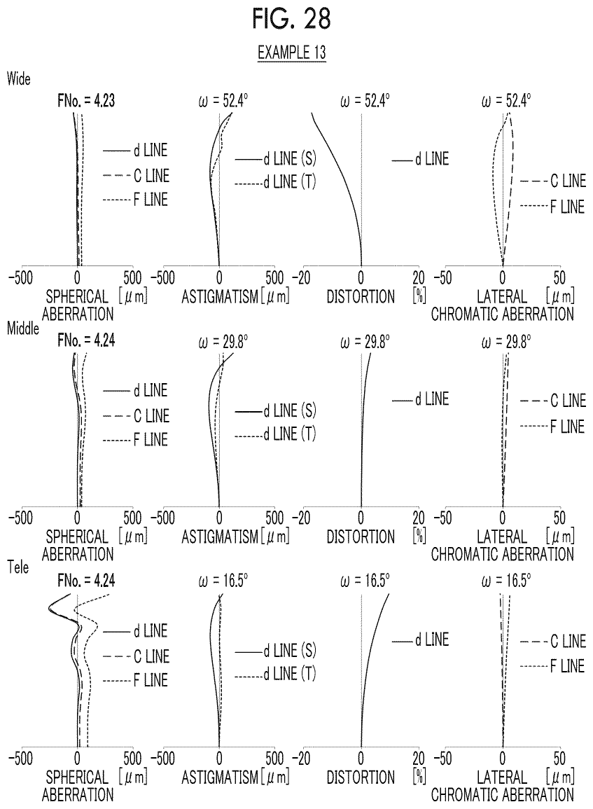

For the variable magnification optical system of Example 13, basic lens data is shown in Table 37, specifications and variable surface spacings are shown in Table 38, aspherical coefficients are shown in Table 39, and each aberration diagram is shown in FIG. 28.

TABLE 37
Example 13

| Sn | R | D | Nd | νd | θg, F | ED |
|---|---|---|---|---|---|---|
| 1 | 250.0039 | 1.5000 | 1.96300 | 24.11 | 0.62126 | 56.00 |
| 2 | 131.9314 | 6.3451 | 1.59522 | 67.73 | 0.54426 | 54.83 |
| 3 | −247.2470 | DD[3] | | | | 54.03 |
| *4 | 250.2499 | 1.5000 | 1.55332 | 71.68 | 0.54029 | 34.97 |
| *5 | 16.5676 | 8.8724 | | | | 24.56 |
| 6 | −28.1992 | 0.5739 | 1.48749 | 70.24 | 0.53007 | 23.49 |
| 7 | 33.3799 | 2.4851 | 1.89190 | 37.13 | 0.57813 | 21.67 |
| 8 | 141.7029 | DD[8] | | | | 21.20 |
| 9(St) | ∞ | 0.0500 | | | | 18.84 |
| 10 | 18.5847 | 1.0000 | 1.91650 | 31.60 | 0.59117 | 21.12 |
| 11 | 13.9972 | 6.8781 | 1.55332 | 71.68 | 0.54029 | 20.39 |
| *12 | −34.3946 | 1.1355 | | | | 20.43 |
| 13 | −54.4566 | 0.5327 | 1.76200 | 40.10 | 0.57655 | 20.43 |
| 14 | 16.6966 | 3.2833 | 1.96300 | 24.11 | 0.62126 | 20.80 |
| 15 | 40.4554 | 0.0498 | | | | 20.70 |
| 16 | 16.0211 | 0.6772 | 1.85478 | 24.80 | 0.61232 | 21.20 |
| 17 | 12.7343 | 7.1810 | 1.49700 | 81.54 | 0.53748 | 20.27 |
| 18 | −59.3222 | 0.0502 | | | | 20.10 |
| *19 | 25.9200 | 2.2572 | 1.51633 | 64.06 | 0.53345 | 19.20 |
| *20 | −109.8680 | DD[20] | | | | 19.09 |
| 21 | 281.9111 | 0.4859 | 1.88300 | 39.22 | 0.57288 | 17.74 |
| 22 | 19.6386 | DD[22] | | | | 17.25 |
| *23 | −28.3302 | 0.6886 | 1.74320 | 49.29 | 0.55303 | 21.23 |
| *24 | −46.4124 | DD[24] | | | | 22.76 |
| 25 | 461.5153 | 4.1337 | 1.64000 | 60.08 | 0.53704 | 36.01 |
| 26 | −58.1797 | DD[26] | | | | 36.40 |

TABLE 38
Example 13

| | Wide | Middle | Tele |
|---|---|---|---|
| Zr | 1.0 | 1.8 | 3.3 |
| f | 20.13 | 36.57 | 66.83 |
| Bf | 16.95 | 21.81 | 17.93 |
| FNo. | 4.23 | 4.24 | 4.24 |
| 2ω[°] | 104.8 | 59.6 | 33.0 |
| DD[3] | 0.05 | 9.39 | 37.49 |
| DD[8] | 27.50 | 10.37 | 1.72 |
| DD[20] | 1.03 | 3.59 | 6.49 |
| DD[22] | 11.61 | 7.12 | 7.30 |
| DD[24] | 0.95 | 9.83 | 25.06 |
| DD[26] | 16.95 | 21.81 | 17.93 |

TABLE 39
Example 13

| Sn | 4 | 12 | 20 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 7.7144053E−06 | 2.7191178E−05 | 4.2474190E−05 |
| A5 | −1.0157376E−06 | 3.9775140E−07 | −1.3735335E−06 |
| A6 | 3.2709879E−08 | −6.1642168E−08 | 1.3424741E−07 |
| A7 | 1.4793579E−09 | −1.9429465E−11 | 1.7716605E−08 |
| A8 | 1.0343152E−11 | −1.3940841E−10 | −1.5706202E−09 |
| A9 | −4.2920504E−12 | −7.9033287E−11 | −3.8237572E−10 |
| A10 | −1.7457577E−13 | −1.5377505E−11 | −3.4880536E−11 |
| A11 | 2.3706662E−15 | 1.3518818E−12 | 4.9392776E−12 |
| A12 | 2.8534041E−16 | 4.9690769E−13 | 1.6378395E−12 |
| A13 | 6.7630407E−18 | 4.7333621E−15 | 3.5084232E−13 |
| A14 | 2.0996068E−19 | −1.7003454E−15 | −1.1634814E−13 |
| A15 | 1.0808047E−20 | −5.3773042E−16 | 1.1417249E−15 |
| A16 | −2.3609365E−22 | −3.7037778E−17 | 6.6796898E−16 |
| A17 | −4.7647174E−23 | 2.3951335E−19 | 1.7112562E−17 |
| A18 | −1.6376910E−24 | 8.5091307E−19 | 8.7259083E−18 |
| A19 | −9.5210930E−26 | 2.5519400E−20 | −2.1618867E−18 |
| A20 | 6.0294660E−27 | −4.9880408E−21 | 9.9213472E−20 |

| Sn | 5 | 19 | 23 | 24 |
|---|---|---|---|---|
| KA | 1.0000000E+00 | 1.0000000E+00 | 1.0000000E+00 | 1.0000000E+00 |
| A4 | 2.4775802E−06 | −2.5319018E−06 | −1.1987931E−05 | 1.3908279E−05 |
| A6 | −5.2241191E−08 | −1.4191747E−07 | −2.1360665E−07 | −1.2581314E−07 |
| A8 | 3.8550101E−10 | −5.1118095E−10 | 6.7230279E−10 | 1.3467062E−09 |
| A10 | 0.0000000E+00 | −1.7280259E−11 | 1.7088134E−12 | −1.4341961E−12 |

### Example 14

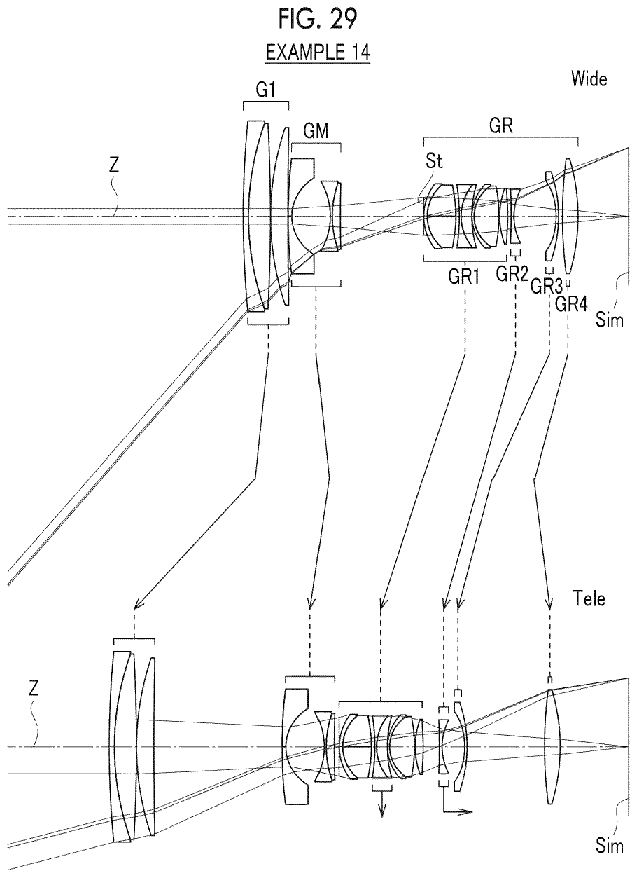

A configuration and a movement trajectory of a variable magnification optical system of Example 14 are shown in FIG. 29. The variable magnification optical system of Example 14 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a negative refractive power, and a fourth subsequent lens group GR4 having a positive refractive power. A lens of the intermediate group GM that is closest to the object side corresponds to an Lmn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of a second cemented lens from the object side of the first subsequent lens group GR1.

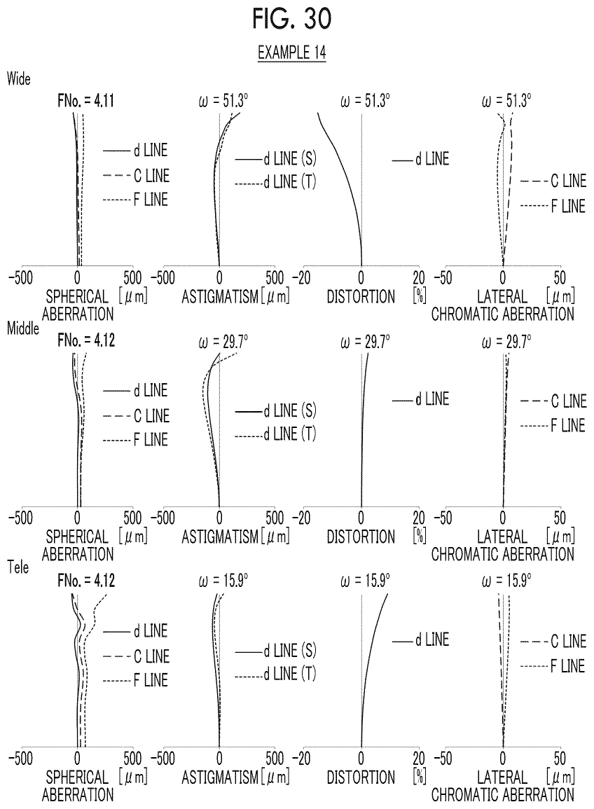

For the variable magnification optical system of Example 14, basic lens data is shown in Table 40, specifications and variable surface spacings are shown in Table 41, aspherical coefficients are shown in Table 42, and each aberration diagram is shown in FIG. 30.

TABLE 40
Example 14

| Sn | R | D | Nd | νd | θg, F | ED |
|---|---|---|---|---|---|---|
| 1 | 339.1825 | 1.5000 | 1.95375 | 32.32 | 0.59056 | 60.00 |
| 2 | 94.2360 | 6.3315 | 1.49700 | 81.54 | 0.53748 | 58.31 |
| 3 | −600.7466 | 0.0498 | | | | 58.05 |
| 4 | 94.9841 | 4.9736 | 1.75500 | 52.32 | 0.54757 | 55.84 |
| 5 | 1512.1481 | DD[5] | | | | 55.31 |
| *6 | 250.0000 | 1.0296 | 1.55332 | 71.68 | 0.54029 | 36.23 |
| *7 | 14.5260 | 10.9189 | | | | 24.14 |
| 8 | −23.5432 | 0.5632 | 1.48749 | 70.24 | 0.53007 | 22.05 |
| 9 | 34.0833 | 2.3212 | 1.89190 | 37.13 | 0.57813 | 20.87 |
| 10 | 381.1343 | DD[10] | | | | 20.60 |
| 11(St) | ∞ | 0.0498 | | | | 18.48 |
| 12 | 17.9243 | 1.0000 | 1.91650 | 31.60 | 0.59117 | 20.39 |
| 13 | 13.6484 | 8.2443 | 1.55332 | 71.68 | 0.54029 | 19.65 |
| *14 | −40.0156 | 0.9998 | | | | 19.64 |
| 15 | −68.3651 | 0.5036 | 1.76200 | 40.10 | 0.57655 | 19.80 |
| 16 | 16.2527 | 3.0746 | 1.96300 | 24.11 | 0.62126 | 19.90 |
| 17 | 37.9460 | 0.0498 | | | | 19.77 |
| 18 | 15.2466 | 0.6185 | 1.85478 | 24.80 | 0.61232 | 20.00 |
| 19 | 11.9856 | 7.1576 | 1.49700 | 81.54 | 0.53748 | 19.03 |
| 20 | −51.3818 | 0.1800 | | | | 18.68 |
| *21 | 25.7101 | 2.3225 | 1.51633 | 64.06 | 0.53345 | 17.40 |
| *22 | −62.9090 | DD[22] | | | | 17.30 |
| 23 | −261.1473 | 0.8127 | 1.88300 | 39.22 | 0.57288 | 17.02 |
| 24 | 19.8334 | DD[24] | | | | 16.74 |
| *25 | −26.2440 | 0.6993 | 1.74320 | 49.29 | 0.55303 | 22.16 |
| *26 | −48.2329 | DD[26] | | | | 24.20 |
| 27 | 152.3931 | 4.4886 | 1.64000 | 60.08 | 0.53704 | 35.57 |
| 28 | −68.6262 | DD[28] | | | | 36.00 |

TABLE 41
Example 14

| | Wide | Middle | Tele |
|---|---|---|---|
| Zr | 1.0 | 1.8 | 3.4 |
| f | 20.44 | 37.13 | 69.49 |
| Bf | 14.57 | 24.06 | 19.72 |
| FNo. | 4.11 | 4.12 | 4.12 |
| 2ω[°] | 102.6 | 59.4 | 31.8 |
| DD[5] | 0.10 | 7.60 | 36.93 |
| DD[10] | 23.94 | 8.07 | 1.37 |
| DD[22] | 0.99 | 3.02 | 4.63 |
| DD[24] | 12.13 | 6.10 | 6.47 |
| DD[26] | 1.13 | 7.77 | 22.29 |
| DD[28] | 14.57 | 24.06 | 19.72 |

TABLE 42
Example 14

| Sn | 6 | 14 | 22 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 1.1141290E−05 | 3.0272176E−05 | 5.2501535E−05 |
| A5 | −9.8519974E−07 | 2.9610178E−07 | −1.2458803E−06 |
| A6 | 2.0771029E−08 | −5.0104219E−08 | 1.3479020E−07 |
| A7 | 1.3580525E−09 | 2.9935050E−10 | 1.9992239E−08 |
| A8 | 1.8650621E−11 | −1.0079999E−10 | −1.6177112E−09 |
| A9 | −3.8622457E−12 | −7.6599555E−11 | −3.1804260E−10 |
| A10 | −1.4987162E−13 | −1.5875847E−11 | −3.3882410E−11 |
| A11 | 2.4697185E−15 | 1.2367563E−12 | 5.7824559E−12 |
| A12 | 2.7640363E−16 | 4.8439432E−13 | 1.6476281E−12 |
| A13 | 6.2720547E−18 | 4.3730798E−15 | 3.4505799E−13 |
| A14 | 1.4421238E−19 | −1.6313625E−15 | −1.1648066E−13 |
| A15 | 8.2478449E−21 | −5.2385760E−16 | 1.1358083E−15 |
| A16 | −3.3494023E−22 | −3.5637105E−17 | 6.7435388E−16 |
| A17 | −5.0473359E−23 | 3.4760981E−19 | 1.7492222E−17 |
| A18 | −1.7976106E−24 | 8.4556539E−19 | 8.6475731E−18 |
| A19 | −8.3142870E−26 | 2.4846993E−20 | −2.1579447E−18 |
| A20 | 8.1018820E−27 | −5.0986770E−21 | 9.8715717E−20 |

| Sn | 7 | 21 | 25 | 26 |
|---|---|---|---|---|
| KA | 1.0000000E+00 | 1.0000000E+00 | 1.0000000E+00 | 1.0000000E+00 |
| A4 | 4.5161500E−07 | −6.3161951E−06 | −1.3348394E−05 | 5.4696539E−06 |
| A6 | −4.5488973E−08 | −1.4493292E−07 | −2.4143629E−07 | −1.8067227E−07 |
| A8 | 1.6458340E−10 | −2.6698534E−10 | 5.8382488E−10 | 1.0928472E−09 |
| A10 | 0.0000000E+00 | −9.8542354E−12 | 2.4460456E−14 | −1.6564172E−12 |

### Example 15

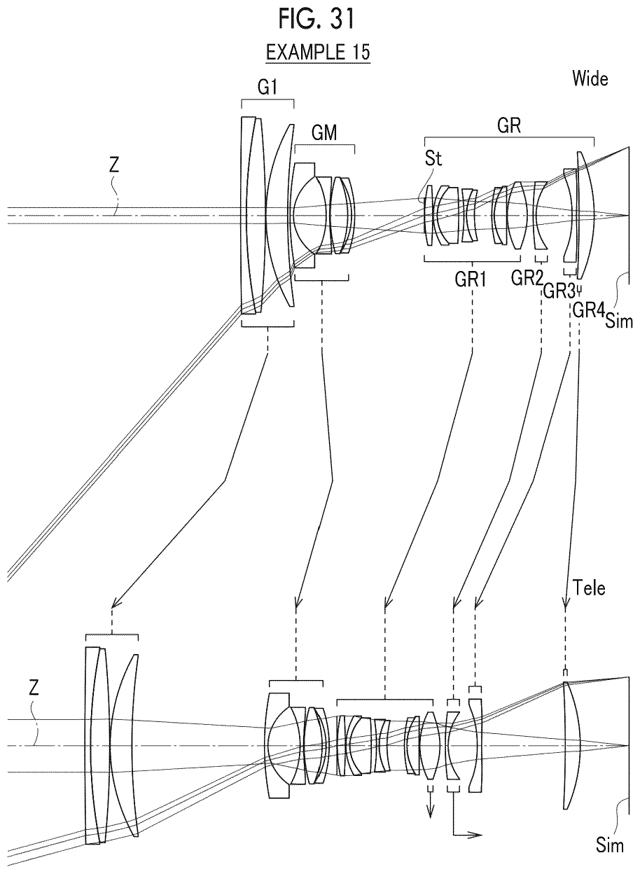

A configuration and a movement trajectory of a variable magnification optical system of Example 15 are shown in FIG. 31. The variable magnification optical system of Example 15 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a negative refractive power, and a fourth subsequent lens group GR4 having a positive refractive power.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of one lens of the first subsequent lens group GR1 that is closest to the image side.

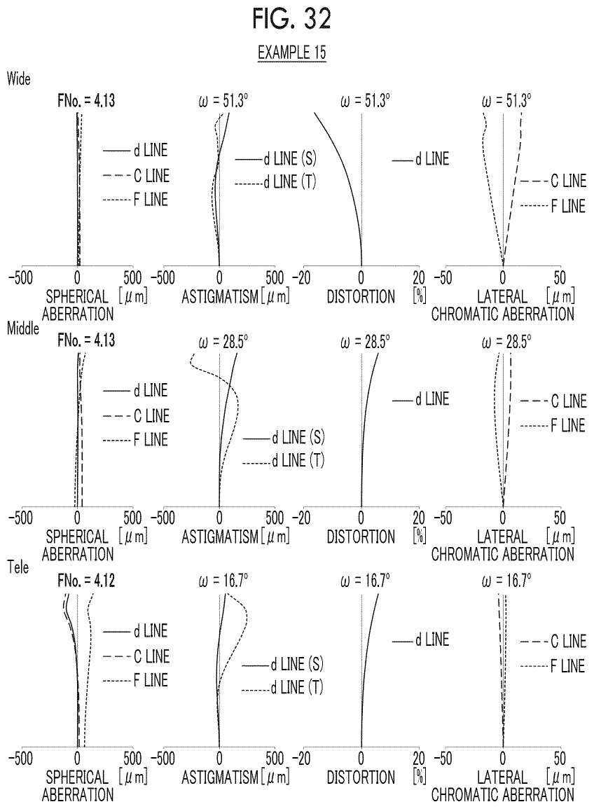

With respect to the variable magnification optical system of Example 15, basic lens data is shown in Table 43, specifications and variable surface spacings are shown in Table 44, aspherical coefficients are shown in Table 45A and Table 45B, and each aberration diagram is shown in FIG. 32.

TABLE 43
Example 15

| Sn | R | D | Nd | νd | θg, F | ED |
|---|---|---|---|---|---|---|
| 1 | 1793.5818 | 1.6248 | 1.95375 | 32.32 | 0.59056 | 62.00 |
| 2 | 175.1463 | 5.5198 | 1.43875 | 94.66 | 0.53402 | 60.96 |
| 3 | −350.6475 | 0.1502 | | | | 60.62 |
| 4 | 63.2154 | 6.2366 | 1.75500 | 52.32 | 0.54757 | 57.25 |
| 5 | 221.6499 | DD[5] | | | | 56.47 |
| 6 | 98.1830 | 1.0001 | 1.83481 | 42.74 | 0.56490 | 33.03 |
| 7 | 15.3566 | 9.2500 | | | | 24.50 |
| *8 | −29.3065 | 0.9999 | 1.59201 | 67.02 | 0.53589 | 24.19 |
| *9 | 76.0236 | 0.1631 | | | | 24.09 |
| 10 | 48.9826 | 5.0142 | 1.85478 | 24.80 | 0.61232 | 24.03 |
| 11 | −33.1705 | 1.1252 | | | | 23.69 |
| 12 | −23.0245 | 0.9033 | 1.84666 | 23.78 | 0.62054 | 23.57 |
| 13 | −39.9485 | DD[13] | | | | 23.57 |
| 14(St) | ∞ | 0.1248 | | | | 18.50 |
| *15 | 53.0394 | 2.3015 | 1.85400 | 40.38 | 0.56890 | 18.88 |
| *16 | −131.9423 | 0.1750 | | | | 18.86 |
| 17 | 19.9986 | 1.1250 | 1.92286 | 18.90 | 0.64960 | 18.65 |
| 18 | 13.2025 | 6.1614 | 1.53775 | 74.70 | 0.53936 | 17.52 |
| 19 | −153.7211 | 1.4994 | | | | 16.85 |
| 20 | −61.3842 | 0.7762 | 1.80100 | 34.97 | 0.58642 | 16.30 |
| 21 | 18.8664 | 2.2502 | 2.10420 | 17.02 | 0.66311 | 15.91 |
| 22 | 35.4509 | 4.9998 | | | | 15.60 |
| 23 | 40.7009 | 0.7252 | 1.74000 | 28.30 | 0.60790 | 17.00 |
| 24 | 17.7234 | 3.5075 | 1.43875 | 94.66 | 0.53402 | 17.60 |
| 25 | 817.8453 | 0.2278 | | | | 18.37 |
| *26 | 23.2601 | 5.7490 | 1.59201 | 67.02 | 0.53589 | 20.80 |
| *27 | −23.8243 | DD[27] | | | | 21.08 |
| 28 | 94.4247 | 0.8381 | 1.69680 | 55.53 | 0.54341 | 21.19 |
| 29 | 18.4868 | DD[29] | | | | 20.91 |
| *30 | −47.7256 | 1.2668 | 1.74320 | 49.29 | 0.55303 | 26.21 |
| *31 | 127.0393 | DD[31] | | | | 29.33 |
| 32 | −403.8015 | 4.3325 | 2.00100 | 29.14 | 0.59974 | 39.51 |
| 33 | −54.7742 | DD[33] | | | | 40.00 |

TABLE 44
Example 15

| | Wide | Middle | Tele |
|---|---|---|---|
| Zr | 1.0 | 1.8 | 3.3 |
| f | 20.70 | 37.61 | 68.32 |
| Bf | 10.05 | 11.08 | 14.04 |
| FNo. | 4.13 | 4.13 | 4.12 |
| 2ω[°] | 102.6 | 57.0 | 33.4 |
| DD[5] | 0.67 | 16.06 | 38.13 |
| DD[13] | 20.00 | 6.97 | 2.21 |
| DD[27] | 1.69 | 2.48 | 1.56 |
| DD[29] | 10.35 | 8.97 | 8.35 |
| DD[31] | 0.75 | 10.28 | 24.03 |
| DD[33] | 10.05 | 11.08 | 14.04 |

TABLE 45A
Example 15

| Sn | 8 | 9 | 26 | 27 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −3.1640508E−07 | −1.5097557E−05 | −2.2486420E−05 | 4.2640445E−05 |
| A5 | 0.0000000E+00 | 0.0000000E+00 | 0.0000000E+00 | 0.0000000E+00 |
| A6 | 2.6811804E−08 | 3.9077853E−08 | 3.0782542E−08 | −1.5406437E−07 |
| A7 | 0.0000000E+00 | 0.0000000E+00 | 0.0000000E+00 | 0.0000000E+00 |
| A8 | −4.5494617E−10 | −3.1631088E−10 | −7.5245156E−10 | 6.9836090E−10 |
| A9 | 0.0000000E+00 | 0.0000000E+00 | 0.0000000E+00 | 0.0000000E+00 |
| A10 | −2.7052788E−12 | −5.7748067E−12 | 1.1779418E−11 | 2.2071335E−12 |
| A11 | 0.0000000E+00 | 0.0000000E+00 | 0.0000000E+00 | 0.0000000E+00 |
| A12 | 1.8894054E−14 | 3.8329935E−15 | −2.3924458E−14 | −3.3555610E−14 |
| A13 | 0.0000000E+00 | 0.0000000E+00 | 0.0000000E+00 | 0.0000000E+00 |
| A14 | −1.0534244E−16 | 1.4470406E−16 | −8.4680613E−16 | 3.1964132E−16 |
| A15 | 0.0000000E+00 | 0.0000000E+00 | 0.0000000E+00 | 0.0000000E+00 |
| A16 | 2.2071938E−19 | 4.6171133E−19 | 2.1910756E−18 | −9.9879614E−19 |
| A17 | 0.0000000E+00 | 0.0000000E+00 | 0.0000000E+00 | 0.0000000E+00 |
| A18 | 1.0724167E−20 | 3.2290543E−21 | 9.2612175E−20 | −1.1306831E−20 |
| A19 | 0.0000000E+00 | 0.0000000E+00 | 0.0000000E+00 | 0.0000000E+00 |
| A20 | −4.8041369E−23 | −3.5771698E−23 | −4.0231885E−22 | 2.4174080E−22 |

| Sn | 15 | 16 |
|---|---|---|
| KA | 1.0000000E+00 | 1.0000000E+00 |
| A4 | 4.4407592E−06 | 4.3976777E−06 |
| A6 | 2.6113183E−10 | 3.4473463E−09 |
| A8 | 3.4509000E−10 | 2.8760741E−10 |
| A10 | 1.1121373E−12 | 1.8478007E−12 |

TABLE 45B
Example 15

| Sn | 30 | 31 |
|---|---|---|
| KA | 1.0000000E+00 | 1.0000000E+00 |
| A3 | 0.0000000E+00 | 0.0000000E+00 |
| A4 | −5.1679804E−05 | −5.7128012E−05 |
| A5 | 0.0000000E+00 | 0.0000000E+00 |
| A6 | 3.1134152E−07 | 4.5132568E−07 |
| A7 | 0.0000000E+00 | 0.0000000E+00 |
| A8 | −9.6880830E−10 | −2.6375888E−09 |
| A9 | 0.0000000E+00 | 0.0000000E+00 |
| A10 | −8.5987204E−12 | 4.9601513E−12 |
| A11 | 0.0000000E+00 | 0.0000000E+00 |
| A12 | 4.2650227E−14 | 1.2465446E−14 |
| A13 | 0.0000000E+00 | 0.0000000E+00 |
| A14 | 1.5269950E−16 | −9.7623526E−18 |
| A15 | 0.0000000E+00 | 0.0000000E+00 |
| A16 | 4.8097835E−19 | −7.8661698E−20 |
| A17 | 0.0000000E+00 | 0.0000000E+00 |
| A18 | 2.7789924E−22 | 2.5296441E−22 |
| A19 | 0.0000000E+00 | 0.0000000E+00 |
| A20 | −2.8773650E−23 | −1.6596836E−24 |

### Example 16

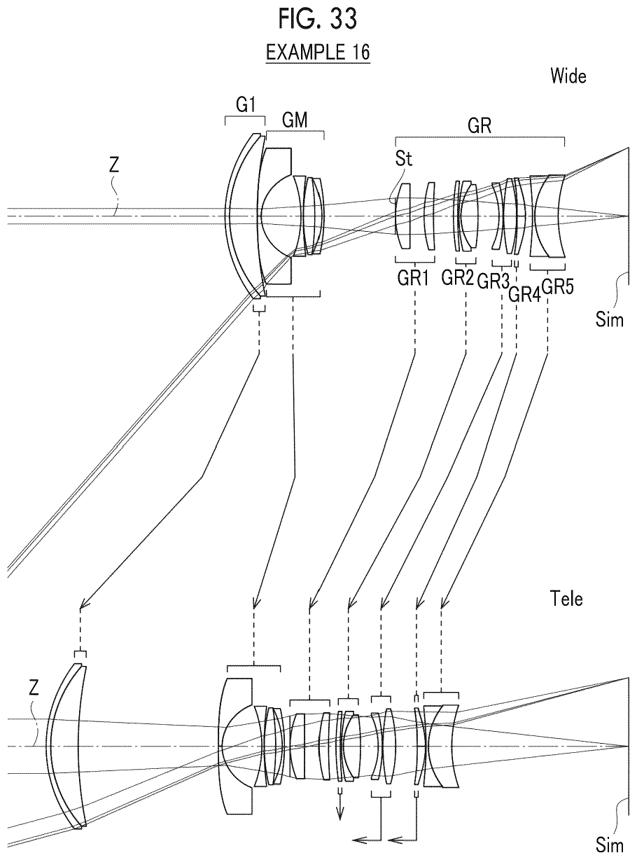

A configuration and a movement trajectory of a variable magnification optical system of Example 16 are shown in FIG. 33. The variable magnification optical system of Example 16 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a positive refractive power, a fourth subsequent lens group GR4 having a positive refractive power, and a fifth subsequent lens group GR5 having a negative refractive power. A lens of the intermediate group GM that is closest to the object side corresponds to an Lmn lens.

During changing a magnification from a wide angle end to a telephoto end, all lens groups move while changing spacings between adjacent lens groups. The variable magnification optical system includes two focusing groups. A focusing group on the object side consists of the third subsequent lens group GR3, and a focusing group on the image side consists of the fourth subsequent lens group GR4. During focusing from an infinite distance object to a close distance object, the third subsequent lens group GR3 and the fourth subsequent lens group GR4 move to the object side by changing a mutual spacing, and other lens groups remain stationary with respect to an image plane Sim. An anti-vibration group consists of the second subsequent lens group GR2.

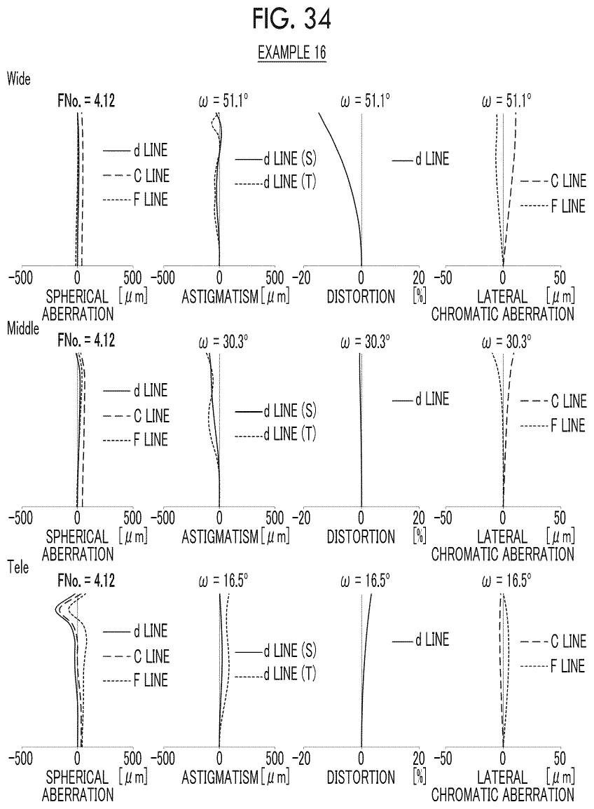

With respect to the variable magnification optical system of Example 16, basic lens data is shown in Table 46, specifications and variable surface spacings are shown in Table 47, aspherical coefficients are shown in Table 48, and each aberration diagram is shown in FIG. 34.

TABLE 46
Example 16

| Sn | R | D | Nd | νd | θg, F | ED |
|---|---|---|---|---|---|---|
| 1 | 45.5896 | 1.2994 | 1.77535 | 50.31 | 0.55042 | 52.00 |
| 2 | 40.0995 | 7.9253 | 1.43875 | 94.66 | 0.53402 | 50.33 |
| 3 | 135.0124 | DD[3] | | | | 49.48 |
| *4 | 195.1679 | 1.0951 | 1.49710 | 81.56 | 0.53848 | 42.67 |
| *5 | 13.6654 | 11.4342 | | | | 26.00 |
| 6 | −37.5185 | 0.6545 | 1.80420 | 46.50 | 0.55727 | 24.84 |
| 7 | 108.1716 | 0.0500 | | | | 23.98 |
| 8 | 56.7964 | 3.2772 | 1.85478 | 24.80 | 0.61232 | 23.81 |
| 9 | −90.4863 | 1.8920 | | | | 23.38 |
| 10 | −28.4149 | 0.6172 | 1.49700 | 81.54 | 0.53748 | 23.21 |
| 11 | −59.8378 | DD[11] | | | | 22.74 |
| 12(St) | ∞ | 0.0498 | | | | 19.12 |
| *13 | 28.3802 | 4.1454 | 1.59201 | 67.02 | 0.53589 | 20.26 |
| *14 | −1859.3164 | 4.0677 | | | | 20.41 |
| 15 | 42.5799 | 2.6865 | 1.64000 | 60.08 | 0.53704 | 21.16 |
| 16 | 161.5285 | DD[16] | | | | 20.97 |
| 17 | 82.6523 | 1.2445 | 1.43875 | 94.66 | 0.53402 | 21.10 |
| 18 | 121.3357 | 0.3534 | | | | 20.95 |
| 19 | 52.3815 | 0.5497 | 1.84666 | 23.78 | 0.62054 | 20.43 |
| 20 | 18.3465 | 4.9152 | 1.49700 | 81.54 | 0.53748 | 19.85 |
| 21 | −79.2174 | DD[21] | | | | 19.86 |
| 22 | −24.7773 | 1.1485 | 1.69895 | 30.13 | 0.60298 | 19.40 |
| 23 | −50.4047 | 0.2015 | | | | 20.90 |
| 24 | 67.2460 | 3.6725 | 1.76200 | 40.10 | 0.57655 | 23.16 |
| 25 | −48.1875 | DD[25] | | | | 23.57 |
| *26 | −143.5609 | 2.3592 | 1.49710 | 81.56 | 0.53848 | 23.82 |
| *27 | −27.7316 | DD[27] | | | | 24.04 |
| *28 | −90.1459 | 0.6649 | 1.88300 | 39.22 | 0.57288 | 24.58 |
| 29 | 21.7675 | 6.7187 | 1.92286 | 18.90 | 0.64960 | 25.39 |
| 30 | 42.9502 | DD[30] | | | | 25.91 |

TABLE 47
Example 16

| | Wide | Middle | Tele |
|---|---|---|---|
| Zr | 1.0 | 1.8 | 3.4 |
| f | 20.49 | 37.22 | 70.70 |
| Bf | 20.30 | 32.61 | 50.91 |
| FNo. | 4.12 | 4.12 | 4.12 |
| 2ω[°] | 102.2 | 60.6 | 33.0 |
| DD[3] | 0.09 | 17.09 | 40.31 |
| DD[11] | 20.51 | 8.31 | 1.59 |
| DD[16] | 5.76 | 4.22 | 2.12 |
| DD[21] | 6.06 | 3.63 | 5.11 |
| DD[25] | 0.20 | 4.39 | 6.19 |
| DD[27] | 2.04 | 1.11 | 0.19 |
| DD[30] | 20.30 | 32.61 | 50.91 |

TABLE 48
Example 16

| Sn | 4 | 5 | 28 |
|---|---|---|---|
| KA | 1.0000000E+00 | 1.0000000E+00 | 1.0000000E+00 |
| A4 | −2.1446209E−06 | −2.0625662E−05 | 7.8349840E−06 |
| A6 | 8.5887533E−08 | −8.6886055E−08 | −1.9436465E−08 |
| A8 | −3.3705196E−10 | 2.5809471E−09 | 2.1924788E−10 |
| A10 | 6.3094863E−13 | −3.2231142E−11 | −1.8926261E−12 |
| A12 | −5.4516344E−16 | 2.0769478E−13 | 8.4786713E−15 |
| A14 | 1.7923550E−19 | −6.3032287E−16 | −1.4416380E−17 |

| Sn | 13 | 14 | 27 |
|---|---|---|---|
| KA | 1.0000000E+00 | 1.0000000E+00 | 1.0000000E+00 |
| A4 | −8.7100580E−06 | 9.7820514E−07 | 2.5561855E−05 |
| A6 | 1.5424945E−08 | −4.5149856E−09 | −5.8399623E−08 |
| A8 | −1.0554352E−10 | 3.0129387E−10 | 9.2270030E−10 |
| A10 | 3.2949656E−12 | −2.1487854E−12 | −2.6132503E−12 |
| A12 | −3.1751032E−15 | 2.2135195E−14 | 7.2514729E−15 |

| Sn | 26 |
|---|---|
| KA | 1.0000000E+00 |
| A4 | −2.2276058E−05 |
| A6 | −7.9717595E−09 |
| A8 | 5.2225656E−10 |

### Example 17

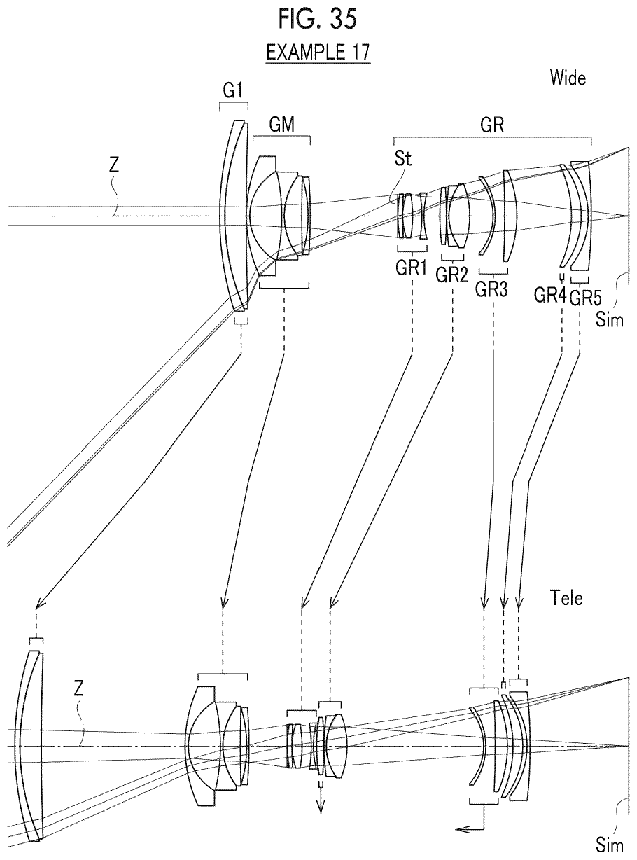

A configuration and a movement trajectory of a variable magnification optical system of Example 17 are shown in FIG. 35. The variable magnification optical system of Example 17 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a positive refractive power, a fourth subsequent lens group GR4 having a positive refractive power, and a fifth subsequent lens group GR5 having a negative refractive power.

During changing a magnification from a wide angle end to a telephoto end, all lens groups move while changing spacings between adjacent lens groups. The variable magnification optical system includes only one focusing group. The focusing group consists of the third subsequent lens group GR3. During focusing from an infinite distance object to a close distance object, the third subsequent lens group GR3 moves to the object side, and other lens groups remain stationary with respect to an image plane Sim. An anti-vibration group consists of one lens of the second subsequent lens group GR2 that is closest to the object side.

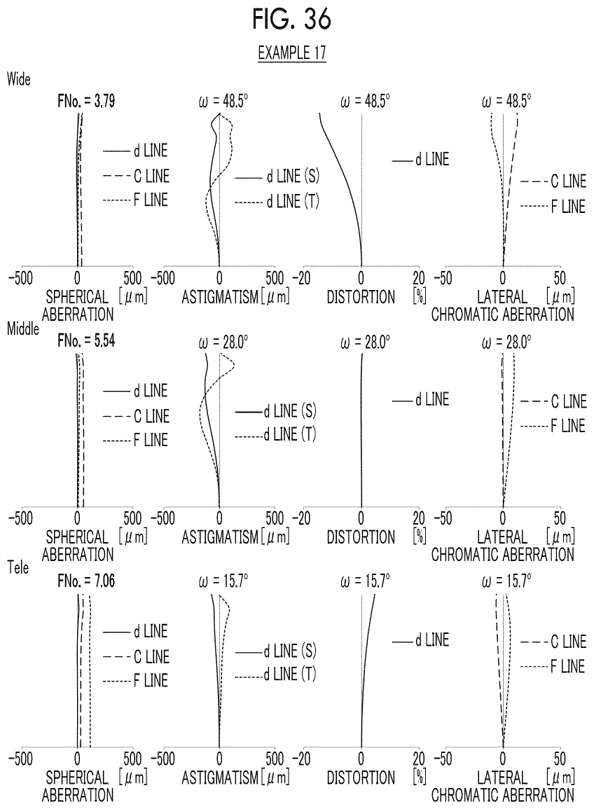

For the variable magnification optical system of Example 17, basic lens data is shown in Table 49, specifications and variable surface spacings are shown in Table 50, aspherical coefficients are shown in Table 51, and each aberration diagram is shown in FIG. 36.

TABLE 49
Example 17

| Sn | R | D | Nd | νd | θg, F | ED |
|---|---|---|---|---|---|---|
| 1 | 108.4421 | 1.4998 | 1.95906 | 17.47 | 0.65993 | 60.00 |
| 2 | 79.7872 | 6.1489 | 1.77535 | 50.31 | 0.55042 | 58.45 |
| 3 | 860.1678 | DD[3] | | | | 57.89 |
| *4 | 48.5996 | 0.9599 | 1.80610 | 40.73 | 0.56940 | 37.54 |
| *5 | 16.9852 | 9.2142 | | | | 28.00 |
| 6 | −67.1971 | 0.7244 | 1.53775 | 74.70 | 0.53936 | 27.69 |
| 7 | 22.2305 | 5.0136 | 1.84666 | 23.78 | 0.62054 | 25.05 |
| 8 | 478.9421 | 1.8241 | | | | 24.38 |
| 9 | −45.9670 | 0.6277 | 2.00100 | 29.14 | 0.59974 | 24.35 |
| 10 | −188.2836 | DD[10] | | | | 24.09 |
| 11(St) | ∞ | 0.0498 | | | | 13.62 |
| *12 | 36.2150 | 1.3517 | 1.61881 | 63.85 | 0.54182 | 13.74 |
| *13 | 92.2368 | 0.0498 | | | | 13.75 |
| 14 | 22.9383 | 2.8399 | 1.59522 | 67.73 | 0.54426 | 13.82 |
| 15 | −42.2079 | 2.6616 | | | | 13.60 |
| 16 | −47.5485 | 0.6248 | 1.64000 | 60.08 | 0.53704 | 14.06 |
| 17 | 31.6028 | DD[17] | | | | 14.50 |
| 18 | 75.7156 | 1.8961 | 1.43875 | 94.66 | 0.53402 | 17.58 |
| 19 | −121.9775 | 0.0498 | | | | 18.01 |
| 20 | 72.5622 | 0.6498 | 1.88300 | 39.22 | 0.57288 | 18.57 |
| 21 | 17.8635 | 5.9815 | 1.49700 | 81.54 | 0.53748 | 19.07 |
| 22 | −29.9478 | DD[22] | | | | 20.00 |
| 23 | −19.3857 | 0.6352 | 1.95906 | 17.47 | 0.65993 | 23.60 |
| 24 | −22.6521 | 2.7069 | | | | 24.52 |
| 25 | −332.3991 | 3.5112 | 1.77535 | 50.31 | 0.55042 | 28.06 |
| 26 | −39.8557 | DD[26] | | | | 28.58 |
| 27 | −40.1070 | 2.8162 | 1.95906 | 17.47 | 0.65993 | 31.71 |
| 28 | −28.5083 | DD[28] | | | | 32.27 |
| 29 | −27.8171 | 0.8755 | 1.88300 | 39.22 | 0.57288 | 31.74 |
| 30 | −175.6559 | DD[30] | | | | 34.21 |

TABLE 50
Example 17

| | Wide | Middle | Tele |
|---|---|---|---|
| Zr | 1.0 | 1.8 | 3.3 |
| f | 22.35 | 40.61 | 73.77 |
| Bf | 10.80 | 25.40 | 28.41 |
| FNo. | 3.79 | 5.54 | 7.06 |
| 2ω[°] | 97.0 | 56.0 | 31.4 |
| DD[3] | 0.05 | 17.37 | 41.34 |
| DD[10] | 25.00 | 19.29 | 10.99 |
| DD[17] | 4.56 | 2.95 | 0.94 |
| DD[22] | 6.71 | 24.32 | 39.28 |
| DD[26] | 15.71 | 1.61 | 1.61 |
| DD[28] | 2.02 | 1.53 | 1.23 |
| DD[30] | 10.80 | 25.40 | 28.41 |

TABLE 51
Example 17

| Sn | 4 | 5 | 12 | 13 |
|---|---|---|---|---|
| KA | 1.0000000E+00 | 1.0000000E+00 | 1.0000000E+00 | 1.0000000E+00 |
| A4 | −2.2287470E−06 | −2.8735168E−06 | −3.0929192E−05 | −1.2925877E−05 |
| A6 | 1.5679774E−08 | 5.3660186E−09 | −7.6189083E−08 | −6.9469994E−08 |
| A8 | −3.0071155E−11 | 1.3375560E−10 | −2.9503097E−09 | −2.7666995E−09 |
| A10 | 5.3601900E−15 | 0.0000000E+00 | −1.6064700E−15 | 0.0000000E+00 |

### Example 18

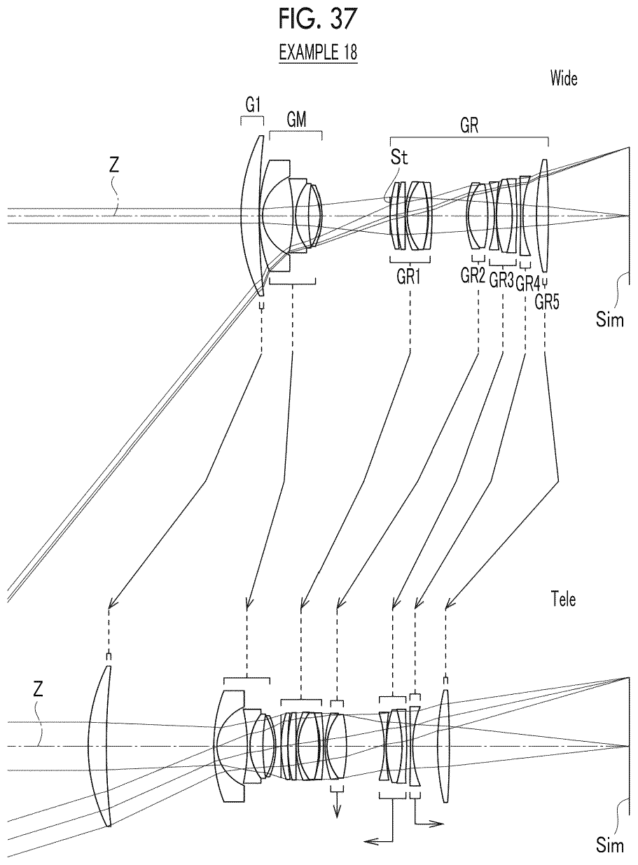

A configuration and a movement trajectory of a variable magnification optical system of Example 18 are shown in FIG. 37. The variable magnification optical system of Example 18 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a positive refractive power, a fourth subsequent lens group GR4 having a negative refractive power, and a fifth subsequent lens group GR5 having a positive refractive power. A lens of the intermediate group GM that is closest to the object side corresponds to an Lmn lens. A lens constituting the fourth subsequent lens group GR4 corresponds to an Lrn lens.

During changing a magnification from a wide angle end to a telephoto end, all lens groups move while changing spacings between adjacent lens groups. The variable magnification optical system includes two focusing groups. A focusing group on the object side consists of the third subsequent lens group GR3, and a focusing group on the image side consists of the fourth subsequent lens group GR4. During focusing from an infinite distance object to a close distance object, the third subsequent lens group GR3 moves to the object side, the fourth subsequent lens group GR4 moves to the image side, and other lens groups remain stationary with respect to an image plane Sim. An anti-vibration group consists of the second subsequent lens group GR2.

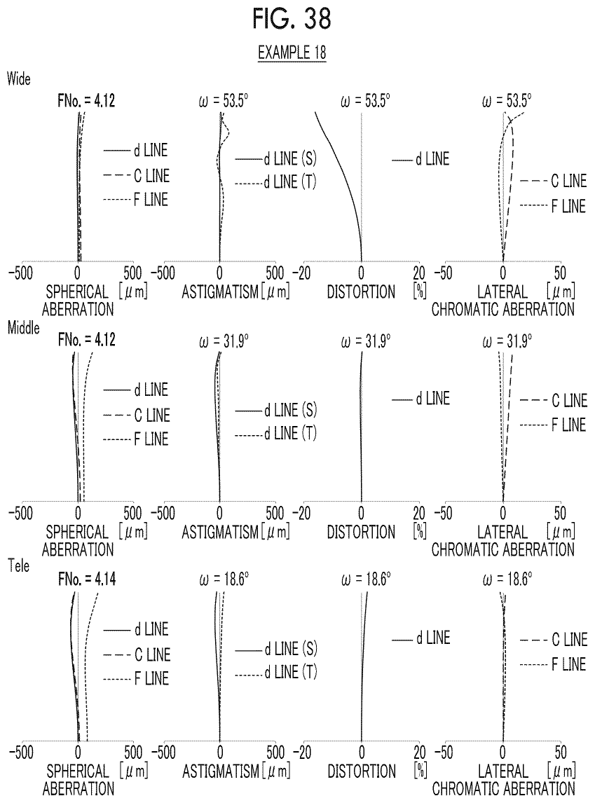

For the variable magnification optical system of Example 18, basic lens data is shown in Table 52, specifications and variable surface spacings are shown in Table 53, aspherical coefficients are shown in Table 54, and each aberration diagram is shown in FIG. 38.

TABLE 52
Example 18

| Sn | R | D | Nd | νd | θg, F | ED |
|---|---|---|---|---|---|---|
| 1 | 62.1592 | 5.2254 | 1.48749 | 70.24 | 0.53007 | 50.40 |
| 2 | 240.6758 | DD[2] | | | | 49.60 |
| *3 | 58.0087 | 0.9000 | 1.69350 | 53.18 | 0.54831 | 35.00 |
| *4 | 13.6089 | 8.7343 | | | | 24.05 |
| 5 | −59.6182 | 0.7633 | 1.59522 | 67.73 | 0.54426 | 23.28 |
| 6 | 17.8086 | 3.7080 | 1.80518 | 25.42 | 0.61616 | 20.24 |
| 7 | 64.8368 | 3.1781 | | | | 19.37 |
| 8 | −21.1422 | 0.5208 | 1.49700 | 81.54 | 0.53748 | 19.23 |
| 9 | −27.2517 | DD[9] | | | | 19.00 |
| 10(St) | ∞ | 0.0502 | | | | 19.81 |
| 11 | 38.6991 | 1.8811 | 1.92286 | 18.90 | 0.64960 | 20.83 |
| 12 | 80.7644 | 0.0500 | | | | 20.90 |
| 13 | 46.2463 | 2.3484 | 1.52841 | 76.45 | 0.53954 | 21.11 |
| 14 | −9251.8637 | 0.0502 | | | | 21.18 |
| 15 | 30.2276 | 0.5597 | 1.85025 | 30.05 | 0.59797 | 21.41 |
| 16 | 18.8412 | 5.8809 | 1.53775 | 74.70 | 0.53936 | 20.93 |
| 17 | −44.7095 | 0.2157 | | | | 20.83 |
| 18 | −38.4575 | 0.9918 | 1.95906 | 17.47 | 0.65993 | 20.83 |
| 19 | −105.3729 | DD[19] | | | | 21.01 |
| 20 | 34.2951 | 0.5410 | 1.90366 | 31.31 | 0.59481 | 20.74 |
| 21 | 17.1068 | 5.6073 | 1.59522 | 67.73 | 0.54426 | 20.00 |
| 22 | −54.7218 | DD[22] | | | | 19.80 |
| 23 | −38.2177 | 0.5569 | 1.92286 | 18.90 | 0.64960 | 20.57 |
| 24 | 78.2776 | 0.0498 | | | | 21.36 |
| 25 | 39.7081 | 4.4977 | 1.95906 | 17.47 | 0.65993 | 22.59 |
| 26 | −44.9417 | 1.3638 | 1.53996 | 59.46 | 0.54418 | 22.89 |
| *27 | −78.5043 | DD[27] | | | | 23.25 |
| *28 | −190.0238 | 0.6466 | 1.76802 | 49.24 | 0.55164 | 24.38 |
| *29 | 42.0004 | DD[29] | | | | 24.90 |
| 30 | 86.5636 | 3.3922 | 1.74100 | 52.68 | 0.54707 | 35.00 |
| 31 | −329.0542 | DD[31] | | | | 35.31 |

TABLE 53
Example 18

| | Wide | Middle | Tele |
|---|---|---|---|
| Zr | 1.0 | 1.8 | 3.3 |
| f | 19.05 | 34.61 | 62.88 |
| Bf | 23.27 | 19.31 | 51.71 |
| FNo. | 4.12 | 4.12 | 4.14 |
| 2ω[°] | 107.0 | 63.8 | 37.2 |
| DD[2] | 0.10 | 13.79 | 30.87 |
| DD[9] | 19.57 | 8.66 | 1.50 |
| DD[19] | 9.91 | 5.79 | 0.50 |
| DD[22] | 1.89 | 5.92 | 10.83 |
| DD[27] | 1.09 | 4.66 | 1.09 |
| DD[29] | 3.89 | 17.69 | 7.11 |
| DD[31] | 23.27 | 19.31 | 51.71 |

TABLE 54
Example 18

| Sn | 3 | 4 | 27 |
|---|---|---|---|
| KA | 1.0000000E+00 | 1.0000000E+00 | 1.0000000E+00 |
| A4 | 2.8085140E−06 | −2.4016096E−06 | 3.7942510E−05 |
| A6 | −5.6971151E−09 | −2.0203650E−09 | −3.4575486E−08 |
| A8 | 1.1048734E−11 | −2.1245556E−10 | 7.9964862E−11 |
| A10 | 3.4211100E−15 | 0.0000000E+00 | 1.9888200E−13 |

| Sn | 28 | 29 |
|---|---|---|
| KA | 1.0000000E+00 | 0.0000000E+00 |
| A4 | 1.9027650E−05 | 1.9068571E−05 |
| A6 | −9.3712911E−08 | −6.1936272E−08 |
| A8 | 1.6690659E−10 | 1.3119878E−10 |
| A10 | 3.0036300E−13 | 0.0000000E+00 |

### Example 19

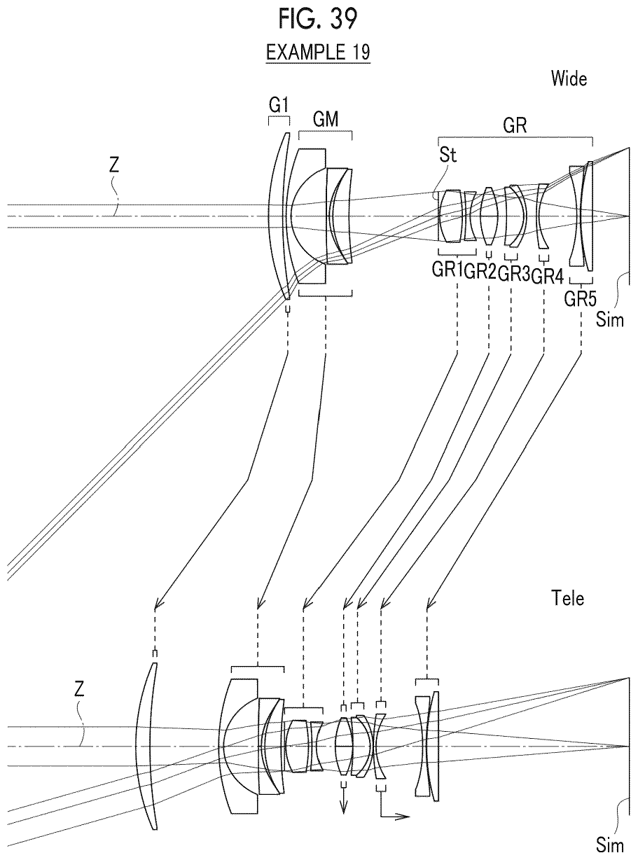

A configuration and a movement trajectory of a variable magnification optical system of Example 19 are shown in FIG. 39. The variable magnification optical system of Example 19 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a positive refractive power, a fourth subsequent lens group GR4 having a negative refractive power, and a fifth subsequent lens group GR5 having a negative refractive power.

During changing a magnification from a wide angle end to a telephoto end, all lens groups move while changing spacings between adjacent lens groups. The variable magnification optical system includes only one focusing group. The focusing group consists of the fourth subsequent lens group GR4. During focusing from an infinite distance object to a close distance object, the fourth subsequent lens group GR4 moves to the image side, and the other lens groups remain stationary with respect to the image plane Sim. An anti-vibration group consists of the second subsequent lens group GR2.

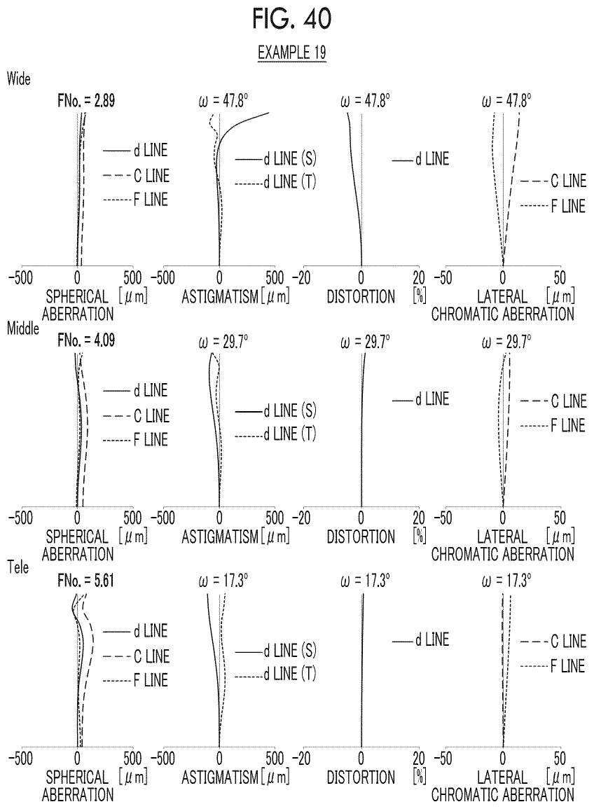

For the variable magnification optical system of Example 19, basic lens data is shown in Table 55, specifications and variable surface spacings are shown in Table 56, aspherical coefficients are shown in Table 57, and each aberration diagram is shown in FIG. 40.

TABLE 55
Example 19

| Sn | R | D | Nd | νd | θg, F | ED |
|---|---|---|---|---|---|---|
| 1 | 71.6951 | 4.0618 | 1.78880 | 28.43 | 0.60092 | 52.40 |
| 2 | 161.6515 | DD[2] | | | | 50.89 |
| 3 | 63.2539 | 1.4069 | 1.90525 | 35.04 | 0.58486 | 42.35 |
| 4 | 16.6623 | 10.0002 | | | | 30.31 |
| *5 | −1147.7377 | 0.8498 | 1.55332 | 71.68 | 0.54029 | 30.19 |
| *6 | 21.3455 | 1.0000 | | | | 29.51 |
| 7 | 27.7771 | 4.6471 | 2.00100 | 29.14 | 0.59974 | 29.53 |
| 8 | 120.3681 | DD[8] | | | | 29.03 |
| 9(St) | ∞ | 0.3888 | | | | 15.45 |
| *10 | 17.6899 | 6.5002 | 1.59201 | 67.02 | 0.53589 | 16.39 |
| *11 | −38.9187 | 1.0002 | | | | 15.87 |
| 12 | −76.8026 | 1.2500 | 1.63930 | 44.87 | 0.56843 | 15.35 |
| 13 | 16.7798 | DD[13] | | | | 14.80 |
| *14 | 22.7963 | 5.0002 | 1.43875 | 94.66 | 0.53402 | 17.81 |
| *15 | −19.6335 | DD[15] | | | | 18.01 |
| 16 | −73.8223 | 4.9323 | 1.65160 | 58.54 | 0.53901 | 17.60 |
| 17 | −12.4842 | 0.8498 | 1.90525 | 35.04 | 0.58486 | 18.21 |
| 18 | −19.0283 | DD[18] | | | | 19.49 |
| 19 | 63.6970 | 0.7498 | 1.88300 | 39.22 | 0.57288 | 20.33 |
| 20 | 19.5723 | DD[20] | | | | 20.08 |
| *21 | −55.1733 | 0.9998 | 1.61881 | 63.85 | 0.54182 | 27.17 |
| *22 | 65.5827 | 0.1501 | | | | 31.39 |
| 23 | 68.3597 | 3.3796 | 2.00272 | 19.32 | 0.64514 | 33.94 |
| 24 | ∞ | DD[24] | | | | 34.43 |

TABLE 56
Example 19

| | Wide | Middle | Tele |
|---|---|---|---|
| Zr | 1.0 | 1.8 | 3.4 |
| f | 20.63 | 37.47 | 69.10 |
| Bf | 10.58 | 32.20 | 54.86 |
| FNo. | 2.89 | 4.09 | 5.61 |
| 2ω[°] | 95.6 | 59.4 | 34.6 |
| DD[2] | 1.00 | 8.74 | 19.76 |
| DD[8] | 25.68 | 12.68 | 1.01 |
| DD[13] | 2.94 | 3.16 | 5.28 |
| DD[15] | 2.50 | 1.25 | 0.10 |
| DD[18] | 2.80 | 0.98 | 0.10 |
| DD[20] | 10.86 | 8.83 | 13.40 |
| DD[24] | 10.58 | 32.20 | 54.86 |

TABLE 57
Example 19

| Sn | 5 | 6 | 10 | 11 |
|---|---|---|---|---|
| KA | 1.0000000E+00 | 1.0000000E+00 | 1.0000000E+00 | 1.0000000E+00 |
| A4 | 1.6982602E−05 | 6.3063592E−06 | −3.6950383E−06 | 4.6021659E−05 |
| A6 | −4.3015114E−08 | −6.0800685E−08 | 1.1167165E−08 | −1.9730174E−07 |
| A8 | −2.4754823E−12 | −1.7629626E−10 | −1.0192313E−09 | 8.9861832E−11 |
| A10 | 0.0000000E+00 | 0.0000000E+00 | 2.1882500E−12 | 2.7923800E−13 |
| Sn | 14 | 15 | 21 | 22 |
| KA | 1.0000000E+00 | 1.0000000E+00 | 1.0000000E+00 | 1.0000000E+00 |
| A4 | −9.1887865E−06 | 5.1908376E−05 | −1.5342096E−05 | −2.1747819E−05 |
| A6 | −1.2663858E−07 | −1.1177326E−09 | 1.0145271E−07 | 1.1324679E−07 |
| A8 | 5.1565799E−10 | −1.1663939E−09 | −4.0082451E−10 | −4.1280784E−10 |
| A10 | 0.0000000E+00 | 7.7268200E−12 | 0.0000000E+00 | 2.9616800E−13 |

### Example 20

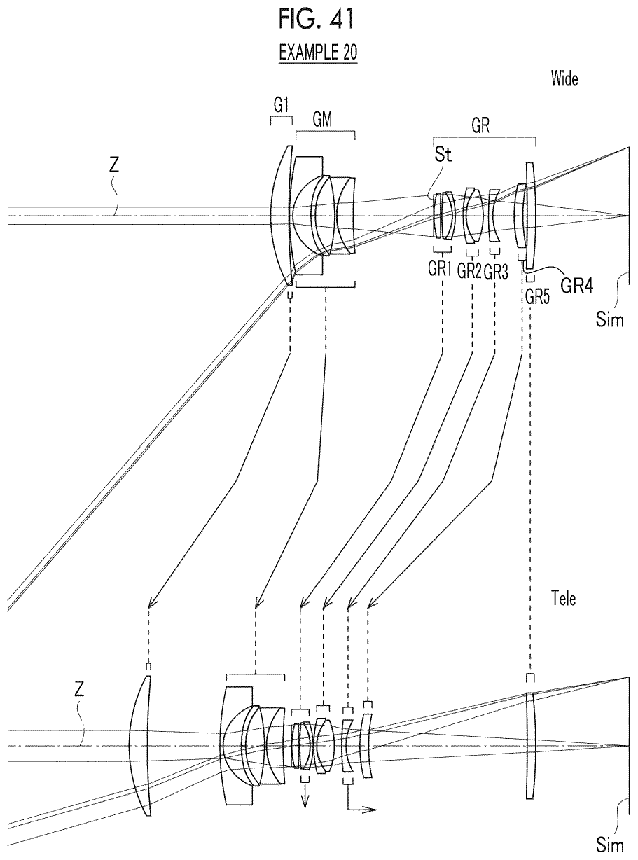

A configuration and a movement trajectory of a variable magnification optical system of Example 20 are shown in FIG. 41. The variable magnification optical system of Example 20 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, a fourth subsequent lens group GR4 having a positive refractive power, and a fifth subsequent lens group GR5 having a positive refractive power. A second lens from the object side of the intermediate group GM corresponds to an Lmn lens.

During changing a magnification from a wide angle end to a telephoto end, the fifth subsequent lens group GR5 remains stationary with respect to an image plane Sim, and other lens groups move along an optical axis Z by changing their spacings with respect to their adjacent lens groups. The variable magnification optical system includes only one focusing group. The focusing group consists of the third subsequent lens group GR3. During focusing from an infinite distance object to a close distance object, the third subsequent lens group GR3 moves to the image side, and the other lens groups remain stationary with respect to the image plane Sim. An anti-vibration group consists of a cemented lens of the first subsequent lens group GR1 that is closest to the image side.

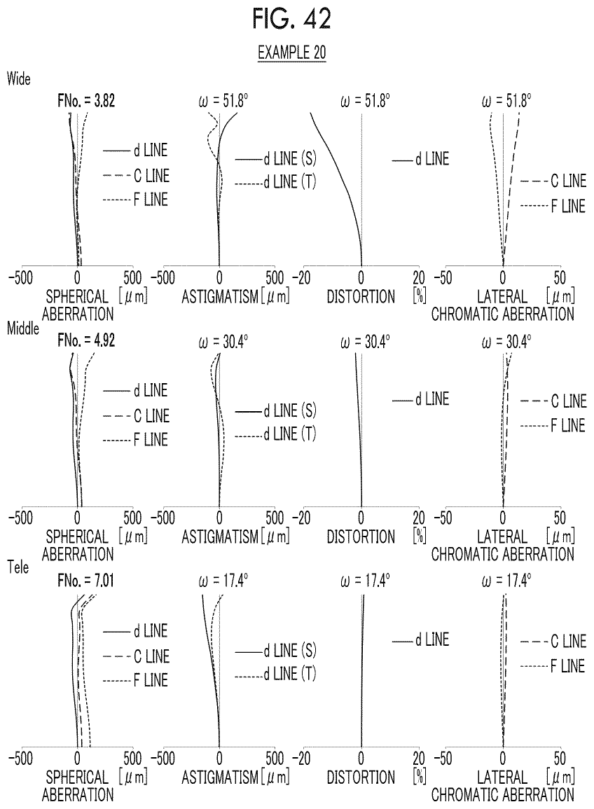

For the variable magnification optical system of Example 20, basic lens data is shown in Table 58, specifications and variable surface spacings are shown in Table 59, aspherical coefficients are shown in Table 60, and each aberration diagram is shown in FIG. 42.

TABLE 58
Example 20

| Sn | R | D | Nd | νd | θg, F | ED |
|---|---|---|---|---|---|---|
| 1 | 51.2344 | 5.2171 | 1.48749 | 70.24 | 0.53007 | 44.00 |
| 2 | 243.3048 | DD[2] | | | | 42.78 |
| 3 | 94.0999 | 0.9223 | 1.77535 | 50.31 | 0.55042 | 37.12 |
| 4 | 13.7292 | 5.2275 | | | | 25.30 |
| *5 | 32.6323 | 1.2498 | 1.49710 | 81.56 | 0.53848 | 25.20 |
| *6 | 24.9047 | 5.3938 | | | | 24.15 |
| 7 | −54.8409 | 0.6034 | 1.49700 | 81.54 | 0.53748 | 24.08 |
| 8 | 20.1127 | 4.7397 | 1.89190 | 37.13 | 0.57813 | 23.74 |
| 9 | 138.7967 | DD[9] | | | | 23.31 |
| 10(St) | ∞ | 0.1000 | | | | 13.14 |
| *11 | 28.6669 | 1.9093 | 1.61881 | 63.85 | 0.54182 | 13.82 |
| *12 | −912.9585 | 0.3699 | | | | 14.07 |
| 13 | 73.7912 | 3.0098 | 1.53775 | 74.70 | 0.53936 | 14.42 |
| 14 | −14.4888 | 0.8498 | 1.88300 | 39.22 | 0.57288 | 14.51 |
| 15 | −24.7871 | DD[15] | | | | 15.00 |
| 16 | 37.8236 | 0.8501 | 1.74100 | 52.68 | 0.54707 | 16.04 |
| 17 | 14.4266 | 4.9236 | 1.43875 | 94.66 | 0.53402 | 15.93 |
| 18 | −24.0198 | DD[18] | | | | 16.19 |
| *19 | 89.6878 | 1.2367 | 1.69304 | 52.93 | 0.54673 | 16.28 |
| *20 | 17.2487 | DD[20] | | | | 16.09 |
| 21 | 45.4918 | 2.5002 | 1.77535 | 50.31 | 0.55042 | 19.79 |
| 22 | 52.8034 | DD[22] | | | | 20.00 |
| 23 | −517.7761 | 2.4276 | 2.00100 | 29.14 | 0.59974 | 32.89 |
| 24 | −166.6923 | 26.8900 | | | | 33.40 |

TABLE 59
Example 20

| | Wide | Middle | Tele |
|---|---|---|---|
| Zr | 1.0 | 1.8 | 3.3 |
| f | 20.70 | 37.60 | 68.31 |
| Bf | 26.89 | 26.89 | 26.89 |
| FNo. | 3.82 | 4.92 | 7.01 |
| 2ω[°] | 103.6 | 60.8 | 34.8 |
| DD[2] | 0.20 | 13.47 | 20.86 |
| DD[9] | 23.09 | 10.60 | 2.41 |
| DD[15] | 2.25 | 1.46 | 0.16 |
| DD[18] | 1.52 | 2.12 | 2.12 |
| DD[20] | 6.14 | 12.33 | 3.98 |
| DD[22] | 1.25 | 9.98 | 45.58 |

TABLE 60
Example 20

| Sn | 5 | 6 | 11 |
|---|---|---|---|
| KA | 1.0000000E+00 | 1.0000000E+00 | 1.0000000E+00 |
| A4 | −1.3035378E−05 | −1.5442142E−05 | 5.6982124E−06 |
| A6 | 5.9035225E−07 | 6.5044056E−07 | −2.5743260E−07 |
| A8 | −1.4724924E−09 | −1.0534217E−09 | 2.8586932E−09 |
| A10 | −1.0697316E−12 | −7.4103638E−12 | −1.9960128E−11 |
| Sn | 12 | 19 | 20 |
| KA | 1.0000000E+00 | 1.0000000E+00 | 1.0000000E+00 |
| A4 | 3.6941268E−05 | 3.1779032E−05 | 2.6782191E−05 |
| A6 | −1.8743107E−07 | −5.7694140E−07 | −8.4854000E−07 |
| A8 | −9.7672883E−11 | 2.7442523E−09 | 9.2451221E−09 |
| A10 | 1.9148623E−12 | 6.8145866E−12 | −5.6342299E−11 |

### Example 21

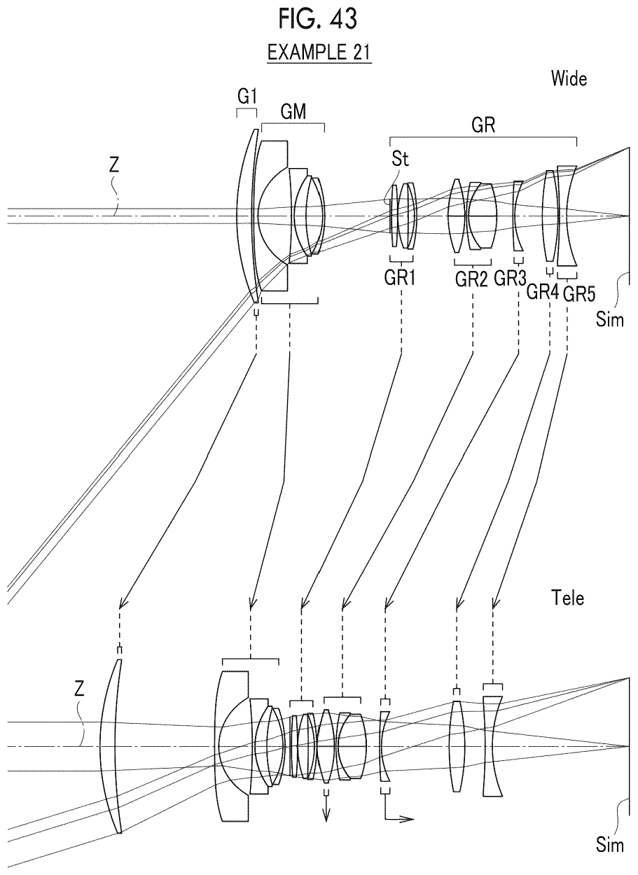

A configuration and a movement trajectory of a variable magnification optical system of Example 21 are shown in FIG. 43. The variable magnification optical system of Example 21 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, a fourth subsequent lens group GR4 having a positive refractive power, and a fifth subsequent lens group GR5 having a negative refractive power. A lens of the intermediate group GM that is closest to the object side corresponds to an Lmn lens.

During changing a magnification from a wide angle end to a telephoto end, all lens groups move while changing spacings between adjacent lens groups. The variable magnification optical system includes only one focusing group. The focusing group consists of the third subsequent lens group GR3. During focusing from an infinite distance object to a close distance object, the third subsequent lens group GR3 moves to the image side, and the other lens groups remain stationary with respect to the image plane Sim. An anti-vibration group consists of one lens of the second subsequent lens group GR2 that is closest to the object side.

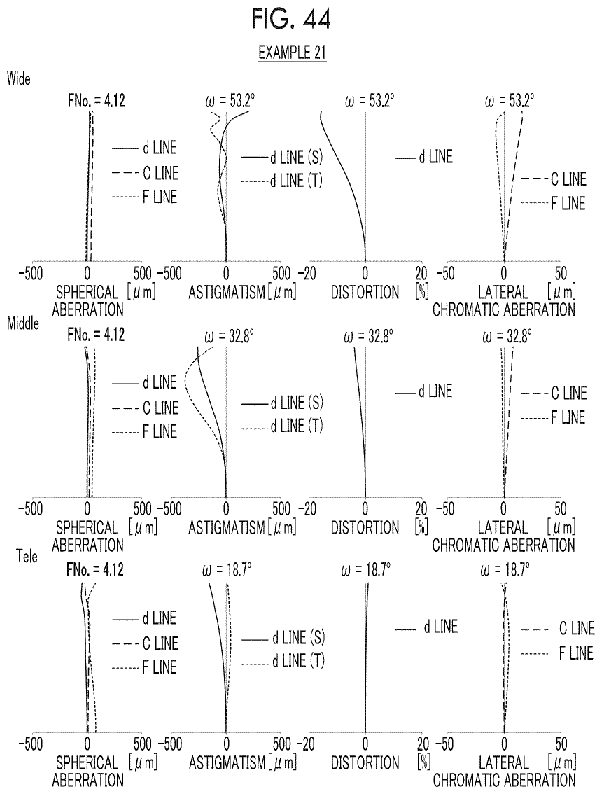

For the variable magnification optical system of Example 21, basic lens data is shown in Table 61, specifications and variable surface spacings are shown in Table 62, aspherical coefficients are shown in Table 63, and each aberration diagram is shown in FIG. 44.

TABLE 61
Example 21

| Sn | R | D | Nd | νd | θg, F | ED |
|---|---|---|---|---|---|---|
| 1 | 76.0207 | 4.2858 | 1.75500 | 52.32 | 0.54757 | 54.60 |
| 2 | 191.6080 | DD[2] | | | | 53.80 |
| *3 | 448.1092 | 1.2049 | 1.61881 | 63.85 | 0.54182 | 47.17 |
| *4 | 18.2690 | 9.6362 | | | | 30.76 |
| 5 | −167.7374 | 0.7815 | 1.49700 | 81.54 | 0.53748 | 29.89 |
| 6 | 23.0676 | 3.3870 | 1.96300 | 24.11 | 0.62126 | 25.25 |
| 7 | 47.7789 | 4.6311 | | | | 24.10 |
| 8 | −25.6758 | 0.6123 | 1.96300 | 24.11 | 0.62126 | 23.88 |
| 9 | −39.8574 | DD[9] | | | | 23.89 |
| 10(St) | ∞ | 0.4364 | | | | 18.47 |
| 11 | 134.5391 | 1.7519 | 1.84666 | 23.78 | 0.62054 | 19.01 |
| 12 | −126.4380 | 0.0500 | | | | 19.31 |
| 13 | 31.6280 | 3.0069 | 1.49700 | 81.54 | 0.53748 | 20.17 |
| 14 | −274.1885 | 1.7764 | | | | 20.21 |
| 15 | −27.6296 | 0.6758 | 1.96300 | 24.11 | 0.62126 | 20.22 |
| 16 | −49.9902 | DD[16] | | | | 20.80 |
| *17 | 30.3603 | 4.8063 | 1.49710 | 81.56 | 0.53848 | 22.17 |
| *18 | −35.2444 | 0.4902 | | | | 22.23 |
| 19 | 52.6992 | 0.5838 | 1.83481 | 42.74 | 0.56490 | 21.13 |
| 20 | 16.3058 | 8.1188 | 1.49700 | 81.54 | 0.53748 | 20.17 |
| *21 | −30.1847 | DD[21] | | | | 20.00 |
| 22 | 173.4277 | 0.5564 | 1.75500 | 52.32 | 0.54757 | 21.71 |
| 23 | 26.2035 | DD[23] | | | | 21.88 |
| 24 | 80.1579 | 4.5003 | 1.96300 | 24.11 | 0.62126 | 28.00 |
| 25 | −70.9568 | DD[25] | | | | 28.47 |
| 26 | −185.6861 | 2.0729 | 1.75520 | 27.51 | 0.61033 | 28.62 |
| 27 | 43.8006 | DD[27] | | | | 29.29 |

TABLE 62
Example 21

| | Wide | Middle | Tele |
|---|---|---|---|
| Zr | 1.0 | 1.8 | 3.3 |
| f | 19.20 | 34.88 | 63.37 |
| Bf | 18.02 | 26.74 | 39.36 |
| FNo. | 4.12 | 4.12 | 4.12 |
| 2ω[°] | 106.4 | 65.6 | 37.4 |
| DD[2] | 0.61 | 16.46 | 28.64 |
| DD[9] | 18.73 | 9.21 | 1.40 |
| DD[16] | 8.99 | 3.07 | 0.10 |
| DD[21] | 4.61 | 1.93 | 3.79 |
| DD[23] | 7.91 | 15.80 | 19.44 |
| DD[25] | 0.42 | 3.61 | 5.84 |
| DD[27] | 18.02 | 26.74 | 39.36 |

TABLE 63
Example 21

| Sn | 3 | 4 | 17 |
|---|---|---|---|
| KA | 1.0000000E+00 | 1.0000000E+00 | 1.0000000E+00 |
| A4 | 5.3160463E−06 | 7.5733231E−08 | −1.4757527E−05 |
| A6 | 1.9676249E−09 | −2.1633658E−08 | −1.3047276E−08 |
| A8 | −9.2359704E−12 | 2.4930244E−10 | −1.1279917E−10 |
| A10 | 9.8562311E−15 | −5.7429509E−13 | 6.7850011E−13 |

| Sn | 18 | 21 |
|---|---|---|
| KA | 1.0000000E+00 | 1.0000000E+00 |
| A4 | 1.3213326E−05 | 1.1076725E−05 |
| A6 | −6.7710737E−08 | 1.2105545E−08 |
| A8 | 6.5056077E−11 | −1.4618463E−10 |
| A10 | 6.2276275E−13 | −8.1288964E−13 |

### Example 22

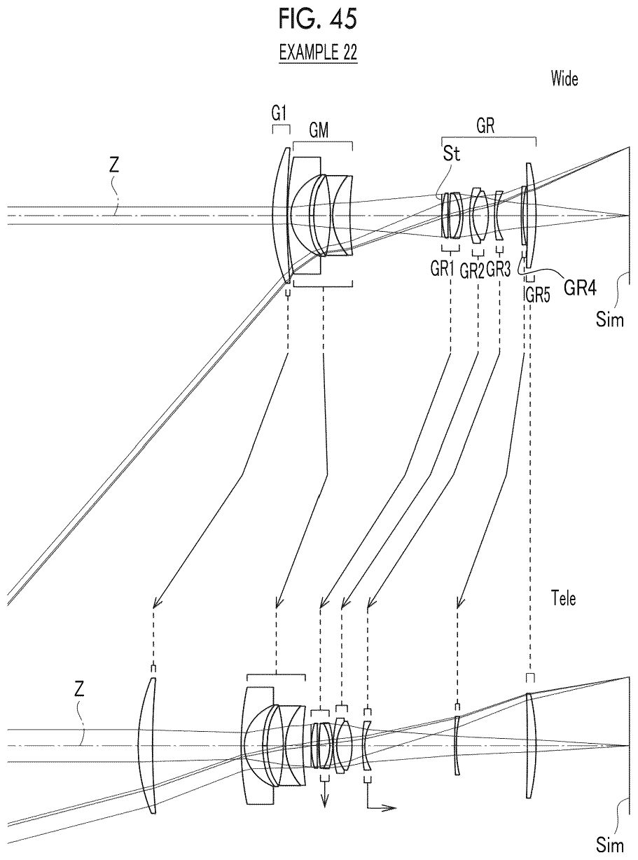

A configuration and a movement trajectory of a variable magnification optical system of Example 22 are shown in FIG. 45. The variable magnification optical system of Example 22 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, a fourth subsequent lens group GR4 having a negative refractive power, and a fifth subsequent lens group GR5 having a positive refractive power. A lens constituting the third subsequent lens group GR3 corresponds to an Lrn lens.

During changing a magnification from a wide angle end to a telephoto end, the fifth subsequent lens group GR5 remains stationary with respect to an image plane Sim, and other lens groups move along an optical axis Z by changing their spacings with respect to their adjacent lens groups. The variable magnification optical system includes only one focusing group. The focusing group consists of the third subsequent lens group GR3. During focusing from an infinite distance object to a close distance object, the third subsequent lens group GR3 moves to the image side, and the other lens groups remain stationary with respect to the image plane Sim. An anti-vibration group consists of a cemented lens of the first subsequent lens group GR1 that is closest to the image side.

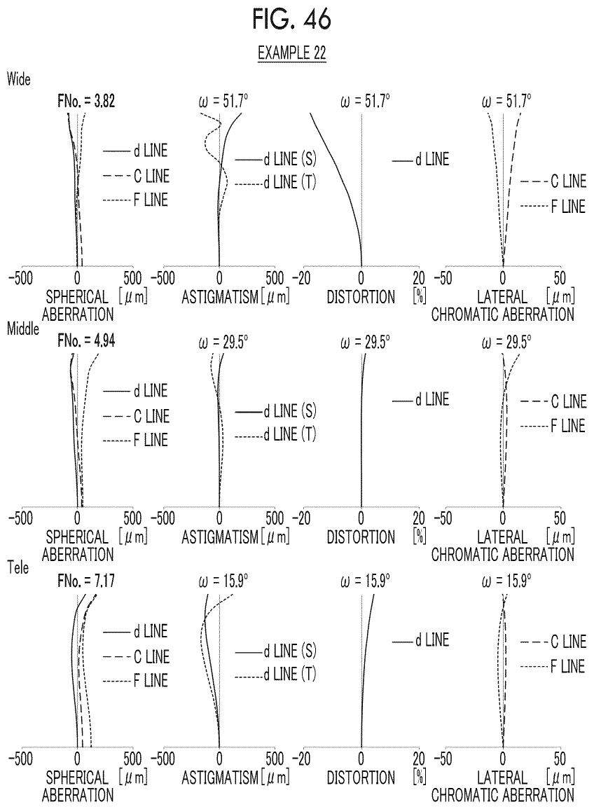

For the variable magnification optical system of Example 22, basic lens data is shown in Table 64, specifications and variable surface spacings are shown in Table 65, aspherical coefficients are shown in Table 66, and each aberration diagram is shown in FIG. 46.

TABLE 64
Example 22

| Sn | R | D | Nd | νd | θg, F | ED |
|---|---|---|---|---|---|---|
| 1 | 61.1438 | 4.1371 | 1.48749 | 70.24 | 0.53007 | 42.60 |
| 2 | 257.2827 | DD[2] | | | | 41.54 |
| 3 | 99.7597 | 0.9235 | 1.77535 | 50.31 | 0.55042 | 36.82 |
| 4 | 14.0304 | 5.2847 | | | | 25.67 |
| *5 | 32.6323 | 1.2827 | 1.49710 | 81.56 | 0.53848 | 25.65 |
| *6 | 30.6180 | 4.6181 | | | | 25.12 |
| 7 | −62.5358 | 0.6524 | 1.49700 | 81.54 | 0.53748 | 25.08 |
| 8 | 20.0936 | 4.9703 | 1.89190 | 37.13 | 0.57813 | 24.90 |
| 9 | 106.2815 | DD[9] | | | | 24.45 |
| 10(St) | ∞ | 0.1000 | | | | 13.45 |
| *11 | 27.8976 | 1.6707 | 1.61881 | 63.85 | 0.54182 | 14.00 |
| *12 | −487.1712 | 0.4381 | | | | 14.09 |
| 13 | 73.2636 | 3.0098 | 1.53775 | 74.70 | 0.53936 | 14.17 |
| 14 | −14.8249 | 0.8502 | 1.88300 | 39.22 | 0.57288 | 14.13 |
| 15 | −25.5136 | DD[15] | | | | 14.40 |
| 16 | 37.4376 | 0.9660 | 1.74100 | 52.68 | 0.54707 | 15.25 |
| 17 | 14.4227 | 4.4194 | 1.43875 | 94.66 | 0.53402 | 15.14 |
| 18 | −22.7392 | DD[18] | | | | 15.33 |
| *19 | 62.7253 | 0.6876 | 1.69304 | 52.93 | 0.54673 | 15.28 |
| *20 | 17.0805 | DD[20] | | | | 15.08 |
| 21 | 161.4957 | 0.4975 | 1.77535 | 50.31 | 0.55042 | 18.29 |
| 22 | 46.8326 | DD[22] | | | | 18.40 |
| 23 | −628.0882 | 2.5002 | 2.00100 | 29.14 | 0.59974 | 32.59 |
| 24 | −84.6140 | 26.8400 | | | | 33.00 |

TABLE 65
Example 22

| | Wide | Middle | Tele |
|---|---|---|---|
| Zr | 1.0 | 1.8 | 3.5 |
| f | 20.77 | 37.73 | 72.69 |
| Bf | 26.84 | 26.84 | 26.84 |
| FNo. | 3.82 | 4.94 | 7.17 |
| 2ω[°] | 103.4 | 59.0 | 31.8 |
| DD[2] | 0.20 | 14.48 | 25.45 |
| DD[9] | 26.39 | 12.13 | 2.35 |
| DD[15] | 1.92 | 1.26 | 0.17 |
| DD[18] | 1.75 | 2.19 | 2.99 |
| DD[20] | 7.01 | 15.18 | 25.79 |
| DD[22] | 1.25 | 6.38 | 20.42 |

TABLE 66
Example 22

| Sn | 5 | 6 | 11 |
|---|---|---|---|
| KA | 1.0000000E+00 | 1.0000000E+00 | 1.0000000E+00 |
| A4 | −3.9661073E−05 | −4.3719864E−05 | 3.6466539E−06 |
| A6 | 6.0603790E−07 | 6.6722179E−07 | −1.3908708E−07 |
| A8 | −2.4542299E−10 | −2.0924920E−10 | 3.2055460E−09 |
| A10 | −5.2215719E−12 | −9.3157048E−12 | 1.8209768E−11 |
| Sn | 12 | 19 | 20 |
| KA | 1.0000000E+00 | 1.0000000E+00 | 1.0000000E+00 |
| A4 | 3.9666709E−05 | 3.5978388E−05 | 3.5367376E−05 |
| A6 | −8.2588223E−08 | −3.7182793E−07 | −5.6856473E−07 |
| A8 | 1.1128171E−09 | −6.4846676E−09 | −1.5590427E−09 |
| A10 | 3.4019677E−11 | 1.0598250E−10 | 5.2445903E−11 |

### Example 23

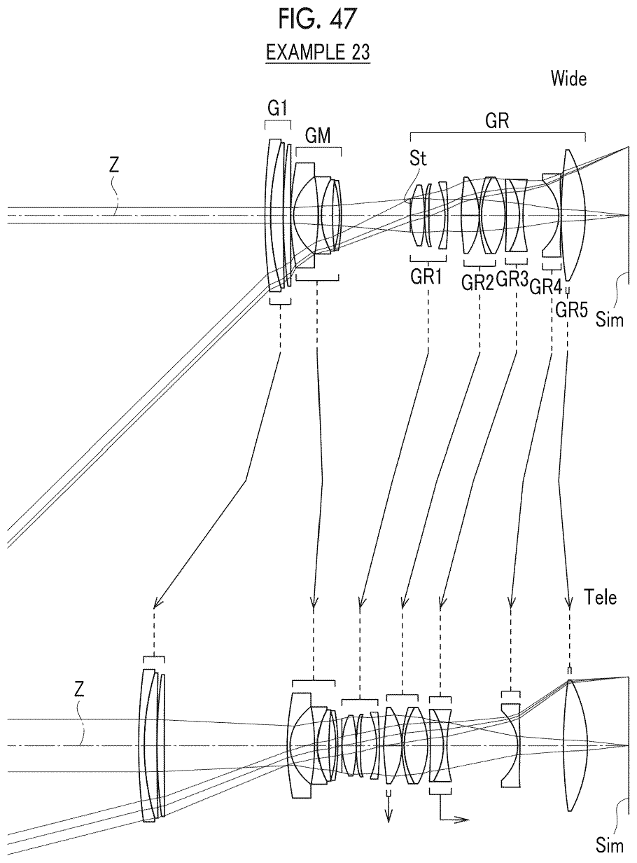

A configuration and a movement trajectory of a variable magnification optical system of Example 23 are shown in FIG. 47. The variable magnification optical system of Example 23 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, a fourth subsequent lens group GR4 having a negative refractive power, and a fifth subsequent lens group GR5 having a positive refractive power. A lens constituting the fourth subsequent lens group GR4 corresponds to an Lrn lens.

During changing a magnification from a wide angle end to a telephoto end, all lens groups move while changing spacings between adjacent lens groups. The variable magnification optical system includes only one focusing group. The focusing group consists of the third subsequent lens group GR3. During focusing from an infinite distance object to a close distance object, the third subsequent lens group GR3 moves to the image side, and the other lens groups remain stationary with respect to the image plane Sim. An anti-vibration group consists of one lens of the second subsequent lens group GR2 that is closest to the object side.

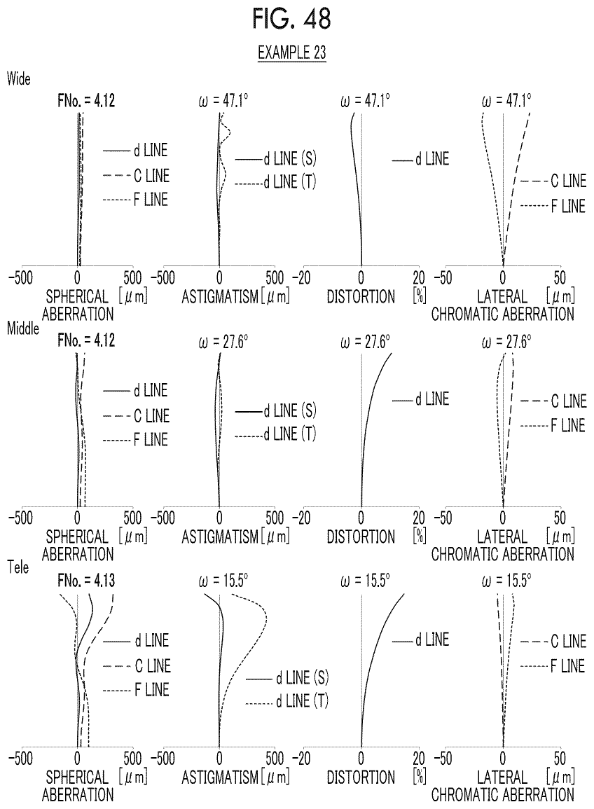

For the variable magnification optical system of Example 23, basic lens data is shown in Table 67, specifications and variable surface spacings are shown in Table 68, aspherical coefficients are shown in Table 69, and each aberration diagram is shown in FIG. 48.

TABLE 67
Example 23

| Sn | R | D | Nd | νd | θg, F | ED |
|---|---|---|---|---|---|---|
| 1 | 207.8680 | 1.6000 | 1.84666 | 23.78 | 0.62054 | 48.00 |
| 2 | 87.9758 | 3.6411 | 1.77250 | 49.60 | 0.55212 | 45.70 |
| 3 | 856.5046 | 0.0500 | | | | 45.33 |
| 4 | 191.0440 | 2.0714 | 1.80400 | 46.53 | 0.55775 | 44.60 |
| 5 | 3097.1764 | DD[5] | | | | 44.27 |
| *6 | 72.2159 | 0.8410 | 1.61881 | 63.85 | 0.54182 | 33.06 |
| *7 | 14.3566 | 7.0320 | | | | 24.40 |
| 8 | −78.1007 | 0.8100 | 1.52841 | 76.45 | 0.53954 | 24.31 |
| 9 | 25.5488 | 3.1789 | 1.84666 | 23.78 | 0.62054 | 22.46 |
| 10 | 110.7334 | 1.9857 | | | | 21.88 |
| 11 | −40.9400 | 0.5663 | 1.75520 | 27.53 | 0.60994 | 21.92 |
| 12 | −73.8880 | DD[12] | | | | 21.71 |
| 13(St) | ∞ | 0.0501 | | | | 16.95 |
| 14 | 24.1924 | 4.0606 | 1.43875 | 94.66 | 0.53402 | 18.77 |
| 15 | −48.9521 | 0.0501 | | | | 19.13 |
| *16 | 61.6193 | 1.2235 | 1.49710 | 81.56 | 0.53848 | 19.65 |
| *17 | 718.1352 | 4.6161 | | | | 19.55 |
| 18 | −29.3213 | 0.8000 | 1.89190 | 37.13 | 0.57813 | 20.05 |
| 19 | −124.9866 | DD[19] | | | | 21.02 |
| *20 | 52.9603 | 5.2146 | 1.49710 | 81.56 | 0.53848 | 23.36 |
| *21 | −23.5404 | 0.0500 | | | | 23.88 |
| 22 | 41.1613 | 0.6115 | 1.86997 | 38.50 | 0.57493 | 24.00 |
| 23 | 25.7175 | 6.7598 | 1.43875 | 94.66 | 0.53402 | 23.81 |
| 24 | −27.2397 | DD[24] | | | | 23.99 |
| 25 | −257.4784 | 3.7702 | 1.88300 | 39.22 | 0.57288 | 22.74 |
| 26 | −23.5407 | 1.0100 | 1.74320 | 49.34 | 0.55312 | 22.66 |
| 27 | 49.6082 | DD[27] | | | | 21.89 |
| *28 | −14.8307 | 0.6724 | 1.74320 | 49.29 | 0.55303 | 22.03 |
| *29 | −94.6147 | DD[29] | | | | 26.21 |
| 30 | 156.8679 | 6.9060 | 1.88300 | 39.22 | 0.57288 | 40.80 |
| 31 | −47.8358 | DD[31] | | | | 41.25 |

TABLE 68
Example 23

| | Wide | Middle | Tele |
|---|---|---|---|
| Zr | 1.0 | 1.8 | 3.3 |
| f | 20.62 | 37.46 | 68.04 |
| Bf | 12.52 | 15.06 | 11.92 |
| FNo. | 4.12 | 4.12 | 4.13 |
| 2ω[°] | 94.2 | 55.2 | 31.0 |
| DD[5] | 0.05 | 11.37 | 35.35 |
| DD[12] | 19.81 | 8.13 | 1.17 |
| DD[19] | 3.83 | 1.82 | 1.25 |
| DD[24] | 0.38 | 0.35 | 0.76 |
| DD[27] | 10.30 | 14.41 | 20.35 |
| DD[29] | 0.05 | 5.76 | 12.49 |
| DD[31] | 12.52 | 15.06 | 11.92 |

TABLE 69
Example 23

| Sn | 6 | 7 | 17 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | −4.3584045E−06 | −1.5554544E−05 | 1.5717549E−05 |
| A5 | −6.3590801E−07 | −1.4915720E−07 | 4.1119613E−07 |
| A6 | 1.6823201E−08 | −2.1164027E−08 | 3.3439024E−08 |
| A7 | 4.6532203E−09 | −2.3397311E−08 | 2.8432162E−08 |
| A8 | 2.2122236E−11 | 1.0491008E−09 | 3.9239985E−09 |
| A9 | −5.9173865E−12 | 3.7071166E−10 | −8.3557121E−10 |
| A10 | −1.8569754E−12 | −3.6180483E−11 | 1.3881557E−10 |
| A11 | 2.6521208E−14 | 1.0651417E−12 | −9.0736525E−12 |
| A12 | 1.7400295E−15 | 1.1365156E−14 | 2.0521568E−13 |
| A13 | 2.8737479E−16 | −1.5922541E−14 | −4.4782720E−14 |
| A14 | −1.8396289E−17 | 8.2935856E−16 | −3.1732981E−15 |
| A15 | 1.1207498E−18 | 1.4365769E−18 | 9.9062405E−16 |
| A16 | −8.2993721E−21 | 3.4395447E−18 | −3.2814770E−18 |
| A17 | −1.6256881E−21 | −1.8137193E−19 | 5.4465802E−18 |
| A18 | −1.4414198E−22 | −2.1026388E−21 | −1.1014540E−18 |
| A19 | 5.4502475E−24 | −3.0942888E−22 | −2.8954070E−21 |
| A20 | 1.0308029E−25 | 1.5048144E−23 | 3.2515777E−21 |
| Sn | 16 | 20 | 21 |
| KA | 1.0000000E+00 | 1.0000000E+00 | 1.0000000E+00 |
| A4 | −1.0306125E−06 | −3.1206869E−05 | 2.0729742E−06 |
| A6 | 1.5737822E−07 | 4.1263194E−08 | −2.2777565E−08 |
| A8 | 2.4878066E−09 | −1.8516973E−12 | 1.8649989E−10 |
| A10 | 0.0000000E+00 | −1.5623589E−13 | −6.5590187E−13 |

| Sn | 28 | 29 |
|---|---|---|
| KA | 1.0000000E+00 | 1.0000000E+00 |
| A4 | 3.4067338E−06 | 2.6370638E−05 |
| A6 | 6.4993227E−08 | 6.7701188E−08 |
| A8 | 1.3685719E−10 | −3.3321623E−10 |
| A10 | 1.2011025E−12 | 5.1943687E−13 |

### Example 24

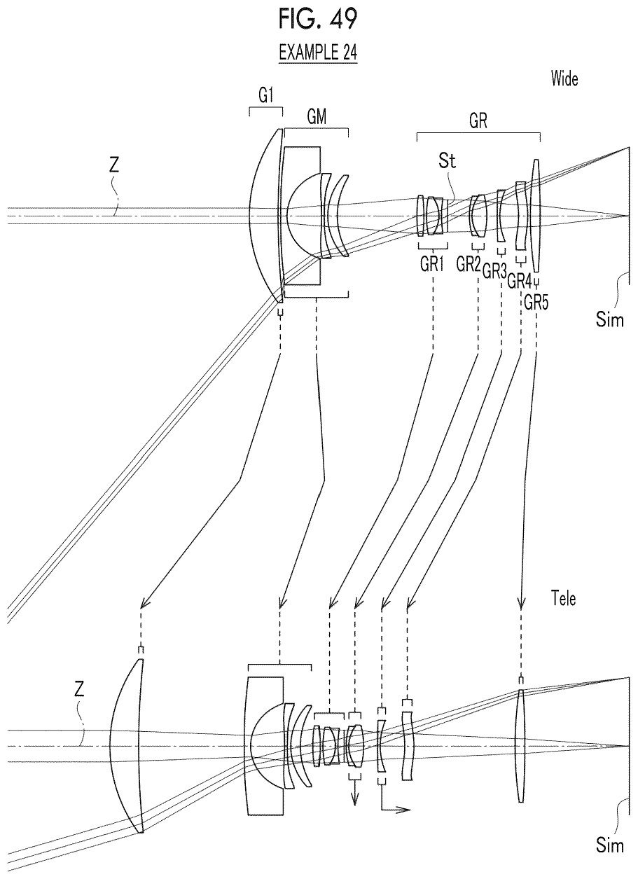

A configuration and a movement trajectory of a variable magnification optical system of Example 24 are shown in FIG. 49. The variable magnification optical system of Example 24 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, a fourth subsequent lens group GR4 having a negative refractive power, and a fifth subsequent lens group GR5 having a positive refractive power. A lens of the intermediate group GM that is closest to the object side and a second lens from the object side of the intermediate group GM correspond to an Lmn lens. A lens constituting the fourth subsequent lens group GR4 corresponds to an Lrn lens.

During changing a magnification from a wide angle end to a telephoto end, all lens groups move while changing spacings between adjacent lens groups. The variable magnification optical system includes only one focusing group. The focusing group consists of the third subsequent lens group GR3. During focusing from an infinite distance object to a close distance object, the third subsequent lens group GR3 moves to the image side, and the other lens groups remain stationary with respect to the image plane Sim. An anti-vibration group consists of the second subsequent lens group GR2.

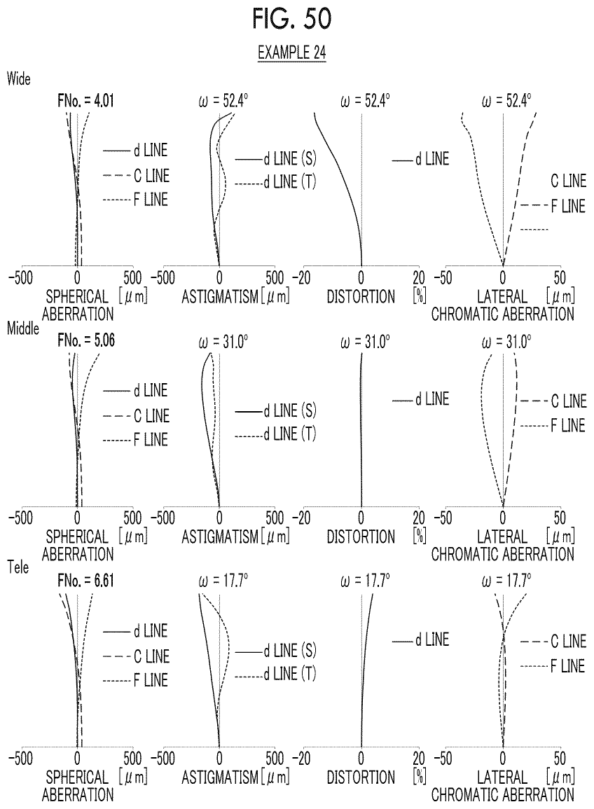

For the variable magnification optical system of Example 24, basic lens data is shown in Table 70, specifications and variable surface spacings are shown in Table 71, aspherical coefficients are shown in Table 72, and each aberration diagram is shown in FIG. 50.

TABLE 70
Example 24

| Sn | R | D | Nd | νd | θg, F | ED |
|---|---|---|---|---|---|---|
| 1 | 49.2270 | 8.2585 | 1.48749 | 70.24 | 0.53007 | 54.60 |
| 2 | 277.7020 | DD[2] | | | | 53.52 |
| *3 | 667.8318 | 1.8095 | 1.74320 | 49.29 | 0.55303 | 43.40 |
| *4 | 14.7352 | 9.7934 | | | | 26.86 |
| *5 | −67.2285 | 0.7502 | 1.49710 | 81.56 | 0.53848 | 26.69 |
| *6 | 105.0368 | 0.9998 | | | | 26.00 |
| 7 | 19.8994 | 2.7498 | 2.00272 | 19.32 | 0.64514 | 25.51 |
| 8 | 25.1133 | DD[8] | | | | 24.42 |
| *9 | 52.3454 | 1.9998 | 1.80610 | 40.73 | 0.56940 | 12.80 |
| *10 | −59.6963 | 0.7498 | | | | 12.59 |
| 11 | 31.3632 | 3.5801 | 1.64000 | 60.08 | 0.53704 | 11.86 |
| 12 | −10.8545 | 0.7498 | 1.76200 | 40.10 | 0.57655 | 11.28 |
| 13 | 40.1017 | 1.7498 | | | | 10.54 |
| 14(St) | ∞ | DD[14] | | | | 10.14 |
| 15 | 23.4735 | 0.7499 | 1.78590 | 44.20 | 0.56317 | 12.00 |
| 16 | 11.1940 | 4.2602 | 1.55200 | 70.70 | 0.54219 | 12.38 |
| 17 | −28.0483 | DD[17] | | | | 13.20 |
| 18 | 289.0155 | 0.7499 | 1.48749 | 70.24 | 0.53007 | 15.58 |
| 19 | 22.2741 | DD[19] | | | | 16.20 |
| *20 | −30.7815 | 2.6310 | 2.00178 | 19.32 | 0.64480 | 19.30 |
| *21 | −32.9764 | DD[21] | | | | 20.11 |
| 22 | 132.9670 | 2.8014 | 1.95375 | 32.32 | 0.59056 | 35.19 |
| 23 | −293.8352 | DD[23] | | | | 35.40 |

TABLE 71
Example 24

| | Wide | Middle | Tele |
|---|---|---|---|
| Zr | 1.0 | 1.8 | 3.3 |
| f | 19.95 | 35.90 | 65.23 |
| Bf | 25.63 | 28.89 | 30.02 |
| FNo. | 4.01 | 5.06 | 6.61 |
| 2ω[°] | 104.8 | 62.0 | 35.4 |
| DD[2] | 0.75 | 14.65 | 30.36 |
| DD[8] | 22.87 | 10.36 | 3.59 |
| DD[14] | 6.25 | 2.24 | 0.60 |
| DD[17] | 3.00 | 3.93 | 4.02 |
| DD[19] | 5.36 | 5.65 | 7.05 |
| DD[21] | 0.77 | 10.56 | 29.08 |
| DD[23] | 25.63 | 28.89 | 30.02 |

TABLE 72
Example 24

| Sn | 3 | 4 | 5 | 6 |
|---|---|---|---|---|
| KA | 1.0000000E+00 | 1.0000000E+00 | 1.0000000E+00 | 1.0000000E+00 |
| A4 | 1.2689178E−05 | 3.6086998E−06 | 4.1528824E−05 | 5.2031686E−05 |
| A6 | −3.6420388E−08 | 7.1579957E−08 | 1.1182172E−07 | 9.8991440E−08 |
| A8 | 4.6935716E−11 | −2.4853983E−10 | −2.8600463E−10 | −6.6311823E−10 |
| A10 | −2.3650662E−14 | 2.2746408E−12 | −9.4149103E−13 | −1.8704811E−12 |

| Sn | 9 | 10 |
|---|---|---|
| KA | 1.0000000E+00 | 1.0000000E+00 |
| A4 | 9.6129157E−06 | 1.1520220E−06 |
| A6 | 7.0960557E−07 | 5.5876811E−07 |
| A8 | −7.2337463E−09 | −6.0935454E−09 |
| A10 | 9.8083065E−11 | 7.6132408E−11 |
| Sn | 20 | 21 |
| KA | 1.0000000E+00 | 1.0000000E+00 |
| A3 | 0.0000000E+00 | 0.0000000E+00 |
| A4 | 5.1198509E−05 | 4.2469571E−05 |
| A5 | 3.2683714E−06 | 3.0034094E−06 |
| A6 | −8.9838872E−09 | −5.8607179E−08 |
| A7 | −2.1597955E−08 | −2.8693610E−08 |
| A8 | −2.5145992E−09 | 2.9747742E−09 |
| A9 | 1.1292745E−09 | 4.4128220E−10 |
| A10 | −1.0927335E−11 | −5.2252440E−11 |
| A11 | −2.4301298E−12 | −3.7832445E−13 |
| A12 | 3.7518325E−13 | 9.5575343E−13 |
| A13 | −8.4750702E−14 | −6.2534193E−14 |
| A14 | −5.9003684E−17 | −2.7462513E−15 |
| A15 | 7.2769137E−16 | 1.6725981E−16 |
| A16 | −1.4375704E−16 | −3.5910439E−17 |
| A17 | 6.3857727E−18 | 2.0756011E−18 |
| A18 | 1.0281432E−18 | 3.8218017E−19 |
| A19 | 7.7057070E−21 | −4.8271543E−21 |
| A20 | −6.5205077E−21 | −1.3088657E−21 |

### Example 25

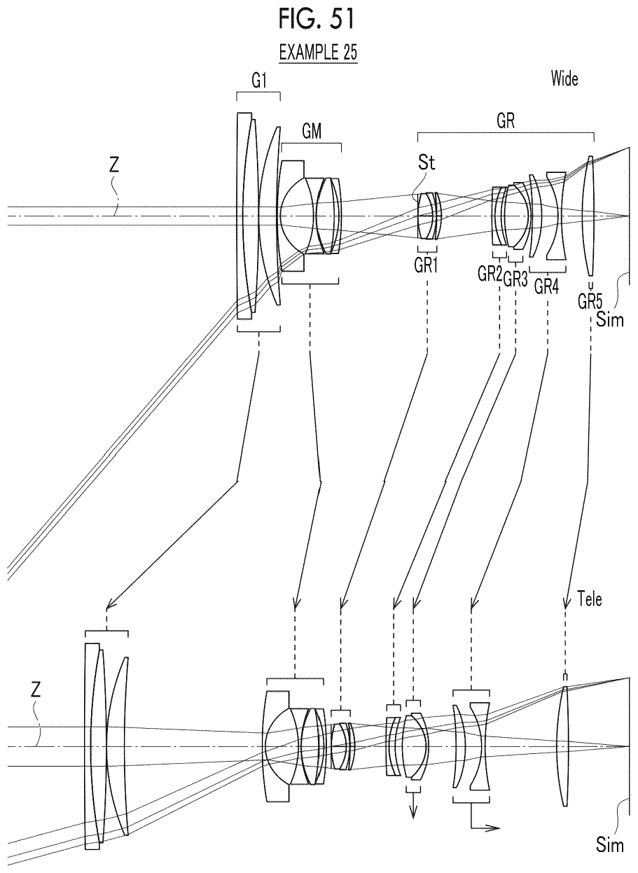

A configuration and a movement trajectory of a variable magnification optical system of Example 25 are shown in FIG. 51. The variable magnification optical system of Example 25 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a positive refractive power, a fourth subsequent lens group GR4 having a negative refractive power, and a fifth subsequent lens group GR5 having a positive refractive power.

During changing a magnification from a wide angle end to a telephoto end, all lens groups move while changing spacings between adjacent lens groups. The variable magnification optical system includes only one focusing group. The focusing group consists of the fourth subsequent lens group GR4. During focusing from an infinite distance object to a close distance object, the fourth subsequent lens group GR4 moves to the image side, and the other lens groups remain stationary with respect to the image plane Sim. An anti-vibration group consists of the third subsequent lens group GR3.

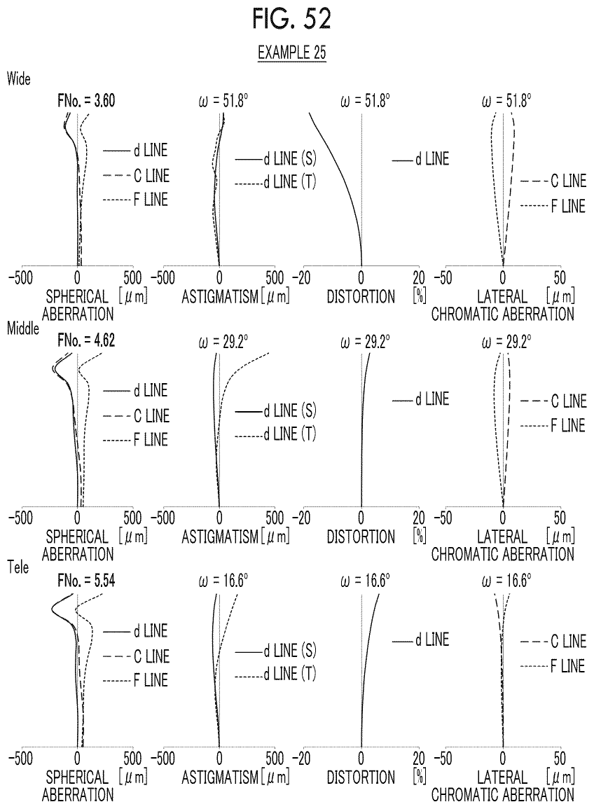

For the variable magnification optical system of Example 25, basic lens data is shown in Table 73, specifications and variable surface spacings are shown in Table 74, aspherical coefficients are shown in Table 75, and each aberration diagram is shown in FIG. 52.

TABLE 73
Example 25

| Sn | R | D | Nd | νd | θg, F | ED |
|---|---|---|---|---|---|---|
| 1 | 2502.2265 | 1.7501 | 1.80000 | 29.84 | 0.60178 | 64.78 |
| 2 | 184.1182 | 4.5356 | 1.49700 | 81.54 | 0.53748 | 60.67 |
| 3 | −448.6005 | 0.0498 | | | | 59.77 |
| 4 | 77.2082 | 5.1062 | 1.72916 | 54.68 | 0.54451 | 56.00 |
| 5 | 358.0913 | DD[5] | | | | 55.43 |
| *6 | 159.1144 | 0.8754 | 1.76450 | 49.10 | 0.55289 | 34.75 |
| *7 | 14.2544 | 9.5087 | | | | 24.00 |
| 8 | −31.1667 | 0.7498 | 1.53775 | 74.70 | 0.53936 | 23.77 |
| 9 | 33.4413 | 0.0553 | | | | 23.64 |
| 10 | 27.9923 | 4.9837 | 1.90525 | 35.04 | 0.58486 | 23.90 |
| 11 | −67.7578 | 1.3547 | | | | 23.62 |
| 12 | −30.6289 | 0.7294 | 1.55200 | 70.70 | 0.54219 | 23.59 |
| 13 | −82.3451 | DD[13] | | | | 23.23 |
| 14(St) | ∞ | 0.0500 | | | | 13.77 |
| *15 | 24.6010 | 4.2656 | 1.43875 | 94.66 | 0.53402 | 14.07 |
| 16 | −14.1622 | 1.0069 | 1.83400 | 37.21 | 0.58082 | 14.13 |
| 17 | −24.1518 | 0.1185 | | | | 14.62 |
| *18 | −67.5880 | 1.3436 | 1.43875 | 94.66 | 0.53402 | 14.60 |
| *19 | −21.6509 | DD[19] | | | | 14.77 |
| 20 | 173.1018 | 0.8851 | 1.88300 | 39.22 | 0.57288 | 18.00 |
| 21 | 22.9357 | 1.7577 | 1.95906 | 17.47 | 0.65993 | 18.19 |
| 22 | 27.5347 | DD[22] | | | | 18.25 |
| 23 | 39.8453 | 6.8332 | 1.64000 | 60.08 | 0.53704 | 18.80 |
| 24 | −13.3047 | 0.7498 | 1.95375 | 32.32 | 0.59056 | 19.36 |
| 25 | −24.5743 | DD[25] | | | | 21.00 |
| *26 | −121.9117 | 2.6727 | 1.95150 | 29.83 | 0.59560 | 25.59 |
| *27 | −37.3192 | 4.6680 | | | | 25.85 |
| 28 | −24.9433 | 1.0001 | 1.83481 | 42.74 | 0.56490 | 24.64 |
| 29 | 75.1156 | DD[29] | | | | 27.49 |
| 30 | 89.2115 | 3.3962 | 1.75520 | 27.51 | 0.61033 | 37.39 |
| 31 | −420.8481 | DD[31] | | | | 37.60 |

TABLE 74
Example 25

| | Wide | Middle | Tele |
|---|---|---|---|
| Zr | 1.0 | 1.8 | 3.3 |
| f | 20.77 | 37.72 | 68.53 |
| Bf | 10.19 | 11.10 | 17.52 |
| FNo. | 3.60 | 4.62 | 5.54 |
| 2ω[°] | 103.6 | 58.4 | 33.2 |
| DD[5] | 0.24 | 9.41 | 39.63 |
| DD[13] | 21.93 | 6.64 | 1.38 |
| DD[19] | 14.52 | 11.30 | 8.94 |
| DD[22] | 1.00 | 1.04 | 2.05 |
| DD[25] | 0.43 | 8.37 | 7.87 |
| DD[29] | 5.94 | 12.72 | 20.56 |
| DD[31] | 10.19 | 11.10 | 17.52 |

TABLE 75
Example 25

| Sn | 6 | 7 | 18 | 19 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 2.1893587E−05 | 1.4673486E−05 | −1.7310712E−05 | −7.5850211E−06 |
| A5 | −1.0324725E−06 | 5.5889985E−07 | 2.4962963E−06 | 1.2331155E−06 |
| A6 | −7.7366537E−08 | −4.7358010E−07 | −1.0690947E−07 | −5.7821004E−08 |
| A7 | 2.4327663E−09 | 1.1476560E−07 | 1.1695852E−08 | 7.2135649E−09 |
| A8 | 2.9805677E−10 | −1.4674865E−08 | −1.0261609E−09 | −2.5704661E−09 |
| A9 | 1.4022189E−12 | −2.0356424E−10 | 2.0616115E−10 | 4.0576032E−11 |
| A10 | −5.9458919E−13 | 2.1665568E−10 | −7.7405032E−12 | 3.0991903E−11 |
| A11 | −1.5136819E−14 | −8.6242187E−12 | 1.0058073E−12 | 6.3076656E−12 |
| A12 | −1.6652893E−16 | −7.4241798E−13 | 2.4783422E−13 | −2.3887724E−13 |
| A13 | 2.8985790E−17 | −6.0223523E−14 | 5.4013364E−14 | 5.2157968E−14 |
| A14 | −3.4379700E−19 | 1.0061054E−14 | 4.4109179E−15 | 2.7146405E−15 |
| A15 | 4.7258600E−20 | 2.0058934E−16 | 4.5823697E−16 | −9.0476805E−16 |
| A16 | 1.5891509E−21 | −1.1513518E−17 | 1.2175948E−17 | 4.2769773E−17 |
| A17 | 8.6267065E−23 | −1.6218121E−18 | −1.2471674E−19 | 2.4755976E−17 |
| A18 | −2.7123089E−24 | −7.0650027E−20 | −3.1048116E−18 | −2.7253399E−18 |
| A19 | −1.4613504E−25 | 4.2100468E−21 | −1.1261740E−19 | −4.4121269E−19 |
| A20 | −5.1129054E−27 | 1.9395439E−22 | −7.6361009E−20 | −4.8006557E−20 |

| Sn | 15 | 26 | 27 |
|---|---|---|---|
| KA | 1.0000000E+00 | 1.0000000E+00 | 1.0000000E+00 |
| A4 | −2.5335747E−05 | −8.3855328E−06 | −9.8921963E−06 |
| A6 | −1.7274959E−07 | 9.9511008E−09 | 4.5988950E−09 |
| A8 | 1.3533311E−10 | 1.0608874E−11 | −1.2047215E−11 |
| A10 | 2.1159035E−11 | −2.0880902E−13 | −1.2187817E−13 |

### Example 26

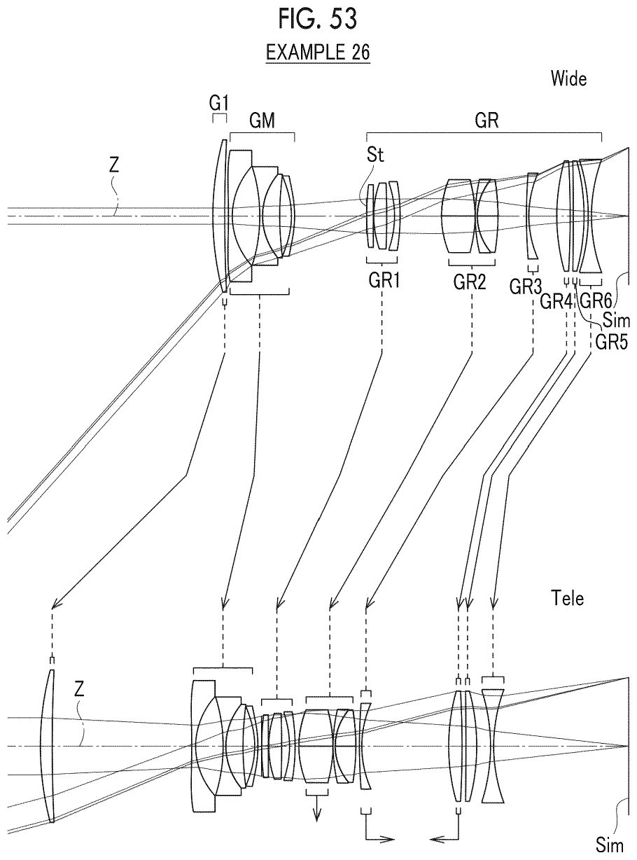

A configuration and a movement trajectory of a variable magnification optical system of Example 26 are shown in FIG. 53. The variable magnification optical system of Example 26 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, a fourth subsequent lens group GR4 having a positive refractive power, a fifth subsequent lens group GR5 having a positive refractive power, and a sixth subsequent lens group GR6 having a negative refractive power. A lens of the intermediate group GM that is closest to the object side corresponds to an Lmn lens.

During changing a magnification from a wide angle end to a telephoto end, all lens groups move while changing spacings between adjacent lens groups. The variable magnification optical system includes two focusing groups. A focusing group on the object side consists of the third subsequent lens group GR3, and a focusing group on the image side consists of the fourth subsequent lens group GR4. During focusing from an infinite distance object to a close distance object, the third subsequent lens group GR3 moves to the image side, the fourth subsequent lens group GR4 moves to the object side, and other lens groups remain stationary with respect to an image plane Sim. An anti-vibration group consists of one lens of the second subsequent lens group GR2 that is closest to the object side.

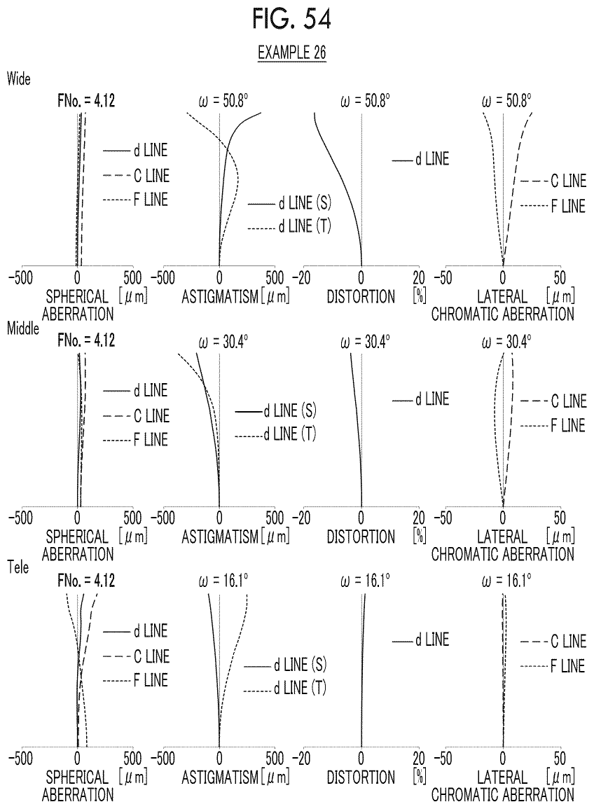

For the variable magnification optical system of Example 26, basic lens data is shown in Table 76, specifications and variable surface spacings are shown in Table 77, aspherical coefficients are shown in Table 78, and each aberration diagram is shown in FIG. 54.

TABLE 76
Example 26

| Sn | R | D | Nd | νd | θg, F | ED |
|---|---|---|---|---|---|---|
| 1 | 102.3723 | 3.4054 | 1.75500 | 52.32 | 0.54757 | 48.00 |
| 2 | 535.5332 | DD[2] | | | | 47.53 |
| *3 | −242.0063 | 1.1197 | 1.76450 | 49.10 | 0.55289 | 41.37 |
| 4 | 24.6698 | 7.9064 | | | | 31.23 |
| 5 | −56.1327 | 0.8056 | 1.48749 | 70.24 | 0.53007 | 30.98 |
| 6 | 21.9129 | 4.9189 | 1.90366 | 31.34 | 0.59636 | 26.33 |
| 7 | 104.2389 | 3.3656 | | | | 25.29 |
| *8 | −29.5398 | 0.9200 | 1.95150 | 29.83 | 0.59560 | 25.26 |
| *9 | −40.2550 | DD[9] | | | | 24.97 |
| 10(St) | ∞ | 0.0498 | | | | 18.89 |
| 11 | 88.8481 | 1.9143 | 1.77250 | 49.60 | 0.55212 | 19.31 |
| 12 | −14160.5641 | 0.1283 | | | | 19.71 |
| 13 | 34.3374 | 3.7020 | 1.59522 | 67.73 | 0.54426 | 20.60 |
| 14 | −314.5969 | 2.2580 | | | | 20.73 |
| 15 | −34.6210 | 1.6053 | 1.90525 | 35.04 | 0.58486 | 20.79 |
| 16 | −69.9999 | DD[16] | | | | 21.61 |
| *17 | 31.6103 | 9.6538 | 1.49710 | 81.56 | 0.53848 | 22.97 |
| *18 | −39.9427 | 0.0498 | | | | 22.80 |
| 19 | 54.8279 | 0.5897 | 1.88300 | 39.22 | 0.57288 | 23.13 |
| 20 | 18.7314 | 5.9418 | 1.52841 | 76.45 | 0.53954 | 22.58 |
| *21 | −70.4221 | DD[21] | | | | 22.80 |
| 22 | 191.4293 | 0.6941 | 1.80400 | 46.53 | 0.55775 | 26.65 |
| 23 | 36.0111 | DD[23] | | | | 26.98 |
| 24 | 69.7950 | 3.8402 | 1.88300 | 39.22 | 0.57288 | 34.74 |
| 25 | −346.2470 | DD[25] | | | | 34.73 |
| 26 | −1195.9754 | 3.0921 | 2.00330 | 28.27 | 0.59802 | 34.60 |
| 27 | −73.0085 | DD[27] | | | | 34.70 |
| 28 | −62.6488 | 0.9094 | 1.75500 | 52.32 | 0.54757 | 34.58 |
| 29 | 55.4675 | DD[29] | | | | 35.66 |

TABLE 77
Example 26

| | Wide | Middle | Tele |
|---|---|---|---|
| Zr | 1.0 | 1.8 | 3.5 |
| f | 21.11 | 38.36 | 73.90 |
| Bf | 10.73 | 34.22 | 38.85 |
| FNo. | 4.12 | 4.12 | 4.12 |
| 2ω[°] | 101.6 | 60.8 | 32.2 |
| DD[2] | 1.07 | 10.52 | 40.15 |
| DD[9] | 20.53 | 9.98 | 1.03 |
| DD[16] | 11.92 | 5.21 | 1.09 |
| DD[21] | 8.19 | 1.15 | 1.03 |
| DD[23] | 8.03 | 10.11 | 24.98 |
| DD[25] | 0.91 | 0.92 | 1.14 |
| DD[27] | 1.21 | 1.54 | 3.97 |
| DD[29] | 10.73 | 34.22 | 38.85 |

TABLE 78
Example 26

| Sn | 3 | 8 | 9 |
|---|---|---|---|
| KA | 1.0000000E+00 | 1.0000000E+00 | 1.0000000E+00 |
| A4 | 7.4953149E−06 | −5.2129624E−06 | 1.5954230E−06 |
| A6 | −4.2414570E−10 | 1.5693261E−07 | 1.5626888E−07 |
| A8 | −1.3230837E−12 | −3.7773815E−10 | −3.6838064E−10 |
| A10 | 5.5800000E−15 | 0.0000000E+00 | −6.6500000E−14 |
| Sn | 17 | 18 | 21 |
| KA | 1.0000000E+00 | 1.0000000E+00 | 1.0000000E+00 |
| A4 | −8.5296176E−06 | 1.1006336E−05 | 5.0646575E−06 |
| A6 | 2.6100803E−08 | 8.5818126E−09 | 7.7533751E−09 |
| A8 | 4.4595687E−11 | 1.0567471E−10 | −1.1756567E−10 |
| A10 | 4.5700000E−14 | 0.0000000E+00 | 5.5700000E−13 |

### Example 27

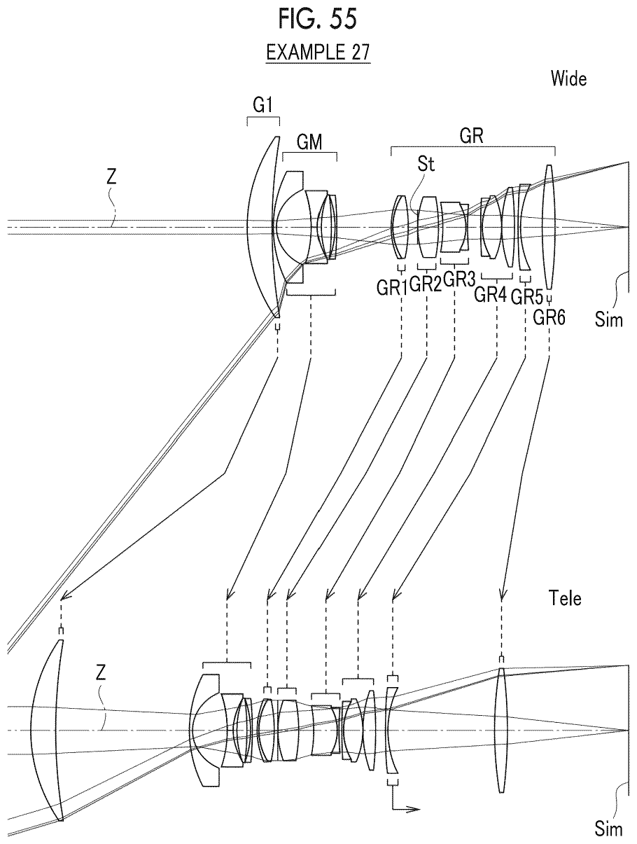

A configuration and a movement trajectory of a variable magnification optical system of Example 27 are shown in FIG. 55. The variable magnification optical system of Example 27 consists of, in order from an object side to an image side, a first lens group G1 having a positive refractive power, an intermediate group GM, and a subsequent group GR. The intermediate group GM consists of one lens group that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, a fourth subsequent lens group GR4 having a positive refractive power, a fifth subsequent lens group GR5 having a negative refractive power, and a sixth subsequent lens group GR6 having a positive refractive power.

During changing a magnification from a wide angle end to a telephoto end, all lens groups move while changing spacings between adjacent lens groups. The variable magnification optical system includes only one focusing group. The focusing group consists of the fifth subsequent lens group GR5. During focusing from an infinite distance object to a close distance object, the fifth subsequent lens group GR5 moves to the image side, and the other lens groups remain stationary with respect to an image plane Sim.

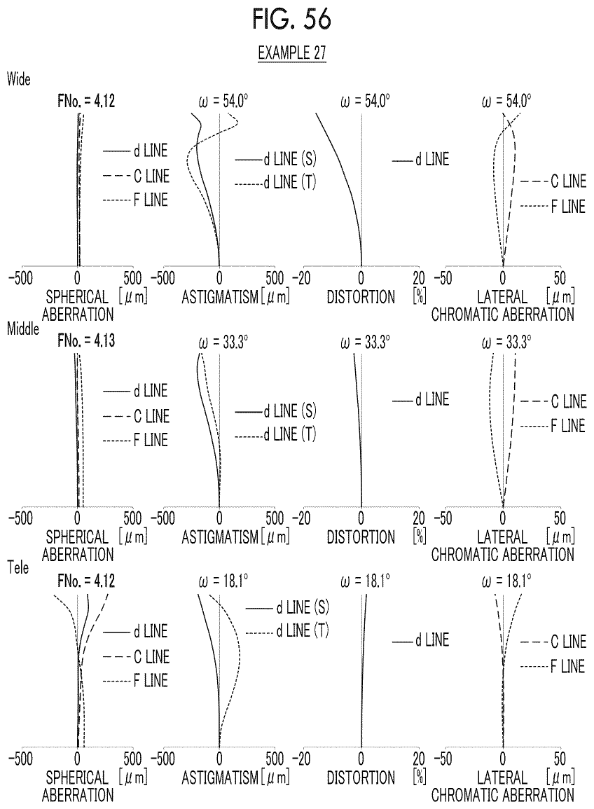

For the variable magnification optical system of Example 27, basic lens data is shown in Table 79, specifications and variable surface spacings are shown in Table 80, aspherical coefficients are shown in Table 81, and each aberration diagram is shown in FIG. 56.

TABLE 79
Example 27

| Sn | R | D | Nd | νd | θg, F | ED |
|---|---|---|---|---|---|---|
| 1 | 56.6875 | 7.5488 | 1.51680 | 64.20 | 0.53430 | 60.00 |
| 2 | 194.0474 | DD[2] | | | | 59.08 |
| 3 | 44.0369 | 0.9522 | 1.80400 | 46.53 | 0.55775 | 37.07 |
| 4 | 13.7377 | 10.5031 | | | | 25.00 |
| *5 | −45.5706 | 1.8186 | 1.49710 | 81.56 | 0.53848 | 24.18 |
| *6 | 17.8863 | 1.1269 | | | | 21.38 |
| 7 | 32.9324 | 3.0364 | 1.92286 | 18.90 | 0.64960 | 21.38 |
| 8 | −88.3818 | 1.0949 | | | | 21.19 |
| 9 | −33.4967 | 0.5495 | 1.95906 | 17.47 | 0.65993 | 21.17 |
| 10 | −121.2192 | DD[10] | | | | 21.05 |
| 11 | 27.8902 | 0.5097 | 1.77250 | 49.60 | 0.55212 | 20.84 |
| 12 | 20.8660 | 4.6673 | 1.59522 | 67.73 | 0.54426 | 20.65 |
| 13 | −54.7346 | DD[13] | | | | 20.60 |
| 14(St) | ∞ | 0.0499 | | | | 19.95 |
| *15 | 30.6841 | 6.2927 | 1.61881 | 63.85 | 0.54182 | 20.05 |
| *16 | −58.1860 | DD[16] | | | | 19.21 |
| 17 | −49.9269 | 7.0006 | 1.53775 | 74.70 | 0.53936 | 16.49 |
| 18 | −16.2432 | 0.4958 | 1.88300 | 39.22 | 0.57288 | 15.13 |
| 19 | 109.4827 | DD[19] | | | | 15.20 |
| 20 | 187.7193 | 0.5017 | 2.00100 | 29.14 | 0.59974 | 18.35 |
| 21 | 21.0071 | 5.8403 | 1.49700 | 81.54 | 0.53748 | 19.25 |
| 22 | −27.9152 | 0.0500 | | | | 20.86 |
| 23 | 43.1722 | 3.8543 | 1.90525 | 35.04 | 0.58486 | 26.00 |
| 24 | −133.4610 | DD[24] | | | | 26.33 |
| *25 | 187.5884 | 0.7503 | 1.68948 | 31.02 | 0.59874 | 28.08 |
| *26 | 34.7576 | DD[26] | | | | 28.40 |
| 27 | 140.8014 | 3.8994 | 1.95906 | 17.47 | 0.65993 | 40.98 |
| 28 | −182.1507 | DD[28] | | | | 41.14 |

TABLE 80
Example 27

| | Wide | Middle | Tele |
|---|---|---|---|
| Zr | 1.0 | 1.8 | 3.5 |
| f | 18.65 | 33.88 | 65.27 |
| Bf | 22.32 | 30.45 | 36.75 |
| FNo. | 4.12 | 4.13 | 4.12 |
| 2ω[°] | 108.0 | 66.6 | 36.2 |
| DD[2] | 0.38 | 8.85 | 40.53 |
| DD[10] | 16.47 | 5.65 | 1.46 |
| DD[13] | 2.83 | 2.75 | 1.06 |
| DD[16] | 1.32 | 3.07 | 4.56 |
| DD[19] | 3.96 | 1.58 | 0.87 |
| DD[24] | 1.09 | 3.49 | 2.97 |
| DD[26] | 6.56 | 15.10 | 32.31 |
| DD[28] | 22.32 | 30.45 | 36.75 |

TABLE 81
Example 27

| Sn | 5 | 6 | 25 | 26 |
|---|---|---|---|---|
| KA | 1.0000000E+00 | 1.0000000E+00 | 1.0000000E+00 | 1.0000000E+00 |
| A4 | −1.8109118E−05 | −5.7681897E−05 | −9.3284331E−06 | −8.8393389E−06 |
| A6 | 2.6203939E−07 | 2.7181399E−07 | 1.0429694E−07 | 7.4924658E−08 |
| A8 | −2.1950765E−09 | −2.2601493E−09 | −1.0893435E−09 | −7.9914683E−10 |
| A10 | 8.8099714E−12 | 7.0821818E−12 | 8.4554662E−12 | 6.2467881E−12 |
| A12 | −1.5019141E−14 | −2.1774600E−15 | −2.0906375E−14 | −1.5233005E−14 |
| A14 | 0.0000000E+00 | 0.0000000E+00 | 0.0000000E+00 | 0.0000000E+00 |

| Sn | 15 | 16 |
|---|---|---|
| KA | 1.0000000E+00 | 1.0000000E+00 |
| A4 | −3.7515547E−06 | 6.4792183E−07 |
| A6 | 7.5868729E−10 | 4.4107820E−09 |
| A8 | 2.6363682E−11 | 2.0404749E−11 |
| A10 | 1.4110036E−13 | 1.9476021E−13 |

### Example 28

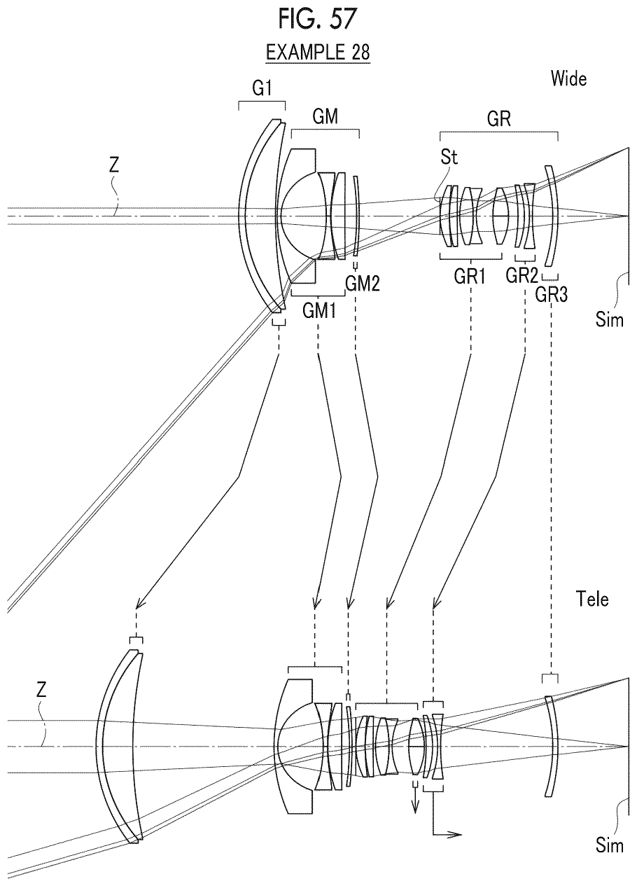

A configuration and a movement trajectory of a variable magnification optical system of Example 28 are shown in FIG. 57. The variable magnification optical system of Example 28 consists of, in order from an object side to an image side, a first lens group G1 having a positive refractive power, an intermediate group GM, and a subsequent group GR. The intermediate group GM consists of, in order from the object side to the image side, two lens groups including a first intermediate lens group GM1 that has a negative refractive power and a second intermediate lens group GM2 that has a negative refractive power. The subsequent group GR consists of, in order from the object side to the image side, a first subsequent lens group GR1 having a positive refractive power, a second subsequent lens group GR2 having a negative refractive power, and a third subsequent lens group GR3 having a negative refractive power. A second lens from the object side of the first intermediate lens group GM1 corresponds to an Lmn lens. A lens of the second subsequent lens group GR2 that is closest to the image side corresponds to an Lrn lens.

During changing a magnification from a wide angle end to a telephoto end, the third subsequent lens group GR3 remains stationary with respect to the image plane Sim, and other lens groups move along an optical axis Z by changing their spacings with respect to their adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of one lens of the first subsequent lens group GR1 that is closest to the image side.

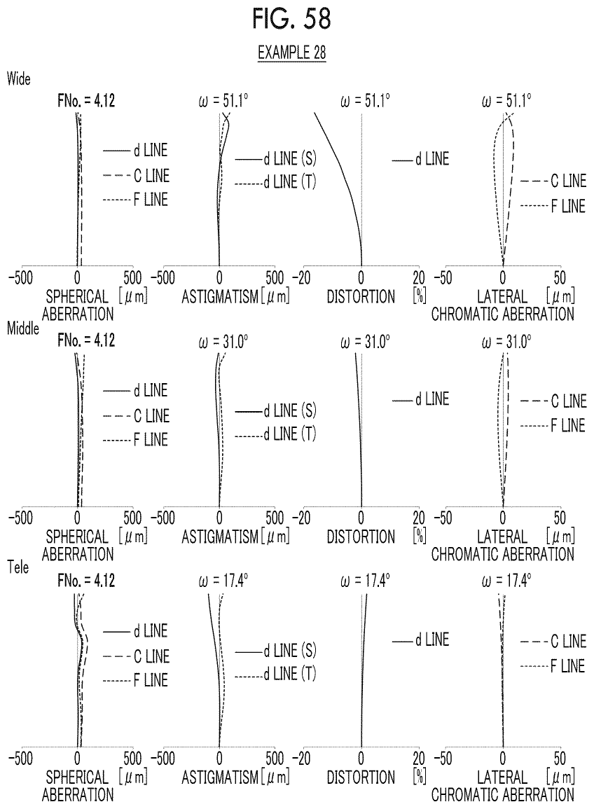

With respect to the variable magnification optical system of Example 28, basic lens data is shown in Table 82, specifications and variable surface spacings are shown in Table 83, aspherical coefficients are shown in Table 84A and Table 84B, and each aberration diagram is shown in FIG. 58.

TABLE 82
Example 28

| Sn | R | D | Nd | νd | θg, F | ED |
|---|---|---|---|---|---|---|
| 1 | 52.4694 | 1.8748 | 2.00272 | 19.32 | 0.64514 | 60.80 |
| 2 | 47.0383 | 8.6998 | 1.55032 | 75.50 | 0.54001 | 58.58 |
| 3 | 147.4604 | DD[3] | | | | 57.59 |
| 4 | 56.8822 | 1.0820 | 1.80420 | 46.50 | 0.55727 | 42.24 |
| 5 | 14.5698 | 12.8860 | | | | 27.60 |
| *6 | −43.2905 | 1.2500 | 1.49710 | 81.56 | 0.53848 | 27.27 |
| *7 | 52.9169 | 0.1000 | | | | 27.23 |
| 8 | 44.0581 | 3.9824 | 2.00069 | 25.46 | 0.61364 | 27.23 |
| 9 | 2456.8082 | DD[9] | | | | 26.63 |
| 10 | −92.0294 | 0.7501 | 1.92286 | 18.90 | 0.64960 | 25.01 |
| 11 | −126.9132 | DD[11] | | | | 24.83 |
| 12(St) | ∞ | 0.0498 | | | | 18.27 |
| *13 | 21.3424 | 2.6418 | 1.59201 | 67.02 | 0.53589 | 19.15 |
| *14 | 63.5034 | 0.0502 | | | | 19.08 |
| 15 | 40.4073 | 2.2498 | 1.84666 | 23.78 | 0.61923 | 19.09 |
| 16 | 529.6123 | 0.6864 | | | | 18.83 |
| 17 | 26.4873 | 3.8988 | 1.43875 | 94.66 | 0.53402 | 18.01 |
| 18 | −38.0291 | 0.8749 | 1.80518 | 25.46 | 0.61572 | 17.39 |
| 19 | 21.4234 | 4.7602 | | | | 16.43 |
| *20 | 26.2549 | 4.5152 | 1.49710 | 81.56 | 0.53848 | 17.00 |
| *21 | −19.6091 | DD[21] | | | | 17.67 |
| 22 | −56.4315 | 1.8462 | 2.00272 | 19.32 | 0.64514 | 19.20 |
| 23 | −30.8458 | 1.4464 | | | | 19.56 |
| *24 | −31.5484 | 0.8748 | 1.85135 | 40.10 | 0.56954 | 19.58 |
| *25 | 78.7884 | DD[25] | | | | 20.40 |
| 26 | −54.6760 | 1.5000 | 1.75500 | 52.32 | 0.54757 | 30.68 |
| 27 | −66.9336 | 20.3800 | | | | 31.60 |

TABLE 83
Example 28

| | Wide | Middle | Tele |
|---|---|---|---|
| Zr | 1.0 | 1.8 | 3.2 |
| f | 20.86 | 36.74 | 67.60 |
| Bf | 20.38 | 20.38 | 20.38 |
| FNo. | 4.12 | 4.12 | 4.12 |
| 2ω[°] | 102.2 | 62.0 | 34.8 |
| DD[3] | 0.50 | 18.52 | 40.60 |
| DD[9] | 3.37 | 3.32 | 2.22 |
| DD[11] | 23.20 | 8.11 | 1.07 |
| DD[21] | 2.70 | 2.88 | 0.50 |
| DD[25] | 5.82 | 14.26 | 32.21 |

TABLE 84A
Example 28

| Sn | 6 | 7 | 14 |
|---|---|---|---|
| KA | 1.0000000E+00 | 1.0000000E+00 | 1.0000000E+00 |
| A4 | 7.3485193E−06 | −4.2669350E−06 | −9.6913180E−06 |
| A6 | −2.0416826E−08 | −1.2773092E−09 | 1.4245061E−08 |
| A8 | −1.8830295E−10 | −5.6808105E−10 | 5.9832247E−11 |
| A10 | 1.4816919E−13 | 1.1661457E−12 | −5.6811133E−12 |
| Sn | 13 | 20 | 21 |
| KA | 1.0000000E+00 | 1.0000000E+00 | 1.0000000E+00 |
| A3 | 0.0000000E+00 | 0.0000000E+00 | 0.0000000E+00 |
| A4 | −1.4782844E−05 | −3.5697613E−05 | 3.8638128E−05 |
| A5 | −1.1509789E−07 | 4.8752632E−07 | −3.3245452E−07 |
| A6 | −1.9245306E−08 | −3.9678060E−08 | −1.9820462E−07 |
| A7 | 3.2401494E−10 | −5.3357984E−09 | 1.0699792E−08 |
| A8 | −3.5372243E−11 | 2.1901828E−09 | 2.2558522E−09 |
| A9 | 3.4770915E−12 | 3.9132477E−11 | −6.1291310E−12 |
| A10 | 1.0764563E−12 | −3.0554423E−11 | −1.3579746E−11 |
| A11 | −1.3310679E−13 | −8.6482923E−13 | −1.8855074E−12 |
| A12 | −6.1946058E−15 | 1.4837557E−13 | −1.6397505E−14 |
| A13 | −1.3815828E−15 | −1.7072871E−14 | 9.1314598E−16 |
| A14 | −5.9999406E−17 | 2.3446844E−17 | 3.1851723E−17 |
| A15 | −1.1152896E−17 | 1.7924706E−16 | −2.2190629E−17 |
| A16 | −8.8010584E−19 | −1.9697949E−17 | 1.7874371E−17 |
| A17 | −7.7872388E−20 | 3.3343589E−18 | 3.3189373E−18 |
| A18 | −4.8655968E−21 | −3.5735995E−20 | −2.0100033E−19 |
| A19 | 2.1319055E−21 | −1.1899592E−20 | −7.3195573E−20 |
| A20 | 3.6801357E−23 | −1.3827011E−21 | 4.1088806E−21 |

TABLE 84B
Example 28

| Sn | 24 | 25 |
|---|---|---|
| KA | 1.0000000E+00 | 1.0000000E+00 |
| A3 | 0.0000000E+00 | 0.0000000E+00 |
| A4 | 3.3165033E−05 | 3.0457532E−05 |
| A5 | −8.8967173E−07 | −1.0859733E−06 |
| A6 | −6.2732323E−07 | −4.6988462E−07 |
| A7 | 3.6676480E−09 | −6.4275067E−09 |
| A8 | 4.6734665E−09 | 6.1300522E−09 |
| A9 | 2.9304773E−10 | 1.9761051E−11 |
| A10 | −3.7171934E−11 | −1.2118750E−11 |
| A11 | 6.2502055E−12 | −3.6117236E−13 |
| A12 | −8.2812148E−13 | 2.1696762E−14 |
| A13 | 1.6731102E−14 | −2.8922988E−15 |
| A14 | 5.9893705E−16 | −3.2419173E−15 |
| A15 | −8.8288180E−17 | −1.8095688E−16 |
| A16 | −1.1439972E−16 | 3.1163324E−17 |
| A17 | 5.5146807E−18 | 1.1120760E−18 |
| A18 | 9.9236214E−19 | 1.3968689E−19 |
| A19 | 7.4274608E−20 | 7.4041335E−21 |
| A20 | −1.0520272E−20 | −1.9503328E−21 |

### Example 29

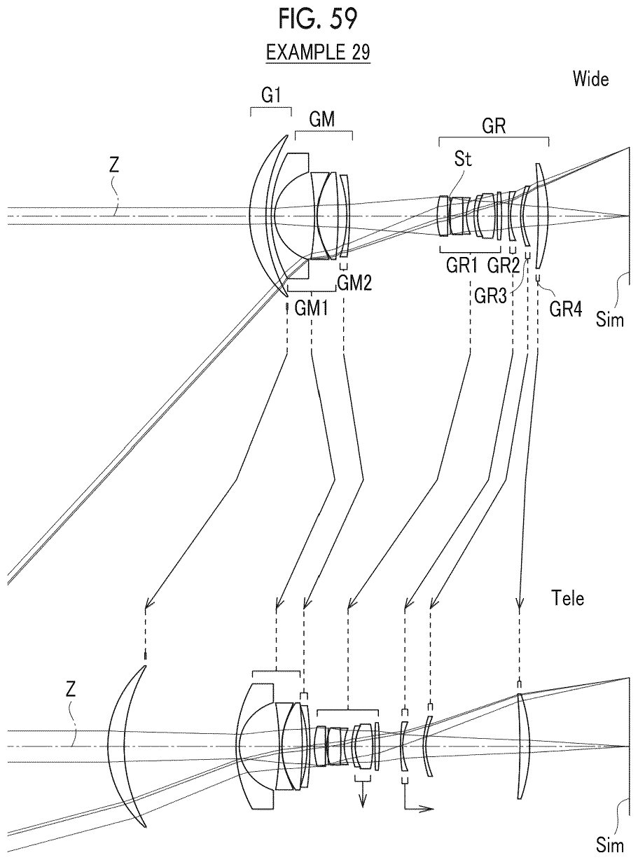

A configuration and a movement trajectory of a variable magnification optical system of Example 29 are shown in FIG. 59. The variable magnification optical system of Example 29 consists of, in order from an object side to an image side, a first lens group G1 having a positive refractive power, an intermediate group GM, and a subsequent group GR. The intermediate group GM consists of, in order from the object side to the image side, two lens groups including a first intermediate lens group GM1 that has a negative refractive power and a second intermediate lens group GM2 that has a negative refractive power. The subsequent group GR consists of, in order from the object side to the image side, a first subsequent lens group GR1 having a positive refractive power, a second subsequent lens group GR2 having a negative refractive power, a third subsequent lens group GR3 having a negative refractive power, and a fourth subsequent lens group GR4 having a positive refractive power. A second lens from the object side of the first intermediate lens group GM1 corresponds to an Lmn lens.

During changing a magnification from a wide angle end to a telephoto end, all lens groups move while changing spacings between adjacent lens groups. The variable magnification optical system includes only one focusing group. The focusing group consists of the second subsequent lens group GR2. During focusing from an infinite distance object to a close distance object, the second subsequent lens group GR2 moves to the image side, and the other lens groups remain stationary with respect to the image plane Sim. An anti-vibration group consists of a cemented lens formed by a second lens and a third lens from the image side of the first subsequent lens group GR1 cemented together.

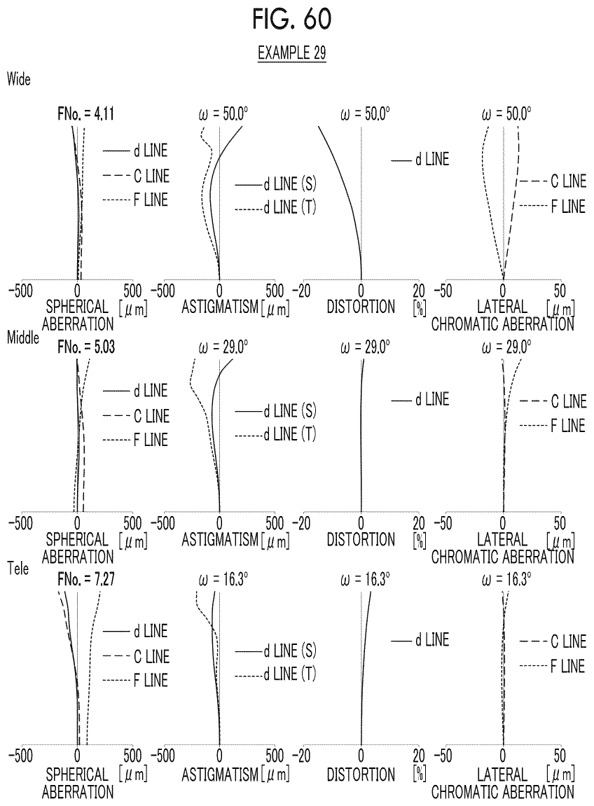

For the variable magnification optical system of Example 29, basic lens data is shown in Table 85, specifications and variable surface spacings are shown in Table 86, aspherical coefficients are shown in Table 87, and each aberration diagram is shown in FIG. 60.

TABLE 85
Example 29

| Sn | R | D | Nd | νd | θg, F | ED |
|---|---|---|---|---|---|---|
| 1 | 35.8086 | 4.6816 | 1.51680 | 64.20 | 0.53430 | 50.80 |
| 2 | 53.5724 | DD[2] | | | | 50.30 |
| 3 | 43.7412 | 0.9616 | 1.77535 | 50.31 | 0.55042 | 39.43 |
| 4 | 14.6413 | 11.4583 | | | | 27.60 |
| *5 | −72.4580 | 0.6840 | 1.69350 | 53.20 | 0.54661 | 27.31 |
| *6 | 26.9797 | 0.0632 | | | | 27.06 |
| 7 | 26.0066 | 5.8041 | 1.96300 | 24.11 | 0.62126 | 27.37 |
| 8 | −144.6055 | DD[8] | | | | 26.90 |
| 9 | −43.4970 | 0.8000 | 1.95906 | 17.47 | 0.65993 | 25.69 |
| 10 | −115.5711 | DD[10] | | | | 25.43 |
| *11 | 25.4182 | 3.0001 | 1.85135 | 40.10 | 0.56954 | 12.60 |
| *12 | −755.5419 | 0.8000 | | | | 11.93 |
| 13(St) | ∞ | −0.4000 | | | | 11.50 |
| 14 | 17.0067 | 4.0100 | 1.53775 | 74.70 | 0.53936 | 11.68 |
| 15 | −115.0431 | 1.0000 | 1.85025 | 30.05 | 0.59797 | 11.46 |
| 16 | 15.4328 | 2.1432 | | | | 11.37 |
| 17 | 23.0558 | 1.0000 | 1.96300 | 24.11 | 0.62126 | 12.80 |
| 18 | 15.1307 | 5.0102 | 1.49700 | 81.54 | 0.53748 | 12.88 |
| 19 | −38.6052 | 0.6262 | | | | 13.99 |
| 20 | 224.2515 | 1.2528 | 2.10420 | 17.02 | 0.66311 | 14.57 |
| 21 | −97.0325 | DD[21] | | | | 14.73 |
| 22 | 75.8977 | 0.6000 | 1.71299 | 53.87 | 0.54587 | 15.40 |
| 23 | 20.9777 | DD[23] | | | | 15.40 |
| *24 | 23.1885 | 0.7498 | 1.51633 | 64.06 | 0.53345 | 18.48 |
| *25 | 18.4755 | DD[25] | | | | 18.85 |
| 26 | −212.2487 | 2.7825 | 1.85026 | 32.27 | 0.59299 | 32.58 |
| 27 | −55.8342 | DD[27] | | | | 33.00 |

TABLE 86
Example 29

| | Wide | Middle | Tele |
|---|---|---|---|
| Zr | 1.0 | 1.8 | 3.4 |
| f | 21.33 | 38.74 | 71.44 |
| Bf | 23.32 | 26.79 | 28.58 |
| FNo. | 4.11 | 5.03 | 7.27 |
| 2ω[°] | 100.0 | 58.0 | 32.6 |
| DD[2] | 1.52 | 22.61 | 32.03 |
| DD[8] | 2.50 | 1.63 | 1.39 |
| DD[10] | 25.08 | 9.91 | 1.28 |
| DD[21] | 1.96 | 4.52 | 6.09 |
| DD[23] | 2.86 | 3.56 | 5.87 |
| DD[25] | 4.34 | 7.11 | 26.96 |
| DD[27] | 23.32 | 26.79 | 28.58 |

TABLE 87
Example 29

| Sn | 5 | 6 | 11 | 12 |
|---|---|---|---|---|
| KA | 1.0000000E+00 | 1.0000000E+00 | 1.0000000E+00 | 1.0000000E+00 |
| A4 | 1.4640937E−05 | 3.9932045E−06 | 1.0054881E−05 | 2.2926172E−05 |
| A6 | −2.3757982E−08 | −2.1997409E−08 | 2.3822140E−07 | 2.0849802E−07 |
| A8 | −1.8777404E−10 | −4.1782682E−10 | −2.0376737E−09 | −1.3418955E−09 |
| A10 | 3.8972026E−13 | 6.7150694E−13 | 2.5662219E−11 | 2.0178986E−11 |

| Sn | 24 | 25 |
|---|---|---|
| KA | 0.0000000E+00 | 0.0000000E+00 |
| A3 | 0.0000000E+00 | 0.0000000E+00 |
| A4 | −1.4731897E−04 | −1.5332131E−04 |
| A5 | 3.0333091E−07 | 1.1930970E−07 |
| A6 | 1.1902247E−06 | 1.2128677E−06 |
| A7 | 5.7642628E−08 | 6.3918492E−08 |
| A8 | 6.5063028E−09 | 5.0376892E−09 |
| A9 | −1.7174540E−09 | −1.0621907E−09 |
| A10 | 5.3413982E−11 | −1.8346575E−10 |
| A11 | −2.7373972E−11 | −1.8047997E−12 |
| A12 | 1.8904861E−12 | −1.0048257E−13 |
| A13 | 4.8763348E−13 | 3.1021806E−13 |
| A14 | −1.2559744E−13 | 8.7907043E−15 |
| A15 | −1.3411903E−15 | −2.3507269E−15 |
| A16 | 2.2596179E−15 | −3.3199183E−17 |
| A17 | 8.6772334E−17 | 2.2618881E−18 |
| A18 | −3.9806103E−17 | 1.4073839E−19 |
| A19 | 1.7617284E−18 | 1.5139338E−19 |
| A20 | 4.6820770E−21 | −1.4382324E−20 |

### Example 30

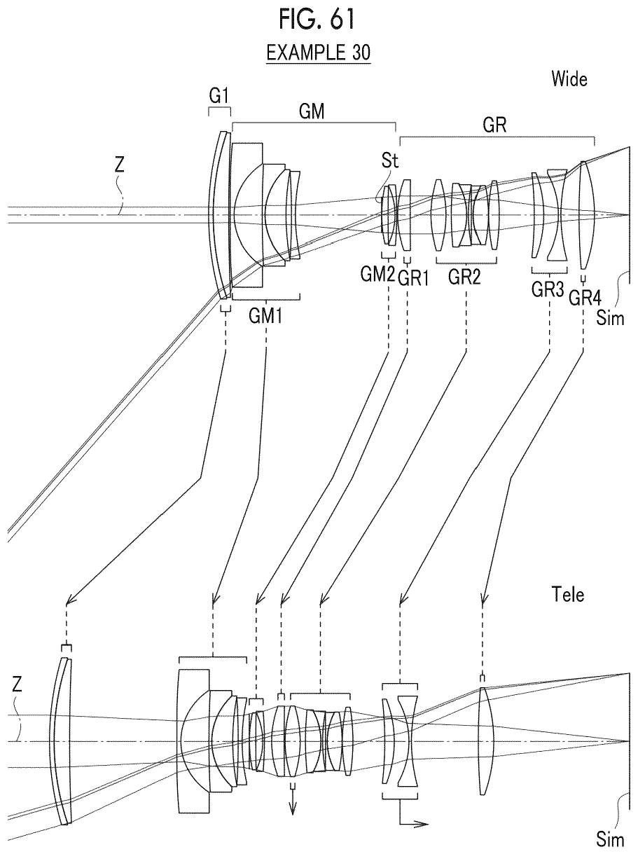

A configuration and a movement trajectory of a variable magnification optical system of Example 30 are shown in FIG. 61. The variable magnification optical system of Example 30 consists of, in order from an object side to an image side, a first lens group G1 having a positive refractive power, an intermediate group GM, and a subsequent group GR. The intermediate group GM consists of, in order from the object side to the image side, two lens groups including a first intermediate lens group GM1 that has a negative refractive power and a second intermediate lens group GM2 that has a negative refractive power. The subsequent group GR consists of, in order from the object side to the image side, a first subsequent lens group GR1 having a positive refractive power, a second subsequent lens group GR2 having a positive refractive power, a third subsequent lens group GR3 having a negative refractive power, and a fourth subsequent lens group GR4 having a positive refractive power. A lens of the first intermediate lens group GM1 that is closest to the object side corresponds to an Lmn lens.

During changing a magnification from a wide angle end to a telephoto end, all lens groups move while changing spacings between adjacent lens groups. The variable magnification optical system includes only one focusing group. The focusing group consists of the third subsequent lens group GR3. During focusing from an infinite distance object to a close distance object, the focusing group moves to the image side, and other lens groups remain stationary with respect to an image plane Sim. An anti-vibration group consists of one lens of the second subsequent lens group GR2 that is closest to the object side.

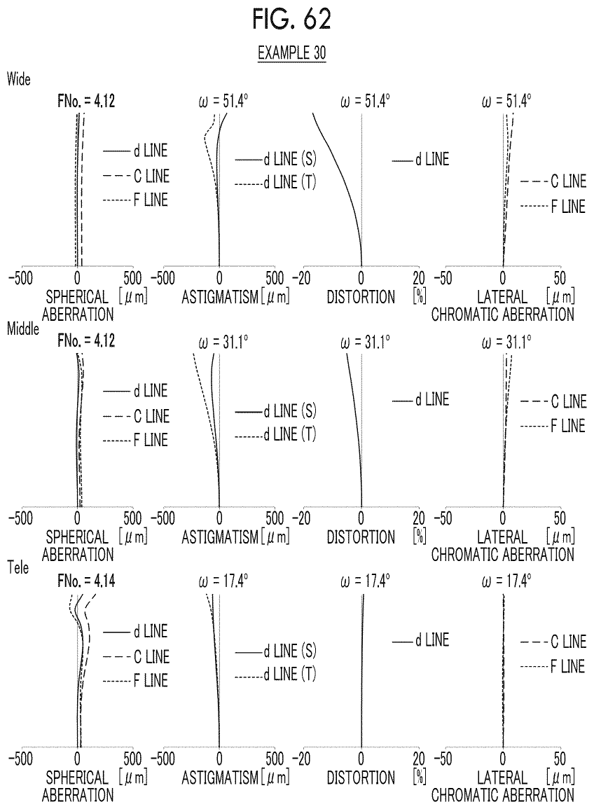

For the variable magnification optical system of Example 30, basic lens data is shown in Table 88, specifications and variable surface spacings are shown in Table 89, aspherical coefficients are shown in Table 90, and each aberration diagram is shown in FIG. 62.

TABLE 88
Example 30

| Sn | R | D | Nd | νd | θg, F | ED |
|---|---|---|---|---|---|---|
| 1 | 102.0389 | 1.3282 | 1.98613 | 16.48 | 0.66558 | 53.00 |
| 2 | 88.6551 | 4.5075 | 1.77535 | 50.31 | 0.55042 | 52.03 |
| 3 | 633.9899 | DD[3] | | | | 51.43 |
| *4 | 5738.8629 | 1.1639 | 1.69304 | 52.93 | 0.54673 | 45.53 |
| *5 | 20.4981 | 8.1422 | | | | 32.44 |
| 6 | 344.6254 | 0.8385 | 1.61800 | 63.32 | 0.54271 | 32.19 |
| 7 | 20.7250 | 6.0720 | 2.00069 | 25.46 | 0.61364 | 28.77 |
| 8 | 84.2829 | 1.5833 | | | | 27.68 |
| 9 | −246.2168 | 1.1419 | 1.96300 | 24.11 | 0.62126 | 27.61 |
| 10 | 66.5960 | DD[10] | | | | 26.15 |
| 11(St) | ∞ | 0.0498 | | | | 17.43 |
| *12 | 47.8997 | 1.8447 | 1.61881 | 63.85 | 0.54182 | 17.91 |
| *13 | 1036.2265 | 1.9998 | | | | 18.08 |
| 14 | −23.4321 | 0.4998 | 1.63930 | 44.87 | 0.56843 | 18.10 |
| 15 | −120.1805 | DD[15] | | | | 19.07 |
| 16 | 34.8310 | 3.6395 | 1.90366 | 31.31 | 0.59481 | 22.23 |
| 17 | 979.4326 | DD[17] | | | | 22.28 |
| *18 | 36.7904 | 4.3653 | 1.61881 | 63.85 | 0.54182 | 22.40 |
| *19 | −37.8855 | 1.5352 | | | | 22.21 |
| 20 | 111.9893 | 4.4790 | 1.65160 | 58.54 | 0.53901 | 19.97 |
| 21 | −21.9372 | 0.5003 | 1.92119 | 23.96 | 0.62025 | 19.16 |
| 22 | 54.1951 | 0.8443 | | | | 18.38 |
| 23 | −2308.9865 | 0.4997 | 2.00100 | 29.14 | 0.59974 | 18.37 |
| 24 | 21.0863 | 4.2814 | 1.48749 | 70.24 | 0.53007 | 18.24 |
| 25 | −50.4104 | 0.0990 | | | | 18.60 |
| *26 | 55.6807 | 3.0558 | 2.00178 | 19.32 | 0.64480 | 21.22 |
| *27 | −74.7498 | DD[27] | | | | 21.64 |
| 28 | −126.1345 | 2.7523 | 2.00272 | 19.32 | 0.64514 | 26.45 |
| 29 | 40.0574 | 4.2497 | | | | 26.77 |
| 30 | −29.0823 | 0.7404 | 1.95375 | 32.32 | 0.59056 | 26.32 |
| 31 | 58.7091 | DD[31] | | | | 28.67 |
| 32 | 236.1534 | 4.4684 | 1.75500 | 52.32 | 0.54757 | 33.60 |
| 33 | −55.0227 | DD[33] | | | | 34.00 |

TABLE 89
Example 30

| | Wide | Middle | Tele |
|---|---|---|---|
| Zr | 1.0 | 1.8 | 3.3 |
| f | 20.78 | 37.74 | 68.57 |
| Bf | 10.20 | 31.18 | 39.43 |
| FNo. | 4.12 | 4.12 | 4.14 |
| 2ω[°] | 102.8 | 62.2 | 34.8 |
| DD[3] | 0.40 | 5.27 | 30.95 |
| DD[10] | 25.00 | 11.12 | 2.07 |
| DD[15] | 0.27 | 0.58 | 2.10 |
| DD[17] | 6.01 | 2.38 | 0.27 |
| DD[27] | 10.15 | 6.72 | 9.25 |
| DD[31] | 5.26 | 7.32 | 19.24 |
| DD[33] | 10.20 | 31.18 | 39.43 |

TABLE 90
Example 30

| Sn | 4 | 5 | 12 | 13 |
|---|---|---|---|---|
| KA | 1.0000000E+00 | 1.0000000E+00 | 1.0000000E+00 | 1.0000000E+00 |
| A4 | 3.7198896E−06 | 1.9607923E−06 | 6.3872932E−06 | 9.9076056E−06 |
| A6 | −3.2067407E−09 | 3.6096637E−09 | 4.6769093E−09 | 3.0710204E−08 |
| A8 | 8.7502673E−13 | 1.1047055E−11 | −3.0908549E−10 | −3.5633942E−10 |
| A10 | 0.0000000E+00 | 0.0000000E+00 | 0.0000000E+00 | 0.0000000E+00 |

| Sn | 18 | 19 | 26 | 27 |
|---|---|---|---|---|
| KA | 1.0000000E+00 | 1.0000000E+00 | 1.0000000E+00 | 1.0000000E+00 |
| A4 | −1.1863014E−05 | 8.9634005E−06 | 8.7477472E−07 | 3.2839947E−07 |
| A6 | 6.7443617E−09 | −1.0433742E−08 | −2.9208783E−09 | −6.2206703E−09 |
| A8 | 3.0748255E−11 | 6.1409593E−11 | −6.4737544E−11 | −5.2317663E−11 |
| A10 | 0.0000000E+00 | 0.0000000E+00 | −3.8412376E−14 | −2.6350071E−13 |

Tables 91 to 102 show the corresponding values of Conditional Expressions (1) to (38) of the variable magnification optical systems of Examples 1 to 30. Preferred ranges of the conditional expressions may be set by using the corresponding values of the examples shown in Tables 91 to 102 as upper limits or lower limits of the conditional expressions.

TABLE 91

| Expression | | | | | | |
|---|---|---|---|---|---|---|
| number | | Example 1 | Example 2 | Example 3 | Example 4 | Example 5 |
| (1) | TLw/(ft × tanωt) | 5.3597 | 5.6478 | 5.4720 | 4.9581 | 5.2818 |
| (2) | Bfw/(ft × tanωt) | 0.4893 | 1.1549 | 0.5703 | 1.3522 | 0.9163 |
| (3) | (fw × TLw)/(ft² × FNow) | 0.1195 | 0.1270 | 0.1456 | 0.1568 | 0.1255 |
| (4) | tanωw/FNow | 0.2746 | 0.2997 | 0.2839 | 0.3011 | 0.3019 |
| (5) | FNow/(ft/fw) | 1.2514 | 1.2486 | 1.2710 | 1.2169 | 1.2716 |
| (6) | fw/f1 | 0.1038 | 0.1288 | 0.1293 | 0.1507 | 0.1292 |
| (7) | f1/(−fMw) | 7.1899 | 8.2917 | 7.4618 | 7.8179 | 6.6771 |
| (8) | (−fMw)/(fw × ft)^{1/2} | 0.7378 | 0.5153 | 0.5888 | 0.4902 | 0.6438 |
| (9) | f1/(ft/FNot) | 12.0298 | 9.7147 | 9.8562 | 14.2719 | 9.8397 |
| (10) | TLw/fw | 5.3744 | 5.6978 | 5.5115 | 5.1498 | 5.4286 |
| (11) | FNot × (TLt/ft) | 9.5524 | 9.4919 | 9.8523 | 15.1965 | 9.3271 |
| (12) | f1/fR1 | 5.5277 | 6.6786 | 6.4980 | 6.6121 | 6.8936 |
| (13) | TLw/ft | 1.6284 | 1.7267 | 1.7779 | 1.7169 | 1.6755 |
| (14) | ft/fw | 3.3004 | 3.2998 | 3.0999 | 2.9995 | 3.2401 |
| (15) | f1/(fw × ft)^{1/2} | 5.3045 | 4.2729 | 4.3933 | 3.8322 | 4.2989 |
| (16) | TLt/TLw | 1.4238 | 1.3310 | 1.4029 | 1.3723 | 1.3512 |
| (17) | fw/fRw | 0.7801 | 0.6729 | 0.7204 | 0.7457 | 0.7302 |
| (18) | ft/fRt | 2.1828 | 1.7085 | 2.1475 | 1.5415 | 2.1846 |
| (19) | fR1/(fw × ft)^{1/2} | 0.9596 | 0.6398 | 0.6761 | 0.5796 | 0.6236 |
| (20) | fw/fR1 | 0.5736 | 0.8604 | 0.8401 | 0.9962 | 0.8909 |
| (21) | \|fIS/ft\| | — | 0.3428 | 0.4184 | — | 0.3442 |
| (22) | \|ff/ft\| | 0.7092 | 0.5235 | 0.9114 | 0.6602 | 0.6077 |
| (23) | Ndn + 0.01 × νdn | 2.1338 | 2.0676 | 2.2744 | — | 2.1959 |
| (24) | Ndp + 0.01 × νdp | 2.2760 | 2.2408 | 2.2408 | — | 2.3053 |
| (25) | νd1p_ave | 54.68 | 60.08 | 63.91 | 42.74 | 75.50 |
| (26) | d1sum/f1 | 0.0301 | 0.0426 | 0.0541 | 0.0287 | 0.0656 |

TABLE 92

| Expression | | | | | | |
|---|---|---|---|---|---|---|
| number | | Example 1 | Example 2 | Example 3 | Example 4 | Example 5 |
| (27) | fM1/fM2 | — | — | — | — | — |
| (28), (28A), | fR1/(−fR2) | — | 0.6728 | 0.4213 | 0.5069 | 0.5701 |
| (28B) | | | | | | |
| (29), (29A) | fR2/(−fR3) | 0.9201 | — | — | — | — |
| (30), (30A), | fR1/fR2 | 0.7448 | — | — | — | — |
| (30B), (30C) | | | | | | |
| (31) | (−fR2)/fR3 | — | — | — | — | — |
| (32) | fR1/fR3 | — | — | — | — | — |
| (33) | (−fR2)/(−fR4) | — | — | — | — | — |
| (34) | fR1/(−fR3) | — | — | — | — | — |
| (35) | fR2/fR4 | — | — | — | — | — |
| (36) | fR2/fR3 | — | — | — | — | — |
| (37) | fR3/fR4 | — | — | — | — | — |
| (38) | (−fR2)/(−fR3) | — | — | 0.0889 | — | — |

TABLE 93

| Expression | | | | | | |
|---|---|---|---|---|---|---|
| number | | Example 6 | Example 7 | Example 8 | Example 9 | Example 10 |
| (1) | TLw/(ft × tanωt) | 5.2800 | 5.1026 | 5.4969 | 5.1418 | 5.2760 |
| (2) | Bfw/(ft × tanωt) | 0.9577 | 1.0136 | 0.7938 | 0.7920 | 0.7313 |
| (3) | (fw × TLw)/(ft² × FNow) | 0.1240 | 0.1213 | 0.1379 | 0.1243 | 0.1371 |
| (4) | tanωw/FNow | 0.2987 | 0.3039 | 0.3001 | 0.3026 | 0.3337 |
| (5) | FNow/(ft/fw) | 1.2719 | 1.2183 | 1.3324 | 1.2646 | 1.0941 |
| (6) | fw/f1 | 0.1292 | 0.1230 | 0.1285 | 0.1287 | 0.1289 |
| (7) | f1/(−fMw) | 6.6941 | 6.3492 | 6.2664 | 7.3317 | 7.4534 |
| (8) | (−fMw)/(fw × ft)^{1/2} | 0.6422 | 0.7048 | 0.7054 | 0.5881 | 0.5731 |
| (9) | f1/(ft/FNot) | 9.8403 | 18.0087 | 10.3445 | 15.7125 | 15.4495 |
| (10) | TLw/fw | 5.3600 | 5.3088 | 5.4705 | 5.3975 | 5.3888 |
| (11) | FNot × (TLt/ft) | 9.1917 | 16.3760 | 10.4348 | 14.9385 | 15.1375 |
| (12) | f1/fR1 | 6.8681 | 2.8753 | 2.9575 | 8.0025 | 7.7721 |
| (13) | TLw/ft | 1.6547 | 1.6088 | 1.7649 | 1.6608 | 1.6332 |
| (14) | ft/fw | 3.2393 | 3.2998 | 3.0997 | 3.2500 | 3.2995 |
| (15) | f1/(fw × ft)^{1/2} | 4.2987 | 4.4752 | 4.4205 | 4.3114 | 4.2714 |
| (16) | TLt/TLw | 1.3483 | 1.3924 | 1.4351 | 1.3691 | 1.4107 |
| (17) | fw/fRw | 0.7480 | 0.7011 | 0.6310 | 0.7257 | 0.8076 |
| (18) | ft/fRt | 2.4367 | 2.0489 | 0.9715 | 2.3137 | 2.3418 |
| (19) | fR1/(fw × ft)^{1/2} | 0.6259 | 1.5564 | 1.4947 | 0.5388 | 0.5496 |
| (20) | fw/fR1 | 0.8877 | 0.3537 | 0.3800 | 1.0296 | 1.0017 |
| (21) | \|fIS/ft\| | 0.3481 | — | 0.4305 | 0.6632 | 0.9047 |
| (22) | \|ff/ft\| | 0.7357 | 0.3366 | 0.4305 | 0.5357 | 0.7010 |
| (23) | Ndn + 0.01 × νdn | 2.1959 | 2.1508 | — | 2.2770 | 2.2553 |
| (24) | Ndp + 0.01 × νdp | 2.3053 | 2.2782 | — | 2.2408 | 2.1768 |
| (25) | νd1p_ave | 75.50 | 52.32 | 70.24 | 60.08 | 59.37 |
| (26) | d1sum/f1 | 0.0652 | 0.0550 | 0.0350 | 0.0710 | 0.0618 |

TABLE 94

| Expression | | | | | | |
|---|---|---|---|---|---|---|
| number | | Example 6 | Example 7 | Example 8 | Example 9 | Example 10 |
| (27) | fM1/fM2 | — | — | — | — | — |
| (28), (28A), | fR1/(−fR2) | 0.4727 | — | — | 0.5579 | 0.4316 |
| (28B) | | | | | | |
| (29), (29A) | fR2/(−fR3) | — | 0.6366 | 0.5572 | — | — |
| (30), (30A), | fR1/fR2 | — | 2.5456 | 1.9722 | — | — |
| (30B), (30C) | | | | | | |
| (31) | (−fR2)/fR3 | — | — | — | 0.5789 | 0.9302 |
| (32) | fR1/fR3 | — | — | — | 0.3230 | 0.4015 |
| (33) | (−fR2)/(−fR4) | — | — | — | 0.2891 | 0.9247 |
| (34) | fR1/(−fR3) | — | — | 1.0989 | — | — |
| (35) | fR2/fR4 | — | — | 0.3155 | — | — |
| (36) | fR2/fR3 | — | — | — | — | — |
| (37) | fR3/fR4 | — | — | — | — | — |
| (38) | (−fR2)/(−fR3) | 0.1191 | — | — | — | — |

TABLE 95

| Expression | | | | | | |
|---|---|---|---|---|---|---|
| number | | Example 11 | Example 12 | Example 13 | Example 14 | Example 15 |
| (1) | TLw/(ft × tanωt) | 5.2571 | 5.1698 | 5.4440 | 5.5949 | 5.4426 |
| (2) | Bfw/(ft × tanωt) | 0.8457 | 1.1058 | 0.8562 | 0.7361 | 0.4903 |
| (3) | (fw × TLw)/(ft² × FNow) | 0.1202 | 0.1119 | 0.1148 | 0.1141 | 0.1198 |
| (4) | tanωw/FNow | 0.3011 | 0.2920 | 0.3070 | 0.3037 | 0.3022 |
| (5) | FNow/(ft/fw) | 1.2518 | 1.2269 | 1.2741 | 1.2089 | 1.2513 |
| (6) | fw/f1 | 0.1297 | 0.1126 | 0.0697 | 0.1291 | 0.1573 |
| (7) | f1/(−fMw) | 7.5638 | 8.1914 | 13.2602 | 8.1178 | 5.6090 |
| (8) | (−fMw)/(fw × ft)^{1/2} | 0.5612 | 0.5922 | 0.5938 | 0.5176 | 0.6238 |
| (9) | f1/(ft/FNot) | 9.6280 | 19.3735 | 18.3232 | 9.3883 | 7.9344 |
| (10) | TLw/fw | 5.4022 | 5.1630 | 5.3537 | 5.4182 | 5.3892 |
| (11) | FNot × (TLt/ft) | 9.1351 | 15.7313 | 9.2420 | 8.8518 | 9.4297 |
| (12) | f1/fR1 | 6.4892 | 8.6508 | 16.0984 | 9.1942 | 5.8244 |
| (13) | TLw/ft | 1.6374 | 1.5412 | 1.6126 | 1.5937 | 1.6329 |
| (14) | ft/fw | 3.2992 | 3.3500 | 3.3199 | 3.3997 | 3.3005 |
| (15) | f1/(fw × ft)^{1/2} | 4.2447 | 4.8508 | 7.8741 | 4.2016 | 3.4987 |
| (16) | TLt/TLw | 1.3541 | 1.3963 | 1.3517 | 1.3481 | 1.4017 |
| (17) | fw/fRw | 0.7781 | 0.7549 | 0.7451 | 0.7898 | 0.7547 |
| (18) | ft/fRt | 2.6672 | 1.8832 | 2.1553 | 2.3002 | 1.4450 |
| (19) | fR1/(fw × ft)^{1/2} | 0.6541 | 0.5607 | 0.4891 | 0.4570 | 0.6007 |
| (20) | fw/fR1 | 0.8417 | 0.9744 | 1.1221 | 1.1868 | 0.9163 |
| (21) | \|fIS/ft\| | 0.4181 | 0.5907 | 0.5781 | 0.5959 | 0.3048 |
| (22) | \|ff/ft\| | 0.6724 | 0.5809 | 0.3580 | 0.3000 | 0.4851 |
| (23) | Ndn + 0.01 × νdn | — | — | 2.2041 | 2.2770 | 2.2770 |
| (24) | Ndp + 0.01 × νdp | — | — | 2.2725 | 2.3124 | 2.3854 |
| (25) | νd1p_ave | 64.20 | 64.20 | 45.92 | 66.93 | 73.49 |
| (26) | d1sum/f1 | 0.0348 | 0.0452 | 0.0272 | 0.0809 | 0.1017 |

TABLE 96

| Expression | | | | | | |
|---|---|---|---|---|---|---|
| number | | Example 11 | Example 12 | Example 13 | Example 14 | Example 15 |
| (27) | fM1/fM2 | — | — | — | — | — |
| (28), (28A), | fR1/(−fR2) | 0.5355 | 0.5274 | 0.7498 | 0.8261 | 0.6816 |
| (28B) | | | | | | |
| (29), (29A) | fR2/(−fR3) | — | — | — | — | — |
| (30), (30A), | fR1/fR2 | — | — | — | — | — |
| (30B), (30C) | | | | | | |
| (31) | (−fR2)/fR3 | 0.6494 | — | — | — | — |
| (32) | fR1/fR3 | 0.3478 | — | — | — | — |
| (33) | (−fR2)/(−fR4) | 0.8786 | — | — | — | — |
| (34) | fR1/(−fR3) | — | — | — | — | — |
| (35) | fR2/fR4 | — | — | — | — | — |
| (36) | fR2/fR3 | — | — | — | — | — |
| (37) | fR3/fR4 | — | — | — | — | — |
| (38) | (−fR2)/(−fR3) | — | 0.1981 | 0.2406 | 0.2655 | 0.7121 |

TABLE 97

| Expression | | | | | | |
|---|---|---|---|---|---|---|
| number | | Example 16 | Example 17 | Example 18 | Example 19 | Example 20 |
| (1) | TLw/(ft × tanωt) | 5.5382 | 5.6695 | 5.2659 | 4.8102 | 4.8055 |
| (2) | Bfw/(ft × tanωt) | 0.9693 | 0.5208 | 1.0996 | 0.4916 | 1.2561 |
| (3) | (fw × TLw)/(ft² × FNow) | 0.1154 | 0.1274 | 0.1303 | 0.1548 | 0.1195 |
| (4) | tanωw/FNow | 0.3008 | 0.2982 | 0.3280 | 0.3816 | 0.3327 |
| (5) | FNow/(ft/fw) | 1.1940 | 1.1483 | 1.2482 | 0.8628 | 1.1576 |
| (6) | fw/f1 | 0.1161 | 0.1270 | 0.1119 | 0.1288 | 0.1569 |
| (7) | f1/(−fMw) | 9.3044 | 8.4489 | 10.4892 | 5.7502 | 6.3501 |
| (8) | (−fMw)/(fw × ft)^{1/2} | 0.4985 | 0.5130 | 0.4690 | 0.7376 | 0.5526 |
| (9) | f1/(ft/FNot) | 10.2870 | 16.8428 | 11.2108 | 13.0015 | 13.5416 |
| (10) | TLw/fw | 5.6604 | 5.2601 | 5.8495 | 5.0183 | 4.9696 |
| (11) | FNot × (TLt/ft) | 9.7576 | 16.8927 | 10.2264 | 11.5023 | 14.7292 |
| (12) | f1/fR1 | 5.4541 | 3.9902 | 5.4496 | 1.5757 | 5.2634 |
| (13) | TLw/ft | 1.6405 | 1.5936 | 1.7722 | 1.4982 | 1.5059 |
| (14) | ft/fw | 3.4505 | 3.3007 | 3.3008 | 3.3495 | 3.3000 |
| (15) | f1/(fw × ft)^{1/2} | 4.6380 | 4.3342 | 4.9198 | 4.2415 | 3.5092 |
| (16) | TLt/TLw | 1.4437 | 1.5014 | 1.3939 | 1.3685 | 1.3953 |
| (17) | fw/fRw | 0.7845 | 0.8703 | 0.6874 | 0.7776 | 0.7552 |
| (18) | ft/fRt | 2.8409 | 2.7618 | 2.5579 | 2.1343 | 2.0935 |
| (19) | fR1/(fw × ft)^{1/2} | 0.8504 | 1.0862 | 0.9028 | 2.6918 | 0.6667 |
| (20) | fw/fR1 | 0.6331 | 0.5067 | 0.6097 | 0.2030 | 0.8257 |
| (21) | \|fIS/ft\| | — | 1.4476 | 0.8403 | 0.3609 | 0.7635 |
| (22) | \|ff/ft\| | 0.9714 | 1.1705 | 0.7114 | 0.4668 | 0.4543 |
| (23) | Ndn + 0.01 × νdn | 2.2785 | 2.1338 | — | — | — |
| (24) | Ndp + 0.01 × νdp | 2.3854 | 2.2785 | — | — | — |
| (25) | νd1p_ave | 94.66 | 50.31 | 70.24 | 28.43 | 70.24 |
| (26) | d1sum/f1 | 0.0523 | 0.0435 | 0.0307 | 0.0112 | 0.0113 |

TABLE 98

| Expression | | | | | | |
|---|---|---|---|---|---|---|
| number | | Example 16 | Example 17 | Example 18 | Example 19 | Example 20 |
| (27) | fM1/fM2 | — | — | — | — | — |
| (28), (28A), | fR1/(−fR2) | — | — | — | — | — |
| (28B) | | | | | | |
| (29), (29A) | fR2/(−fR3) | — | — | — | — | 1.8952 |
| (30), (30A), | fR1/fR2 | 0.1670 | 0.7272 | 0.5914 | 4.0754 | 0.4263 |
| (30B), (30C) | | | | | | |
| (31) | (−fR2)/fR3 | — | — | — | — | — |
| (32) | fR1/fR3 | — | — | — | — | — |
| (33) | (−fR2)/(−fR4) | — | — | — | — | — |
| (34) | fR1/(−fR3) | — | — | — | — | 0.8079 |
| (35) | fR2/fR4 | — | — | — | — | 0.1595 |
| (36) | fR2/fR3 | 2.6637 | 0.7024 | 0.2714 | 0.4932 | — |
| (37) | fR3/fR4 | — | — | — | — | — |
| (38) | (−fR2)/(−fR3) | — | — | — | — | — |

TABLE 99

| Expression | | | | | | |
|---|---|---|---|---|---|---|
| number | | Example 21 | Example 22 | Example 23 | Example 24 | Example 25 |
| (1) | TLw/(ft × tanωt) | 5.2521 | 6.2401 | 5.5387 | 5.2366 | 5.5163 |
| (2) | Bfw/(ft × tanωt) | 0.8401 | 1.2962 | 0.6635 | 1.2312 | 0.4988 |
| (3) | (fw × TLw)/(ft² × FNow) | 0.1307 | 0.1330 | 0.1130 | 0.1275 | 0.1384 |
| (4) | tanωw/FNow | 0.3244 | 0.3315 | 0.2612 | 0.3238 | 0.3530 |
| (5) | FNow/(ft/fw) | 1.2483 | 1.0915 | 1.2486 | 1.2264 | 1.0911 |
| (6) | fw/f1 | 0.1169 | 0.1271 | 0.1289 | 0.1645 | 0.1512 |
| (7) | f1/(−fMw) | 9.2241 | 7.2443 | 7.7034 | 6.0877 | 6.3626 |
| (8) | (−fMw)/(fw × ft)^{1/2} | 0.5106 | 0.5805 | 0.5545 | 0.5524 | 0.5724 |
| (9) | f1/(ft/FNot) | 10.6814 | 16.1171 | 9.7111 | 12.2919 | 11.1082 |
| (10) | TLw/fw | 5.8674 | 6.2209 | 5.0684 | 5.4643 | 5.4259 |
| (11) | FNot × (TLt/ft) | 9.8780 | 16.5572 | 8.5502 | 15.1092 | 12.6431 |
| (12) | f1/fR1 | 2.7115 | 6.6406 | 2.5317 | 2.7561 | 5.0839 |
| (13) | TLw/ft | 1.7777 | 1.7775 | 1.5360 | 1.6712 | 1.6445 |
| (14) | ft/fw | 3.3005 | 3.4998 | 3.2997 | 3.2697 | 3.2995 |
| (15) | f1/(fw × ft)^{1/2} | 4.7100 | 4.2052 | 4.2713 | 3.3625 | 3.6421 |
| (16) | TLt/TLw | 1.3487 | 1.2991 | 1.3478 | 1.3678 | 1.3878 |
| (17) | fw/fRw | 0.7279 | 0.7463 | 0.8271 | 0.6804 | 0.7672 |
| (18) | ft/fRt | 2.6598 | 2.1377 | 1.9423 | 1.7090 | 2.2020 |
| (19) | fR1/(fw × ft)^{1/2} | 1.7370 | 0.6333 | 1.6871 | 1.2200 | 0.7164 |
| (20) | fw/fR1 | 0.3169 | 0.8441 | 0.3263 | 0.4533 | 0.7685 |
| (21) | \|fIS/ft\| | 0.5307 | 0.7340 | 0.4930 | 0.4853 | 0.4806 |
| (22) | \|ff/ft\| | 0.6462 | 0.4688 | 1.1748 | 0.7597 | 0.6227 |
| (23) | Ndn + 0.01 × νdn | — | — | 2.0845 | — | 2.0984 |
| (24) | Ndp + 0.01 × νdp | — | — | 2.2685 | — | 2.3124 |
| (25) | νd1p_ave | 52.32 | 70.24 | 48.07 | 70.24 | 68.11 |
| (26) | d1sum/f1 | 0.0261 | 0.0253 | 0.0457 | 0.0681 | 0.0829 |

TABLE 100

| Expression | | | | | | |
|---|---|---|---|---|---|---|
| number | | Example 21 | Example 22 | Example 23 | Example 24 | Example 25 |
| (27) | fM1/fM2 | — | — | — | — | — |
| (28), (28A), | fR1/(−fR2) | — | — | — | — | 0.7048 |
| (28B) | | | | | | |
| (29), (29A) | fR2/(−fR3) | 0.6370 | — | — | — | — |
| (30), (30A), | fR1/fR2 | 2.3226 | 0.4479 | 2.9703 | 1.3902 | — |
| (30B), (30C) | | | | | | |
| (31) | (−fR2)/fR3 | — | — | — | — | 1.1643 |
| (32) | fR1/fR3 | — | — | — | — | 0.8206 |
| (33) | (−fR2)/(−fR4) | — | — | — | — | 0.8987 |
| (34) | fR1/(−fR3) | 1.4796 | — | — | — | — |
| (35) | fR2/fR4 | 0.6577 | — | — | — | — |
| (36) | fR2/fR3 | — | — | — | — | — |
| (37) | fR3/fR4 | — | 0.3998 | 3.3656 | 0.0430 | — |
| (38) | (−fR2)/(−fR3) | — | — | — | — | — |

TABLE 101

| Expression | | | | | | |
|---|---|---|---|---|---|---|
| number | | Example 26 | Example 27 | Example 28 | Example 29 | Example 30 |
| (1) | TLw/(ft × tanωt) | 5.6005 | 5.4127 | 5.2864 | 5.1989 | 5.6761 |
| (2) | Bfw/(ft × tanωt) | 0.5030 | 1.0462 | 0.9620 | 1.1163 | 0.4747 |
| (3) | (fw × TLw)/(ft² × FNow) | 0.1121 | 0.1227 | 0.1241 | 0.1104 | 0.1308 |
| (4) | tanωw/FNow | 0.2976 | 0.3341 | 0.3008 | 0.2900 | 0.3040 |
| (5) | FNow/(ft/fw) | 1.1769 | 1.1772 | 1.2713 | 1.2271 | 1.2486 |
| (6) | fw/f1 | 0.1264 | 0.1226 | 0.1294 | 0.1112 | 0.1270 |
| (7) | f1/(−fMw) | 7.3451 | 10.5536 | 6.8352 | 8.2678 | 12.1119 |
| (8) | (−fMw)/(fw × ft)^{1/2} | 0.5759 | 0.4131 | 0.6282 | 0.5941 | 0.3580 |
| (9) | f1/(ft/FNot) | 9.3145 | 9.6015 | 9.8267 | 19.5129 | 9.8823 |
| (10) | TLw/fw | 5.6589 | 6.1915 | 5.3686 | 5.0918 | 5.8697 |
| (11) | FNot × (TLt/ft) | 9.4281 | 11.4285 | 9.3248 | 15.1860 | 10.1427 |
| (12) | f1/fR1 | 2.6979 | 4.4788 | 7.0274 | 8.7476 | 4.1029 |
| (13) | TLw/ft | 1.6165 | 1.7691 | 1.6567 | 1.5203 | 1.7788 |
| (14) | ft/fw | 3.5007 | 3.4997 | 3.2407 | 3.3493 | 3.2998 |
| (15) | f1/(fw × ft)^{1/2} | 4.2300 | 4.3597 | 4.2936 | 4.9120 | 4.3361 |
| (16) | TLt/TLw | 1.4156 | 1.5679 | 1.3662 | 1.3740 | 1.3773 |
| (17) | fw/fRw | 0.7468 | 0.6121 | 0.7566 | 0.7546 | 0.7171 |
| (18) | ft/fRt | 2.5608 | 1.5611 | 2.4387 | 1.9411 | 1.8258 |
| (19) | fR1/(fw × ft)^{1/2} | 1.5679 | 0.9734 | 0.6110 | 0.5615 | 1.0568 |
| (20) | fw/fR1 | 0.3409 | 0.5491 | 0.9092 | 0.9731 | 0.5209 |
| (21) | \|fIS/ft\| | 0.5029 | — | 0.3453 | 0.5900 | 0.4499 |
| (22) | \|ff/ft\| | 0.7480 | 0.9499 | 0.6615 | 0.5718 | 0.5084 |
| (23) | Ndn + 0.01 × νdn | — | — | 2.1959 | — | 2.1509 |
| (24) | Ndp + 0.01 × νdp | — | — | 2.3053 | — | 2.2785 |
| (25) | νd1p_ave | 52.32 | 64.20 | 75.50 | 64.20 | 50.31 |
| (26) | d1sum/f1 | 0.0204 | 0.0496 | 0.0656 | 0.0244 | 0.0357 |

TABLE 102

| Expression | | | | | | |
|---|---|---|---|---|---|---|
| number | | Example 26 | Example 27 | Example 28 | Example 29 | Example 30 |
| (27) | fM1/fM2 | — | — | 0.0724 | 0.6263 | 0.1814 |
| (28), (28A), | fR1/(−fR2) | — | — | 0.5131 | 0.5366 | — |
| (28B) | | | | | | |
| (29), (29A) | fR2/(−fR3) | 0.5924 | 1.3881 | — | — | 1.0536 |
| (30), (30A), | fR1/fR2 | 1.8910 | 1.0178 | — | — | 1.0862 |
| (30B), (30C) | | | | | | |
| (31) | (−fR2)/fR3 | — | — | — | — | — |
| (32) | fR1/fR3 | — | — | — | — | — |
| (33) | (−fR2)/(−fR4) | — | — | — | — | — |
| (34) | fR1/(−fR3) | 1.1203 | 1.4128 | — | — | 1.1443 |
| (35) | fR2/fR4 | 0.4957 | 0.9964 | — | — | 0.6173 |
| (36) | fR2/fR3 | — | — | — | — | — |
| (37) | fR3/fR4 | — | — | — | — | — |
| (38) | (−fR2)/(−fR3) | — | — | 0.1071 | 0.2194 | — |

The variable magnification optical systems of Examples 1 to 30 maintain high optical performance by favorably correcting various aberrations in an entire magnification range, while being configured to be reduced in size.

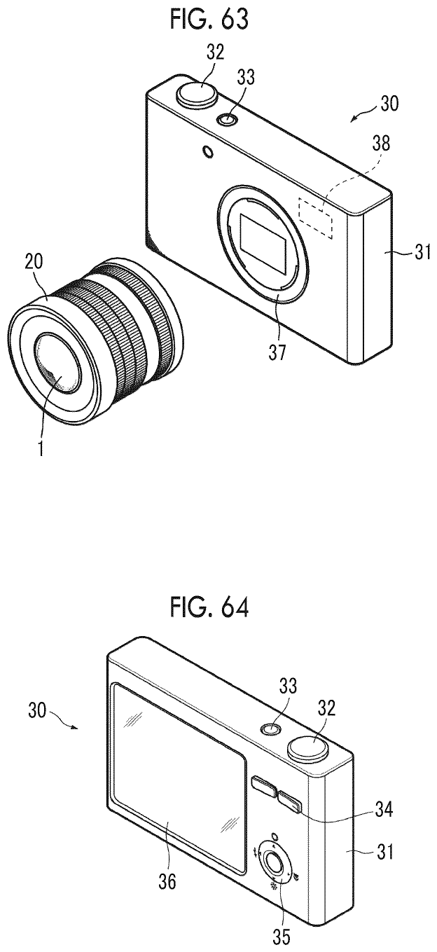

Next, an imaging apparatus according to the embodiment of the present disclosure will be described. FIGS. 63 and 64 are external views of a camera 30 that is the imaging apparatus according to the embodiment of the present disclosure. FIG. 63 is a perspective view of the camera 30 as seen from a front side, and FIG. 64 is a perspective view of the camera 30 as seen from a rear side. The camera 30 is a so-called mirrorless type digital camera in which an interchangeable lens 20 can be attachably and detachably mounted. The interchangeable lens 20 includes a variable magnification optical system 1 according to the embodiment of the present disclosure accommodated in a lens barrel.

The camera 30 comprises a camera body 31. An upper surface of the camera body 31 is provided with a shutter button 32 and a power button 33. In addition, an operation unit 34, an operation unit 35, and a display unit 36 are provided on a rear surface of the camera body 31. The display unit 36 can display a captured image and an image within an angle of view before capturing.

An imaging aperture on which light from an imaging target is incident is provided at a center portion of a front surface of the camera body 31. A mount 37 is provided at a position corresponding to the imaging aperture, and the interchangeable lens 20 is mounted in the camera body 31 via the mount 37.

An imaging element 38 is provided inside the camera body 31. The imaging element 38 outputs an imaging signal corresponding to a subject image formed by the interchangeable lens 20. As the imaging element 38, for example, a charge-coupled device (CCD) or a complementary metal-oxide-semiconductor (CMOS) is used. A signal processing circuit (not shown), a recording medium (not shown), and the like are provided inside the camera body 31. The signal processing circuit generates an image by processing the imaging signal output from the imaging element 38. The recording medium is used for recording the generated image. In the camera 30, a still image or a moving image can be captured by pressing the shutter button 32, and image data obtained by this capturing is recorded on the recording medium.

The technology of the present disclosure has been hitherto described through the embodiments and the examples, but the technology of the present disclosure is not limited to the above-mentioned embodiments and examples, and may be modified into various forms. For example, a curvature radius, a surface spacing, a refractive index, an Abbe number, an aspherical coefficient, and the like of each lens are not limited to values shown in the examples, and different values may be used.

In addition, the imaging apparatus according to the embodiment of the present disclosure is not limited to the above-described example and can have various aspects of, for example, a camera of a type other than a mirrorless type, a film camera, a video camera, and a security camera.

Regarding the above-described embodiments and examples, the following Supplementary Notes will be further disclosed.

### [Supplementary Note 1]

A variable magnification optical system consisting of a first lens group having a positive refractive power, an intermediate group consisting of two or fewer lens groups that have a negative refractive power, and a subsequent group consisting of a plurality of lens groups in order from an object side to an image side, in which a lens group of the subsequent group that is closest to the object side has a positive refractive power, the first lens group moves and all spacings of adjacent lens groups change during changing a magnification, and in a case in which a sum of a distance on an optical axis from a lens surface of the first lens group that is closest to the object side to a lens surface of the subsequent group that is closest to the image side and a back focus of an entire system in an air-equivalent distance, in a state in which an infinite distance object is in focus at a wide angle end, is denoted by TLw, a focal length of the entire system in a state in which the infinite distance object is in focus at a telephoto end is denoted by ft, a maximum half angle of view in a state in which the infinite distance object is in focus at the telephoto end is denoted by ωt, the back focus of the entire system in the air-equivalent distance in a state in which the infinite distance object is in focus at the wide angle end is denoted by Bfw, a focal length of the entire system in a state in which the infinite distance object is in focus at the wide angle end is denoted by fw, and an open F-number in a state in which the infinite distance object is in focus at the wide angle end is denoted by FNow, Conditional Expressions (1), (2), and (3) are satisfied, which are represented by

$$2.9 < TLw / ( ft \times tan ω t ) < 7 , \qquad ( 1 )$$

$$0.4 < Bfw / ( ft \times tan ω t ) < 1.5 , and \qquad ( 2 )$$

$$0.05 < ( fw \times TLw ) / ( {ft}^{2} \times FNow ) < 0.23 . \qquad ( 3 )$$

### [Supplementary Note 2]

The variable magnification optical system according to Supplementary Note 1, in which Conditional Expression (1-1) is satisfied, which is represented by

$$3.5 < TLw / ( ft \times tan ω t ) < 6. \qquad ( 1 - 1 )$$

### [Supplementary Note 3]

The variable magnification optical system according to Supplementary Note 1 or 2, in which Conditional Expression (3-1) is satisfied, which is represented by

$$0.08 < ( fw \times TLw ) / ( {ft}^{2} \times FNow ) < 0.165 . \qquad ( 3 - 1 )$$

### [Supplementary Note 4]

The variable magnification optical system according to Supplementary Note 3, in which Conditional Expression (3-2) is satisfied, which is represented by

$$0.1 < ( fw \times TLw ) / ( {ft}^{2} \times FNow ) < 0.16 . \qquad ( 3 - 2 )$$

### [Supplementary Note 5]

The variable magnification optical system according to any one of Supplementary Notes 1 to 4, in which in a case in which a maximum half angle of view in a state in which the infinite distance object is in focus at the wide angle end is denoted by ωw, Conditional Expression (4) is satisfied, which is represented by

$$0.15 < tan ω w / FNow < 0.5 . \qquad ( 4 )$$

### [Supplementary Note 6]

The variable magnification optical system according to Supplementary Note 5, in which Conditional Expression (4-1) is satisfied, which is represented by

$$0.21 < tan ω w / FNow < 0.35 . \qquad ( 4 - 1 )$$

### [Supplementary Note 7]

The variable magnification optical system according to any one of Supplementary Notes 1 to 6, in which Conditional Expression (5) is satisfied, which is represented by

$$0.65 < FNow / ( ft / fw ) < 1.6 . \qquad ( 5 )$$

### [Supplementary Note 8]

The variable magnification optical system according to Supplementary Note 7, in which Conditional Expression (5-1) is satisfied, which is represented by

$$0.85 < FNow / ( ft / fw ) < 1.28 . \qquad ( 5 - 1 )$$

### [Supplementary Note 9]

The variable magnification optical system according to any one of Supplementary Notes 1 to 8, in which in a case in which a focal length of the first lens group is denoted by f1, Conditional Expression (6) is satisfied, which is represented by

$$0.02 < fw / f 1 < 0.3 . \qquad ( 6 )$$

### [Supplementary Note 10]

The variable magnification optical system according to Supplementary Note 9, in which Conditional Expression (6-1) is satisfied, which is represented by

$$0.048 < fw / f 1 < 0.14 . \qquad ( 7 )$$

### [Supplementary Note 11]

The variable magnification optical system according to Supplementary Note 9, in which Conditional Expression (6-2) is satisfied, which is represented by

$$0.05 < fw / f 1 < 0.13 . \qquad ( 6 - 2 )$$

### [Supplementary Note 12]

The variable magnification optical system according to any one of Supplementary Notes 1 to 11, in which in a case in which a focal length of the first lens group is denoted by f1, and a focal length of the intermediate group in a state in which the infinite distance object is in focus at the wide angle end is denoted by fMw, Conditional Expression (7) is satisfied, which is represented by

$$4.5 < f 11 / ( - fMw ) < 14. \qquad ( 7 )$$

### [Supplementary Note 13]

The variable magnification optical system according to Supplementary Note 12, in which Conditional Expression (7-1) is satisfied, which is represented by

$$5.7 < f 1 / ( - fMw ) < 8.7 . \qquad ( 7 - 1 )$$

### [Supplementary Note 14]

The variable magnification optical system according to any one of Supplementary Notes 1 to 13, in which in a case in which a focal length of the intermediate group in a state in which the infinite distance object is in focus at the wide angle end is denoted by fMw, Conditional Expression (8) is satisfied, which is represented by

$$0.3 < ( - fMw ) / {( fw \times ft )}^{1 / 2} < 1.4 . \qquad ( 8 )$$

### [Supplementary Note 15]

The variable magnification optical system according to Supplementary Note 14, in which Conditional Expression (8-1) is satisfied, which is represented by

$$0.6 < ( - fMw ) / {( fw \times ft )}^{1 / 2} < 0.9 . \qquad ( 8 - 1 )$$

### [Supplementary Note 16]

The variable magnification optical system according to any one of Supplementary Notes 1 to 15, in which in a case in which a focal length of the first lens group is denoted by fl, and an open F-number in a state where the infinite distance object is in focus at the telephoto end is denoted by FNot, Conditional Expression (9) is satisfied, which is represented by

$$5 < f 1 / ( ft / FNot ) < 20. \qquad ( 9 )$$

### [Supplementary Note 17]

The variable magnification optical system according to Supplementary Note 16, in which Conditional Expression (9-1) is satisfied, which is represented by

$$7 < f 1 / ( ft / FNot ) < 11. \qquad ( 9 - 1 )$$

### [Supplementary Note 18]

The variable magnification optical system according to any one of Supplementary Notes 1 to 17, in which Conditional Expression (10) is satisfied, which is represented by

$$2.5 < TLw / fw < 8. \qquad ( 10 )$$

### [Supplementary Note 19]

The variable magnification optical system according to Supplementary Note 18, in which Conditional Expression (10-1) is satisfied, which is represented by

$$3.5 < TLw / fw < 6. \qquad ( 10 - 1 )$$

### [Supplementary Note 20]

The variable magnification optical system according to any one of Supplementary Notes 1 to 19, in which the first lens group includes a negative lens and a positive lens.

### [Supplementary Note 21]

The variable magnification optical system according to any one of Supplementary Notes 1 to 20, in which the intermediate group includes three negative lenses.

### [Supplementary Note 22]

The variable magnification optical system according to any one of Supplementary Notes 1 to 21, in which the intermediate group includes an Lmn lens having a negative refractive power, and a surface of the Lmn lens on the object side is an aspherical surface in which a refractive power at a position of a maximum effective diameter is shifted in a positive direction compared to a refractive power in a paraxial region.

### [Supplementary Note 23]

The variable magnification optical system according to Supplementary Note 22, in which the surface of the Lmn lens on the object side has a concave shape in the paraxial region and has a convex shape in a peripheral portion including the position of the maximum effective diameter.

### [Supplementary Note 24]

The variable magnification optical system according to any one of Supplementary Notes 1 to 23, in which in a case in which an open F-number in a state in which the infinite distance object is in focus at the telephoto end is denoted by FNot, and a sum of a distance on the optical axis from the lens surface of the first lens group that is closest to the object side to the lens surface of the subsequent group that is closest to the image side and a back focus of the entire system in the air-equivalent distance, in a state in which the infinite distance object is in focus at the telephoto end, is denoted by TLt, Conditional Expression (11) is satisfied, which is represented by

$$8 < FNot \times ( TLt / ft ) < 17. \qquad ( 11 )$$

### [Supplementary Note 25]

The variable magnification optical system according to any one of Supplementary Notes 1 to 24, in which in a case in which a focal length of the first lens group is denoted by f1, and a focal length of the lens group of the subsequent group that is closest to the object side is denoted by fR1, Conditional Expression (12) is satisfied, which is represented by

$$1.5 < f 1 / fR 1 < 17. \qquad ( 12 )$$

### [Supplementary Note 26]

The variable magnification optical system according to any one of Supplementary Notes 1 to 25, in which Conditional Expression (13) is satisfied, which is represented by

$$1.2 < TLw / ft < 2.2 . \qquad ( 13 )$$

### [Supplementary Note 27]

The variable magnification optical system according to any one of Supplementary Notes 1 to 26, in which Conditional Expression (14) is satisfied, which is represented by

$$2.8 < ft / fw < 4. \qquad ( 14 )$$

### [Supplementary Note 28]

The variable magnification optical system according to any one of Supplementary Notes 1 to 27, in which in a case in which a focal length of the first lens group is denoted by f1, Conditional Expression (15) is satisfied, which is represented by

$$3 < f 1 / {( fw \times ft )}^{1 / 2} < 9. \qquad ( 15 )$$

### [Supplementary Note 29]

The variable magnification optical system according to any one of Supplementary Notes 1 to 28, in which in a case in which a sum of a distance on the optical axis from the lens surface of the first lens group that is closest to the object side to the lens surface of the subsequent group that is closest to the image side and a back focus of the entire system in terms of the air-equivalent distance, in a state in which the infinite distance object is in focus at the telephoto end, is denoted by TLt, Conditional Expression (16) is satisfied, which is represented by

$$1.25 < TLt / TLw < 1.6 . \qquad ( 16 )$$

### [Supplementary Note 30]

The variable magnification optical system according to any one of Supplementary Notes 1 to 29, in which in a case in which a focal length of the subsequent group in a state in which the infinite distance object is in focus at the wide angle end is denoted by fRw, Conditional Expression (17) is satisfied, which is represented by

$$0.3 < fw / fRw < 1.2 . \qquad ( 17 )$$

### [Supplementary Note 31]

The variable magnification optical system according to any one of Supplementary Notes 1 to 30, in which in a case in which a focal length of the subsequent group in a state in which the infinite distance object is in focus at the telephoto end is denoted by fRt, Conditional Expression (18) is satisfied, which is represented by

$$0.6 < ft / fRt < 5. \qquad ( 18 )$$

### [Supplementary Note 32]

The variable magnification optical system according to any one of Supplementary Notes 1 to 31, in which in a case in which a focal length of the lens group of the subsequent group that is closest to the object side is denoted by fR1, Conditional Expression (19) is satisfied, which is represented by

$$0.5 < fR 1 / {( fw \times ft )}^{1 / 2} < 3. \qquad ( 19 )$$

### [Supplementary Note 33]

The variable magnification optical system according to any one of Supplementary Notes 1 to 32, in which in a case in which a focal length of the lens group of the subsequent group that is closest to the object side is denoted by fR1, Conditional Expression (20) is satisfied, which is represented by

$$0.15 < fw / fR 1 < 2. \qquad ( 20 )$$

### [Supplementary Note 34]

The variable magnification optical system according to any one of Supplementary Notes 1 to 33, in which an anti-vibration group that moves in a direction intersecting the optical axis during image shake correction is disposed in the subsequent group, and in a case in which a focal length of the anti-vibration group is denoted by fIS, Conditional Expression (21) is satisfied, which is represented by

$$0.2 < \vert fIS / ft \vert < 2. \qquad ( 21 )$$

### [Supplementary Note 35]

The variable magnification optical system according to any one of Supplementary Notes 1 to 34, in which at least one focusing group that moves along the optical axis during focusing is disposed in the subsequent group, and in a case in which a focal length of the at least one focusing group is denoted by ff, Conditional Expression (22) is satisfied, which is represented by

$$0.2 < \vert ff / ft \vert < 1.4 . \qquad ( 22 )$$

### [Supplementary Note 36]

The variable magnification optical system according to any one of Supplementary Notes 1 to 35, in which the subsequent group includes an Lrn lens having a negative refractive power, and a surface of the Lrn lens on the image side is an aspherical surface in which a refractive power at a position of a maximum effective diameter is shifted in a positive direction compared to a refractive power in a paraxial region.

### [Supplementary Note 37]

The variable magnification optical system according to Supplementary Note 36, in which the surface of the Lrn lens on the image side has a concave shape in the paraxial region and has a convex shape in a peripheral portion including the position of the maximum effective diameter.

### [Supplementary Note 38]

The variable magnification optical system according to any one of Supplementary Notes 1 to 37, in which a focusing group that moves along the optical axis during focusing is disposed only in the subsequent group.

### [Supplementary Note 39]

The variable magnification optical system according to Supplementary Note 38, in which two focusing groups that move by changing a mutual spacing during focusing are disposed in the subsequent group.

### [Supplementary Note 40]

The variable magnification optical system according to any one of Supplementary Notes 1 to 39, in which the first lens group includes a cemented lens formed by a negative meniscus lens having a convex surface facing the object side and a positive lens having a convex surface facing the object side cemented together in order from the object side, and in a case in which a refractive index of the negative meniscus lens for a d line is denoted by Ndn, and an Abbe number of the negative meniscus lens based on the d line is denoted by vdn, Conditional Expression (23) is satisfied, which is represented by

$$1.94 < Ndn + 0.01 \times vdn < 2.5 . \qquad ( 23 )$$

### [Supplementary Note 41]

The variable magnification optical system according to Supplementary Note 40, in which in a case in which a refractive index of the positive lens for the d line is denoted by Ndp, the positive lens having the convex surface facing the object side, and an Abbe number of the positive lens based on the d line is denoted by vdp, the positive lens having the convex surface facing the object side, Conditional Expression (24) is satisfied, which is represented by

$$2 < Ndp + 0.01 \times vdp < 2.6 . \qquad ( 24 )$$

### [Supplementary Note 42]

The variable magnification optical system according to any one of Supplementary Notes 1 to 41, in which in a case in which an average value of Abbe numbers of all positive lenses of the first lens group based on a d line is denoted by vd1p_ave, Conditional Expression (25) is satisfied, which is represented by

$$40 < vd 1 p\_ave < 85. \qquad ( 25 )$$

### [Supplementary Note 43]

The variable magnification optical system according to any one of Supplementary Notes 1 to 42, in which in a case in which a sum of thicknesses of all lenses of the first lens group on the optical axis is denoted by d1 sum, and a focal length of the first lens group is denoted by f1, Conditional Expression (26) is satisfied, which is represented by

$$0.01 < d 1 sum / f 1 < 0.2 . \qquad ( 26 )$$

### [Supplementary Note 44]

The variable magnification optical system according to any one of Supplementary Notes 1 to 43, in which the intermediate group consists of two lens groups having a negative refractive power, and in a case in which a focal length of a lens group of the intermediate group that is closest to the object side is denoted by fM1, and a focal length of a lens group of the intermediate group that is closest to the image side is denoted by fM2, Conditional Expression (27) is satisfied, which is represented by

$$0.01 < fM 1 / fM 2 < 1.6 . \qquad ( 27 )$$

### [Supplementary Note 45]

The variable magnification optical system according to any one of Supplementary Notes 1 to 44, in which the subsequent group consists of a first subsequent lens group having a positive refractive power, a second subsequent lens group having a negative refractive power, and a third subsequent lens group in order from the object side to the image side.

### [Supplementary Note 46]

The variable magnification optical system according to Supplementary Note 45, in which in a case in which a focal length of the first subsequent lens group is denoted by fR1, and a focal length of the second subsequent lens group is denoted by fR2, Conditional Expression (28) is satisfied, which is represented by

$$0.2 < fR 1 / ( - fR 2 ) < 2. \qquad ( 28 )$$

### [Supplementary Note 47]

The variable magnification optical system according to any one of Supplementary Notes 1 to 44, in which the subsequent group consists of a first subsequent lens group having a positive refractive power, a second subsequent lens group having a positive refractive power, and a third subsequent lens group having a negative refractive power in order from the object side to the image side.

### [Supplementary Note 48]

The variable magnification optical system according to Supplementary Note 47, in which in a case in which a focal length of the second subsequent lens group is denoted by fR2, and a focal length of the third subsequent lens group is denoted by fR3, Conditional Expression (29) is satisfied, which is represented by

$$0.4 < fR 2 / ( - fR 3 ) < 3.7 . \qquad ( 29 )$$

### [Supplementary Note 49]

The variable magnification optical system according to Supplementary Note 47 or 48, in which in a case in which a focal length of the first subsequent lens group is denoted by fR1, and a focal length of the second subsequent lens group is denoted by fR2, Conditional Expression (30) is satisfied, which is represented by

$$0.3 < fR 1 / fR 2 < 4. \qquad ( 30 )$$

### [Supplementary Note 50]

The variable magnification optical system according to any one of Supplementary Notes 1 to 44, in which the subsequent group includes at least a first subsequent lens group having a positive refractive power, a second subsequent lens group having a negative refractive power, a third subsequent lens group having a positive refractive power, and a fourth subsequent lens group having a negative refractive power consecutively in order from the object side to the image side.

### [Supplementary Note 51]

The variable magnification optical system according to Supplementary Note 50, in which in a case in which a focal length of the first subsequent lens group is denoted by fR1, and a focal length of the second subsequent lens group is denoted by fR2, Conditional Expression (28A) is satisfied, which is represented by

$$0. 2 < fR 1 / ( - fR 2 ) < 1.5 . \qquad ( 28 A )$$

### [Supplementary Note 52]

The variable magnification optical system according to Supplementary Note 50 or 51, in which in a case in which a focal length of the second subsequent lens group is denoted by fR2, and a focal length of the third subsequent lens group is denoted by fR3, Conditional Expression (31) is satisfied, which is represented by

$$0.3 < ( - fR 2 ) / fR 3 < 2.4 . \qquad ( 31 )$$

### [Supplementary Note 53]

The variable magnification optical system according to any one of Supplementary Notes 50 to 52, in which in a case in which a focal length of the first subsequent lens group is denoted by fR1, and a focal length of the third subsequent lens group is denoted by fR3, Conditional Expression (32) is satisfied, which is represented by

$$0.1 < fR 1 / fR 3 < 1.4 . \qquad ( 32 )$$

### [Supplementary Note 54]

The variable magnification optical system according to any one of Supplementary Notes 50 to 53, in which in a case in which a focal length of the second subsequent lens group is denoted by fR2, and a focal length of the fourth subsequent lens group is denoted by fR4, Conditional Expression (33) is satisfied, which is represented by

$$0.15 < ( - fR 2 ) / ( - fR 4 ) < 1.8 . \qquad ( 33 )$$

### [Supplementary Note 55]

The variable magnification optical system according to any one of Supplementary Notes 1 to 44, in which the subsequent group includes at least a first subsequent lens group having a positive refractive power, a second subsequent lens group having a positive refractive power, a third subsequent lens group having a negative refractive power, and a fourth subsequent lens group having a positive refractive power consecutively in order from the object side to the image side.

### [Supplementary Note 56]

The variable magnification optical system according to Supplementary Note 55, in which in a case in which a focal length of the first subsequent lens group is denoted by fR1, and a focal length of the third subsequent lens group is denoted by fR3, Conditional Expression (34) is satisfied, which is represented by

$$0. 4 < fR 1 / ( - fR 3 ) < 2.5 . \qquad ( 34 )$$

### [Supplementary Note 57]

The variable magnification optical system according to Supplementary Note 55 or 56, in which in a case in which a focal length of the second subsequent lens group is denoted by fR2, and a focal length of the third subsequent lens group is denoted by fR3, Conditional Expression (29A) is satisfied, which is represented by

$$0.3 < fR 2 / ( - fR 3 ) < 3.5 . \qquad ( 29 A )$$

### [Supplementary Note 58]

The variable magnification optical system according to any one of Supplementary Notes 55 to 57, in which in a case in which a focal length of the first subsequent lens group is denoted by fR1, and a focal length of the second subsequent lens group is denoted by fR2, Conditional Expression (30A) is satisfied, which is represented by

$$0.3 < fR 1 / fR 2 < 5. \qquad ( 30 A )$$

### [Supplementary Note 59]

The variable magnification optical system according to any one of Supplementary Notes 55 to 58, in which in a case in which a focal length of the second subsequent lens group is denoted by fR2, and a focal length of the fourth subsequent lens group is denoted by fR4, Conditional Expression (35) is satisfied, which is represented by

$$0 \text{.1} < fR 2 / fR 4 < 2. \qquad ( 35 )$$

### [Supplementary Note 60]

The variable magnification optical system according to any one of Supplementary Notes 1 to 44, in which the subsequent group consists of a first subsequent lens group having a positive refractive power, a second subsequent lens group having a positive refractive power, a third subsequent lens group having a positive refractive power, a fourth subsequent lens group, and a fifth subsequent lens group in order from the object side to the image side.

### [Supplementary Note 61]

The variable magnification optical system according to Supplementary Note 60, in which in a case in which a focal length of the first subsequent lens group is denoted by fR1, and a focal length of the second subsequent lens group is denoted by fR2, Conditional Expression (30B) is satisfied, which is represented by

$$0.1 < fR 1 / fR 2 < 4.5 . \qquad ( 30 B )$$

### [Supplementary Note 62]

The variable magnification optical system according to Supplementary Note 60 or 61, in which in a case in which a focal length of the second subsequent lens group is denoted by fR2, and a focal length of the third subsequent lens group is denoted by fR3, Conditional Expression (36) is satisfied, which is represented by

$$0. 2 < fR 2 / fR 3 < 3. \qquad ( 36 )$$

### [Supplementary Note 63]

The variable magnification optical system according to any one of Supplementary Notes 1 to 44, in which the subsequent group consists of a first subsequent lens group having a positive refractive power, a second subsequent lens group having a positive refractive power, a third subsequent lens group having a negative refractive power, a fourth subsequent lens group having a negative refractive power, and a fifth subsequent lens group having a positive refractive power in order from the object side to the image side.

### [Supplementary Note 64]

The variable magnification optical system according to Supplementary Note 63, in which in a case in which a focal length of the first subsequent lens group is denoted by fR1, and a focal length of the second subsequent lens group is denoted by fR2, Conditional Expression (30C) is satisfied, which is represented by

$$0. 2 < fR 1 / fR 2 < 4. \qquad ( 30 C )$$

### [Supplementary Note 65]

The variable magnification optical system according to Supplementary Note 63 or 64, in which in a case in which a focal length of the third subsequent lens group is denoted by fR3, and a focal length of the fourth subsequent lens group is denoted by fR4, Conditional Expression (37) is satisfied, which is represented by

$$0.01 < fR 3 / fR 4 < 4. \qquad ( 37 )$$

### [Supplementary Note 66]

The variable magnification optical system according to any one of Supplementary Notes 1 to 44, in which the subsequent group includes at least a first subsequent lens group having a positive refractive power, a second subsequent lens group having a negative refractive power, and a third subsequent lens group having a negative refractive power consecutively in order from the object side to the image side.

### [Supplementary Note 67]

The variable magnification optical system according to Supplementary Note 66, in which in a case in which a focal length of the first subsequent lens group is denoted by fR1, and a focal length of the second subsequent lens group is denoted by fR2, Conditional Expression (28B) is satisfied, which is represented by

$$0. 2 < fR 1 / ( - fR 2 ) < 1.8 . \qquad ( 28 B )$$

### [Supplementary Note 68]

The variable magnification optical system according to Supplementary Note 66 or 67, in which in a case in which a focal length of the second subsequent lens group is denoted by fR2, and a focal length of the third subsequent lens group is denoted by fR3, Conditional Expression (38) is satisfied, which is represented by

$$0.05 < ( - fR 2 ) / ( - fR 3 ) < 1.2 . \qquad ( 38 )$$

### [Supplementary Note 69]

An imaging apparatus comprising: the variable magnification optical system according to any one of Supplementary Notes 1 to 68.

All documents, patent applications, and technical standards described in the present specification are herein incorporated by reference to the same extent that each individual document, patent application, or technical standard was specifically and individually indicated to be incorporated by reference.

What is claimed is:

1. A variable magnification optical system consisting of a first lens group having a positive refractive power, an intermediate group consisting of two or fewer lens groups that have a negative refractive power, and a subsequent group consisting of a plurality of lens groups in order from an object side to an image side,
wherein a lens group of the subsequent group that is closest to the object side has a positive refractive power,
the first lens group moves and all spacings of adjacent lens groups change during changing a magnification, and
in a case in which
a sum of a distance on an optical axis from a lens surface of the first lens group that is closest to the object side to a lens surface of the subsequent group that is closest to the image side and a back focus of the variable magnification optical system in an air-equivalent distance, in a state in which an infinite distance object is in focus at a wide angle end, is denoted by TLw,
a focal length of the variable magnification optical system in a state in which the infinite distance object is in focus at a telephoto end is denoted by ft,
a maximum half angle of view in a state in which the infinite distance object is in focus at the telephoto end is denoted by ωt,
the back focus of the variable magnification optical system in the air-equivalent distance in a state in which the infinite distance object is in focus at the wide angle end is denoted by Bfw,
a focal length of the variable magnification optical system in a state in which the infinite distance object is in focus at the wide angle end is denoted by fw, and
an open F-number in a state in which the infinite distance object is in focus at the wide angle end is denoted by FNow,
Conditional Expressions (1), (2), and (3) are satisfied, which are represented by
$$2.9 < TLw / ( f t \times tan ω t ) < 7 , \qquad ( 1 )$$
$$0.4 < BFw / ( f t \times tan ω t ) < 1.5 , and \qquad ( 2 )$$
$$0.05 < ( fw \times TLw ) / ( f {t}^{2} \times FNow ) < 0.23 . \qquad ( 3 )$$

2. The variable magnification optical system according to claim 1,
wherein Conditional Expression (3-1) is satisfied, which is represented by
$$0.08 < ( f w \times T L w ) / ( f {t}^{2} \times F Now ) < 0.165 . \qquad ( 3 - 1 )$$

3. The variable magnification optical system according to claim 1,
wherein in a case in which a maximum half angle of view in a state in which the infinite distance object is in focus at the wide angle end is denoted by ωw, Conditional Expression (4) is satisfied, which is represented by
$$0.15 < tan ω w / FNow < 0.5 . \qquad ( 4 )$$

4. The variable magnification optical system according to claim 1,
wherein Conditional Expression (5) is satisfied, which is represented by
$$0.65 < FNow / ( f t / f w ) < 1.6 . \qquad ( 5 )$$

5. The variable magnification optical system according to claim 1,
wherein in a case in which a focal length of the first lens group is denoted by f1, Conditional Expression (6) is satisfied, which is represented by
$$0.02 < f w / f l < 0.3 . \qquad ( 6 )$$

6. The variable magnification optical system according to claim 1,
wherein in a case in which
a focal length of the first lens group is denoted by f1, and
a focal length of the intermediate group in a state in which the infinite distance object is in focus at the wide angle end is denoted by fMw,
Conditional Expression (7) is satisfied, which is represented by
$$4.5 < f l / ( - fMw ) < 14. \qquad ( 7 )$$

7. The variable magnification optical system according to claim 1,
wherein in a case in which a focal length of the intermediate group in a state in which the infinite distance object is in focus at the wide angle end is denoted by fMw, Conditional Expression (8) is satisfied, which is represented by
$$0.3 < ( - fMw ) / {( f w \times f t )}^{1 / 2} < 1.4 . \qquad ( 8 )$$

8. The variable magnification optical system according to claim 2,
wherein Conditional Expression (1-1) is satisfied, which is represented by
$$3. 5 < TLw / ( f t \times tan ω t ) < 6. \qquad ( 1 - 1 )$$

9. The variable magnification optical system according to claim 8,
wherein in a case in which a maximum half angle of view in a state in which the infinite distance object is in focus at the wide angle end is denoted by ωw, Conditional Expression (4-1) is satisfied, which is represented by
$$0. 21 < tan ω w / FNow < 0.35 . \qquad ( 4 - 1 )$$

10. The variable magnification optical system according to claim 9,
wherein Conditional Expression (5-1) is satisfied, which is represented by
$$0.85 < FNow / ( f t / f w ) < 1.28 . \qquad ( 5 - 1 )$$

11. The variable magnification optical system according to claim 10,
wherein in a case in which a focal length of the first lens group is denoted by f1, Conditional Expression (6-2) is satisfied, which is represented by
$$0.05 < f w / f l < 0.13 . \qquad ( 6 - 2 )$$

12. The variable magnification optical system according to claim 11,
wherein in a case in which a focal length of the intermediate group in a state in which the infinite distance object is in focus at the wide angle end is denoted by fMw, Conditional Expression (7-1) is satisfied, which is represented by
$$5.7 < f l / ( - fMw ) < 8.7 . \qquad ( 7 - 1 )$$

13. The variable magnification optical system according to claim 11,
wherein the intermediate group includes an Lmn lens having a negative refractive power, and
a surface of the Lmn lens on the object side is an aspherical surface in which a refractive power at a position of a maximum effective diameter is shifted in a positive direction compared to a refractive power in a paraxial region.

14. The variable magnification optical system according to claim 13,
wherein the surface of the Lmn lens on the object side has a concave shape in the paraxial region and has a convex shape in a peripheral portion including the position of the maximum effective diameter.

15. The variable magnification optical system according to claim 1,
wherein the intermediate group consists of two lens groups having a negative refractive power, and
in a case in which
a focal length of a lens group of the intermediate group that is closest to the object side is denoted by fM1, and
a focal length of a lens group of the intermediate group that is closest to the image side is denoted by fM2,
Conditional Expression (27) is satisfied, which is represented by
$$0.01 < fM 1 / fM 2 < 1.6 . \qquad ( 27 )$$

16. The variable magnification optical system according to claim 1,
wherein the subsequent group consists of a first subsequent lens group having a positive refractive power, a second subsequent lens group having a negative refractive power, and a third subsequent lens group in order from the object side to the image side.

17. The variable magnification optical system according to claim 16,
wherein in a case in which
a focal length of the first subsequent lens group is denoted by fR1, and
a focal length of the second subsequent lens group is denoted by fR2, Conditional Expression (28) is satisfied, which is represented by
$$0. 2 < f R 1 / ( - fR 2 ) < 2. \qquad ( 28 )$$

18. The variable magnification optical system according to claim 1,
wherein the subsequent group consists of a first subsequent lens group having a positive refractive power, a second subsequent lens group having a positive refractive power, and a third subsequent lens group having a negative refractive power in order from the object side to the image side.

19. The variable magnification optical system according to claim 18,
wherein in a case in which
a focal length of the second subsequent lens group is denoted by fR2, and
a focal length of the third subsequent lens group is denoted by fR3, Conditional Expression (29) is satisfied, which is represented by
$$0. 4 < fR 2 / ( - fR 3 ) < 3.7 . \qquad ( 29 )$$

20. The variable magnification optical system according to claim 18,
wherein in a case in which
a focal length of the first subsequent lens group is denoted by fR1, and
a focal length of the second subsequent lens group is denoted by fR2, Conditional Expression (30) is satisfied, which is represented by
$$0.3 < fR 1 / fR 2 < 4. \qquad ( 30 )$$

21. The variable magnification optical system according to claim 1,
wherein the subsequent group includes at least a first subsequent lens group having a positive refractive power, a second subsequent lens group having a negative refractive power, a third subsequent lens group having a positive refractive power, and a fourth subsequent lens group having a negative refractive power consecutively in order from the object side to the image side.

22. The variable magnification optical system according to claim 21,
wherein in a case in which
a focal length of the first subsequent lens group is denoted by fR1, and
a focal length of the second subsequent lens group is denoted by fR2, Conditional Expression (28A) is satisfied, which is represented by
$$0. 2 < f R 1 / ( - fR 2 ) < 1.5 . \qquad ( 28 A )$$

23. The variable magnification optical system according to claim 21,
wherein in a case in which
a focal length of the second subsequent lens group is denoted by fR2, and
a focal length of the third subsequent lens group is denoted by fR3, Conditional Expression (31) is satisfied, which is represented by
$$0.3 < ( - fR 2 ) / fR 3 < 2.4 . \qquad ( 31 )$$

24. The variable magnification optical system according to claim 21,
wherein in a case in which
a focal length of the first subsequent lens group is denoted by fR1, and
a focal length of the third subsequent lens group is denoted by fR3, Conditional Expression (32) is satisfied, which is represented by
$$0.1 < fR 1 / fR 3 < 1.4 . \qquad ( 32 )$$

25. The variable magnification optical system according to claim 21,
wherein in a case in which
a focal length of the second subsequent lens group is denoted by fR2, and
a focal length of the fourth subsequent lens group is denoted by fR4, Conditional Expression (33) is satisfied, which is represented by
$$0.15 < ( - fR 2 ) / ( - fR 4 ) < 1.8 . \qquad ( 33 )$$

26. The variable magnification optical system according to claim 1,
wherein the subsequent group includes at least a first subsequent lens group having a positive refractive power, a second subsequent lens group having a positive refractive power, a third subsequent lens group having a negative refractive power, and a fourth subsequent lens group having a positive refractive power consecutively in order from the object side to the image side.

27. The variable magnification optical system according to claim 26,
wherein in a case in which
a focal length of the first subsequent lens group is denoted by fR1, and
a focal length of the third subsequent lens group is denoted by fR3, Conditional Expression (34) is satisfied, which is represented by
$$0. 4 < fR 1 / ( - fR 3 ) < 2.5 . \qquad ( 34 )$$

28. The variable magnification optical system according to claim 26,
wherein in a case in which
a focal length of the second subsequent lens group is denoted by fR2, and
a focal length of the third subsequent lens group is denoted by fR3, Conditional Expression (29A) is satisfied, which is represented by
$$0.3 < fR 2 / ( - fR 3 ) < 3.5 . \qquad ( 29 A )$$

29. The variable magnification optical system according to claim 26,
wherein in a case in which
a focal length of the first subsequent lens group is denoted by fR1, and
a focal length of the second subsequent lens group is denoted by fR2, Conditional Expression (30A) is satisfied, which is represented by
$$0.3 < fR 1 / fR 2 < 5. \qquad ( 30 A )$$

30. The variable magnification optical system according to claim 26,
wherein in a case in which
a focal length of the second subsequent lens group is denoted by fR2, and
a focal length of the fourth subsequent lens group is denoted by fR4, Conditional Expression (35) is satisfied, which is represented by
$$0 \text{.1} < fR 2 / fR 4 < 2. \qquad ( 35 )$$

31. The variable magnification optical system according to claim 1,
wherein the subsequent group consists of a first subsequent lens group having a positive refractive power, a second subsequent lens group having a positive refractive power, a third subsequent lens group having a positive refractive power, a fourth subsequent lens group, and a fifth subsequent lens group in order from the object side to the image side.

32. The variable magnification optical system according to claim 31,
wherein in a case in which
a focal length of the first subsequent lens group is denoted by fR1, and
a focal length of the second subsequent lens group is denoted by fR2, Conditional Expression (30B) is satisfied, which is represented by
$$0.1 < fR 1 / fR 2 < 4.5 . \qquad ( 30 B )$$

33. The variable magnification optical system according to claim 31,
wherein in a case in which
a focal length of the second subsequent lens group is denoted by fR2, and
a focal length of the third subsequent lens group is denoted by fR3, Conditional Expression (36) is satisfied, which is represented by
$$0. 2 < fR 2 / fR 3 < 3. \qquad ( 36 )$$

34. The variable magnification optical system according to claim 1,
wherein the subsequent group consists of a first subsequent lens group having a positive refractive power, a second subsequent lens group having a positive refractive power, a third subsequent lens group having a negative refractive power, a fourth subsequent lens group having a negative refractive power, and a fifth subsequent lens group having a positive refractive power in order from the object side to the image side.

35. The variable magnification optical system according to claim 34,
wherein in a case in which
a focal length of the first subsequent lens group is denoted by fR1, and
a focal length of the second subsequent lens group is denoted by fR2, Conditional Expression (30C) is satisfied, which is represented by
$$0. 2 < fR 1 / fR 2 < 4. \qquad ( 30 C )$$

36. The variable magnification optical system according to claim 34,
wherein in a case in which
a focal length of the third subsequent lens group is denoted by fR3, and
a focal length of the fourth subsequent lens group is denoted by fR4, Conditional Expression (37) is satisfied, which is represented by
$$0.01 < f R 3 / f R 4 < 4 . \qquad ( 37 )$$

37. The variable magnification optical system according to claim 1,
wherein the subsequent group includes at least a first subsequent lens group having a positive refractive power, a second subsequent lens group having a negative refractive power, and a third subsequent lens group having a negative refractive power consecutively in order from the object side to the image side.

38. The variable magnification optical system according to claim 37,
wherein in a case in which
a focal length of the first subsequent lens group is denoted by fR1, and
a focal length of the second subsequent lens group is denoted by fR2, Conditional Expression (28B) is satisfied, which is represented by
$$0. 2 < f R 1 / ( - fR 2 ) < 1.8 . \qquad ( 28 B )$$

39. The variable magnification optical system according to claim 37,
wherein in a case in which
a focal length of the second subsequent lens group is denoted by fR2, and
a focal length of the third subsequent lens group is denoted by fR3, Conditional Expression (38) is satisfied, which is represented by
$$0.05 < ( - fR 2 ) / ( - f R 3 ) < 1.2 . \qquad ( 38 )$$

40. An imaging apparatus comprising:
the variable magnification optical system according to claim 1.
